(19) United States
(12) Patent Application Publication
(10) Pub. No.: US 2026/0228156 A1
(43) Pub. Date: Aug. 6, 2026

(54) Scale-Up Memory Access over IEEE 802.3 PMA in Processors and Accelerators including ARM-Based SoCs

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/576,413

(22) Filed: Mar. 24, 2026

Related U.S. Application Data
(63) Continuation-in-part of application No. 19/371,779, filed on Oct. 28, 2025, now Pat. No. 12,657,153.
Application No. 19/371,779 is a continuation of application No. 19/017,420, filed on Jan. 11, 2025, now Pat. No. 12,613,826.
Application No. 19/017,420 is a continuation-in-part of application No. 18/981,443, filed on Dec. 13, 2024.
(60) Provisional application No. 63/609,833, filed on Dec. 13, 2023.
(60) Provisional application No. 63/641,404, filed on May 1, 2024.
(60) Provisional application No. 63/652,165, filed on May 27, 2024.
(60) Provisional application No. 63/678,045, filed on Jul. 31, 2024.
(60) Provisional application No. 63/695,957, filed on Sep. 18, 2024.
(60) Provisional application No. 63/701,554, filed on Sep. 30, 2024.
(60) Provisional application No. 63/719,640, filed on Nov. 12, 2024.
(60) Provisional application No. 63/734,031, filed on Dec. 13, 2024.
(60) Provisional application No. 63/743,658, filed on Jan. 10, 2025.
(60) Provisional application No. 63/752,940, filed on Feb. 3, 2025.
(60) Provisional application No. 63/784,089, filed on Apr. 5, 2025.
(60) Provisional application No. 63/811,859, filed on May 25, 2025.
(60) Provisional application No. 63/826,342, filed on Jun. 18, 2025.
(60) Provisional application No. 63/856,653, filed on Aug. 3, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.
(60) Provisional application No. 63/991,122, filed on Feb. 25, 2026.

(51) Int. Cl. G06F 13/42

(52) U.S. Cl. CPC G06F 13/4221; G06F 2213/0026

(57) ABSTRACT

Large-scale AI and HPC systems are expected to increasingly deploy heterogeneous accelerators interconnected via high-bandwidth fabrics built on IEEE 802.3 PMA. Implementations disclose a processor comprising processing cores coupled via an interconnect, an interconnect component coupled to the interconnect, an RPU coupled to the interconnect component, a physical layer based on IEEE 802.3 PMA coupled to the RPU for communicating with an external entity, and a CXL device implemented in at least one of the RPU or the interconnect component. At least one of the RPU or the interconnect component translates between CXL transactions associated with data communicated with the external entity via the physical layer and interconnect transactions communicated via the interconnect. In other implementations, a CXL root port is coupled to the interconnect, and at least one of the RPU or the CXL root port translates between the CXL transactions and interconnect transactions communicated via the interconnect.

### CROSS-REFERENCE TO RELATED APPLICATIONS

This Application claims priority to: U.S. Provisional Patent Application No. 63/991,122, filed Feb. 25, 2026; U.S. Provisional Patent Application No. 63/931,124, filed Dec. 4, 2025; U.S. Provisional Patent Application No. 63/906,709, filed Oct. 28, 2025; U.S. Provisional Patent Application No. 63/895,053, filed Oct. 7, 2025; U.S. Provisional Patent Application No. 63/874,393, filed Sep. 2, 2025; U.S. Provisional Patent Application No. 63/856,653, filed Aug. 3, 2025; U.S. Provisional Patent Application No. 63/826,342, filed Jun. 18, 2025; U.S. Provisional Patent Application No. 63/811,859, filed May 25, 2025; and U.S. Provisional Patent Application No. 63/784,089, filed Apr. 5, 2025. This Application is also a Continuation-In-Part of U.S. patent application Ser. No. 19/371,779, filed Oct. 28, 2025, which claims priority to: U.S. Provisional Patent Application No. 63/752,940, filed Feb. 3, 2025; U.S. Provisional Patent Application No. 63/743,658, filed Jan. 10, 2025; and U.S. Provisional Patent Application No. 63/734,031, filed Dec. 13, 2024. U.S. patent application Ser. No. 19/371,779 is a Continuation of U.S. patent application Ser. No. 19/017,420, filed Jan. 11, 2025, which claims priority to: U.S. Provisional Patent Application No. 63/719,640, filed 12 Nov. 2024; U.S. Provisional Patent Application No. 63/701,554, filed 30 Sep. 2024; U.S. Provisional Patent Application No. 63/695,957, filed 18 Sep. 2024; U.S. Provisional Patent Application No. 63/678,045, filed 31 Jul. 2024; U.S. Provisional Patent Application No. 63/652,165, filed 27 May 2024; and U.S. Provisional Patent Application No. 63/641,404, filed 1 May 2024. U.S. patent application Ser. No. 19/017,420 is also a Continuation-In-Part of U.S. patent application Ser. No. 18/981,443, filed Dec. 13, 2024, which claims priority to U.S. Provisional Patent Application No. 63/609,833, filed 13 Dec. 2023.

### BACKGROUND

Compute Express Link (CXL) is an interconnect technology that enables cache-coherent memory access and high-bandwidth communication between hosts and devices in modern computing systems. CXL builds upon the physical and electrical interface defined by PCI Express (PCIe) while adding protocols that support memory semantics and cache coherency operations. The CXL specification defines sub-protocols, including CXL.io, CXL.mem, and CXL.cache. CXL devices include Type-1, Type-2, and Type-3 devices supporting different combinations of CXL sub-protocols, and Global Fabric-Attached Memory Devices (GFDs) that support CXL.mem transactions for fabric-attached memory pooling. Processors may include CXL root ports that provide root complex functionality for CXL devices coupled to the processor.

IEEE 802.3 defines standards for Ethernet and related networking technologies, including the Physical Medium Attachment (PMA) sublayer that specifies the interface between physical layer devices and the transmission medium.

### SUMMARY

Processor architecture that incorporates an interconnect may benefit from coupling CXL devices to the interconnect through interconnect components, enabling external entities to access processor memory or enabling the processor to access external resources via CXL protocols transported over IEEE 802.3-based physical layers. A resource provisioning unit (RPU) and an interconnect component may translate between CXL transactions associated with data communicated with external entities via an IEEE 802.3-based physical layer and interconnect transactions communicated via the interconnect, utilizing a CXL device implemented in at least one of the RPU or the interconnect component.

In various implementations, an apparatus comprises a processor comprising processing cores coupled via an interconnect; an interconnect component coupled to the interconnect; a resource provisioning unit (RPU) coupled to the interconnect component; a physical layer based on IEEE 802.3 physical medium attachment (PMA), coupled to the RPU, configured to communicate with an external entity; and a Compute Express Link (CXL) device implemented in at least one of the RPU or the interconnect component. At least one of the RPU or the interconnect component is configured to translate between CXL transactions and interconnect transactions, wherein the CXL transactions are associated with data communicated with the external entity via the physical layer based on IEEE 802.3 PMA, and the interconnect transactions are communicated via the interconnect. The external entity may include an accelerator, a memory device, a switch, or other entity reachable over an IEEE 802.3 PMA-based carrier, and the translation may support read and write operations as well as coherency transactions depending on the CXL sub-protocol employed.

In other implementations, a method comprises receiving, via a physical layer based on IEEE 802.3 PMA, data from an external entity; and translating, utilizing a CXL device implemented in at least one of an RPU or an interconnect component coupled to an interconnect of a processor, between CXL transactions and interconnect transactions communicated via the interconnect, wherein the processor comprises processing cores coupled via the interconnect, and the CXL transactions are associated with the data received from the external entity via the physical layer based on IEEE 802.3 PMA. The method may be performed by firmware, logic, or circuitry implemented in the RPU or the interconnect component, and may support bidirectional data flow between the interconnect domain and the external entity.

In yet other implementations, an apparatus comprises a processor comprising processing cores coupled via an interconnect; a CXL root port coupled to the interconnect; an RPU coupled to the CXL root port; and a physical layer based on IEEE 802.3 PMA, coupled to the RPU, configured to communicate with an external entity. At least one of the RPU or the CXL root port is configured to translate between CXL transactions and interconnect transactions, wherein the CXL transactions are associated with data communicated with the external entity via the physical layer based on IEEE 802.3 PMA, and the interconnect transactions are communicated via the interconnect. The CXL root port may serve as the interface through which the processor exposes CXL protocol semantics toward the RPU, enabling the RPU to bridge between the CXL domain and the IEEE 802.3 PMA-based physical layer toward the external entity.

In still other implementations, a method comprises receiving, via a physical layer based on IEEE 802.3 PMA, data from an external entity; and translating, by at least one of an RPU or a CXL root port coupled to an interconnect of a processor, between CXL transactions and interconnect transactions, wherein the processor comprises processing cores coupled via the interconnect, the CXL transactions are associated with the data received from the external entity via the physical layer based on IEEE 802.3 PMA, and the interconnect transactions are communicated via the interconnect. The method may be performed by an IC, a chiplet, or an active cable assembly, and may encompass protocol adaptation for CXL sub-protocols including CXL.io, CXL.cache, or CXL.mem, depending on the nature of the external entity and the interconnect topology.

### BRIEF DESCRIPTION OF THE DRAWINGS

FIG. 1A illustrates an example of a system comprising a processor comprising multiple interfaces;

FIG. 1B illustrates an example of a system comprising a processor capable of servicing external requests through CCGs optimized for handling CXL.mem traffic;

FIG. 2A illustrates an example of a processing pipeline for extracting passenger protocol messages from carrier protocol communications received over a PHY based on IEEE 802.3 PMA;

FIG. 2B illustrates an example of a packet structure that may be suitable for L3 switching operations;

FIG. 2C illustrates an example of a packet structure that may be suitable for L2 switching operations;

FIG. 3A, FIG. 3B, and FIG. 3C illustrate three examples of variations for the Passenger Protocol PDU that may be encapsulated within the Carrier Protocol PDU illustrated in FIG. 2B;

FIG. 4 illustrates an example of a system comprising a processor comprising an RPU based interface including an IEEE 802.3 PMA coupled to a CXL Device;

FIG. 5A illustrates an example of a system comprising a processor comprising a CXL EP and a PHY based on IEEE 802.3 PMA;

FIG. 5B illustrates an example of a TFD demonstrating CXL.mem communications over a carrier protocol utilizing PHY based on IEEE 802.3 PMA;

FIG. 6A illustrates an example of a system comprising an RPU that translates between UALink-based traffic and CXL.mem-based traffic;

FIG. 6B illustrates an example of a TFD demonstrating translations between UPLI request and CXL.mem M2S Req MemRd;

FIG. 7A illustrates an example of a system comprising an RPU that enables UALink-based entities to access CXL-based resources coupled to the RPU;

FIG. 7B illustrates an example of a TFD demonstrating intent-based translation between UPLI and CXL.mem;

FIG. 8A illustrates an example of a system comprising a processor comprising a UALink port enabling external entities to access memory resources mapped to an address space utilized by the processor's coherent interconnect;

FIG. 8B illustrates an example of a TFD demonstrating two UPLI requests forwarded to different memories mapped to an address space utilized by a processor's coherent interconnect;

FIG. 9A illustrates an example of a system comprising a processor comprising a coherent interconnect, a UALink port, and a CXL RP;

FIG. 9B illustrates an example of a TFD demonstrating translating two UPLI requests to a coherent interconnect request and to a CXL.mem request;

FIG. 10A illustrates an example of a system that translates between UALink-based traffic and CXL.mem traffic;

FIG. 10B illustrates an example of a TFD demonstrating translations between UPLI request and CXL.mem request, with an optional speculative memory read;

FIG. 11A illustrates an example of a system that translates between first and second CXL.mem;

FIG. 11B illustrates an example of a transaction flow diagram (TFD) demonstrating translations between CXL.mem M2S MemRdData request and CXL.mem M2S MemRd request, with optional speculative memory reads;

FIG. 12A illustrates an example of a system comprising a computer, having a buffer/cache, which translates between first and second CXL.mem;

FIG. 12B illustrates an example of a TFD demonstrating translations between a first CXL.mem M2S MemSpecRd and a second CXL.mem M2S MemSpecRd, with an optional initiation of a third CXL.mem M2S MemSpecRd;

FIG. 12C illustrates an example of a TFD demonstrating translations between CXL.mem M2S MemSpecRd and CXL.mem M2S MemRd*;

FIG. 13A illustrates an example of a system that translates between three CXL.mem interfaces;

FIG. 13B illustrates an example of a TFD demonstrating translations between four CXL.mem M2S requests;

FIG. 14A illustrates an example of a system comprising a processor/switch with a CXL device configured to enable external entities to access resources coupled to the processor;

FIG. 14B illustrates an example of a TFD demonstrating translations between first and second CXL.mem transactions comprising MemRd*;

FIG. 15A illustrates an example of a system comprising a processor configured to communicate with multiple hosts according to CXL.mem;

FIG. 15B illustrates an example of a TFD demonstrating two CXL.mem transactions directed to different memories coupled to a processor;

FIG. 16A illustrates an example of a system that translates between UALink-based traffic and CXL.cache traffic when communicating with a host;

FIG. 16B illustrates an example of a TFD demonstrating translations between a UPLI request and a CXL.cache D2H RdCurr request;

FIG. 16C illustrates an example of a TFD demonstrating translations between a UPLI request and a CXL.cache D2H RdShared request;

FIG. 17A illustrates an example of a system that translates between UALink-based traffic and CXL.cache traffic when communicating with a device;

FIG. 17B illustrates an example of a TFD demonstrating translations between a UPLI request and a CXL.cache H2D SnpCur request;

FIG. 17C illustrates an example of a TFD demonstrating translations between a UPLI request and a CXL.cache H2D SnpData request;

FIG. 18A illustrates an example of a system comprising a processor comprising an RPU chiplet that translates between UALink and CXL;

FIG. 18B illustrates an example of a TFD demonstrating translating a UPLI request to a protocol utilized by a processor's coherent interconnect;

FIG. 19A illustrates an example of a system comprising a cable that translates between UALink-based traffic and CXL-based traffic;

FIG. 19B illustrates an example of an active optical cable comprising an RPU that translates between UALink-based traffic and CXL-based traffic;

FIG. 20A illustrates an example of a system that translates between UALink-based traffic and CXL-based traffic;

FIG. 20B illustrates an example of a TFD demonstrating translations between a UPLI transaction comprising UPLI read response/data and a CXL transaction;

FIG. 20C illustrates an example of a TFD demonstrating translations between a UPLI transaction comprising UPLI write response and a CXL transaction;

FIG. 21A illustrates an example of a system comprising an apparatus that translates between NVLink-based traffic and CXL.mem traffic;

FIG. 21B illustrates an example of a TFD demonstrating translations between NVLink-based traffic and CXL.mem traffic;

FIG. 22A illustrates an example of a system, comprising an RPU having an NVLink interface, which enables a GPU to access resources coupled to the RPU over CXL.mem;

FIG. 22B illustrates an example of a TFD demonstrating translations between an NVLink-based protocol and CXL.mem utilized for communicating with a CXL device or CXL memory;

FIG. 22C illustrates an example of a TFD demonstrating translations between NVLink-based requests and CXL.mem requests;

FIG. 23A illustrates an example of a system that translates between an NVLink-based protocol and a CXL protocol;

FIG. 23B illustrates an example of a system comprising an RPU in an NVLink switch or NVSwitch, coupled to NVLink and CXL.mem entities;

FIG. 23C illustrates an example of a system comprising an xPU with an NVLink Fusion chiplet;

FIG. 24A illustrates an example of a system comprising a processor including a coherent interconnect and an NVLink interface;

FIG. 24B illustrates an example of a TFD demonstrating two NVLink read requests forwarded to different memories via a coherent interconnect;

FIG. 25A illustrates an example of a system comprising a processor comprising an NVLink interface and a CXL RP;

FIG. 25B illustrates an example of a TFD demonstrating translating a first NVLink request to a coherent interconnect protocol, and translating a second NVLink read request to a CXL.mem M2S MemRd request;

FIG. 26A illustrates an example of a TFD demonstrating intent-based translations between CXL.mem M2S SnpCur and CXL.cache D2H RdCurr;

FIG. 26B illustrates an example of a TFD demonstrating intent-based translations between CXL.mem M2S SnpData and CXL.cache D2H RdShared;

FIG. 26C illustrates an example of a TFD demonstrating intent-based translations between CXL.mem M2S SnpInv and CXL.cache D2H RdOwn;

FIG. 27A illustrates an example of a TFD demonstrating intent-based translations between CXL.cache D2H RdCurr and CXL.mem M2S SnpCur;

FIG. 27B illustrates an example of a TFD demonstrating intent-based translations between CXL.cache D2H RdShared and CXL.mem M2S SnpData;

FIG. 27C illustrates an example of a TFD demonstrating intent-based translations between CXL.cache D2H RdOwn and CXL.mem M2S SnpInv;

FIG. 28A illustrates an example of a system comprising a memory switch, a memory pool, or a Global Fabric-Attached Memory Device;

FIG. 28B illustrates an example of a system comprising a memory pool coupled to hosts and to a memory expander;

FIG. 29A illustrates an example of a system comprising a memory pool comprising two or more MxPUs;

FIG. 29B illustrates an example of a system comprising a memory pool comprising at least one MxPU and at least one xPU or CPU;

FIG. 30A illustrates an example of a system comprising a memory pool comprising a processor, DRAM, and an RPU performing host-to-host physical address translations;

FIG. 30B illustrates an example of a system comprising a memory pool comprising a CXL Multi Headed Device (MHD) comprising a processor coupled to DRAM;

FIG. 31 illustrates an example of a system comprising an AI memory switch or a memory pool, comprising a CXL Multi Headed Device (MHD);

FIG. 32A illustrates an example of a system wherein an entity is coupled via an IEEE 802.3 PHY to an RPU comprising a CXL device coupled to an ARM architecture processor;

FIG. 32B illustrates an example of a TFD demonstrating translating CXL.mem messages to ARM CHI requests;

FIG. 33 illustrates an example of a multi-host memory pooling or sharing utilizing a switch-based topology with physical layers based on IEEE 802.3 PMA;

FIG. 34A illustrates an example of a system that translates between PCIe and CXL.mem;

FIG. 34B illustrates an example of a TFD demonstrating translations between PCIe TLPs and CXL.mem messages;

FIG. 34C illustrates an example of a TFD demonstrating translations between PCIe UIO TLPs and CXL.mem messages;

FIG. 35A illustrates an example of a system that translates between first and second CXL.cache;

FIG. 35B illustrates an example of a transaction flow diagram (TFD) demonstrating translations between CXL.cache H2D SnpInv request and CXL.cache D2H CLFlush request;

FIG. 35C illustrates an example of a TFD demonstrating translations between CXL.cache H2D SnpCur request and CXL.cache D2H RdCurr request;

FIG. 36A illustrates an example of a system that translates between CXL.cache messages, such as between CXL.cache Host-to-Device (H2D) requests and CXL.cache Device-to-Host (D2H) requests;

FIG. 36B illustrates an example of a TFD demonstrating translations between CXL.cache transactions;

FIG. 37A illustrates an example of a system that translates between CXL.cache messages, such as between CXL.cache H2D requests comprising Snoops and CXL.cache D2H requests comprising read opcodes;

FIG. 37B illustrates an example of a TFD demonstrating translations between CXL.cache H2D request comprising SnpData and CXL.cache D2H request comprising RdShared;

FIG. 37C illustrates an example of a TFD demonstrating translations between CXL.cache H2D request comprising SnpData and CXL.cache D2H request comprising RdOwn;

FIG. 37D illustrates an example of a TFD demonstrating translations between CXL.cache H2D request comprising SnpInv and CXL.cache D2H request comprising CLFlush;

FIG. 38A illustrates an example of a TFD demonstrating translations between CXL.cache H2D SnpInv and CXL.cache D2H RdOwnNoData;

FIG. 38B illustrates an example of a TFD demonstrating translations between CXL.cache H2D SnpInv and CXL.cache D2H RdOwn, returning a cacheline in Modified state (GO-M);

FIG. 38C illustrates an example of a TFD demonstrating translations between CXL.cache H2D SnpInv and CXL.cache D2H RdOwn, returning a cacheline in Exclusive state (GO-E);

FIG. 39A illustrates an example of a system that translates between CXL.cache messages;

FIG. 39B illustrates an example of a TFD demonstrating translations between CXL.cache H2D SnpData and CXL.cache D2H RdShared, returning a cacheline in Shared state (GO-S);

FIG. 40A illustrates an example of a system that translates between CXL.cache messages that affect cacheline state transitions;

FIG. 40B illustrates an example of a transaction flow diagram (TFD) demonstrating translations between CXL.cache D2H CLFlush request and CXL.cache H2D SnpInv request; and

FIG. 40C illustrates an example of a TFD demonstrating translations between CXL.cache D2H RdCurr and CXL.cache H2D SnpCur.

### DETAILED DESCRIPTION

Some implementations of the following apparatus relate to processor architectures that incorporate interconnects with CXL protocol interfaces coupled through interconnect components and RPUs for enabling CXL communication with external entities via a physical layer based on IEEE 802.3 PMA. The interconnect within the processor may be implemented as a mesh interconnect that routes messages among processing cores, cache controllers, home agents, memory controllers, and interface agents through crosspoints or similar routing elements. Interconnect components, such as ARM CCG, may bridge CXL protocol domains with CHI protocol domains on the interconnect, enabling CXL devices coupled to RPUs to exchange coherent and non-coherent traffic with agents on the interconnect. The CXL device may be implemented in at least one of the RPU or the interconnect component, and may serve as the CXL endpoint logic that enables CXL transactions between the external entities and the interconnect. The RPU and the interconnect component may together perform the translation between CXL transactions associated with data communicated with external entities via the physical layer based on IEEE 802.3 PMA, and interconnect transactions communicated via the interconnect. The translation may include extracting CXL information from carrier protocol PDUs, reconstructing CXL transactions, performing address and Tag translations, translating CXL transactions to interconnect transactions, and encapsulating CXL responses for transmission back to external entities.

In various implementations, an apparatus comprising: a processor comprising processing cores coupled via an interconnect; an interconnect component coupled to the interconnect; a resource provisioning unit (RPU) coupled to the interconnect component; a physical layer based on IEEE 802.3 physical medium attachment (PMA), coupled to the RPU, configured to communicate with an external entity; a Compute Express Link (CXL) device implemented in at least one of the RPU or the interconnect component; and wherein at least one of the RPU or the interconnect component is configured to translate between CXL transactions and interconnect transactions; wherein the CXL transactions are associated with data communicated with the external entity via the physical layer based on IEEE 802.3 PMA, and the interconnect transactions are communicated via the interconnect. The processor may be implemented as a SoC, a multi-chip module, or a chiplet-based design incorporating processing cores, an interconnect, and various interface agents. The interconnect may provide a scalable on-chip fabric that routes transactions among agents based on packet identifiers, node addresses, or other routing information. The interconnect component may translate between CXL transactions (such as CXL.mem M2S and S2M transactions, CXL.cache H2D and D2H transactions) and interconnect transactions (such as CHI Read, Write, Snoop, and Data transactions) for communication with agents on the interconnect. The CXL device, implemented in at least one of the RPU or the interconnect component, may present CXL endpoint functionality, implementing the CXL protocol logic for one or more CXL sub-protocols. The RPU and the interconnect component may together perform carrier-to-CXL and CXL-to-interconnect protocol translations, enabling external entities connected via the IEEE 802.3 PMA to exchange CXL traffic with the processor's interconnect-coupled agents. Multiple interconnect components may be utilized to provide ports or to handle different CXL sub-protocols.

In the context of coherent interconnects, an interconnect component may refer to various types of devices, blocks, or functional entities that participate in, terminate, bridge, gateway, aggregate, or otherwise interface with a coherent or non-coherent fabric. Non-limiting examples of interconnect components may include router modules, request nodes, home nodes, subordinate nodes, gateways, bridges, and domain bridges. For example, in certain revisions of ARM-based coherent mesh architectures, such as the ARM Neoverse and CoreLink CMN families, interconnect components may include: crosspoint (XP) router blocks; Request Nodes, such as Fully Coherent Request Node (RN-F), I/O-coherent Request Node (RN-I), or I/O-coherent Request Node with Distributed Virtual Memory support (RN-D); Home Nodes, such as Fully Coherent Home Node (HN-F) or I/O-coherent Home Node (HN-I); Gateways, such as CXL/CCIX Gateway (CCG) blocks used with Coherent Multichip Link (CML) or external CXL attachment, or CCIX Gateway (CXG) bridging between CHI and CXS interfaces; and Bridges, such as AMBA 5 CHI to ACE5-Lite bridge (SBSX), AMBA Domain Bridge (ADB), CHI Domain Bridge (CDB), or CXS Domain Bridge (CXSDB). Other revisions of ARM architectures or other coherent interconnect architectures may define different interconnect component types, classifications, or naming conventions.

In some implementations of the apparatus, the interconnect component comprises an ARM CXL/CCIX Gateway (CCG). The CCG may translate between CXL and CHI protocol domains. The CCG may be coupled to the interconnect via one or more ports at a crosspoint.

In some implementations of the apparatus, the interconnect comprises a mesh interconnect, the mesh interconnect comprising crosspoints (XPs) configured to route interconnect transactions between the processing cores, the interconnect component, and memory controllers based on packet identifiers. The crosspoints may function as routing elements at intersections within the mesh topology, examining fields within packets to determine the appropriate output port and routing path. Packet identifiers may include target node identifiers, address-based routing information, or other fields defined by the interconnect protocol for mesh routing. The crosspoints may connect to processing cores, LLC slices, home agents, memory controllers, interconnect components, RN-D nodes, SN-F nodes, and other agents on the mesh interconnect.

In some implementations, the apparatus further comprises an I/O-coherent Request Node with Distributed Virtual Memory support (RN-D) coupled to the interconnect, the RN-D configured to handle CXL.io or non-coherent traffic between the CXL device and the processing cores. The RN-D may handle CXL.io configuration reads and writes, memory-mapped I/O (MMIO) access, and other non-coherent transactions. The RN-D may support Distributed Virtual Memory (DVM) operations, which may enable synchronization of virtual memory management operations across the interconnect.

In some implementations, the apparatus further comprises Subordinate Node (SN-F) nodes coupled to memory controllers, the memory controllers coupled to DRAM via DDR PHY and memory channels. The SN-F nodes may serve as subordinate agents on the interconnect that interface between the interconnect protocol domain and the memory controllers. The SN-F nodes may include snoop filter functionality for tracking cacheline state and location across the interconnect. The memory controllers may access DRAM through DDR PHY interfaces and memory channels, supporting memory technologies such as DDR4, DDR5, LPDDR5, or HBM. When a CXL.mem request from an external entity is translated through the RPU, the request may be routed through the interconnect to a home node, which may in turn access the SN-F node and memory controller to read from or write to DRAM.

In some implementations of the apparatus, the interconnect component comprises a CXL Streaming (CXS) interface and a Coherent Multichip Link (CML) gateway or a Cache Coherent Interconnect for Accelerators (CCIX) Gateway (CXG) that utilizes the CXS interface. Utilizing the CXS interface may enable modular design where different CXL device configurations can be paired with different interconnect component implementations. The CXS interface may support flow control, credit management, and virtual channels for different CXL sub-protocols. The CML gateway or CXG may utilize the CXS interface as the streaming interface protocol for exchanging CXL transactions between the CXL device and the interconnect. The CML gateway may provide coherent multichip link functionality that extends the coherent interconnect across chip boundaries, while the CXG may provide CCIX-based gateway functionality that bridges between CXL and CHI protocol domains with CCIX compatibility. Optionally, a 32-bit cyclic-redundancy check (CRC-32) may be applied to transactions conforming to the CXS interface to detect bit errors, which may be beneficial when the CXS interface spans die-to-die boundaries within a multi-chip module or chiplet-based design where signal integrity conditions may differ from on-die interconnects.

In some implementations of the apparatus, the interconnect component is configured to initiate a CHI allocating ReadShared request to a Home Node in response to a CXL.mem request, wherein the Home Node is coupled to a memory controller. When the RPU receives a CXL.mem read request from an external entity via the physical layer based on IEEE 802.3 PMA and translates it into a CXL transaction, the interconnect component may translate the CXL.mem request into a CHI allocating ReadShared request directed to the Home Node responsible for the targeted address.

In some implementations of the apparatus, the Home Node is configured to send a ReadNoSnp request to the memory controller, and the memory controller is configured to return data to the interconnect component using a CompData response. The combined response optimization may reduce transaction latency by enabling the memory controller to send response data directly to the interconnect component as the requester, rather than routing the data back through the Home Node.

In some implementations of the apparatus, the CXL device comprises a Global Fabric-Attached Memory Device (GFD) supporting CXL.mem transactions, and the interconnect component is optimized for handling CXL.mem traffic. The GFD may operate as a specialized CXL device that supports CXL.mem transactions without supporting CXL.io or CXL.cache sub-protocols. By limiting the supported sub-protocols to CXL.mem, the GFD and the associated interconnect component may be optimized specifically for memory access operations, simplifying the design by eliminating the need for separate CXL.io handling paths that would otherwise be managed by RN-D or RN-I nodes. This simplified architecture may be suitable for processors or accelerators designed for servicing external memory requests through fabric-attached memory pooling, where CXL.io configuration and enumeration may be handled through alternative mechanisms or may not be utilized.

In some implementations of the apparatus, the data communicated with the external entity via the physical layer based on IEEE 802.3 PMA comprises protocol data units (PDUs) of a carrier protocol encapsulating CXL PDUs, and the RPU is configured to extract CXL PDUs from the carrier protocol PDUs. The carrier protocol may include Ethernet, Ultra Ethernet Transport (UET), Ethernet for Scale-Up Networking (ESUN), Scale Up Ethernet (SUE), UALink, NVLink, or other protocols that utilize the IEEE 802.3 PMA for data transmission. The carrier protocol PDUs may encapsulate CXL information within carrier protocol headers and trailers, including encapsulating headers with fields such as source and destination node identifiers, segmentation identifiers, PDU sequence numbers, and passenger protocol identifiers. The RPU may extract the encapsulated CXL PDUs by parsing the carrier protocol headers, identifying the passenger protocol type, extracting CXL fields from the carrier protocol payload, translating field formats between carrier and CXL representations, and reconstructing complete CXL PDUs conforming to the CXL specification. The extracted and reconstructed CXL transactions may then be communicated to the interconnect component for translation to interconnect transactions.

In some implementations of the apparatus, the external entity comprises at least one of a GPU, an accelerator, or a switch, and the apparatus is configured to enable the external entity to access memory coupled to memory controllers of the processor via the RPU and the interconnect component. External entities such as GPUs, accelerators (including AI/ML accelerators, FPGAs, and data processing units), or switches may communicate with the processor through a carrier protocol fabric via the physical layer based on IEEE 802.3 PMA. The RPU and the interconnect component may translate carrier protocol PDUs from these external entities into interconnect transactions that traverse the interconnect to home nodes and memory controllers, which access DRAM to service the requests. This path may enable external entities to read from or write to the processor's memory for purposes such as shared memory access in heterogeneous computing environments, memory pooling across a fabric, or remote direct memory access (RDMA) operations.

In various implementations, a method comprising: receiving, via a physical layer based on IEEE 802.3 physical medium attachment (PMA), data from an external entity; translating, utilizing a Compute Express Link (CXL) device implemented in at least one of a resource provisioning unit (RPU) or an interconnect component coupled to an interconnect of a processor, between CXL transactions and interconnect transactions communicated via the interconnect; and wherein the processor comprises processing cores coupled via the interconnect, and the CXL transactions are associated with the data received from the external entity via the physical layer based on IEEE 802.3 PMA. The receiving of data may include receiving carrier protocol PDUs from the external entity via the physical layer based on IEEE 802.3 PMA. The translating may include extracting CXL information from the received data, reconstructing CXL transactions conforming to the CXL specification, and translating the CXL transactions into interconnect transactions for routing through the interconnect. The CXL device, implemented in at least one of the RPU or the interconnect component, may provide the CXL protocol endpoint functionality utilized during the translation.

In some implementations of the method, the data comprises protocol data units (PDUs) of a carrier protocol encapsulating CXL PDUs, and the translating comprises extracting CXL PDUs from the carrier protocol PDUs and reconstructing CXL transactions from the extracted CXL PDUs. The carrier protocol PDUs may include headers and trailers specific to the carrier protocol (such as Ethernet, UET, ESUN, or SUE), encapsulating headers with routing and identification metadata, and a payload containing CXL PDU fields. The extraction may involve parsing the carrier protocol structure, identifying the CXL sub-protocol type from a passenger protocol identifier, extracting CXL fields such as opcodes, addresses, and transaction identifiers, and translating field formats where the carrier protocol utilizes different encodings than the CXL specification. Reconstruction may include assembling the extracted and translated fields into complete CXL transactions and inserting any fields that were omitted from the carrier protocol PDU for bandwidth optimization, utilizing configuration parameters or default values for the omitted fields.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

Some implementations of the following apparatus further relate to processor architectures where a CXL root port couples to an interconnect for exchanging CXL traffic with external entities via an RPU and a physical layer based on IEEE 802.3 PMA. A root port may provide root complex functionality and may couple to the interconnect through different nodes depending on the types of CXL traffic to be supported. In one configuration, the root port may couple to a fully coherent request node (RN-F) and a fully coherent home node (HN-F), enabling bidirectional coherent access where external entities access the processor's memory and the processor's cores access resources coupled to external entities. In another configuration, the root port may couple to a CXL/CCIX Gateway (CCG) and an RN-D node, providing coherent CXL.mem handling through the CCG and non-coherent CXL.io handling through the RN-D node.

In various implementations, an apparatus comprising: a processor comprising processing cores coupled via an interconnect; a Compute Express Link (CXL) root port coupled to the interconnect; a resource provisioning unit (RPU) coupled to the CXL root port; a physical layer based on IEEE 802.3 physical medium attachment (PMA), coupled to the RPU, configured to communicate with an external entity; and wherein at least one of the RPU or the CXL root port is configured to translate between CXL transactions and interconnect transactions; wherein the CXL transactions are associated with data communicated with the external entity via the physical layer based on IEEE 802.3 PMA, and the interconnect transactions are communicated via the interconnect. The CXL root port may provide root complex functionality for CXL devices and endpoints coupled to or accessed through the RPU and the IEEE 802.3 PMA. The root port may be coupled to the interconnect through one or more intermediate nodes that translate between CXL protocol transactions and interconnect protocol transactions for communication with agents on the interconnect. The specific node configuration through which the root port is coupled to the interconnect may vary depending on the types of CXL traffic to be supported and the coherency requirements of the deployment. The RPU and the CXL root port may together translate between CXL transactions associated with data from external entities (received as carrier protocol PDUs via the IEEE 802.3 PMA) and interconnect transactions communicated via the interconnect.

In some implementations of the apparatus, the CXL root port is coupled to a fully coherent request node (RN-F) and a fully coherent home node (HN-F) on the interconnect. The RN-F and HN-F may be included within a gateway or bridge node structure coupled between the root port and the interconnect. The RN-F may act as a fully coherent request node that participates in the interconnect coherency protocol, enabling it to issue fully coherent requests (such as ReadShared, ReadUnique, or MakeUnique) on behalf of external entities whose CXL traffic arrives through the RPU and root port. The HN-F may act as a fully coherent home node that manages a portion of the address space, enabling the processor's cores to issue coherent requests to resources accessible through the external entity. Together, the RN-F and HN-F may enable bidirectional coherent communication between the processor and external entities through the CXL root port path.

In some implementations of the apparatus, the RN-F enables the external entity to access memory coupled to memory controllers of the processor via the physical layer based on IEEE 802.3 PMA, the RPU, the CXL root port, and the RN-F. When the external entity, such as a GPU or a storage device, transmits a read or write request encapsulated within a carrier protocol PDU, the RPU may extract the CXL request, translate it into a CXL transaction, and deliver it via the root port to the RN-F node on the interconnect. The RN-F may issue a corresponding interconnect request (such as a ReadShared or WriteBack) to the Home Node responsible for the targeted address, which may access the memory controller and DRAM to service the request. The response data may traverse back through the interconnect to the RN-F, the root port, the RPU, and the physical layer for delivery to the external entity. This path may enable external entities to access the processor's DRAM with full cache coherency, meaning that if the targeted cacheline is present in any of the processor's caches, the coherency protocol may handle the applicable snoops and state transitions.

In some implementations of the apparatus, the HN-F enables the processing cores to access a resource coupled to the external entity via the interconnect, the CXL root port, the RPU, and the physical layer based on IEEE 802.3 PMA. The HN-F may serve as a home node proxy for an address range that maps to resources coupled to the external entity, such as HBM coupled to a GPU, storage buffers coupled to a storage device, or memory-mapped registers of a remote accelerator. When a processing core issues a coherent read or write to an address within this range, the request may be routed through the interconnect to the HN-F, which may translate the interconnect request into a CXL transaction delivered through the root port to the RPU. The RPU may encapsulate the CXL transaction within a carrier protocol PDU and transmit it via the physical layer to the external entity for servicing. The response from the external entity may traverse the reverse path back to the processing core. This outbound path may enable the processor's cores to access external resources with coherency, without requiring the cores to be aware that the resource is accessible via a carrier protocol fabric.

In some implementations of the apparatus, the CXL root port is coupled to the interconnect via a CXL/CCIX Gateway (CCG) and an I/O-coherent Request Node with Distributed Virtual Memory support (RN-D). In this configuration, the CXL root port may couple to the interconnect through a CCG for handling coherent traffic, and through an RN-D node for handling non-coherent traffic. The CCG may translate CXL.mem and CXL.cache transactions arriving through the root port into interconnect transactions for communication with agents on the interconnect. The RN-D node may handle CXL.io or PCIe traffic that does not require full cache coherency but may participate in DVM operations. This configuration may provide a different balance of functionality compared to the RN-F/HN-F configuration, potentially offering advantages for workloads that primarily utilize CXL.mem for memory access combined with CXL.io for device configuration and management.

In some implementations of the apparatus, the CCG is optimized for handling CXL.mem traffic. The CCG in this configuration may be optimized specifically for CXL.mem transactions, potentially simplifying the translation logic by focusing on memory read, memory write, and related memory operations without the overhead of supporting CXL.cache coherency operations through the root port path. The optimization may reduce the logic area, power consumption, and latency of the CXL-to-interconnect translation for CXL.mem traffic. When CXL.cache operations are not expected through the root port path (for example, when cache coherency is managed through a separate path or is not utilized), the CCG may omit or disable the CXL.cache translation logic, further simplifying the design.

In some implementations of the apparatus, the RN-D is configured to handle CXL.io or PCIe traffic communicated via the CXL root port. The RN-D may receive CXL.io or PCIe transactions from the root port and communicate them to the interconnect for routing to the appropriate agents. CXL.io traffic may include configuration reads and writes for device enumeration and management, MMIO access for device control, and other non-coherent transactions defined by the CXL.io (PCIe-based) protocol. The RN-D may support DVM operations that enable synchronization of virtual memory management across the interconnect. The separation of CXL.mem traffic (handled by the CCG) and CXL.io traffic (handled by the RN-D) through the same root port may enable the root port to support the full range of CXL sub-protocols while utilizing specialized nodes for each traffic type.

In some implementations, the apparatus further comprises Subordinate Nodes (SN-F) coupled to memory controllers, the memory controllers coupled to DRAM via DDR PHY and memory channels. The memory subsystem in the root port architecture may be similar to that in the CXL device architecture, with SN-F nodes serving as subordinate agents that interface between the interconnect protocol domain and the memory controllers. CXL traffic arriving through the root port path may ultimately be serviced by the memory controllers accessing DRAM through the DDR PHY and memory channels, after traversal through the interconnect and home node processing.

In some implementations of the apparatus, the data communicated with the external entity via the physical layer based on IEEE 802.3 PMA comprises protocol data units (PDUs) of a carrier protocol encapsulating CXL PDUs, and the RPU is configured to extract CXL PDUs from the carrier protocol PDUs. The carrier protocol PDUs may include Ethernet, UET, ESUN, SUE, or other carrier protocol frames carrying encapsulated CXL information within headers, payloads, and trailers. The RPU may parse the carrier protocol structure, extract CXL fields, translate between carrier and CXL field formats, and deliver reconstructed CXL transactions to the root port for communication with the interconnect.

In some implementations of the apparatus, the external entity comprises at least one of a GPU, an accelerator, or a switch, and the apparatus is configured to enable the external entity to access memory coupled to memory controllers of the processor via the RPU, the CXL root port, and the interconnect. External entities communicating through a carrier protocol fabric may access the processor's memory through the root port path, with the RPU and the CXL root port translating carrier protocol PDUs into interconnect transactions routed to home nodes and memory controllers. The type of external entity may influence the traffic patterns and CXL sub-protocols utilized: GPUs may generate high-bandwidth CXL.mem read and write requests for shared memory access, accelerators may combine CXL.mem access with CXL.io for device control, and switches may aggregate and route CXL traffic from downstream entities. The root port path may provide advantages for certain entity types that benefit from root complex enumeration and management capabilities.

In some implementations of the apparatus, the interconnect comprises a mesh interconnect, the mesh interconnect comprising crosspoints (XPs) configured to route interconnect transactions between the processing cores, the CXL root port, and memory controllers based on packet identifiers. The crosspoints in the root port architecture may route interconnect transactions between agents including the processing cores, the nodes through which the root port couples to the interconnect (such as RN-F, HN-F, CCG, or RN-D nodes), home agents, SN-F nodes, memory controllers, and other agents. The routing based on packet identifiers may enable the crosspoints to direct transactions along the mesh topology from source to destination without centralized routing control. The crosspoints may support virtual channels, quality-of-service levels, and flow control mechanisms defined by the interconnect protocol.

In various implementations, a method comprising: receiving, via a physical layer based on IEEE 802.3 physical medium attachment (PMA), data from an external entity; translating, by at least one of a resource provisioning unit (RPU) or a Compute Express Link (CXL) root port coupled to an interconnect of a processor, between CXL transactions and interconnect transactions; wherein the processor comprises processing cores coupled via the interconnect, the CXL transactions are associated with the data received from the external entity via the physical layer based on IEEE 802.3 PMA, and the interconnect transactions are communicated via the interconnect. The receiving of data may include receiving carrier protocol PDUs from external entities such as GPUs, accelerators, or switches. The translating may include extracting CXL information from the received data, reconstructing CXL transactions, and translating the CXL transactions into interconnect transactions for routing to agents on the interconnect through the root port and its coupled nodes.

In some implementations of the method, the CXL root port is coupled to a fully coherent request node (RN-F) and a fully coherent home node (HN-F) on the interconnect, the RN-F enabling the external entity to access memory coupled to memory controllers of the processor, and the HN-F enabling the processing cores to access a resource coupled to the external entity. The bidirectional coherent access method may enable external entities to read from or write to the processor's memory through the RN-F path, and may enable the processor's cores to read from or write to resources coupled to external entities through the HN-F path. The inbound path through the RN-F may involve the RPU extracting and translating incoming data into CXL transactions, which the root port delivers to the RN-F for issuance as interconnect requests. The outbound path through the HN-F may involve the processing cores issuing coherent requests that the HN-F translates into CXL transactions delivered through the root port and RPU for transmission to the external entity via the physical layer. Both paths may operate simultaneously, enabling full-duplex coherent communication between the processor and external entities.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

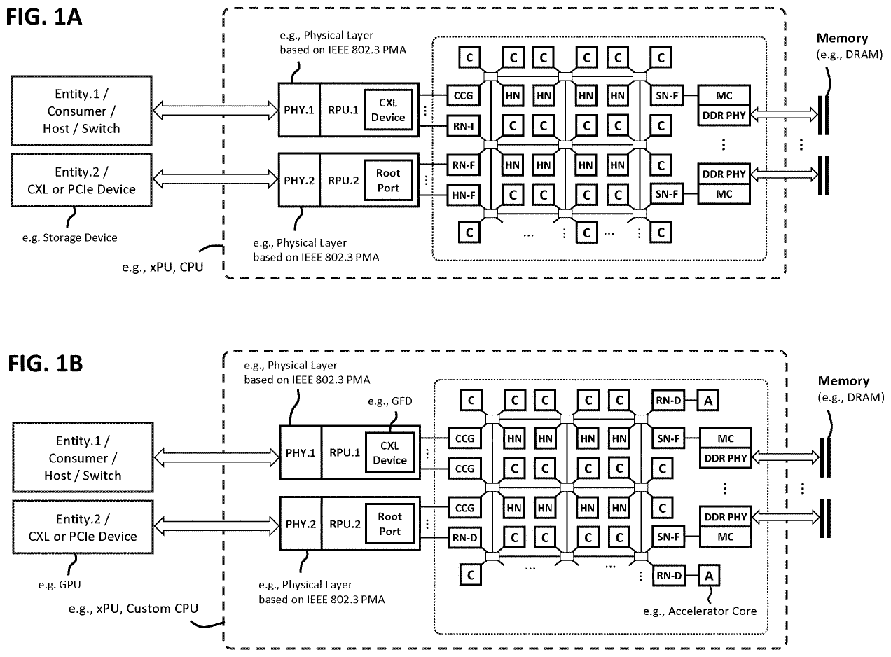

FIG. 1A illustrates an example of a system comprising a processor comprising interfaces that may utilize a physical layer based on IEEE 802.3 PMA. A first RPU includes or is coupled to a CXL device that is coupled to both a CCG node for handling coherent CXL.mem and/or CXL.cache transactions and an RN-D node for handling non-coherent CXL.io transactions, where the CXL device may be implemented in at least one of the RPU or the CCG. The system may couple the first RPU to the CCG over a CXS interface, providing a path for coherent communications. A second RPU includes or is coupled to a root port that is coupled to both a fully coherent request node (RN-F) and a fully coherent home node (HN-F) that may be included within a gateway or a bridge node structure, enabling bidirectional coherent access wherein an external entity, such as a GPU or a storage device, may read from the processor's DRAM through the RN-F node, and in the opposite direction, the processor cores may read from the GPU's HBM or from buffers in the storage device through the HN-F node.

FIG. 1B illustrates an example of a system comprising an xPU or a CPU, which may be a custom CPU design, incorporating accelerator cores and interfaces that may utilize a physical layer based on IEEE 802.3 PMA. A Global Fabric-Attached Memory Device (GFD), utilized by a first RPU, may operate as a specialized CXL device that supports only CXL.mem transactions, allowing the GFD to service external requests through CCGs that are optimized for handling CXL.mem traffic, thereby simplifying the design by eliminating the need for separate CXL.io handling paths typically managed by RN-D or RN-I nodes. The system further includes an optional second RPU that includes or is coupled to a root port, coupled to the interconnect via a CCG and an I/O-Coherent Request Node with DVM support (RN-D), wherein the RN-D may handle CXL.io or PCIe traffic.

It is noted that a line in the drawings may denote more than one port, interface, or link. For example, a single line connecting a CCG to an XP may represent two ports, such as one port for a Request Agent (RA) proxy and another port for a Home Agent (HA) proxy.

Coherent Hub Interface (CHI) employs a role-based node classification system. Non-limiting examples of CHI node types may include the following. Request Nodes (RN) may generate transactions, including reads and writes, to the interconnect. For example, a Fully Coherent Request Node (RN-F) may include a hardware-coherent cache and may support snoop transactions. An I/O-Coherent Request Node with Distributed Virtual Memory (DVM) support (RN-D) may not include a hardware-coherent cache but may receive DVM transactions and generate a subset of transactions defined by the protocol. An I/O-Coherent Request Node (RN-I) may not include a hardware-coherent cache and may not receive DVM transactions, generating a subset of transactions defined by the protocol without requiring snoop functionality. Home Nodes (HN) may be located within the interconnect and may receive transactions from Request Nodes. For example, a Fully Coherent Home Node (HN-F) may include a Point of Coherence (PoC) that manages coherency by snooping the required RN-Fs, consolidating the snoop responses for a transaction, and sending a single response to the requesting Request Node. HN-F nodes are expected to be the Point of Serialization (PoS) for memory requests, and may include a snoop filter or directory and an integrated interconnect cache. An I/O-coherent Home Node (HN-I) may process a limited subset of request types and may serve as the PoS for IO requests targeting the IO subsystem. Subordinate Nodes (SN) may receive requests from Home Nodes and return responses. For example, a Subordinate Node (SN-F) may be used for normal memory and may be capable of processing non-snoopable read, write, and atomic requests, including Cache Maintenance Operation (CMO) requests. Other CHI implementations may define additional or different node types and classifications.

References herein to ARM CHI component types, such as RN-F, HN-F, HN-I, RN-I, RN-D, SN-F, CCG, CXG, and XP, are intended to encompass the functionality associated with these designations as defined in the ARM AMBA CHI Architecture Specifications and related ARM documentations, including present and future revisions that may refine, rename, or extend these designations.

In some examples utilizing ARM-based coherent mesh architectures, crosspoints (XP) may function as routing nodes that direct traffic between different components of the system. For example, crosspoints may route packets both horizontally and vertically within a mesh structure based on identifiers within protocol messages. Nodes within the mesh may maintain registers accessible through memory-mapped I/O (MMIO) operations, such as via ARM's Advanced Microcontroller Bus Architecture (AMBA) Advanced Peripheral Bus (APB). These registers may contain configuration information and operational parameters that allow system firmware, system software, or diagnostic tools to determine the presence and configuration of specific nodes and blocks within the architecture. Other coherent interconnect architectures may utilize different routing topologies and register access mechanisms.

In some examples, systems integrating CXL with ARM CHI interconnects may utilize specialized interfaces and gateways to manage the translation and routing of different protocol types. For example, a CXL/CCIX Gateway (CCG) may incorporate Request Node (RN) functionality, Home Node (HN) functionality, and link interface logic, managing conversion between CXL-based protocols and CHI-based protocols. The CCG may be coupled to the CHI interconnect via a CXS interface, which may provide a pathway for coherent transactions that is less complex to implement than a full CHI interface. CXL.mem and CXL.cache transactions, being coherent in nature, may be routed through the CCG via the CXS interface. CXL.io transactions, being non-coherent, may be routed through alternative paths, such as via an AXI interface coupled to RN-D or HN-I nodes within the CHI interconnect. For example, CXL.mem and CXL.cache traffic may be routed via a CXS interface to CCG nodes, while CXL.io traffic may be routed via an AXI interface to RN-D and HN-I nodes, allowing different paths to be optimized for their specific protocol characteristics. Other architectures may utilize different interfaces, gateways, or routing approaches for integrating CXL with coherent interconnects.

Non-limiting examples of transaction flows within CHI-based systems with CXL integration may follow the sequences described below. In one example, a requester, which may be a CCG block coupled to CXL Device logic or a CXL Device coupled to a mesh crosspoint, may issue an allocating read request to a Home Node (HN). The initial request may utilize various opcodes such as ReadClean, ReadNotSharedDirty, ReadShared, ReadUnique, ReadPreferUnique, or MakeReadUnique. The Home Node may process these transactions and may employ different response approaches based on system configuration and optimization goals. In one example, the Home Node may utilize combined responses from subordinate nodes, wherein the Home Node sends a downstream read request, such as ReadNoSnp, to a Subordinate node such as a Memory Controller. The Subordinate node may then return a combined response along with the requested data to the original requester using CompData, bypassing the need for the data to flow back through the Home Node. Using CompData may reduce message count and may decrease transaction latency by eliminating one hop in the data return path. The selection between different response approaches may be made by the Home Node based on factors such as current system load, transaction type, or design complexity considerations. In some examples, CCG blocks may be used for coupling RPUs and CXL Devices to mesh interconnects, providing a standardized interface for CXL integration. In other examples, RPUs may expose CHI interfaces capable of connecting to XP crosspoints within the mesh, wherein these RPUs may perform address translations as part of the transaction processing flow.

Some implementations of the following method relate to processing pipelines, such as in a Fabric Processing Unit (FPU), for extracting and reconstructing CXL PDUs from carrier protocol communications received over a physical layer based on IEEE 802.3 PMA, possibly via software-defined methods, such as via protocol processing firmware executed on an FPU. A carrier protocol may refer to a protocol that transports or encapsulates other protocol data for transmission across a network or fabric, such as Ethernet, Ultra Ethernet Transport (UET), Ethernet for Scale-Up Networking (ESUN), Scale Up Ethernet (SUE), NVLink, or UALink. A passenger protocol may refer to a protocol whose data is encapsulated within the carrier protocol for transport, such as CXL.mem, CXL.cache, or CXL.io. A carrier protocol PDU refers to a protocol data unit of the carrier protocol, and a CXL PDU refers to a protocol data unit of a CXL sub-protocol. The CXL PDU may represent data indicative of a CXL message or a subset thereof, and may include fields that have been formatted, reduced, or otherwise adapted for transport within the carrier protocol PDU.

Modern datacenter architectures may benefit from transporting CXL traffic over network fabrics that utilize IEEE 802.3-based physical layers, enabling memory disaggregation, composable infrastructure, and remote memory access across rack-scale and cluster-scale deployments. When CXL PDUs are encapsulated within carrier protocol PDUs, the carrier protocol may utilize different field formats, may omit fields that are not required for transport, or may encode CXL information in carrier-specific representations. A processing pipeline within an RPU or similar processing unit may receive carrier protocol PDUs, extract encapsulated CXL information, translate fields between carrier and CXL formats, and reconstruct complete CXL PDUs that conform to the CXL specification for delivery to CXL devices or hosts. The pipeline may include stages for physical coding sublayer (PCS) processing, parsing, validity checking, stream extraction, access control, field translation, stream editing, address translation, and protocol translation, wherein different stages may be utilized depending on the carrier protocol type, the passenger protocol type, and the system configuration.

In various implementations, a method comprising: receiving, via a physical layer based on IEEE 802.3 physical medium attachment (PMA), a transmission comprising a protocol data unit (PDU) of a carrier protocol (carrier protocol PDU) encapsulating data indicative of a Compute Express Link (CXL) PDU; parsing the carrier protocol PDU to identify a passenger protocol type; extracting, from the carrier protocol PDU, fields of the CXL PDU; translating at least one extracted field from a format associated with the carrier protocol PDU to a field conforming to a CXL specification; and reconstructing an output CXL PDU comprising the translated field and at least one additional field not present in the carrier protocol PDU. The processing pipeline may be implemented as hardware, firmware, software, or combination thereof, within an FPU, an RPU, or a similar processing unit that is coupled to the physical layer based on IEEE 802.3 PMA. The physical layer may receive transmissions from external entities such as hosts, accelerators, switches, or memory devices that communicate CXL traffic encapsulated within carrier protocol PDUs. The parsing stage may examine protocol-specific patterns or markers in the data stream to identify both the carrier protocol type and the type of CXL sub-protocol (such as CXL.mem, CXL.cache, or CXL.io) encapsulated within. The extraction stage may identify and extract fields of interest from the carrier protocol PDU, including data indicative of CXL opcodes, physical addresses, transaction identifiers, and other protocol-specific fields. The translation stage may convert one or more extracted fields from a representation or encoding utilized by the carrier protocol into a representation that conforms to the CXL specification, such as translating a carrier-specific command encoding into a CXL opcode. The reconstruction stage may assemble a complete CXL PDU by combining translated fields with additional fields that were not included in the carrier protocol PDU, such as reserved fields, validity indicators, or metadata fields that may be omitted from the carrier PDU to conserve bandwidth but are utilized by CXL devices for proper parsing and processing of the CXL request.

In some implementations of the method, the at least one additional field is reconstructed based on at least one of a configuration or a default value, and wherein the method further comprises validating access permissions based on at least one of a physical address or an opcode extracted from the CXL PDU, and blocking the output CXL PDU from further processing when the access permissions are not satisfied. The reconstruction of fields not present in the carrier protocol PDU may utilize configuration parameters stored in registers or memory of the RPU, or may utilize default values defined by the CXL specification or by system policy. For example, a Valid field may be reconstructed as valid based on the presence of a well-formed carrier protocol PDU, while Reserved (RSVD) fields may be reconstructed utilizing configured default values such as zero. The access control validation may be performed by an Access Control List (ACL) module within the processing pipeline that evaluates extracted CXL fields against access policies. The ACL module may examine physical addresses to determine whether the requesting entity is permitted to access the targeted memory region, and may examine opcodes to determine whether the requested operation type is permitted. When access permissions are not satisfied, the pipeline may discard the CXL PDU, generate an error response, or log the access violation. This access control may operate at the CXL protocol level rather than at the carrier protocol level, enabling fine-grained memory access control that is specific to the CXL address space and operation types.

In some implementations, the method further comprises translating a physical address extracted from the CXL PDU from a first physical address space to a second physical address space. The address translation may be performed by an Address Translator stage within the processing pipeline, downstream of the field extraction and translation stages. The first physical address space may correspond to a Host Physical Address (HPA) space utilized by the external entity that originated the CXL request, while the second physical address space may correspond to an HPA space utilized by a local host or a Device Physical Address (DPA) space utilized by a local CXL device. The translation may be implemented utilizing lookup tables, page tables, hash tables, base-and-offset calculations, or programmable translation functions. The address translation may enable entities utilizing different address spaces to communicate via CXL over the carrier protocol fabric, without requiring the entities to share a common address space or address mapping.

In some implementations, the method further comprises translating the output CXL PDU from a first CXL channel to a second CXL channel, wherein the first CXL channel and the second CXL channel are different CXL sub-protocols. The protocol translation may be performed by a Protocol Translator stage within the processing pipeline, downstream of the stream editing and address translation stages. The first CXL channel may be CXL.mem and the second CXL channel may be CXL.cache, or vice versa, depending on the system configuration and the types of entities involved. For example, the Protocol Translator may translate a CXL.mem M2S request message into a CXL.cache H2D request message when the receiving entity is a CXL host that issues snoop requests to a local CXL device. Conversely, the Protocol Translator may translate a CXL.cache H2D request message into a CXL.mem M2S request message when the receiving entity is a memory device that processes memory access requests. The cross-channel translation may enable heterogeneous CXL deployments where different entities utilize different CXL sub-protocols while communicating through a common carrier protocol fabric.

In some implementations of the method, the carrier protocol comprises at least one of Ethernet, Ultra Ethernet Transport (UET), Ethernet for Scale-Up Networking (ESUN), Scale Up Ethernet (SUE), NVLink, or UALink, and wherein the physical layer based on IEEE 802.3 PMA operates at a lane rate of at least 100 Gbps. Different carrier protocols may utilize the IEEE 802.3 PMA in different ways while maintaining compatibility with the PMA interface specifications. Ethernet may utilize standard Ethernet framing with MAC-layer processing, while UET, ESUN, and SUE may utilize optimized framing adapted for high-performance computing and artificial intelligence workloads. UALink may utilize the IEEE 802.3 PMA as its physical layer while employing UALink-specific data link and transport layer protocols. The lane rate of at least 100 Gbps may correspond to IEEE 802.3 PMA specifications such as 100GBASE or higher rates, enabling sufficient bandwidth for CXL memory traffic that may involve high-frequency, low-latency transactions. Higher lane rates, such as 200 Gbps or 400 Gbps per lane, may further increase the available bandwidth for encapsulated CXL traffic.

In some implementations, the method further comprises receiving a CXL response PDU, removing at least one field from the CXL response PDU, encapsulating remaining fields of the CXL response PDU within a second carrier protocol PDU, and transmitting the second carrier protocol PDU via the physical layer based on IEEE 802.3 PMA. The return path may operate as a reverse pipeline that processes CXL responses generated by local CXL devices or hosts for transmission to remote entities via the carrier protocol fabric. The removal of fields from the CXL response PDU may reduce bandwidth consumption by omitting fields that can be reconstructed at the receiving end, such as Valid fields, Reserved fields, or metadata fields that carry default or derivable values. The encapsulation may include generating carrier protocol headers and trailers appropriate for the carrier protocol type being utilized. The return path processing may mirror the inbound processing pipeline stages in reverse order, with the Stream Editor stripping unnecessary fields, the Field Translator converting CXL-specific field representations into carrier-specific formats, and the PCS performing encoding operations such as 64 B/66 B encoding, scrambling, and FEC encoding for transmission via the IEEE 802.3 PMA.

In some implementations of the method, the CXL PDU comprises a CXL.mem Master-to-Subordinate (M2S) PDU, the extracted fields comprise a MemOpcode field and an Address field, and the at least one additional field not present in the carrier protocol PDU comprises at least one of a Valid field, a Reserved (RSVD) field, a MetaField field, a SnpType field, or a Traffic Class (TC) field. The CXL.mem M2S PDU may refer to a Master-to-Subordinate message from either the M2S Req channel, which carries requests without data such as reads and invalidations, or the M2S RwD channel, which carries requests with data such as writes. Both channel types may include a MemOpcode field and an Address field as the primary extracted fields, along with other fields such as Valid, MetaField, SnpType, Tag, TC, and RSVD. When the carrier protocol PDU encapsulates CXL.mem information, the MemOpcode and Address fields may be included because they carry the operation type and target address that are needed for routing and processing. Other fields, such as Valid, RSVD, MetaField, SnpType, and TC, may be omitted from the carrier protocol PDU when their values can be reconstructed. The Valid field may be reconstructed based on the presence of a well-formed carrier protocol PDU. The RSVD field may be reconstructed utilizing a default value of zero. The MetaField, SnpType, and TC fields may be reconstructed based on RPU configuration parameters, system policies, or context derived from the MemOpcode and other extracted fields. The Tag field, which provides a transaction identifier for response correlation, may also be extracted from the carrier protocol PDU.

In some implementations of the method, the translating comprises translating a command field of the carrier protocol PDU to the MemOpcode field conforming to the CXL specification, the MemOpcode field comprising at least one of MemRd, MemRdData, MemWr, MemWrPtl, or MemInv. The carrier protocol may encode memory operation types utilizing a carrier-specific command field that differs in format, bit width, or encoding from the CXL MemOpcode field. The Field Translator may map carrier-specific command encodings to CXL MemOpcode values such as MemRd for memory read operations, MemRdData for memory read operations with specific metadata handling, MemWr for full cacheline write operations, MemWrPtl for partial cacheline write operations, or MemInv for invalidation operations. The mapping may be configurable, enabling the same processing pipeline to support different carrier protocols that utilize different command encoding schemes.

In some implementations of the method, the CXL PDU comprises a CXL.cache Host-to-Device (H2D) request PDU, the extracted fields comprise an Opcode field, an Address field, and a Unique Queue ID (UQID) field, and the at least one additional field not present in the carrier protocol PDU comprises at least one of a Valid field or a Reserved (RSVD) field. The CXL.cache H2D request PDU may include fields as defined by the CXL specification, including Valid, Opcode, Address, UQID, and RSVD fields. The Opcode field may carry H2D request opcodes such as SnpData, SnpInv, or SnpCur that indicate the type of snoop operation. The Address field may carry the physical address of the cacheline targeted by the snoop operation. The UQID field may identify the host entry that originated the request, enabling response routing. The Valid and RSVD fields may be omitted from the carrier protocol PDU because their values can be reconstructed: the Valid field based on PDU presence, and the RSVD field utilizing default values. Different flit modes defined by the CXL specification (such as 68 B flit, 256 B flit, or PBR flit) may include different sets of additional fields such as CacheID, SPID, and DPID, which may also be subject to extraction or reconstruction depending on the flit mode negotiated for the target CXL link.

In some implementations of the method, the CXL PDU comprises a CXL.cache Device-to-Host (D2H) request PDU, the extracted fields comprise an Opcode field, a command queue identifier (CQID) field, and an Address field, and the at least one additional field not present in the carrier protocol PDU comprises at least one of a Valid field, a NonTemporal (NT) field, or a Reserved (RSVD) field. The CXL.cache D2H request PDU may include fields as defined by the CXL specification, including Valid, Opcode, CQID, NT, Address, and RSVD fields. The D2H request direction carries requests from a device toward a host, with D2H request opcodes such as RdShared, RdOwn, RdCurr, RdOwnNoData, CLFlush, or other D2H request opcodes. The CQID field may identify the device tracker entry associated with the request. The NT (NonTemporal) field may provide a caching hint indicating that the requested data is not expected to be reused in the near term, allowing the host to avoid caching the data in a preferred cache position or to treat it as non-cacheable. The RSVD field in D2H requests may be larger than in H2D requests, and the NT field may carry a default value that can be reconstructed based on system configuration. The field set for D2H requests differs from H2D requests in both the transaction identifier (CQID versus UQID) and the available fields (NT versus CacheID in certain flit modes), which may result in different extraction and reconstruction behavior for each direction.

In some implementations of the method, the CXL PDU comprises a CXL.io Transaction Layer Packet (TLP), the extracted fields comprise a Type field, an Address field, and a Tag field, and the translating comprises translating a command field of the carrier protocol PDU to a Fmt/Type field of the CXL.io TLP. CXL.io utilizes TLPs based on the PCIe Transaction Layer specification. The TLP header may include fields such as Fmt/Type (which encodes the packet format and transaction type), TC (Traffic Class), Attr (Attributes), EP (Error Poisoned), Length, Requester ID, Tag, and Address, among others. The Fmt and Type fields together determine the TLP type, such as Memory Read (MRd), Memory Write (MWr), Completion with Data (CplD), or Configuration Read/Write. The carrier protocol may encode the CXL.io transaction type utilizing a carrier-specific command field that differs from the PCIe Fmt/Type encoding. The Field Translator may map carrier-specific commands to appropriate Fmt/Type values. In flit mode, the Fmt field may be absorbed into the Type field, and the translation may accommodate both flit mode and non-flit mode TLP header formats. The Tag and Address fields may be extracted from the carrier protocol PDU for routing and transaction tracking, while other TLP header fields such as TC, Attr, and EP may be omitted from the carrier PDU and reconstructed utilizing default values or configuration parameters.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a physical layer based on IEEE 802.3 physical medium attachment (PMA) configured to receive a transmission comprising a protocol data unit (PDU) of a carrier protocol (carrier protocol PDU) encapsulating data indicative of a Compute Express Link (CXL) PDU; and a processing unit coupled to the physical layer, the processing unit configured to: parse the carrier protocol PDU to identify a passenger protocol type; extract, from the carrier protocol PDU, fields of the CXL PDU; translate at least one extracted field from a format associated with the carrier protocol PDU to a field conforming to a CXL specification; and reconstruct an output CXL PDU comprising the translated field and at least one additional field not present in the carrier protocol PDU. The apparatus may be implemented as an integrated circuit, an SoC, an FPGA, a SmartNIC, a data processing unit (DPU), a Fabric Processing Unit (FPU), or any other suitable hardware platform that includes a physical layer based on IEEE 802.3 PMA and a processing unit capable of performing the described operations. The processing unit may include dedicated hardware logic, a programmable processor, or a combination thereof. The processing unit may implement the pipeline stages, including parsing, extraction, translation, and reconstruction, as hardware pipeline stages that process carrier protocol PDUs at line rate, or as software-driven stages that provide configurability and flexibility. The apparatus may include physical layers based on IEEE 802.3 PMA for communicating with external entities, and may include processing units or pipeline instances for parallel processing of carrier protocol PDUs.

Some implementations of the following method further relate to bandwidth-optimized transport of CXL protocol data over carrier protocols utilizing a physical layer based on IEEE 802.3 PMA. When CXL PDUs are transported over carrier protocol fabrics, the bandwidth available for encapsulated CXL traffic may be constrained by the carrier protocol overhead, the physical layer data rate, and the number of concurrent transactions. Bandwidth optimization may be achieved by encapsulating a subset of the CXL PDU fields within the carrier protocol PDU, omitting fields that can be reconstructed at the receiving end. Different levels of field inclusion may be utilized depending on available bandwidth, quality-of-service requirements, and/or system configuration.

For example, a CXL.mem M2S request may include fields such as Valid, MemOpcode, MetaField, SnpType, Address, Tag, TC, and RSVD. A complete format may include all fields, while a reduced format may omit the Valid and RSVD fields, and an essential format may include the MemOpcode, Address, and Tag fields. The omitted fields may be reconstructed by the receiving processing unit based on configuration parameters, default values, or context derived from the received fields. Similar bandwidth optimization may be applied to CXL.cache and CXL.io PDUs by identifying fields that can be omitted and reconstructed.

In various implementations, a method comprising: receiving, via a physical layer based on IEEE 802.3 physical medium attachment (PMA), a protocol data unit (PDU) of a carrier protocol (carrier protocol PDU) encapsulating a subset of fields of a Compute Express Link (CXL) PDU, the subset excluding at least one field defined by a CXL specification for the CXL PDU; extracting the subset of fields from the carrier protocol PDU; reconstructing the at least one excluded field; and generating a CXL request comprising the extracted subset of fields and the at least one reconstructed field. The method may enable bandwidth-efficient transport of CXL traffic over carrier protocol fabrics by transmitting those CXL PDU fields that cannot be derived or reconstructed at the receiving end. The sender may analyze the CXL PDU and determine which fields carry information that is not derivable from other fields or from system configuration, and may include those fields in the carrier protocol PDU. The receiver may extract the included fields, reconstruct the excluded fields, and assemble a complete CXL request that conforms to the CXL specification. The bandwidth savings may be proportional to the number and size of excluded fields, and may vary depending on the CXL sub-protocol, the message type, and the level of field inclusion selected. For CXL.mem M2S requests, the savings may range from omitting a few bits (Valid and RSVD) to omitting several fields (MetaField, SnpType, TC, Valid, RSVD), depending on the selected format level.

In some implementations of the method, the at least one excluded field is reconstructed based on at least one of a configuration, a default value, or context derived from the subset of fields. Different reconstruction methods may be utilized for different excluded fields depending on the nature of the field and the information available. Configuration-based reconstruction may utilize values stored in registers or memory of the processing unit, such as system-wide settings for Traffic Class or metadata policies. Default-value reconstruction may utilize values defined by the CXL specification or by system convention, such as zero for Reserved fields or a valid indication for the Valid field when the carrier protocol PDU is well-formed. Context-based reconstruction may derive field values from other extracted fields, such as inferring a SnpType value from the MemOpcode when certain operation types imply specific snoop behaviors. The reconstruction method for each excluded field may be independently configurable, enabling the system to adapt to different deployment scenarios and CXL specification revisions.

In some implementations, the method further comprises receiving a CXL response, excluding at least one field of the CXL response defined by the CXL specification, and transmitting, via the physical layer based on IEEE 802.3 PMA, a carrier protocol PDU encapsulating a subset of fields of the CXL response excluding the at least one excluded field of the CXL response. The bandwidth optimization may be applied symmetrically on both the request and response paths. CXL responses, such as S2M No-Data Response (NDR) messages or S2M Data Response (DRS) messages for CXL.mem, or D2H response and D2H Data messages for CXL.cache, may also include fields that can be omitted for transport. The processing unit may analyze the CXL response, identify fields that can be reconstructed by the remote receiving entity, exclude those fields, and encapsulate the remaining fields within a carrier protocol PDU for transmission. The level of field reduction on the response path may be the same as or different from the level utilized on the request path, depending on the specific response message type and the fields available for reconstruction.

In some implementations, the method further comprises receiving the carrier protocol PDU by a remote processing unit, extracting the subset of fields of the CXL response, and reconstructing the at least one excluded field of the CXL response. The remote processing unit may receive the carrier protocol PDU transmitted by the local processing unit, extract the encapsulated subset of fields of the CXL response, and reconstruct the at least one excluded field. The remote processing unit may utilize its own configuration parameters, default values, or context to reconstruct excluded response fields. The remote processing unit may be implemented within an RPU, a SmartNIC, a DPU, or any other suitable entity coupled to a physical layer based on IEEE 802.3 PMA. The configuration parameters utilized by the remote processing unit for reconstruction may be synchronized with those utilized by the local processing unit for field exclusion, either through out-of-band configuration protocols or through negotiation during connection establishment.

In some implementations of the method, the CXL PDU comprises a CXL.mem Master-to-Subordinate (M2S) request, the subset of fields comprises MemOpcode, MetaField, SnpType, Address, Tag, and TC fields, and the at least one excluded field comprises a Valid field and a Reserved (RSVD) field. The reduced format for CXL.mem M2S requests may retain the fields that carry operational semantics (MemOpcode for the operation type, MetaField and SnpType for coherency behavior, Address for the target location, Tag for transaction tracking, and TC for traffic classification) while omitting the Valid field and the Reserved field. The Valid field may be reconstructed based on the presence of a well-formed carrier protocol PDU, since the receipt of a properly framed and validated carrier protocol PDU implies that the encapsulated CXL information is valid. The Reserved field may be reconstructed utilizing a default value of zero, as reserved fields are defined by the CXL specification to be cleared by the sender and ignored by the receiver.

In some implementations of the method, the CXL PDU comprises a CXL.mem M2S request, the subset of fields comprises MemOpcode, Address, and Tag fields, and the at least one excluded field comprises a Valid field, a MetaField field, a SnpType field, a TC field, and a Reserved (RSVD) field. In one example, the essential format may include the minimum fields for basic CXL.mem operation: MemOpcode to specify the memory operation, Address to identify the target physical address, and Tag to enable transaction tracking and response correlation. The excluded fields (Valid, MetaField, SnpType, TC, and RSVD) may be reconstructed utilizing default values or configuration parameters. The MetaField may be reconstructed as No-Op when the system configuration does not utilize metadata operations, the SnpType may be reconstructed based on the MemOpcode (such as defaulting to No-Op or to a configured snoop type), and the TC may be reconstructed utilizing a configured traffic class priority. The essential format may provide the greatest bandwidth savings and may be suitable for deployments where the carrier protocol bandwidth is constrained or where the additional fields carry predictable values.

In some implementations of the method, the CXL PDU comprises a CXL.cache Host-to-Device (H2D) request, the subset of fields comprises an Opcode field, an Address field, and a UQID field, and the at least one excluded field comprises at least one of a Valid field or a Reserved (RSVD) field. The CXL.cache H2D request may include Opcode, Address, UQID, Valid, and RSVD fields in the 68 B flit format. The Opcode field may carry snoop opcodes such as SnpData, SnpInv, or SnpCur. The Address field carries the cacheline address targeted by the snoop. The UQID identifies the host entry originating the request. The Valid and RSVD fields may be omitted from the carrier protocol PDU and reconstructed. In 256 B flit or PBR flit formats, additional fields such as CacheID, SPID, and DPID may also be subject to field reduction and reconstruction, and the set of excluded fields may vary based on the negotiated flit mode.

In some implementations of the method, the CXL PDU comprises a CXL.cache Device-to-Host (D2H) request, the subset of fields comprises an Opcode field, a command queue identifier (CQID) field, and an Address field, and the at least one excluded field comprises at least one of a Valid field, a NonTemporal (NT) field, or a Reserved (RSVD) field. The CXL.cache D2H request may include Opcode, CQID, NT, Address, Valid, and RSVD fields. The D2H request carries device-initiated requests toward a host, with opcodes such as RdShared, RdOwn, RdCurr, RdOwnNoData, or CLFlush. The CQID identifies the device tracker entry for response routing. The NT field provides a caching hint indicating that the requested data is not expected to be reused in the near term, allowing the host to avoid caching the data in a preferred cache position or to treat it as non-cacheable, and may carry a default value in many configurations. The RSVD field in D2H requests may include a larger number of reserved bits compared to H2D requests, making it a suitable candidate for exclusion. The reconstruction of the NT field may utilize a configured default caching policy, while the RSVD field may be reconstructed as zero.

In some implementations of the method, the CXL PDU comprises a CXL.io Transaction Layer Packet (TLP), the subset of fields comprises a Fmt/Type field, an Address field, a Requester ID field, and a Tag field, and the at least one excluded field comprises at least one of a Traffic Class (TC) field, an Attributes (Attr) field, or a reserved field. CXL.io TLP headers may include fields such as Fmt/Type, TC, Attr, EP, Length, Requester ID, Tag, and Address, among others. The Fmt/Type fields (or the combined Type field in flit mode) determine the transaction type and packet format. The Address and Tag fields are retained for routing and transaction tracking. The Requester ID identifies the originating function. The TC field, which indicates the traffic class for quality-of-service handling, may be reconstructed utilizing a configured default traffic class. The Attr field, which includes attributes such as relaxed ordering and no-snoop hints, may be reconstructed from configuration. Reserved fields and other padding may be reconstructed utilizing zero values. The bandwidth savings from excluding these fields may be proportional to the TLP header size, which varies depending on whether the TLP utilizes 32-bit or 64-bit addressing and whether flit mode or non-flit mode is in use.

In some implementations, the method further comprises selecting between a first format comprising a first subset of fields and a second format comprising a second subset of fields based on at least one of available bandwidth, quality-of-service parameters, or a configuration setting. The processing unit may dynamically select between different field inclusion levels based on runtime conditions or system configuration. When the carrier protocol fabric has sufficient bandwidth, a complete or reduced format with more fields may be selected to minimize reconstruction overhead and maximize protocol compliance fidelity. When bandwidth is constrained, an essential format with fewer fields may be selected to maximize the number of CXL transactions that can be transported within the available bandwidth. Quality-of-service parameters may influence the selection, such as utilizing a complete format for high-priority traffic classes and a reduced format for lower-priority traffic. The selection may be performed on a per-connection basis, a per-transaction basis, or a per-time-interval basis, and may be negotiated between the sender and receiver during connection establishment or renegotiated during operation in response to changing network conditions.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a physical layer based on IEEE 802.3 physical medium attachment (PMA) configured to receive a protocol data unit (PDU) of a carrier protocol (carrier protocol PDU) encapsulating a subset of fields of a Compute Express Link (CXL) PDU, the subset excluding at least one field defined by a CXL specification for the CXL PDU; and a processing unit configured to extract the subset of fields from the carrier protocol PDU, reconstruct the at least one excluded field, and generate a CXL request comprising the extracted subset of fields and the at least one reconstructed field. The apparatus may be implemented as an RPU, a SmartNIC, a DPU, a network interface, a switch, an active cable, or any other suitable device that receives carrier protocol PDUs via a physical layer based on IEEE 802.3 PMA and processes encapsulated CXL traffic. The processing unit may include hardware logic, a programmable processor, or a combination thereof, configured to perform the extraction, reconstruction, and CXL request generation operations. The apparatus may support multiple levels of field inclusion and may be configurable to select between different levels based on system requirements. The apparatus may further include a CXL device or CXL port coupled to the processing unit for delivering the generated CXL requests to the CXL fabric.

In some implementations of the apparatus, the processing unit is configured to reconstruct the at least one excluded field based on at least one of a configuration, a default value, or context derived from the subset of fields. The processing unit may maintain configuration registers or memory structures that store reconstruction parameters for each field type and each CXL sub-protocol. The configuration parameters may be programmed during system initialization, updated during operation via management interfaces, or negotiated with remote entities during connection establishment. Default values may be defined by the CXL specification version targeted by the system, enabling automatic reconstruction without explicit configuration for fields that have specification-defined default behaviors.

In some implementations of the apparatus, the processing unit is further configured to receive a CXL response, exclude at least one field of the CXL response defined by the CXL specification, and transmit, via the physical layer based on IEEE 802.3 PMA, a carrier protocol PDU encapsulating a subset of fields of the CXL response excluding the at least one excluded field of the CXL response. The apparatus may support bidirectional bandwidth optimization by applying field reduction to both request and response directions. The processing unit may analyze outgoing CXL responses to identify fields that can be excluded for transport while maintaining the ability for the remote entity to reconstruct the complete response. The response field exclusion may be coordinated with the remote entity to facilitate proper reconstruction at the receiving end.

In some implementations of the apparatus, the processing unit is further configured to select between a first format comprising a first subset of fields and a second format comprising a second subset of fields based on at least one of available bandwidth, quality-of-service parameters, or a configuration setting. The apparatus may monitor bandwidth utilization on the carrier protocol fabric and dynamically adjust the field inclusion level to optimize performance. When bandwidth utilization is low, the apparatus may select a format with more fields to minimize reconstruction overhead. When bandwidth utilization is high or approaching congestion thresholds, the apparatus may select a format with fewer fields to reduce per-transaction bandwidth consumption and maintain throughput. The quality-of-service parameters may include priority levels, latency targets, or throughput guarantees that influence the selection of field inclusion formats for different traffic classes or transaction types.

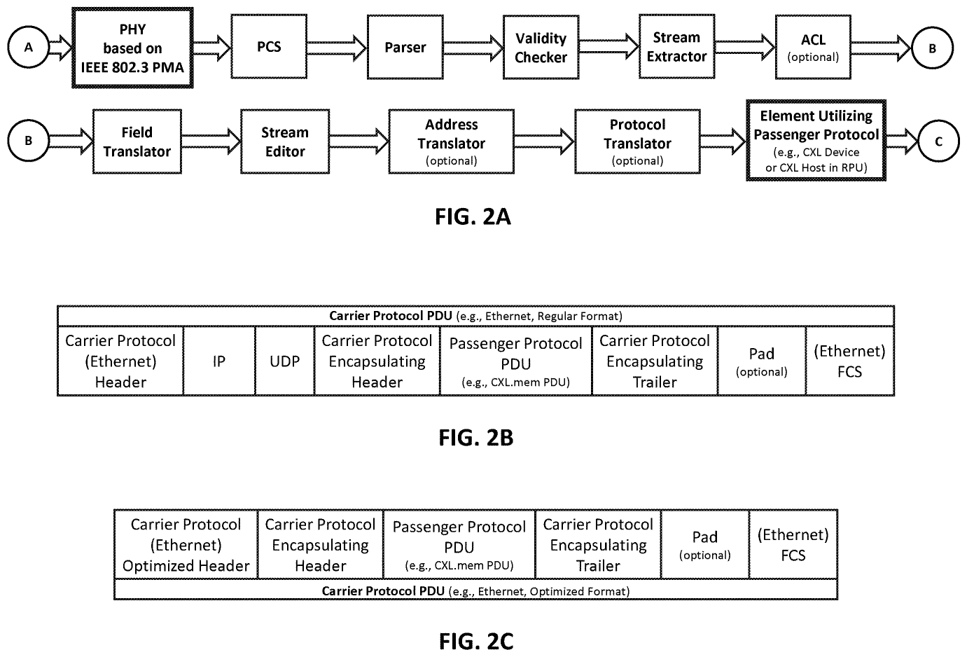

FIG. 2A illustrates an example of a processing pipeline for extracting passenger protocol messages from carrier protocol communications received over a physical layer based on IEEE 802.3 Physical Medium Attachment (PMA). The pipeline may process various carrier protocols that utilize a PMA based on IEEE 802.3, such as certain versions of Ethernet, ESUN, SUE, UALink, or NVLink, to extract encapsulated passenger protocol messages such as CXL.mem, CXL.cache, or CXL.io messages. The figure describes a transmission received by a PMA that is based on IEEE 802.3, which forwards a data stream of the carrier protocol to a Physical Coding Sublayer (PCS). The PCS may include protocol-specific processing operations that may vary based on the carrier protocol being utilized. For Ethernet examples, the PCS may perform operations such as 64 B/66 B block decoding, block framing, block synchronization, descrambling, lane deskewing, and/or forward error correction (FEC) decoding. For UALink or NVLink examples, the PCS may additionally or alternatively perform other operations specific to those protocols while maintaining compatibility with the IEEE 802.3 PMA interface.

The PCS forwards processed data to a Parser. The data may take the form of a partially-delineated stream wherein protocol boundaries have been identified but detailed field parsing has not yet been performed. The Parser may analyze the received data to identify protocol structures and extract protocol-specific information. The Parser may perform analysis operations including identification of the carrier protocol type by examining protocol-specific patterns or markers in the data stream, identification of the passenger protocol type that is encapsulated within the carrier protocol, delineation of Protocol Data Units (PDUs) of the carrier protocol (Carrier PDU) according to the specific framing rules of the identified carrier protocol (such as Ethernet framing, frame-boundary delimitation, and frame synchronization which may involve operations similar to those performed by an Ethernet MAC), and identification of locations of interest within the carrier protocol PDU such as headers, addresses, identifiers, payload sections, and other fields that may be required by subsequent stages of the processing pipeline. The Parser may add metadata fields to the processed data, such as metadata identifying protocol types and data patterns.

The Parser forwards to a Validity Checker a structured data with location information, such as an array of offsets to locations of interest in the Carrier PDU. The Validity Checker performs validation operations on the received data structure, such as validation of data stream format conformance and carrier PDU validity checks including cyclic redundancy checks (CRC) or other error detection logic specific to the carrier protocol. The Validity Checker forwards validated data structures to a Stream Extractor.

The Stream Extractor processes the validated data structures to extract passenger protocol information, such as extracting fields of interest from the Carrier PDU including data indicative of passenger protocol opcodes and physical addresses within a second physical address space utilized by the requesting entity. The Stream Extractor may identify and extract various passenger protocol fields required for message processing, regardless of the specific passenger protocol type. The Stream Extractor forwards its output to an optional Access Control List (ACL) module that may validate access permissions based on the extracted fields. The ACL feeds validated data to a Field Translator that performs field-level transformations between carrier and passenger protocol formats, such as translating fields of interest from the Carrier PDU (e.g., a command field) to fields conforming to the Passenger Protocol specifications (e.g., a CXL opcode field required for constructing a CXL request).

The Field Translator feeds transformed field data to a Stream Editor that reconstructs complete passenger protocol messages. The Stream Editor may perform several operations including reconstruction and formatting of translated fields into a PDU structure compliant with a valid Passenger Protocol PDU (Passenger PDU), such as CXL, insertion of mandatory or optional Passenger Protocol fields that may not be included in the Carrier PDU such as reserved fields of a CXL message that may be omitted from the Carrier PDU but are necessary for an element utilizing passenger protocol, such as a CXL device, to properly parse the request wherein values of omitted fields may be reconstructed based on RPU configurations and/or configurable default values, and removal of intermediate data and metadata that was collected and generated in the processing pipeline but is not part of a compliant Passenger PDU, such as a CXL request.

When no address translation or protocol translation is required, the Stream Editor forwards the Passenger PDU to an element utilizing passenger protocol, such as a CXL device within an RPU. When address translation and/or protocol translation is required, the Stream Editor forwards the Passenger PDU, such as a CXL.mem M2S Req message carrying a physical address within a second HPA space, to an optional Address Translator. The Address Translator translates physical addresses between different physical address spaces, such as translating from a second HPA space to a first HPA space, and forwards the result to an optional Protocol Translator. The Protocol Translator may perform protocol-specific translations, such as translating from a CXL.mem M2S Req message to a CXL.cache D2H Req message. The translated Passenger PDU is then forwarded to the appropriate protocol device, such as forwarding a CXL.cache D2H Req message carrying the physical address within the first HPA space to an element utilizing passenger protocol, such as a CXL host.

FIG. 2B illustrates an example of a packet structure that may be suitable for Layer 3 (L3) switching operations. L3 switching typically refers to packet forwarding based on network layer information, typically using IP addresses or similar network-layer identifiers to make routing decisions across different network segments or subnets. The illustrated packet structure shows a carrier protocol PDU in a regular format that may be processed by standard networking equipment while carrying an encapsulated passenger protocol PDU. The packet structure includes a Carrier Protocol Header, shown as an Ethernet header, which may contain standard Ethernet fields such as destination MAC address, source MAC address, and EtherType or length fields. Following the Ethernet header, the packet includes an IP header that may contain network layer routing information including source and destination IP addresses, protocol identifiers, and other IP-specific fields required for L3 routing decisions. A UDP header follows the IP header and may contain transport layer information including source and destination port numbers that may be used to identify specific services or applications. The packet includes a Carrier Protocol Encapsulating Header that may carry metadata specific to the encapsulation scheme. This header may include a PDU Version (Ver) field that indicates the version or format of the protocol PDU structure, enabling the Parser to correctly interpret the packet structure. A Source Node ID (SourceNodeID) field may identify the originating node in a format specific to the overlay network or fabric topology. A Destination Node ID (DestinationNodeID) field may identify the target node for routing within the overlay network. A Segmentation ID (SegmentID) field may be used for infrastructure virtualization, such as to provide isolation between different tenants or logical networks in multi-tenant environments. A PDU Sequence Number (PSN) field may provide ordering information for reliable delivery or reassembly of segmented messages. A Passenger Protocol (PassengerProt) field may identify the type of passenger protocol encapsulated within the PDU, such as CXL.io, CXL.cache, or CXL.mem, enabling the Parser to apply appropriate processing rules. The Passenger Protocol PDU section may contain the actual passenger protocol message, such as a CXL.mem PDU, that is being transported across the network. The Passenger Protocol PDU section may include the fields required by the passenger protocol specification, or a subset of the fields that enable reconstruction of the message, as further discussed below.

The packet further includes a Carrier Protocol Encapsulating Trailer that may carry additional metadata and integrity information. This trailer may include an Encapsulating CRC (E-CRC) field that provides error detection for the encapsulated portion of the packet, potentially offering stronger integrity protection than the standard Ethernet FCS. A Data Poisoning (Poison) field may be used to mark data that is known to be corrupted, allowing protocols such as CXL or UPI to propagate error indications across the network. A Reported Load (ReportedLoad) field may communicate congestion or load information from the source device, possibly augmented with congestion information from intermediate components along the path, such as CXL DevLoad indicators, enabling network-aware load balancing or congestion management. The packet structure may further include an optional Pad field that may be used to meet minimum frame size requirements of the carrier protocol, and may conclude with an Ethernet Frame Check Sequence (FCS) that provides error detection for the entire Ethernet frame according to Ethernet specifications.

FIG. 2C illustrates an example of a packet structure that may be suitable for Layer 2 (L2) switching operations. L2 switching typically refers to packet forwarding based on data link layer information, typically using MAC addresses to make forwarding decisions within a network segment or broadcast domain. The Carrier Protocol Optimized Header may contain condensed addressing or routing information suitable for L2 forwarding decisions. The Carrier Protocol Encapsulating Header, Passenger Protocol PDU, and Carrier Protocol Encapsulating Trailer may contain similar fields and serve similar functions as described for the L3 packet structure in FIG. 2B, adapted for the L2 switching context. The packet structure maintains the optional Pad field and Ethernet FCS for compatibility with the frame requirements as defined by the Ethernet specification.

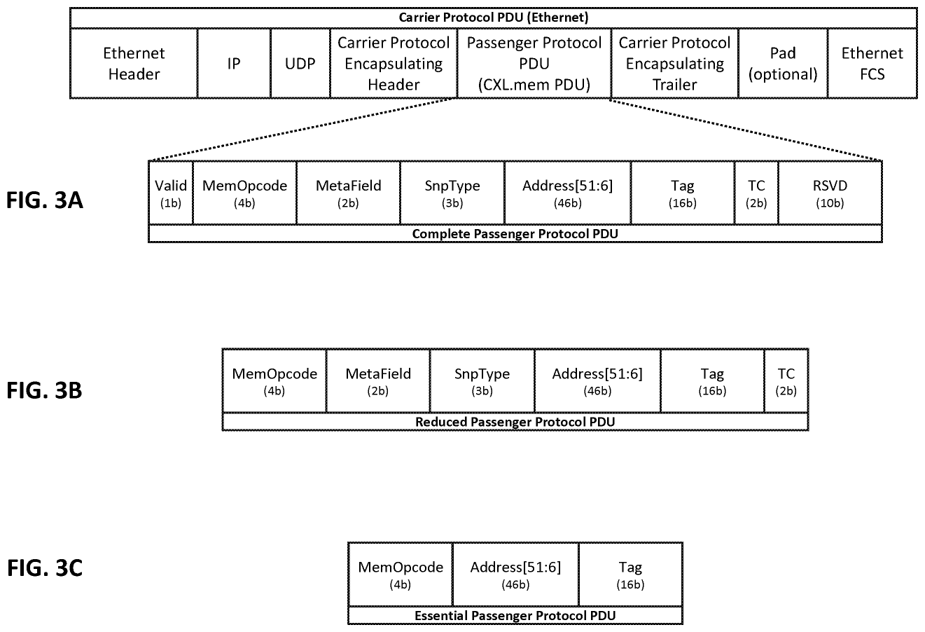

FIG. 3A to FIG. 3C illustrate three examples of variations for the Passenger Protocol PDU that may be encapsulated within the Carrier Protocol PDU illustrated in FIG. 2B. These variations illustrate different levels of field inclusion that may be utilized to optimize bandwidth utilization while maintaining the ability to reconstruct complete passenger protocol messages. The lower part of FIG. 3A illustrates a complete Passenger Protocol PDU for a CXL.mem message conforming to Revision 1.1 of the CXL Specification. The complete PDU includes the fields required by CXL.mem: a Valid field (1 bit) that indicates whether the message contains valid data, a MemOpcode field (4 bits) that specifies the memory operation type, a MetaField field (2 bits) that contains metadata about the transaction, a SnpType field (3 bits) that indicates the snoop type for cache coherency operations, an Address field (46 bits) that carries the physical address for the operation, a Tag field (16 bits) that provides a unique identifier for tracking the transaction, a TC field (2 bits) that may indicate traffic class or priority information, and a Reserved (RSVD) field (10 bits) that is reserved for future use or protocol compliance. This complete format may be utilized when full protocol compliance is required or when the carrier protocol has sufficient bandwidth to accommodate the fields.

FIG. 3B illustrates an example of a reduced Passenger Protocol PDU, wherein some of the fields that can be reconstructed are omitted from the Carrier PDU to reduce bandwidth requirements. The reduced PDU retains the MemOpcode field (4 bits), MetaField field (2 bits), SnpType field (3 bits), Address field (46 bits), Tag field (16 bits), and TC field (2 bits). The reconstructed fields, which are not included in the Carrier PDU but are required for a CXL device for parsing the CXL request, may be reconstructed by the Stream Editor of the RPU. For FIG. 3B, the fields to be reconstructed are the one bit Valid field and the 10 bits Reserved (RSVD) field. The Valid field may be reconstructed based on the presence of a well-formed PDU, while the RSVD field may be reconstructed using configured default values.

FIG. 3C illustrates an example of an essential Passenger Protocol PDU, which may include essentially the minimum fields required for basic operation of the passenger protocol. The essential PDU comprises the MemOpcode field (4 bits) that specifies the operation to be performed, the Address field (46 bits) that identifies the physical address, and the Tag field (16 bits) that enables transaction tracking and response correlation. The fields omitted from the essential PDU, including Valid, MetaField, SnpType, TC, and RSVD fields, may be reconstructed by the Stream Editor using protocol-specific default values or configuration parameters.

Some implementations of the following apparatus relate to processor architectures that integrate an RPU with a physical layer based on IEEE 802.3 PMA for enabling CXL protocol communication with external entities across carrier protocol fabrics. Modern datacenter deployments may benefit from disaggregated and composable architectures wherein processing resources and memory resources, such as scale-up memory resources for storing KV-cache entries, are decoupled and interconnected via high-speed fabrics. By integrating an RPU with a CXL device in a processor's IC package, the processor may communicate with external entities such as accelerators, GPUs, memory expanders, storage devices, switches, or other processors utilizing CXL protocols encapsulated within carrier protocol PDUs such as ESUN, SUE, UALink, NVLink, or Ethernet transported over IEEE 802.3-based physical layers.

The RPU may serve as a translation bridge between the processor's internal CXL domain and the external carrier protocol domain, where carrier protocol PDUs carrying encapsulated CXL information are transmitted and received via the physical layer based on IEEE 802.3 PMA. The translation may include extracting CXL fields from incoming carrier protocol PDUs, translating field formats between carrier and CXL representations, reconstructing complete CXL PDUs, and performing the reverse operations for outgoing CXL traffic. The RPU may further perform address translation between different physical address spaces and Tag translation between different Tag spaces to enable interoperability across fabric boundaries.

In various implementations, an apparatus comprising: an integrated circuit package (IC package) comprising processing cores coupled to a memory controller; memory channels coupled to memory accessible via the memory controller; a physical layer based on IEEE 802.3 physical medium attachment (PMA) configured to communicate with an external entity; and a resource provisioning unit (RPU) comprising a Compute Express Link (CXL) device; wherein the RPU is coupled between the processing cores and the physical layer based on IEEE 802.3 PMA, and the RPU is configured to translate between CXL-based protocol data units (PDUs) communicated via the CXL device and carrier protocol PDUs encapsulating data indicative of CXL opcodes and physical addresses, wherein the carrier protocol PDUs are transmitted and received via the physical layer based on IEEE 802.3 PMA. The apparatus may be implemented as an SoC, a multi-chip module (MCM), a chiplet-based design, or any other form of IC that incorporates the processing cores, the memory controller, and the RPU. The processing cores may include general-purpose CPU cores, accelerator cores, or a combination thereof, and may be coupled to the memory controller through an on-chip interconnect, a coherent fabric, or a direct interface. The memory accessible via the memory controller may include DRAM, HBM, or other memory technologies coupled through one or more memory channels utilizing DDR, LPDDR, or HBM interfaces. The RPU may be integrated within the IC package or may be implemented on a separate die within the same package, coupled to the processing cores via an on-chip or inter-die interface. The CXL device within the RPU may include one or more CXL devices, CXL endpoints, or CXL ports that communicate CXL-based PDUs according to one or more CXL sub-protocols including CXL.io, CXL.mem, and CXL.cache. The carrier protocol PDUs may encapsulate CXL information in various formats, including complete CXL PDUs, subsets of CXL PDU fields, or carrier-specific encodings of CXL opcodes and physical addresses.

In some implementations of the apparatus, the processing cores are coupled to the memory controller via a coherent interconnect, and the processing cores respond to snoop requests utilizing physical addresses within a host physical address (HPA) space. The coherent interconnect may be implemented as a ring-based interconnect, a mesh-based interconnect, a crossbar, or another on-chip fabric that maintains cache coherency among the processing cores, LLC slices, home agents, and other coherent agents within the IC package. The processing cores may include cache hierarchies (such as L1, L2, and L3 caches) and may participate in a coherency protocol that handles snoop requests to maintain data consistency. When a snoop request targeting a physical address within the HPA space is received, the processing cores may respond by providing cached data, invalidating cached copies, or indicating the cacheline state, depending on the snoop type and the current coherency state of the cacheline. The HPA space defines the physical address range through which the processing cores and other agents within the IC package access memory resources.

In some implementations, the apparatus further comprises a memory management unit (MMU) coupled to the processing cores, the MMU configured to translate virtual addresses to physical addresses within the host physical address space. The MMU may be integrated within each processing core or may be shared among a group of processing cores. The MMU may utilize page tables, translation lookaside buffers (TLBs), and other address translation structures to map virtual addresses generated by software executing on the processing cores to physical addresses within the HPA space. The MMU may support multiple page sizes, multi-level page table walks, and IOMMU functionality for device-initiated address translations. The presence of the MMU in conjunction with the coherent interconnect may enable the processing cores to execute software that utilizes virtual memory while the underlying CXL transactions operate on physical addresses within the HPA space.

In some implementations of the apparatus, the RPU is further configured to translate a carrier protocol PDU received via the physical layer based on IEEE 802.3 PMA to a CXL request communicated via the CXL device, whereby the translating enables the external entity to access the memory via the physical layer based on IEEE 802.3 PMA, the RPU, the memory controller, and the memory channels. In the inbound direction, the RPU may receive carrier protocol PDUs from external entities such as remote processors, GPUs, accelerators, or memory fabric switches, and may extract and translate the encapsulated CXL information into CXL requests that are communicated via the CXL device to the internal CXL domain of the processor. The CXL requests may traverse the on-chip interconnect to reach the memory controller, which may service the requests by accessing the memory via the memory channels. This inbound path may enable remote entities to read from or write to the processor's memory without requiring a direct CXL link, instead utilizing the carrier protocol fabric and the IEEE 802.3 PMA as the transport medium. The inbound translation may include extraction of CXL.mem M2S request fields, reconstruction of omitted fields, address translation from the external entity's physical address space to the processor's HPA space, and delivery of the reconstructed CXL request via the CXL device.

In some implementations of the apparatus, the RPU is further configured to translate a CXL request originating from the processing cores to a carrier protocol PDU for transmission via the physical layer based on IEEE 802.3 PMA, whereby the translating enables the processing cores to access a resource coupled to the external entity via the RPU and the physical layer based on IEEE 802.3 PMA. In the outbound direction, the processing cores may generate CXL requests targeting resources that are accessible via external entities, such as HBM coupled to a remote GPU, storage buffers coupled to a remote storage device, MMIO registers of a remote accelerator, or memory pooled across a fabric. The CXL requests may traverse the on-chip interconnect to the CXL device within the RPU, which may translate the CXL requests into carrier protocol PDUs for transmission via the physical layer based on IEEE 802.3 PMA to the targeted external entity. The outbound translation may include converting CXL-based PDU fields into carrier protocol representations, translating physical addresses from the processor's HPA space to the external entity's physical address space, encapsulating the translated fields within carrier protocol headers and trailers, and transmitting the carrier protocol PDUs via the IEEE 802.3 PMA.

In some implementations of the apparatus, the RPU is further configured to translate a CXL request originating from the processing cores to a carrier protocol PDU for transmission via the physical layer based on IEEE 802.3 PMA, whereby the translating enables the processing cores to access a resource coupled to the external entity via the RPU and the physical layer based on IEEE 802.3 PMA. The bidirectional configuration may enable the RPU to serve as a full-duplex translation bridge, supporting concurrent inbound and outbound CXL traffic over the carrier protocol fabric. In one direction, external entities may access the processor's memory through the RPU, and in the other direction, the processing cores may access resources coupled to external entities through the same RPU. The bidirectional translation may utilize shared pipeline stages for operations common to both directions, such as carrier protocol framing and physical layer processing, while maintaining separate translation contexts for inbound and outbound traffic to handle different address spaces, Tag spaces, and protocol requirements. Bidirectional operation may be particularly beneficial in deployments where processors and accelerators maintain peer-to-peer relationships, each needing to access the other's memory or resources.

In some implementations of the apparatus, the CXL device comprises at least one of a CXL endpoint or a CXL port, and the CXL device operates as at least one of a CXL Type-2 device, a CXL Type-3 device, or a Global Fabric-Attached Memory Device (GFD). The CXL device within the RPU may take different forms depending on the types of CXL transactions to be supported and the processor architecture. A CXL device may implement the device-side CXL protocol logic, presenting itself as a CXL endpoint visible to the internal CXL fabric in the IC package. When operating as a CXL Type-2 device, it may support CXL.io, CXL.cache, and CXL.mem sub-protocols, enabling both memory access and cache coherency operations. When operating as a CXL Type-3 device, it may support CXL.io and CXL.mem sub-protocols, enabling memory access without device-initiated cache coherency. When operating as a GFD, it may support CXL.mem transactions optimized for fabric-attached memory pooling, potentially simplifying the design by omitting CXL.io handling. The selection of CXL device type may depend on the intended use case, the types of external entities to be served, and the processor's internal coherency architecture.

In some implementations, the apparatus further comprises a root port coupled to a fully coherent request node (RN-F) and a fully coherent home node (HN-F), the root port coupled to the RPU, wherein the RN-F enables the external entity to access the memory of the apparatus and the HN-F enables the processing cores to access a resource coupled to the external entity. The root port may provide a CXL or PCIe root complex interface that is coupled to both an RN-F node and an HN-F node within the processor's coherent interconnect. The RN-F node may act as a fully coherent request node that issues requests on behalf of external entities, enabling those entities to access the processor's memory through the coherent interconnect with full cache coherency. The HN-F node may act as a fully coherent home node that provides a home agent proxy for resources coupled to external entities, enabling the processing cores to issue coherent read and write requests to those resources through the coherent interconnect. This dual-node architecture may support bidirectional coherent access: the RN-F path enables an external entity, such as a GPU, to read from the processor's DRAM, while the HN-F path enables the processing cores to read from the external entity's memory, such as HBM or storage buffers. The root port may be coupled to a second RPU, or may share the RPU with the CXL device path, depending on the implementation.

In some implementations of the apparatus, the RPU is coupled to the processing cores via at least one CXL/CCIX Gateway (CCG) and a coherent interconnect. The CCG may serve as a bridge between the CXL protocol domain and the ARM AMBA CHI protocol domain utilized by the coherent interconnect.

In some implementations of the apparatus, the RPU is further coupled to the processing cores via at least one I/O-coherent Request Node (RN-I) for handling CXL.io traffic. The RN-I node may provide a path for CXL.io or PCIe-based non-coherent traffic that does not participate in the cache coherency protocol.

In some implementations, the apparatus further comprises a second RPU comprising a second CXL device and a second physical layer based on IEEE 802.3 PMA, the second RPU coupled to a root port, wherein the RPU is further configured to handle coherent CXL.mem traffic and the second RPU is configured to handle coherent CXL.mem traffic via the root port. The dual-RPU architecture may provide two distinct paths for CXL.mem traffic, each serving different roles or optimized for different access patterns. The first RPU, coupled to a CXL device and an interconnect component, may handle CXL.mem traffic through a path that is optimized for device-style memory access patterns. The second RPU, coupled to a root port with associated coherent nodes such as RN-F and HN-F, may handle CXL.mem traffic through a path that supports bidirectional coherent access between the processor and external entities. The two RPUs may operate independently, each with its own physical layer based on IEEE 802.3 PMA, enabling the processor to communicate with external entities in parallel, or to provide redundant paths to the same external entity. The two paths may serve different CXL sub-protocol combinations: the first path through the CXL device may support CXL.mem and CXL.io via the CXL-to-CHI and RN-D nodes, while the second path through the root port may support CXL.mem and CXL.cache via the RN-F and HN-F nodes.

In some implementations of the apparatus, the CXL device comprises a Global Fabric-Attached Memory Device (GFD) supporting CXL.mem transactions, the GFD coupled to the processing cores via a CXL/CCIX Gateway (CCG) optimized for handling CXL.mem traffic. The GFD may operate as a specialized CXL device optimized specifically for memory access operations, which simplifies the design. This simplified architecture may be suitable for processors or accelerators (such as xPUs or custom CPU designs) that are designed primarily for servicing external memory requests through CXL.mem fabric access, such as in memory pooling or memory disaggregation deployments.

In some implementations of the apparatus, the RPU is further configured to translate physical addresses between a first physical address space utilized by the external entity and a second physical address space utilized by the processing cores. The external entity may utilize a first physical address space, such as a first HPA space, that differs from the second physical address space, such as a second HPA space, utilized by the processing cores in the IC package. The RPU may perform address translation as part of the extraction and encapsulation processing pipeline, mapping physical addresses from incoming carrier protocol PDUs to the processor's HPA space for inbound requests, and mapping physical addresses from outgoing CXL requests to the external entity's HPA space for outbound requests. The address translation may be implemented utilizing lookup tables, base-and-offset calculations, page table structures, or other translation mechanisms. The translation may enable external entities with different physical address spaces to access the processor's memory through the RPU, and may enable the processing cores to access resources in different physical address spaces via different external entities.

In some implementations of the apparatus, a carrier protocol PDU comprises an encapsulating header comprising at least one field selected from: a PDU version field, a source node identifier, a destination node identifier, a segmentation identifier, a PDU sequence number, or a passenger protocol identifier. The encapsulating header may be placed within the carrier protocol PDU between the carrier protocol headers (such as Ethernet, IP, and UDP headers) and the passenger protocol PDU payload. The PDU version field may indicate the version or format of the encapsulation structure, enabling the processing pipeline to correctly interpret the packet. The source node identifier and the destination node identifier may carry node addresses within the fabric topology for routing purposes. The segmentation identifier may provide tenant isolation or logical network segmentation. The PDU sequence number may provide ordering information for reliable delivery or for reassembly of segmented messages across the fabric. The passenger protocol identifier may indicate the type of CXL sub-protocol (such as CXL.io, CXL.cache, or CXL.mem) encapsulated within the PDU, enabling the processing pipeline to apply appropriate extraction and translation rules.

In some implementations of the apparatus, the carrier protocol PDU further comprises an encapsulating trailer comprising at least one field selected from: an encapsulating CRC (E-CRC) field, a data poisoning (Poison) field, or a reported load (ReportedLoad) field. The encapsulating trailer may be placed after the passenger protocol PDU payload and before any carrier protocol trailer fields such as an Ethernet Frame Check Sequence (FCS). The E-CRC field may provide error detection specifically for the encapsulated portion of the packet, potentially offering additional integrity protection beyond the standard Ethernet FCS. The Poison field may propagate data poisoning indications across the carrier protocol fabric, enabling CXL poison semantics to be maintained end-to-end even when CXL traffic is encapsulated within carrier protocol PDUs. The ReportedLoad field may communicate load or congestion information from the source device or from intermediate network components along the path.

In some implementations of the apparatus, the ReportedLoad field communicates at least one of congestion or load information, wherein the congestion information is augmented with congestion information from intermediate components along a path. The ReportedLoad field may serve a function analogous to CXL DevLoad indicators, carrying information about the load or congestion state at the source device and optionally along intermediate points in the carrier protocol fabric path. Intermediate components such as switches, routers, or fabric managers may augment the ReportedLoad value with their own congestion observations as the carrier protocol PDU traverses the fabric. The receiving RPU may utilize the ReportedLoad information for load balancing decisions, quality-of-service management, congestion avoidance, or adaptive routing. The augmentation by intermediate components may provide a more comprehensive view of fabric congestion than source-only reporting, enabling more effective end-to-end congestion management.

In some implementations of the apparatus, the segmentation identifier provides isolation between different tenants or logical networks. The segmentation identifier may enable infrastructure virtualization within the carrier protocol fabric, allowing multiple tenants, virtual machines, or logical networks to share the same physical fabric infrastructure while maintaining isolation of their CXL traffic. Different segmentation identifier values may correspond to different tenants or logical domains, and the RPU or intermediate switching elements may utilize the segmentation identifier to enforce access control and traffic separation. The segmentation identifier may function similarly to VLAN identifiers in Ethernet or segment identifiers in overlay networks, applied specifically to CXL traffic transported over the carrier protocol fabric. The isolation may prevent CXL requests from one tenant from being visible to or interfering with CXL traffic of another tenant.

In some implementations of the apparatus, the carrier protocol PDU further comprises an Ethernet header, an IP header, and a UDP header suitable for Layer 3 (L3) switching operations. The L3 variant of the carrier protocol PDU may include standard Ethernet, IP, and UDP headers preceding the encapsulating header, enabling the carrier protocol PDU to be routed through standard L3 networking equipment, IP routers, and datacenter switches without modification. The Ethernet header may carry MAC addresses for hop-by-hop forwarding. The IP header may carry source and destination IP addresses for network-layer routing decisions across subnets. The UDP header may carry port numbers for service identification and may enable load balancing by varying port numbers across flows. The L3 variant may be suitable for deployments where CXL traffic traverses network segments, subnets, or routing domains within a datacenter fabric.

In some implementations of the apparatus, the carrier protocol PDU comprises a carrier protocol optimized header suitable for Layer 2 (L2) switching operations. The L2 variant of the carrier protocol PDU may utilize a condensed or optimized header structure that reduces per-packet overhead compared to the L3 variant. The optimized header may carry addressing or routing information suitable for L2 forwarding decisions based on MAC addresses or other data link layer identifiers, without the overhead of IP and UDP headers. The encapsulating header, passenger protocol PDU, and encapsulating trailer may contain similar fields and serve similar functions as in the L3 variant, adapted for the L2 switching context. The L2 variant may be suitable for deployments where CXL traffic remains within a network segment or broadcast domain, such as within a rack or a top-of-rack switch domain, where L3 routing is not required.

In some implementations, the apparatus further comprises a root port coupled to an upstream port (USP) of a switch, the switch comprising downstream ports (DSPs) coupled to CXL Type-3 devices, and the RPU coupled to the switch via the physical layer based on IEEE 802.3 PMA, wherein both the root port and the RPU access the CXL Type-3 devices via the switch. The switch-based dual-path topology may enable two distinct paths for accessing the same CXL Type-3 memory devices. The first path may connect the root port in the IC package to the USP of the switch, providing a CXL or PCIe-native path for the processing cores to access the memory within the CXL Type-3 devices through the switch's DSPs. The second path may connect external entities (such as remote processors, GPUs, or accelerators) through the carrier protocol fabric, the physical layer based on IEEE 802.3 PMA, the RPU, and then to the switch, enabling those external entities to access the same CXL Type-3 memory devices. The switch may be a Port Based Routing (PBR) switch or a fabric switch that supports multiple upstream connections. This dual-path topology may enable memory pooling or memory sharing scenarios where hosts access shared memory resources through different connectivity paths, some native CXL and some CXL-over-carrier-protocol.

In some implementations of the apparatus, the carrier protocol comprises at least one of Ethernet, Ultra Ethernet Transport (UET), Ethernet for Scale-Up Networking (ESUN), or Scale Up Ethernet (SUE), and the RPU is further configured to extract CXL PDUs from the carrier protocol PDUs and encapsulate CXL PDUs into the carrier protocol PDUs. Different carrier protocols may utilize the IEEE 802.3 PMA while employing different framing, encoding, or header structures. The RPU may support one or more of these carrier protocols and may be configurable to adapt its extraction and encapsulation behavior based on the carrier protocol in use. For Ethernet, the RPU may process standard Ethernet frames with MAC-layer framing. For UET, the RPU may process frames utilizing UET-specific framing optimized for high-performance computing workloads. For ESUN/SUE, the RPU may process frames utilizing ESUN/SUE-specific framing optimized for scale-up interconnect topologies. The extraction operation may include parsing carrier protocol headers, identifying and extracting encapsulated CXL PDU fields, and translating carrier-specific field representations to CXL-conformant formats. The encapsulation operation may include converting CXL PDU fields to carrier-specific representations, generating carrier protocol headers and trailers, and transmitting the resulting carrier protocol PDUs via the physical layer.

In some implementations of the apparatus, the RPU is further configured to translate Tags between a first Tag space utilized by the external entity and a second Tag space utilized by the processing cores. Tags may serve as transaction identifiers that enable response correlation and tracking within CXL transactions. Different entities may utilize different Tag spaces, each with its own range and allocation policies. The RPU may maintain a Tag translation table or mapping function that translates Tags from the external entity's Tag space to the processor's Tag space for inbound transactions, and from the processor's Tag space to the external entity's Tag space for outbound transactions. The Tag translation may enable the RPU to manage concurrent transactions from multiple external entities without Tag collisions, by mapping each entity's Tag values into non-overlapping ranges within the processor's Tag space. In some implementations, the RPU may not terminate the CXL protocol, in which case the Tag may pass through unchanged.

In various implementations, a method comprising: communicating, via a physical layer based on IEEE 802.3 physical medium attachment (PMA), with an external entity; and translating, by a resource provisioning unit (RPU) comprising a Compute Express Link (CXL) device, between CXL-based protocol data units (PDUs) communicated via the CXL device and carrier protocol PDUs encapsulating data indicative of CXL opcodes and physical addresses, wherein the carrier protocol PDUs are transmitted and received via the physical layer based on IEEE 802.3 PMA. The translating may occur continuously during operation, processing both inbound carrier protocol PDUs carrying CXL requests from external entities and outbound CXL requests from the processing cores directed to external entities. The method may be implemented in hardware, firmware, software, or a combination thereof within the RPU.

In some implementations of the method, the translating comprises translating a carrier protocol PDU received via the physical layer based on IEEE 802.3 PMA to a CXL request communicated via the CXL device, whereby the translating enables the external entity to access memory via the physical layer based on IEEE 802.3 PMA, the RPU, a memory controller, and memory channels. The inbound translation method may involve receiving a carrier protocol PDU from the physical layer, parsing the carrier protocol headers to identify the encapsulated CXL information, extracting CXL fields such as opcodes and physical addresses, translating fields from carrier-specific formats to CXL-conformant formats, reconstructing any omitted CXL fields, and delivering the resulting CXL request via the CXL device to the CXL domain of the processor that includes the memory channels. The CXL request may then traverse the on-chip fabric to the memory controller, which services the request by accessing the memory via the memory channels. The method may further include generating a CXL response upon completion of the memory access and translating the response back into a carrier protocol PDU for return to the external entity.

In some implementations of the method, the translating comprises translating a CXL request originating from processing cores to a carrier protocol PDU for transmission via the physical layer based on IEEE 802.3 PMA, whereby the translating enables the processing cores to access a resource coupled to the external entity via the RPU and the physical layer based on IEEE 802.3 PMA. The outbound translation method may involve receiving a CXL request from the processing cores via the on-chip fabric and the CXL device, converting CXL PDU fields to carrier-specific representations, translating physical addresses from the processor's HPA space to the external entity's physical address space, encapsulating the translated fields within a carrier protocol PDU including appropriate headers and trailers, and transmitting the carrier protocol PDU via the physical layer based on IEEE 802.3 PMA. The resource coupled to the external entity may include HBM, DRAM, storage buffers, MMIO registers, or other addressable elements. The method may further include receiving a carrier protocol PDU carrying a response from the external entity and translating the response back into a CXL response for delivery to the processing cores.

In some implementations, the method further comprises translating, by the RPU, physical addresses between a first physical address space utilized by the external entity and a second physical address space utilized by processing cores. The address translation may be performed as part of the inbound and outbound translation operations. For inbound transactions, the RPU may translate physical addresses from the external entity's address space to the processor's address space before delivering the CXL request to the internal CXL domain. For outbound transactions, the RPU may translate physical addresses from the processor's address space to the external entity's address space before encapsulating the CXL request within the carrier protocol PDU. The address translation may utilize lookup tables, base-and-offset calculations, or other programmable translation mechanisms that are configurable during system initialization or runtime.

In some implementations of the method, a carrier protocol PDU comprises an encapsulating header comprising at least one field selected from: a PDU version field, a source node identifier, a destination node identifier, a segmentation identifier, a PDU sequence number, or a passenger protocol identifier. The encapsulating header may enable routing, ordering, multi-tenancy isolation, and protocol identification across the carrier protocol fabric. During inbound translation, the RPU may parse the encapsulating header to determine the destination, identify the passenger protocol type, verify sequencing, and apply tenant isolation policies. During outbound translation, the RPU may generate the encapsulating header with appropriate field values for the target external entity, including source and destination node identifiers for fabric routing, a segmentation identifier for tenant isolation, a PDU sequence number for ordering, and a passenger protocol identifier indicating the CXL sub-protocol being transported.

In some implementations of the method, the carrier protocol comprises at least one of Ethernet, Ultra Ethernet Transport (UET), Ethernet for Scale-Up Networking (ESUN), or Scale Up Ethernet (SUE), and the translating comprises extracting CXL PDUs from the carrier protocol PDUs and encapsulating CXL PDUs into the carrier protocol PDUs. The method may be applied to various carrier protocols that utilize the IEEE 802.3 PMA, including Ethernet for general datacenter networking, UET for optimized high-performance computing fabrics, and ESUN/SUE for scale-up interconnect topologies. The extraction and encapsulation operations may be adapted to the specific framing, header, and encoding conventions of the carrier protocol in use. The method may support automatic detection of the carrier protocol type based on patterns or markers in the received data stream, or the carrier protocol type may be configured statically based on the system deployment.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

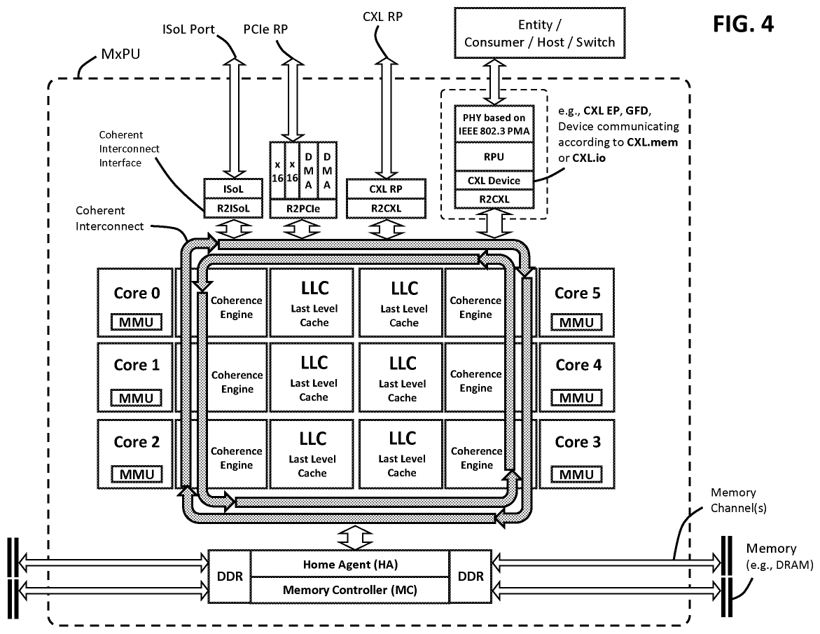

FIG. 4 illustrates an example of a system comprising a processor (such as an MxPU) comprising processing cores (Core 0 through Core 5) comprising MMUs. The cores are coupled to LLC sections and coherence engines via a coherent interconnect, which may be an on-chip processor interconnect such as Intel ring/mesh/crossbar or ARM CHI ring/mesh/crossbar. The MxPU includes external interfaces: an ISoL Port (e.g., ARM CHI C2C, or Intel UPI) coupled to the coherent interconnect via a coherent interconnect interface labeled Ring-to-ISoL (R2ISoL), a PCIe root port (RP) coupled via R2PCIe with PCIe lane configurations (such as x16 and DMA), a CXL RP coupled via R2CXL, and an RPU based interface. The RPU based interface includes a Physical Layer based on IEEE 802.3 PMA coupled to an RPU, coupled to a CXL Device, coupled to an R2CXL interface coupled to the coherent interconnect. The CXL Device may function as different device types such as a CXL EP, GFD, or other device communicating according to a protocol based on CXL, such as CXL.mem or CXL.io. An entity, shown as Entity/Consumer/Host/Switch, is coupled to the MxPU via the Physical Layer based on IEEE 802.3 PMA. The CXL Device enables communication with the external entity using encapsulated CXL protocols over a carrier protocol supported by the IEEE 802.3 PMA, while the RPU performs the applicable translations between the carrier domain and the MxPU's internal coherent interconnect domain. The MxPU further includes a Home Agent (HA) and Memory Controller (MC) coupled to memory (e.g., DRAM) via DDR memory channels.

Translations and bridging logic can enable interoperability between different communication standards while conforming to performance and coherency requirements. The IEEE 802.3 PMA layer provides a standardized physical interface that may be utilized by various protocols for data transmission, offering a well-established foundation for high-speed communication. This PMA layer and its variants may serve as the physical transport for one or more protocols such as Ethernet, UALink, NVLink, Ethernet for Scale-Up Networking (ESUN), Scale Up Ethernet (SUE), and/or other high-performance interconnect technologies.

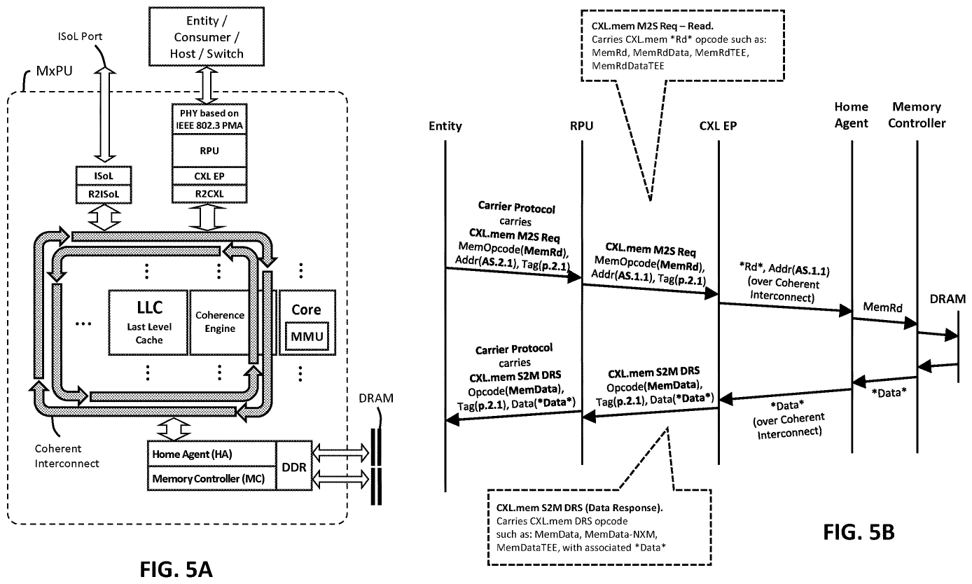

FIG. 5A illustrates an example of a system comprising a processor, such as an MxPU, comprising a PHY based on IEEE 802.3 PMA for transmitting and receiving data according to a carrier protocol. The processor comprises processing cores with MMU and LLC coupled via a coherent interconnect, such as a ring-based interconnect, to various components including a Home Agent (HA), Memory Controller (MC), and CBox (LLC Coherence Engine). The processor further includes an ISoL port, such as ARM CHI C2C or Intel UPI, coupled to the coherent interconnect via a Ring-to-ISoL (R2ISoL) interface. The memory controller is coupled via DDR memory channels to DRAM. The PHY based on IEEE 802.3 PMA enables communication with entities using carrier protocols that encapsulate CXL messages, wherein the IEEE 802.3 PMA provides the physical layer interface for transmitting and receiving frames carrying the encapsulated CXL protocol data. The processor further includes an RPU and a CXL EP associated with the PHY, wherein the RPU is coupled to the coherent interconnect via a Ring-to-CXL (R2CXL) interface. Alternatively, the RPU may be coupled to the coherent interconnect essentially directly. The CXL EP exposes a Type-3 CXL Device or a Type-2 CXL Device. The RPU extracts CXL messages from the carrier protocol frames received via the PHY, performs physical address translations between the entity's HPA space and the processor's physical address space, and encapsulates CXL responses back into the carrier protocol for transmission via the PHY.

FIG. 5B illustrates an example of a TFD demonstrating CXL.mem communications over a carrier protocol utilizing the PHY based on IEEE 802.3 PMA. An entity, such as a host or switch, transmits frames via the carrier protocol, wherein the frames encapsulate CXL.mem M2S requests. The PHY based on IEEE 802.3 PMA receives these frames and provides them to the RPU. The encapsulated request includes a CXL.mem read opcode such as MemRd, MemRdData, MemRdTEE, or MemRdDataTEE, along with a physical address (AS.2.1) from a second physical address space and optionally a Tag (p.2.1) from the entity's Tag space. The RPU extracts the CXL.mem request from the carrier protocol frame, translates the physical address (AS.2.1) to a physical address (AS.1.1) from a first physical address space utilized by the coherent interconnect, and optionally translates the Tag (p.2.1) to a Tag from the coherent interconnect's Tag space. The figure illustrates an example wherein the RPU does not terminate the protocol, and thus the Tag (p.2.1) passes through the RPU unchanged. The RPU performs translations to generate a read request conforming to the coherent interconnect protocol, which is sent to the Home Agent (also known as home node) and/or Memory Controller. The requested data is retrieved from the LLC or DRAM and returned via the coherent interconnect. The CXL EP generates CXL.mem S2M DRS messages carrying the data and optionally CXL.mem S2M NDR messages. The RPU optionally translates response Tags back from the processor's Tag space to the entity's Tag space, encapsulates the CXL.mem responses within carrier protocol frames, and transmits them via the PHY based on IEEE 802.3 PMA to the requesting entity.

In environments where entities may utilize different protocols while requiring coordinated access to shared resources, there may be scenarios where a first entity communicating according to UALink UPLI, such as an accelerator, needs to access memory resources coupled to a second entity communicating according to CXL, such as CXL.mem. An RPU may translate between UPLI and CXL.mem to facilitate memory operations, data transfers, and/or resource sharing across different protocol domains while maintaining the requirements of each protocol. The RPU may translate opcodes, commands, addresses, Tags, and additional fields between UPLI and CXL.mem messages, and may further perform address translations between different address spaces, such as between a Network Physical Address (NPA) space utilized by UALink-based traffic and a Host Physical Address (HPA) space utilized by CXL-based traffic, or between addresses within the same address space, such as a global address space, a partitioned global address space (PGAS), a pod address space, a virtual pod address space, or a fabric address space. The RPU may be implemented as a discrete component, as an IP block embedded in a processor, or as a chiplet within an IC package.

In various implementations, a method for translating from Ultra Accelerator Link (UALink) Protocol Level Interface (UPLI) requests to Compute Express Link (CXL) requests, comprising: communicating with a first entity according to UPLI; communicating with a second entity according to CXL.mem; receiving, from the first entity, a UPLI request comprising a read command and a first physical address; translating the UPLI request to a CXL.mem Master-to-Subordinate request comprising: a MemRd* and a second physical address (CXL.mem M2S Req MemRd*); and sending the CXL.mem M2S Req MemRd* to the second entity. The translation may enable entities communicating according to UPLI to access memory resources coupled to entities communicating according to CXL.mem. The method may be implemented in hardware, firmware, software, or combinations thereof, and may be performed by various types of devices, such as a processor, a switch, a bridge, an RPU, or a semiconductor device. MemRd* may refer to MemRd, MemRdData, MemRdTEE, MemRdDataTEE, or other memory read opcode variants defined or to be defined in CXL.mem. The first physical address may be associated with a first address space, such as an NPA space, and the second physical address may be associated with a second address space, such as an HPA space or an SPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The elements may communicate through one or more intermediary components, such as a switch, a retimer, or other suitable entity that facilitates information transfer.

In some implementations of the method, the UPLI request further comprises a ReqSrcPhysAccID field, a ReqDstPhysAccID field, a ReqLen field, a ReqTag field, a ReqAddr field comprising the first physical address, and a ReqCmd field comprising the read command; and further comprising translating the ReqTag to a Tag associated with the CXL.mem M2S Req. The ReqSrcPhysAccID and ReqDstPhysAccID fields may carry identifiers that may be utilized by the RPU for routing the UPLI request to its target, and may be further utilized for constructing response routing information. The ReqLen field may indicate a transfer size of up to 256 Bytes of data. When the ReqLen indicates a transfer size exceeding a CXL.mem cacheline size (e.g., 64 Bytes), the RPU may translate a UPLI request to multiple CXL.mem M2S requests. The Tag translation may involve maintaining a bidirectional mapping between UPLI ReqTag values and CXL.mem Tag values, enabling proper correlation of CXL.mem responses with their corresponding UPLI requests.

In some implementations, the method further comprises receiving, from the second entity, a CXL.mem Subordinate-to-Master Data Response (S2M DRS) comprising MemData, a Tag, and data; translating the CXL.mem S2M DRS to a UPLI read response (RdRsp) comprising a RdRspSrcPhysAccID field, a RdRspDstPhysAccID field, a RdRspTag field, and RdRspData comprising the data; and sending the UPLI RdRsp to the first entity. The RdRspSrcPhysAccID may correspond to the ReqDstPhysAccID from the original UPLI request, and the RdRspDstPhysAccID may correspond to the ReqSrcPhysAccID, reflecting the routing path for the response. The RdRspTag may be retrieved from the bidirectional mapping maintained by the RPU, enabling the first entity to correlate the response with its original request. In some examples, the RPU may accumulate data from one or more CXL.mem S2M DRS messages before sending the data via the UPLI RdRsp, such as when CXL.mem M2S requests were generated from a UPLI request.

In some implementations of the method, the CXL.mem S2M DRS further comprises a Poison field, and the UPLI RdRsp further comprises a RdRspDataError field; and further comprising translating the Poison field of the CXL.mem S2M DRS to the RdRspDataError field of the UPLI RdRsp. The Poison field in CXL.mem S2M DRS may indicate that the returned data contains an error. The RdRspDataError field in UPLI may serve as a per-beat data poison indicator. The translation of error indications across protocol boundaries may enable the first entity to detect data corruption that originated in the CXL domain, and to take appropriate recovery actions, such as discarding the corrupted data, retrying the request, or reporting the error to system management software.

In some implementations of the method, the read command comprises a Read Class Vendor Defined Command, the first entity comprises an accelerator or a UALink switch, the second entity comprises a CXL device, and the second physical address is a host physical address (HPA) utilized by the second entity. Read Class VDCs may correspond to ReqCmd encodings and may enable vendor-specific memory access operations that extend beyond the standard UPLI read commands. The CXL device may include a CXL memory expander, a CXL memory pool, a Global Fabric-Attached Memory (G-FAM) Device (GFD), or a CXL accelerator. The HPA may represent an address within the address space utilized by the second entity for servicing memory requests.

In some implementations of the method, the UPLI request indicates an I/O-coherent read, and the CXL.mem M2S Req MemRd* further comprises a SnpType field comprising SnpCur, a MetaField field comprising Meta0-State (MS0), and a MetaValue field comprising Invalid (I). The SnpType(SnpCur), MetaField(MS0), and MetaValue(I) combination in the CXL.mem M2S request may indicate an intent to perform an I/O-coherent read by requesting a non-cacheable but current value of the data. This combination may correspond to the I/O-coherency model utilized by UALink, wherein a read from peer memory returns the most recent coherent copy from memory or a cache within the destination's system node. The RPU may select the SnpType, MetaField, and MetaValue values based on a predefined, predetermined, configurable, rule-based, or dynamic intent mapping between the UPLI I/O-coherent read semantics and CXL.mem coherency fields.

In some implementations, the method further comprises sending to the second entity a CXL.mem M2S request comprising MemSpecRd. The speculative memory read may be initiated by the RPU to facilitate data availability from the second entity before, or without, the first entity explicitly requesting that data. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. When utilizing the MemSpecRd opcode, some of the CXL.mem M2S Req fields, such as Tag, MetaField, MetaValue, and SnpType, may be reserved. Additionally or alternatively, the RPU may issue reads (e.g., CXL.mem M2S requests comprising MemRd or MemRdData) to prefetch data from the second entity, and may buffer the returned data for satisfying subsequent demand requests from the first entity.

In some implementations of the method, the first physical address is associated with a first address space, the second physical address is associated with a second address space different from the first address space, and the translating further comprises translating the first physical address to the second physical address. The first address space may include an NPA space utilized by the UALink-based traffic, and the second address space may include an HPA space utilized by CXL-based traffic. The first and second address spaces may have different sizes, different base addresses, different memory layouts, or different granularities, and the translation may accommodate these differences while maintaining the meaning of the memory operations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In computing environments where external entities, such as accelerators, may access memory resources coupled to a processing unit, there may be scenarios where the processing unit provides access to memory resources via different memory paths. For example, a processing unit may include a first memory path from a UALink port to a first memory via a memory controller, and a second memory path from the UALink port to a second memory via a CXL port. The processing unit may include an RPU that translates between a UALink-based protocol, such as UPLI, and the protocols utilized for accessing the first and second memories. The RPU may perform physical address translations, such as from NPAs to HPAs, to enable external entities to access both memory resources via the UALink port.

In various implementations, a system comprising: a processing unit comprising an Ultra Accelerator Link (UALink) port, a memory controller coupled to a first memory, and a Compute Express Link (CXL) port coupled to a second memory; wherein the UALink port is configured to communicate with an entity according to a UALink-based protocol; wherein the processing unit is configured to provide a first memory path from the UALink port to the first memory via the memory controller, and a second memory path from the UALink port to the second memory via the CXL port; and wherein the processing unit further comprises a resource provisioning unit (RPU) configured to receive a first UALink Protocol Level Interface (UPLI) request from the entity and forward a first translated request to the first memory via the first memory path, and to receive a second UPLI request from the entity and forward a second translated request to the second memory via the second memory path. The processing unit may be implemented as a processor, a system-on-chip (SoC), or as chiplets within an IC package. The first memory may include DRAM coupled to the memory controller, and the second memory may include a CXL memory expander, a CXL memory pool, or a CXL device that exposes memory resources. The RPU may perform physical address translations to determine whether a given UPLI request targets the first memory or the second memory, and may route the translated request to the appropriate memory path accordingly. The entity may include an accelerator, a CPU, or a switch that communicates with the processing unit via the UALink port according to UPLI. In some examples, the requested data may be provided by a cache of the processing unit, such as by LLC, instead of by the first or second memory.

In some implementations of the system, the processing unit further comprises a coherent interconnect, and wherein the first memory path and the second memory path traverse a portion of the coherent interconnect. The coherent interconnect may include a mesh network, a ring interconnect, a crossbar, a Network on Chip (NoC), or other types of interconnect fabrics that maintain cache coherency among processing cores and other components of the processing unit. The first memory path may traverse the coherent interconnect from the RPU to the memory controller, and the second memory path may traverse the coherent interconnect from the RPU to the CXL port. In some examples, the RPU may translate between the UALink-based protocol, such as UPLI, and a protocol utilized by the coherent interconnect. The paths from the RPU to the different memories may traverse other components coupled to the coherent interconnect, such as caching/home agent (CHA) slices, snoop filter (SF) slices, or LLC slices, optionally for resolving coherency.

In some implementations of the system, the CXL port comprises a CXL/PCIe root port (RP) coupled to the coherent interconnect. The CXL/PCIe RP may be a separate component on the coherent interconnect, enabling the processing unit to communicate with CXL devices coupled to the second memory. In other examples, the CXL/PCIe RP may be included within the RPU.

In some implementations of the system, the processing unit further comprises processing cores, caching/home agent (CHA), snoop filter (SF), and Last Level Cache (LLC) slices coupled to the coherent interconnect; and further comprising at least one of: a PCIe root port coupled to an I/O device, or an inter-socket link (ISoL) port coupled to a second processing unit. The processing cores, CHA/SF/LLC slices, and additional ports may be coupled to the coherent interconnect, enabling coordinated access to memory resources. The PCIe RP may be coupled to an I/O device, such as a network controller, an Ethernet NIC, an InfiniBand adapter, or a PCIe GPU. The ISoL port may utilize NVIDIA NVLink-C2C, ARM CHI C2C, or ICPIP for inter-socket or inter-chip communication.

In some implementations of the system, the UALink port, the CXL port, and the memory controller are located in a same integrated circuit (IC) package; and wherein the RPU is further configured to translate physical addresses associated with the UALink-based protocol to physical addresses associated with the processing unit, enabling the entity to access the first memory and the second memory. The IC package may be implemented as a monolithic die or as chiplets within a multi-chip module. The physical address translation may include translating Network Physical Addresses (NPAs) carried in UPLI requests to Host Physical Addresses (HPAs) utilized by the processing unit's address space. The translated addresses may be utilized by the processing unit to determine whether a given request targets the first memory or the second memory, and to route the translated request to the appropriate memory path.

In some implementations of the system, the second translated request comprises a CXL.mem Master-to-Subordinate (M2S) request comprising MemRd*, and the CXL port is configured to send the CXL.mem M2S request to the second memory; and wherein the CXL port is further configured to receive a CXL.mem Subordinate-to-Master Data Response (S2M DRS) comprising MemData and data from the second memory, and the RPU is further configured to translate the CXL.mem S2M DRS to a UPLI read response (RdRsp) comprising the data and send the UPLI RdRsp to the entity. The second memory path may utilize CXL.mem for communication between the CXL port and the second memory, wherein the RPU may translate between UPLI and CXL.mem, including translations of addresses, Tags, and opcodes. The second memory may include a CXL memory expander or a CXL device that responds to CXL.mem M2S requests with CXL.mem S2M DRS messages carrying the requested data.

In computing environments where a cluster of accelerators may be coupled via a switch, the accelerators may need to access memory resources that are external to the UALink domain. For example, memory resources such as CXL memory expanders, CXL memory pools, or GFDs may be coupled to the cluster via an RPU that translates between the UALink-based protocol utilized by the accelerators and CXL.mem utilized by the CXL memory devices. In some configurations, the RPU may be coupled to multiple distinct CXL memory devices, and may route translated requests to different CXL memory devices based on the physical addresses carried in the UPLI requests received from the accelerators. The RPU may thus enable accelerators within the cluster to access a pool of CXL memory resources distributed across devices, while the switch provides the communication fabric among the accelerators and between the accelerators and the RPU.

In various implementations, a system comprising: a switch; accelerators coupled to the switch, wherein the accelerators communicate according to a UALink-based protocol; a resource provisioning unit (RPU) coupled to the switch; a first Compute Express Link (CXL) memory device coupled to the RPU; and a second CXL memory device coupled to the RPU; wherein the RPU is configured to receive a first UALink Protocol Level Interface (UPLI) request and a second UPLI request from a first accelerator of the accelerators via the switch, translate the first UPLI request to a first CXL.mem Master-to-Subordinate (M2S) request and send the first CXL.mem M2S request to the first CXL memory device, and translate the second UPLI request to a second CXL.mem M2S request and send the second CXL.mem M2S request to the second CXL memory device. The system may enable accelerators within a UALink cluster to access CXL memory resources that reside outside the UALink domain, without requiring modifications to the accelerators'UALink interfaces or protocols. The RPU may determine which CXL memory device to target for each translated request based on the physical address carried in the UPLI request, for example by comparing the address against address range registers or translation tables that map address ranges to specific CXL memory devices. The first and second CXL memory devices may have different capacities, different performance characteristics, different address ranges, or different device types. The RPU may be implemented as a discrete component coupled to the switch, as an IP block embedded within one of the accelerators, or as a chiplet within an IC package. The RPU may translate between UPLI and CXL.mem including translations of opcodes, addresses, Tags, and additional fields. In some examples, the RPU may be coupled to more than two CXL memory devices, and may distribute translated requests across the CXL memory devices based on address, load balancing policies, or other criteria. The method may be implemented in hardware, firmware, software, or combinations thereof.

In some implementations of the system, at least one of the first CXL memory device or the second CXL memory device comprises a Global Fabric-Attached Memory Device (GFD); and wherein the RPU is further configured to receive a CXL.mem Subordinate-to-Master Data Response (S2M DRS) from the GFD, translate the CXL.mem S2M DRS to a UPLI read response (RdRsp), and send the UPLI RdRsp to the first accelerator via the switch. The GFD may provide large-capacity memory resources accessible via CXL.mem, and may be shared among requesters including accelerators via the RPU and hosts via direct CXL.mem access. The RPU may translate the CXL.mem S2M DRS, including by translating the Tag back to the original UPLI ReqTag and formatting the data as UPLI RdRspData for delivery to the first accelerator.

In some implementations, the system further comprises a host coupled to at least one of the first CXL memory device or the second CXL memory device via CXL.mem; wherein both the first accelerator, via the RPU, and the host access the at least one of the first CXL memory device or the second CXL memory device. The shared access configuration may enable both accelerators and hosts to access the same CXL memory resources, potentially for data sharing, producer-consumer communication, or tiered memory management. The host may access the CXL memory device via CXL.mem without translation, while the accelerators access the same CXL memory device via the RPU that translates between UPLI and CXL.mem.

In some implementations, the system further comprises a CXL fabric coupling the RPU to the first CXL memory device and the second CXL memory device; wherein at least one of the first CXL memory device or the second CXL memory device comprises at least one of: a CXL memory expander, a CXL memory pool, or a Global Fabric-Attached Memory Device (GFD). The CXL fabric may include one or more CXL switches, and may provide connectivity between the RPU and CXL memory devices. The CXL fabric may enable the RPU to reach CXL memory devices that are not directly coupled to the RPU.

In some implementations of the system, the first UPLI request comprises a first physical address associated with a first address space, and the second UPLI request comprises a second physical address associated with the first address space; wherein the first CXL.mem M2S request comprises a third physical address associated with a second address space, and the second CXL.mem M2S request comprises a fourth physical address associated with the second address space; and wherein the RPU translates the first physical address to the third physical address and the second physical address to the fourth physical address; and wherein the first address space comprises a Network Physical Address (NPA) space or a System Physical Address (SPA) space, and the second address space comprises a Host Physical Address (HPA) space. The address translation may be implemented utilizing lookup tables, page tables, base-and-offset calculations, range-based mapping, and/or programmable translation functions. The RPU may determine which CXL memory device to target based on the translated address, for example by comparing the third or fourth physical address against address ranges assigned to the first and second CXL memory devices. In some examples, the first and second address spaces may be the same address space, such as a global address space or a fabric address space, and the RPU may perform routing without address translation.

In some implementations of the system, the switch comprises a UALink switch comprising a route table, and the UALink switch routes the first UPLI request and the second UPLI request from the first accelerator to the RPU based on a Destination Accelerator ID carried in the first UPLI request and the second UPLI request; and wherein the accelerators communicate with the UALink switch via UPLI request channels and UPLI response channels. The UALink switch may route UPLI traffic based on the ReqDstPhysAccID field in each UPLI request, utilizing the route table to map the Destination Accelerator ID to an egress port coupled to the RPU. The RPU may thus appear to the accelerators as a UALink endpoint identified by an Accelerator ID, enabling the accelerators to send UPLI requests to the RPU using standard UALink routing mechanisms. The route table may be programmed by a Pod Controller or other management entity. The UPLI request channels may carry read, write, atomic, and vendor defined commands, and the UPLI response channels may carry corresponding read responses and write responses.

In environments where entities communicating according to UPLI need to write data to memory resources coupled to entities communicating according to CXL.mem, an RPU or other translating device may translate between UPLI write requests and CXL.mem write requests. The write path involves translating from UPLI request and Originator Data channels to CXL.mem M2S RwD messages, and translating the CXL.mem S2M NDR completion back to a UPLI write response (WrRsp). The RPU may translate opcodes, commands, addresses, Tags, byte enables, and completion status between the two protocol domains. In some examples, the RPU may split a UPLI write request carrying a transfer size exceeding a CXL.mem cacheline size into multiple CXL.mem M2S RwD requests, and may aggregate the corresponding completions before returning the UPLI WrRsp to the originating entity.

In various implementations, a method for translating from Ultra Accelerator Link (UALink) Protocol Level Interface (UPLI) write requests to Compute Express Link (CXL) write requests, comprising: communicating with a first entity according to UPLI; communicating with a second entity according to CXL.mem; receiving, from the first entity, a UPLI request comprising a write command, a first physical address, and write data; translating the UPLI request to a CXL.mem Master-to-Subordinate Request with Data (M2S RwD) comprising a MemWr* and a second physical address; sending the CXL.mem M2S RwD and the write data to the second entity; receiving, from the second entity, a CXL.mem Subordinate-to-Master No Data Response (S2M NDR) comprising Cmp*; translating the CXL.mem S2M NDR to a UPLI write response (WrRsp); and sending the UPLI WrRsp to the first entity. The write translation may enable entities communicating according to UPLI to store data in memory resources coupled to entities communicating according to CXL.mem. The method may be implemented in hardware, firmware, software, or combinations thereof, and may be performed by various types of devices, such as a processor, a switch, a bridge, an RPU, or a semiconductor device. The first physical address may be associated with a first address space, such as an NPA space, and the second physical address may be associated with a second address space, such as an HPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The UPLI write command may include a Write, a WriteFull, or a Write Class Vendor Defined Command as defined by the UPLI specification.

In some implementations of the method, the UPLI request further comprises a ReqSrcPhysAccID field, a ReqDstPhysAccID field, a ReqTag field, and a ReqAddr field comprising the first physical address; wherein the write data is received on a UPLI Originator Data (OrigData) channel comprising OrigDataByteEn; and further comprising translating the ReqTag to a Tag associated with the CXL.mem M2S RwD. The ReqSrcPhysAccID and ReqDstPhysAccID fields may carry identifiers utilized for routing the UPLI request and for constructing response routing information. The OrigDataByteEn field may carry per-byte enable bits indicating which bytes of the write data are valid. The Tag translation may involve maintaining a bidirectional mapping between UPLI ReqTag values and CXL.mem Tag values, enabling proper correlation of CXL.mem S2M NDR completions with their corresponding UPLI write requests.

In some implementations of the method, the MemWr* comprises MemWrPtl, and the write data comprises a partial cacheline update; and wherein byte enables associated with a UPLI Originator Data channel are utilized to indicate which bytes of the cacheline are to be written by the second entity. The MemWrPtl opcode may indicate a partial write where only a subset of bytes within a CXL.mem cacheline are updated. The byte enables from the UPLI OrigDataByteEn field may be propagated to the CXL.mem domain, enabling the second entity to update only the specified bytes while preserving the remaining bytes of the cacheline.

In some implementations of the method, the UPLI WrRsp further comprises a WrRspTag field and a WrRspStatus field, and the CXL.mem S2M NDR further comprises a Cmp* completion opcode; and further comprising translating a Tag of the CXL.mem S2M NDR to the WrRspTag of the UPLI WrRsp, and translating a completion status of the CXL.mem S2M NDR to the WrRspStatus of the UPLI WrRsp. The WrRspTag may be retrieved from the bidirectional mapping maintained by the RPU, enabling the first entity to correlate the write response with its original write request. The WrRspStatus may indicate success or failure of the write operation. The translation of completion status across protocol boundaries may enable the first entity to detect write failures that originated in the CXL domain and to take appropriate recovery actions.

In some implementations of the method, the first entity comprises an accelerator, the second entity comprises a CXL device comprising at least one of: a CXL memory expander, a CXL memory pool, or a Global Fabric-Attached Memory Device (GFD); the first physical address is associated with a Network Physical Address (NPA) space; and the second physical address is associated with a Host Physical Address (HPA) space; and wherein the translating further comprises translating the first physical address to the second physical address. The address translation from NPA to HPA may be implemented utilizing lookup tables, page tables, base-and-offset calculations, range-based mapping, and/or programmable translation functions. The GFD may provide large-capacity memory resources accessible via CXL.mem and shared among requesters.

In some implementations of the method, the UPLI request further comprises a ReqLen field indicating a transfer size exceeding a CXL.mem cacheline size; and wherein the translating further comprises generating CXL.mem M2S RwD requests from the UPLI request, each of the CXL.mem M2S RwD requests comprising a respective MemWr* and a respective portion of the write data. UPLI write requests may carry a ReqLen indicating a transfer size of up to 256 bytes, while CXL.mem M2S RwD messages may carry up to 64 bytes of data per request. When the ReqLen exceeds the CXL.mem cacheline size, the RPU may split the UPLI write request into CXL.mem M2S RwD requests, each carrying a respective portion of the write data with a respective translated address. The RPU may aggregate the corresponding CXL.mem S2M NDR completions before returning a UPLI WrRsp to the first entity.

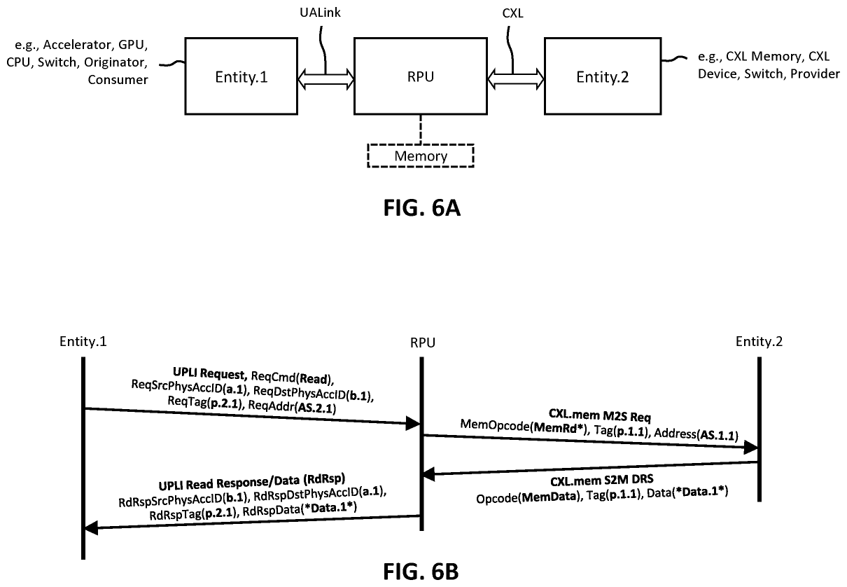

FIG. 6A illustrates an example of a system comprising an RPU, which may be coupled to memory, wherein the RPU may enable external entities to access resources coupled to the RPU. The RPU may translate between a UALink-based protocol (such as UPLI) and a CXL-based protocol (such as CXL.mem). Additionally or alternatively, the RPU may translate between UPLI and CXL.io, and/or between UPLI and CXL.cache. In some examples, the RPU may be implemented as a discrete component, such as on a PCB, coupled to other components such as CPUs, GPUs, accelerators, switches, or CXL devices. In other examples, the RPU may be embedded in another silicon design, such as an IP within a processor, or may be implemented as a chiplet within an IC package. The RPU is coupled to a first entity (Entity.1), which may be an accelerator, a GPU, a CPU, a switch, an originator, or a consumer, wherein the RPU may communicate with the first entity according to a UALink-based protocol, such as UPLI. The RPU is further coupled to a second entity (Entity.2), which may be a CXL memory, a CXL device, a switch, or a provider, wherein the RPU may communicate with the second entity according to a CXL-based protocol, such as at least one of CXL.mem, CXL.io, or CXL.cache. In some examples, the UALink-based traffic, such as UPLI traffic, may be associated with a first address space, such as an NPA space, and the CXL-based traffic, such as CXL.mem traffic, may be associated with a second address space, such as a System Physical Address (SPA) space or a Host Physical Address (HPA) space; wherein the RPU may perform address translations between addresses within the first and second address spaces, respectively, such as between addresses within the NPA space and addresses within the SPA space or the HPA space. In other examples, the UALink-based traffic and the CXL-based traffic may be associated with the same physical address space, such as with a global address space, a partitioned global address space (PGAS), a pod address space, a virtual pod address space, or a fabric address space; wherein the RPU may perform address translations between addresses within the same address spaces. The RPU may perform further translations, such as opcode, command, or TLP translations, e.g., translating between commands in requests conforming to the UALink-based protocol (e.g. UPLI vendor-defined read command) to opcodes in requests conforming to the CXL-based protocol (e.g., CXL.mem MemRd). The RPU may further translate between messages conforming to the UALink-based protocol and messages conforming to the CXL-based protocol, Tag translations, traffic class (TC) translations, and/or cross-field translations such as between CXL.mem Tag and UPLI ReqTag, and/or between UPLI RdRspTag and CXL.mem Tag. Additionally, the RPU may maintain tracking between Tags in the UPLI domain and Tags in the CXL domain, such as in order to associate responses with their corresponding requests. The RPU may further translate error indications, such as poison.

FIG. 6B illustrates an example of a TFD demonstrating translations performed by an RPU, between UALink-based traffic, such as UPLI traffic, utilized for communicating with a first entity (Entity.1), such as an accelerator, a GPU, a CPU, a switch, an originator, or a consumer, and CXL-based traffic, such as CXL.mem traffic, utilized for communicating with a second entity (Entity.2), such as a CXL device, a CXL memory, or a CXL switch. Additionally or alternatively, the RPU may translate between UPLI and CXL.io requests, and/or between UPLI and CXL.cache requests. The first entity may initiate a UPLI transaction that may include a UPLI request (Req) comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Tag (e.g., ReqTag(p.2.1)), and Request Address (e.g., ReqAddr(AS.2.1)). The RPU may translate the UPLI transaction to a CXL.mem transaction that may include a CXL.mem M2S request comprising MemOpcode(MemRd*), Tag(p.1.1), and Address(AS.1.1), and may send the CXL.mem M2S request to the second entity. The asterisks in the translated CXL.mem M2S request MemRd indicate that this could represent any suitable superset combination of read opcodes, commands, or operations, supported by CXL.mem, such as MemRd, MemRdData, MemRdTEE, MemRdDataTEE, etc. The RPU may further translate between other fields of the UPLI transaction and fields of the CXL.mem transaction, such as between address fields, Tag fields, QoS-related fields, or identification (ID) fields that may serve to route the UPLI request to its target.

Upon receiving a response from the second entity, that may include a CXL.mem S2M DRS comprising Opcode(MemData), Tag(p.1.1), and Data(*Data.1*), the RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(p.2.1)), and Read Response Data (e.g., RdRspData(*Data.1*)). Optionally, the RPU may act as an endpoint, or may act as a completer device, and may terminate the UPLI transactions. The RPU may issue the CXL.mem transactions, optionally acting as an independent protocol initiator, such as a CXL host, and may utilize translated fields from the UPLI transaction for constructing the CXL.mem transaction. The RPU may perform further translations, such as opcode or command translations, e.g., translating between vendor-defined read commands in UPLI requests and MemRd in CXL.mem requests. The RPU may further translate between messages conforming to UPLI and messages conforming to CXL.mem, translate Tags, and/or translate error indications, such as poison.

In some examples, the RPU may translate a UPLI transaction to multiple CXL.mem transactions, such as when the UPLI request may include a request length field, such as ReqLen, that may carry values representing a read of up to 256 Bytes of data, wherein the RPU may translate such UPLI requests to CXL.mem M2S requests, such that each may carry up to 64 Bytes of data that may represent a cacheline. The RPU may further translate between CXL.mem responses, such as CXL.mem S2M NDR and/or CXL.mem S2M DRS, and UPLI responses, such as UPLI read response, and may forward read data carried in CXL.mem DRS messages into the UPLI read response. In some examples, the RPU may accumulate data from one or more CXL.mem DRS messages before sending the data via the UPLI read response.

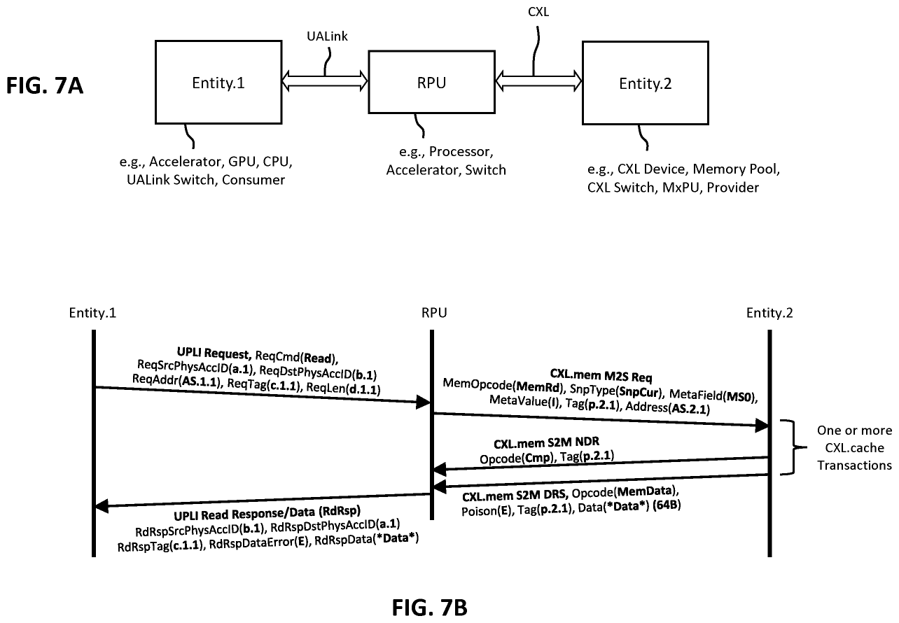

FIG. 7A illustrates an example of a system comprising an RPU (such as a processor, an accelerator, or a switch) that enables external entities to access resources coupled to the RPU, such as CXL devices or CXL memory. The RPU is coupled to a first entity (Entity.1), which may be an accelerator, a GPU, a CPU, a UALink switch, or a consumer, wherein the RPU may communicate with the first entity according to a UALink-based protocol, such as a UPLI. The RPU is further coupled to a second entity (Entity.2), which may be a CXL device, CXL memory, CXL-based memory pool, a CXL switch, an MxPU, or a provider, wherein the RPU may communicate with the second entity according to a CXL-based protocol, such as CXL.mem. In some examples, the UALink-based protocol, such as UPLI, may be associated with a first address space, such as an NPA space, and the CXL-based protocol, such as CXL.mem, may be associated with a second address space, such as an HPA space; wherein the RPU may perform address translations between addresses within the first and second address spaces, respectively, such as between addresses within the NPA space and addresses within the HPA space. In other examples, the UALink-based protocol, such as UPLI, and the CXL-based protocol, such as CXL.mem, may be associated with the same physical address space, such as a global address space; wherein the RPU may perform address translations between addresses within the same address spaces. The RPU may perform further translations, such as opcode or command translations, e.g., translating between Read commands in UPLI requests and MemRd in CXL.mem requests. The RPU may further translate between messages conforming to UPLI and messages conforming to CXL.mem, translate Tags, and/or translate error indications, such as poison.

FIG. 7B illustrates an example of a TFD demonstrating an RPU that may translate between UALink-based traffic, such as UPLI traffic, and CXL-based traffic, such as CXL.mem traffic. Additionally or alternatively, the RPU may translate between UPLI and CXL.io, and/or between UPLI and CXL.cache. The RPU may provide intent-based translation between protocols, such as between UPLI and CXL.mem, identifying the intent of a received transaction, and generating a translated transaction that may convey a corresponding intent, or convey an intent based on a predefined, predetermined, configurable, rule-based, or dynamic mapping between intentions. The RPU may receive from a first entity (Entity.1), such as an accelerator, a UALink UPLI transaction that may include a UPLI request comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)). The received UPLI transaction may indicate an intent to perform an I/O-coherent read, e.g., a request for the most recent copy of the data, corresponding to an I/O-coherency model that may be typical for UALink.

The RPU may translate the UPLI transaction to a CXL.mem transaction, that may include a CXL.mem M2S request comprising Memory Operation (e.g., MemOpcode(MemRd)), Snoop Type (e.g., SnpType(SnpCur)), Metadata Field (e.g., MetaField(MS0)), Metadata Value (e.g., MetaValue(I)), Tag(p.2.1), and Address(AS.2.1). This translation from UPLI to CXL.mem may indicate an intent to perform an I/O-coherent read, via a CXL.mem request for a non-cacheable but current value of the data, wherein the data may be represented as 64 B cachelines that correspond to the Request Length (e.g., ReqLen(d.1.1)) in the UPLI request. The RPU may further translate between other values of the UPLI transaction and the CXL.mem transaction, such as between addresses, Tags, QoS-related values, or identifications (IDs) that may serve to route the UPLI request to its destination.

In some examples, the RPU may translate a UPLI transaction to multiple CXL.mem transaction, such as when the UPLI request comprises a request length field (e.g., ReqLen), which may carry values indicating a read of more than 64 Bytes of data, wherein the RPU may translate such UPLI requests to CXL.mem M2S requests, such that each may carry up to 64 Bytes of data, possibly representing a 64 Byte cacheline. The RPU may further translate between CXL.mem responses, such as CXL.mem S2M NDR and/or CXL.mem S2M DRS, and UPLI responses, such as UPLI read responses, and may forward read data carried in CXL.mem DRS messages via UPLI read responses.

In some examples, the RPU may receive a response from the second entity (Entity.2), which may include a CXL.mem S2M NDR comprising Opcode(Cmp) and Tag(p.2.1), and may further include a CXL.mem S2M DRS comprising Opcode(MemData), Poison(E), Tag(p.2.1), and Data(*Data*). The RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), Read Response Data Error (e.g., RdRspDataError(E)), and Read Response Data (e.g., RdRspData(*Data*)). This translation demonstrates that the RPU may propagate error responses from the CXL domain to the UPLI domain, such as by translating error indications carried in CXL.mem S2M DRS messages, such as poison, to error indications carried in UPLI RdRsp messages, such as Read Response Data Error (e.g. RdRspDataError). Additionally, the RPU may accumulate data from one or more CXL.mem DRS messages before sending the data via the UPLI read response.

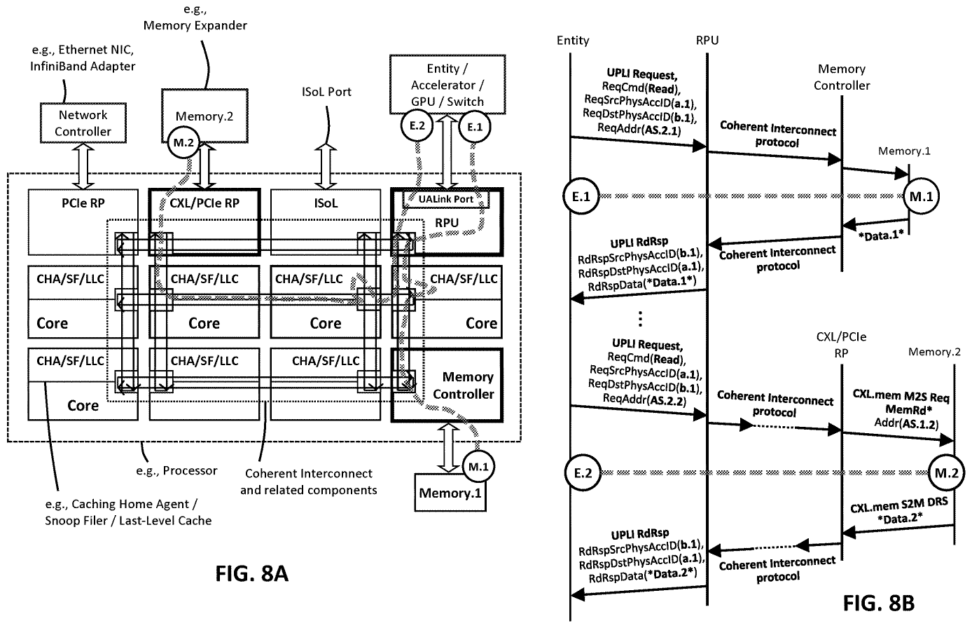

FIG. 8A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a Network Controller, such as an Ethernet NIC or an InfiniBand Adapter, a CXL/PCIe RP, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may be coupled to a second memory (Memory.2), such as a CXL memory expander, and may further include an RPU that includes or is coupled to a UALink port that may communicate with the entity according to a UALink-based protocol, such as UPLI, wherein the RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may be implemented as an IP block embedded into a silicon design, such as a switch or an accelerator. In other examples, the processor may be implemented as a monolithic die, as chiplets within an IC package, or as components on a board, and may utilize a mesh-based coherent interconnect, may utilize a ring, a crossbar, a Network on Chip (NoC) or other types of coherent interconnects.

FIG. 8B illustrates an example of a TFD demonstrating two UPLI requests, such as UPLI read requests, received from an entity, such as a GPU or an accelerator, processed by an RPU and forwarded, possibly using a protocol utilized by a coherent interconnect, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), to enable the entity to access the processor's memories. The processor may have multiple memory resources, such as first memory (Memory.1), which may be a DRAM coupled to a memory controller of the processor, and/or second memory (Memory.2), which may be a CXL memory expander coupled to a CXL/PCIe RP of the processor. The RPU may further perform additional translations, such as protocol translations from a UALink-based protocol, such as UPLI, to a protocol utilized by the coherent interconnect, and may send the optionally translated request to the coherent interconnect, requesting a read from memory. In some examples, the requested data may be provided by a processor cache, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction includes a first UPLI request (Req) comprising physical address (AS.2.1), which may be an NPA, which the RPU translates and forwards via the coherent interconnect protocol and via the memory controller to the first memory (Memory.1), resulting in the retrieval of *Data.1*, that is sent to the entity via the coherent interconnect protocol and via the RPU with the first UPLI RdRsp. The second exemplary transaction includes a second UPLI request comprising physical address (AS.2.2), which may be an NPA, which the RPU may translate to physical address (AS.1.2) and forward to the second memory (Memory.2), via the coherent interconnect protocol and via the CXL/PCIe RP, utilizing a CXL.mem M2S request. *Data.2* is retrieved from the second memory utilizing a CXL.mem S2M DRS, and sent to the RPU via the coherent interconnect protocol. The RPU may then send *Data.2* to the entity via the second UPLI RdRsp. It is noted that the physical addresses (AS.2.1) and (AS.2.2) may refer to different memory regions within an NPA address space exposed via the UALink port, enabling the entity to access memory resources based on the RPU's translation capabilities.

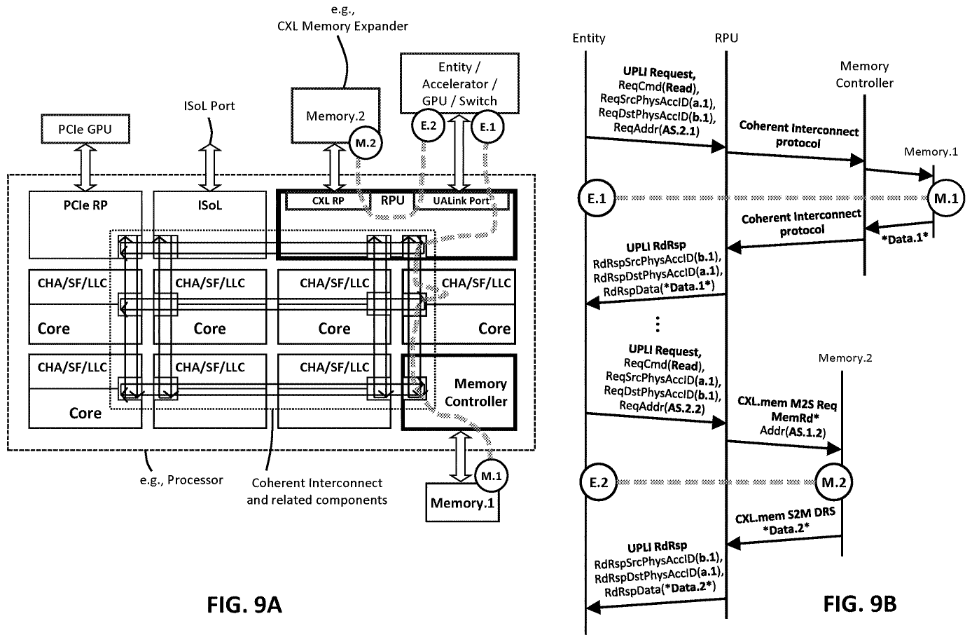

FIG. 9A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a PCIe GPU, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may include an RPU that includes or is coupled to a UALink port that may communicate with the entity according to a UALink-based protocol, such as UPLI, wherein the RPU further includes a CXL RP coupled to a second memory (Memory.2), such as a CXL memory expander. The RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may utilize a mesh-based coherent interconnect, or in other examples may utilize a ring, a crossbar, a Network on Chip (NoC) or other types of coherent interconnects.

FIG. 9B illustrates an example of a TFD demonstrating two UPLI requests, such as UPLI read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), or from NPAs to System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between a UALink-based protocol, such as UPLI, and a protocol utilized by the coherent interconnect, wherein the RPU may send the optionally translated UPLI requests to the coherent interconnect, requesting reads from memory, such as from the first memory or from the second memory. The RPU may further translate between UALink-based traffic, such as UPLI traffic, and CXL-based traffic, such as at least one of CXL.mem, CXL.io, or CXL.cache traffic, wherein the RPU may send the optionally translated UPLI traffic to the second memory via the CXL RP. In some examples, the requested data may be provided by a cache of the processor, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first UPLI request (Req) comprising physical address (AS.2.1), which may be an NPA, which the RPU may translate and forward via the coherent interconnect protocol and via the memory controller to the first memory, resulting in the retrieval of *Data.1*, that is sent to the entity via the coherent interconnect protocol and via the RPU with the first UPLI RdRsp. The second exemplary transaction corresponds to the memory read path denoted as (E.2)-(M.2), and may include a second UPLI request comprising physical address (AS.2.2), which may be an NPA. The RPU may translate the second UPLI request to a CXL.mem M2S request comprising MemRd* and Address(AS.1.2), wherein the RPU may send the translated request to the second memory via the CXL RP. *Data.2* is retrieved from the second memory utilizing a CXL.mem S2M DRS, and sent to the RPU via the CXL RP, wherein the RPU may send *Data.2* to the entity utilizing the second UPLI RdRsp.

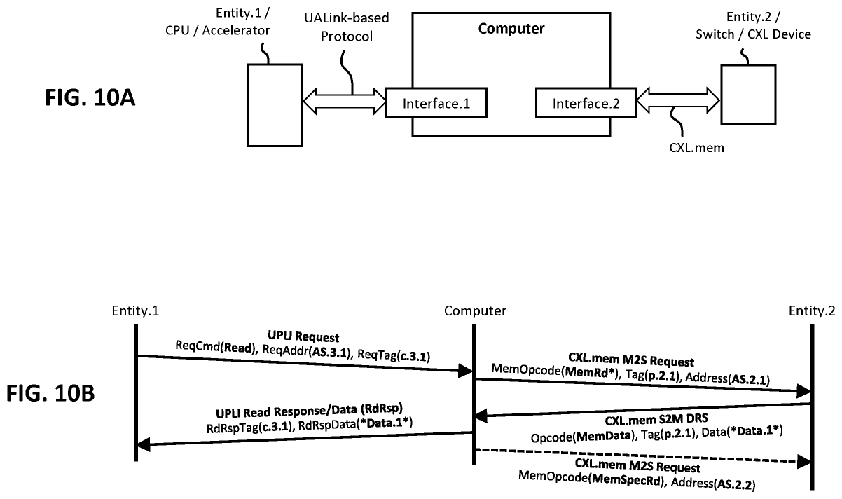

FIG. 10A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.mem, with a second entity (Entity.2), such as a switch, or a CXL device which may be a CXL memory expander, a CXL memory pool, a GFD, or a CXL accelerator. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In other examples, the first address space and the second address space may be associated with the same address space, such as a common address space, a global address space, a pod address space, or a fabric address space, wherein the computer may perform address translations between addresses within the same common address space. The computer may be implemented in an IC package having high-speed differential I/O balls positioned according to a ball grid array layout defined by a retimer specification.

FIG. 10B illustrates an example of a TFD demonstrating translations, such as address translations, performed by a computer, between: (1) first physical addresses, such as Network Physical Addresses (NPAs), carried in UALink-based requests, such as UPLI requests, received from a first entity (Entity.1), which may be a CPU or an accelerator; and (2) second physical addresses, such as Host Physical Addresses (HPAs), carried in CXL requests, such as CXL.mem requests, sent to a second entity (Entity.2), which may be a switch or a CXL device, possibly enabling the first entity to access resources mapped to an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.mem M2S request comprising MemOpcode(MemRd*), Tag(p.2.1), and Address(AS.2.1), and may send the CXL.mem M2S request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to a UPLI read response/data (RdRsp) comprising RdRspTag(c.3.1) and RdRspData(*Data.1*), and send the UPLI RdRsp to the first entity.

The computer may further initiate speculative memory reads targeting the second entity, wherein the speculative memory reads may include a CXL.mem M2S request comprising MemOpcode(MemSpecRd) and Address(AS.2.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved. The computer may perform further translations, such as protocol translations, opcode translations, command translations, TLP type translations, and translations between the UALink-based domain and the CXL domain. In some examples, the computer may issue multiple CXL.mem reads in response to receiving a UPLI request from the first entity. For example, the computer may issue CXL.mem M2S requests comprising MemRd or MemRdData, such as when splitting a UPLI request for a large block of data (e.g., 256 B) to smaller CXL.mem reads (e.g., 64 B each), or when prefetching data from the second entity utilizing CXL.mem reads. The computer may translate requests or transactions initiated from the UALink-based domain to the CXL domain, may translate requests or transactions initiated from the CXL domain to the UALink-based domain, or may translate requests or transactions initiated from both domains.

Modern data center architectures increasingly utilize disaggregated memory systems wherein multiple compute hosts may require access to shared memory resources through different protocols and address spaces. CXL.mem enables memory access between a CXL host and CXL devices, wherein different CXL device types may utilize different CXL.mem revisions and/or instances. Translations between different CXL.mem messages may enable CXL communications between a CXL device and CXL hosts, may facilitate memory prefetching and speculative read operations to reduce access latency, and/or may enable novel architectures wherein hosts access memory devices without an intervening CXL switch, contrary to standard CXL topologies, which require a CXL switch between hosts and a Single Logical Device (SLD), a Multi-Logical Device (MLD), or a Global Fabric-Attached Memory Device (GFD), when hosts require access to the same device.

In various implementations, a method for translating between Compute Express Link (CXL) messages, comprising: receiving, from a first entity, a first CXL.mem Master-to-Subordinate (M2S) request; translating, by a computer, the first CXL.mem M2S request to a second CXL.mem M2S request, wherein value of at least one field, selected from MemOpcode, Tag, or Address, is different between the first and second CXL.mem M2S requests; and sending the second CXL.mem M2S request to a second entity. The translation between CXL.mem M2S requests may enable communication between a first entity, such as a CXL host, and a second entity, such as a CXL device that utilizes different CXL.mem revisions and/or fields values. The modified fields may affect protocol fields including physical addresses which may be carried in Address fields for address space mapping, opcodes which may be carried in MemOpcode fields for protocol semantic adaptation, or Tags for transaction management. The computer may selectively translate values of one or more of these field types depending on the incompatibility between the CXL host's protocol and the CXL device's protocol. Physical address translation may enable access across different memory domains, opcode translation may enable different operations or device type bridging, and Tag translation may enable transaction tracking across protocol boundaries.

In some implementations of the method, the first entity comprises a CXL host, and the first CXL.mem M2S request comprises a first physical address belonging to a first Host Physical Address (HPA) space utilized by the CXL host; and wherein the second entity comprises a CXL device, and the second CXL.mem M2S request comprises a second physical address within an address space exposed by the second entity. The address translation between HPA spaces may enable a CXL host to access memory resources exposed by a CXL device that utilizes a different HPA space.

In some implementations of the method, the at least one field comprises the Address, the first CXL.mem M2S request comprises a first physical address belonging to a first Host Physical Address (HPA) space utilized by the first entity, and the second CXL.mem M2S request comprises a second physical address belonging to a second HPA space utilized by the second entity. The physical address translation between HPA spaces may involve mapping memory locations from the CXL host's address space to corresponding locations in the address space utilized by the second entity. The computer may maintain address translation tables, implement base-and-offset calculations, or utilize programmable mapping functions to convert between addresses from the different address spaces. The first and second HPA spaces may differ in size, base addresses, memory layouts, or granularity, and the translation algorithm may accommodate these differences while preserving memory operation semantics.

In some implementations of the method, the at least one field comprises the MemOpcode and the Tag, the first CXL.mem M2S request comprises a first opcode and a first Tag, and the second CXL.mem M2S request comprises a second opcode and a second Tag. The first and second opcodes may correspond to different memory access behaviors, and the first and second Tags may belong to different transaction identifier queues.

In some implementations of the method, the first opcode is selected from MemRd, MemRdData, MemRdTEE, MemRdDataTEE, and MemSpecRd; and wherein the second opcode is selected from MemInv, MemRd, MemRdData, MemRdTEE, MemRdDataTEE, MemInvTEE, MemSpecRd, MemInvNT, MemInvP, MemClnEvct, MemInvPTEE, MemSpecRdTEE, MemClnEvctTEE, or MemClnEvctU. Different opcodes are typically associated with different values or different encodings of an opcode field, such as MemOpcode in CXL.mem M2S Req. For example, according to CXL 3.2 specification, MemRdData is associated with the value 0010b of MemOpcode, whereas MemRd is associated with the value 0001b of MemOpcode. The translation from MemRdData to MemRd may enable protocol adaptation between different CXL device types, wherein MemRdData may be associated with CXL Type-3 device operations while MemRd may be associated with CXL Type-2 device operations. The Tag translation may involve maintaining a bidirectional mapping between the host-side and device-side transaction identifiers.

In some implementations, the method further comprises initiating a third CXL.mem M2S request, and sending the third CXL.mem M2S request to the second entity. The computer may generate additional requests, such as speculative memory read requests or predictive read requests that may facilitate data readiness before, or without, the CXL host explicitly requesting it. The decision to initiate the additional operations may be based on pattern recognition algorithms analyzing the CXL host's memory access behavior, statistical models predicting future access locations, configurable prefetch policies defining aggressiveness and scope of speculation, and/or bandwidth availability assessments determining when additional operations that may be speculative, predictive, or performed on a best-effort basis, will not interfere with requests originated by the CXL host.

In some implementations of the method, the third CXL.mem M2S request comprises MemSpecRd; or wherein the third CXL.mem M2S request comprises MemRd*, and further comprising receiving, from the second entity, a CXL.mem S2M DRS comprising MemData. The computer may generate speculative read requests, such as CXL.mem M2S requests comprising MemSpecRd opcodes, to start a memory access before, or without, the CXL host explicitly requesting it. Speculative reads may enable latency savings, such as when the memory resource exhibits long access times, e.g., due to slow memory media, or when the memory read address references remote memory resources over a fabric or a network. Additionally or alternatively, the computer may further generate prefetch read requests, such as CXL.mem M2S requests comprising MemRd* opcodes, to prefetch data before, or without, the CXL host explicitly requesting it. The prefetched data may be stored in the computer's local buffers or caches for rapid delivery when subsequently requested.

In some implementations, the method further comprises detecting sequential access patterns in physical addresses of prior CXL.mem M2S requests received from the first entity, and initiating the third CXL.mem M2S request targeting a next sequential physical address. The computer may track physical addresses from consecutive CXL.mem M2S requests received from the CXL host to identify sequential access patterns indicative of linear memory traversal. Upon detecting that the CXL host has accessed certain addresses in sequence, the computer may speculatively prefetch data from subsequent addresses before the CXL host explicitly requests them. The sequential pattern detection may account for cacheline boundaries, page boundaries, or other memory organization units to optimize prefetch granularity.

In some implementations, the method further comprises detecting strided access patterns in physical addresses of prior CXL.mem M2S requests received from the first entity, calculating a stride distance between accessed addresses, and initiating the third CXL.mem M2S request targeting a physical address offset by the stride distance. The computer may identify non-sequential but regular access patterns wherein the CXL host accesses memory locations separated by a consistent stride distance, such as when processing array elements or matrix columns. For example, if the computer observes accesses to addresses A, A+S, A+2S, where S represents the stride, it may speculatively prefetch from address A+3S. The stride detection algorithm may maintain a history buffer of recent addresses and compute stride patterns using difference calculations or pattern matching algorithms.

In some implementations of the method, the at least one field comprises the Address, the first CXL.mem M2S request comprises a first physical address and first MemSpecRd, and the second CXL.mem M2S request comprises a second physical address and second MemSpecRd; and further comprising translating the first physical address to the second physical address.

In some implementations of the method, the at least one field further comprises the MemOpcode, and the value of the MemOpcode is different between the first and second CXL.mem M2S requests; or wherein the first CXL.mem M2S request conforms to a first CXL specification revision, and the second CXL.mem M2S request conforms to a second CXL specification revision; and further comprising exposing, by the computer, a CXL Type-2 device or CXL Type-3 device to the first entity via a first interface, and exposing a root port to the second entity via a second interface. When the CXL host initiates its own speculative reads using MemSpecRd opcodes, the computer may perform physical address translation while preserving the speculative semantics of the request. The translation enables the host-initiated speculative operations to target the correct memory locations in the address space utilized by the second entity, enabling end-to-end speculative prefetching across different address domains. Additionally or alternatively, the translation between different CXL specification revisions may involve adapting message formats, field encodings, and protocol semantics between the revisions. For example, CXL 1.1 to CXL 2.0 translations may require handling new fields introduced in CXL 2.0, managing deprecated features from CXL 1.1, adjusting field widths or bit positions, and/or converting between different opcode encodings used in each version. The asymmetric interface configuration enables the computer to present different protocol roles to each connected entity. By exposing a CXL Type-2 or Type-3 device to the CXL host, the computer can receive memory requests as a subordinate device. By exposing a root port to the second entity (which may be a CXL device), the computer can initiate memory requests as a master. This dual-role architecture enables the computer to bridge protocols that would otherwise be incompatible due to both entities expecting to communicate with complementary protocol endpoints.

In some implementations of the method, the at least one field comprises the Address and the Tag; wherein the first CXL.mem M2S request comprises MemRd*, a first Tag, and a first physical address; and wherein the second CXL.mem M2S request comprises a second Tag and a second physical address; and further comprising receiving from the second entity a first CXL.mem Subordinate-to-Master Data Response (S2M DRS) comprising the second Tag; translating the first CXL.mem S2M DRS to a second CXL.mem S2M DRS comprising the first Tag; and sending the second CXL.mem S2M DRS to the first entity. The response translation may reverse the Tag mapping performed during request translation, ensuring that the CXL host receives responses with Tags matching its original requests. The computer may maintain a Tag translation table or utilize algorithmic Tag generation to translate between device-side Tags (second Tag) and host-side Tags (first Tag). Additionally, the computer may consolidate or filter response messages, potentially absorbing No Data Response messages while forwarding only Data Response messages to simplify the message flow.

In some implementations of the method, the second entity comprises a Global Fabric-Attached Memory (G-FAM) or a Global Fabric-Attached Memory Device (GFD); and wherein there is no CXL switch positioned between the computer and the second entity; and further comprising receiving, from a third entity, a third CXL.mem M2S request, translating the third CXL.mem M2S request to a fourth CXL.mem M2S request, and sending the fourth CXL.mem M2S request to the second entity; and wherein there is no CXL switch positioned between the computer and the third entity. The CXL specification mandates that GFDs connect through a Virtual CXL Switch (VCS) for proper protocol handling and routing. This implementation bypasses that requirement by having the computer perform the applicable translations and routing functions, eliminating the CXL switch from the topology. Removing the switch traversal delays may reduce latency, reduce cost by eliminating switch hardware, and/or simplify system configuration by reducing the number of CXL components requiring management. The translation of requests from multiple entities to a common destination entity, without an intervening CXL switch, may enable topologies where the computer aggregates traffic from multiple sources. The computer may maintain separate translation contexts for each source entity to preserve transaction isolation and enable independent address mappings.

In some implementations of the method, the third entity comprises a second CXL host, the second entity comprises a CXL device, and there is no CXL switch positioned between the third entity and the second entity. The computer enables multi-host access the same CXL device, without the CXL switch typically required for such multi-host configurations, by implementing separate translation contexts for each host, including independent address mappings, Tag translations, and transaction queues. The computer may also implement arbitration algorithms to fairly schedule requests from multiple hosts, coherency protocols to manage shared memory access, and isolation algorithms to prevent unauthorized cross-host memory access.

In some implementations, the method further comprises receiving, from a third entity, a third CXL.mem M2S request, translating the third CXL.mem M2S request to a fourth CXL.mem M2S request, and sending the fourth CXL.mem M2S request to the second entity; wherein the second entity exposes memory, and there is no CXL switch positioned between the computer and the second entity. The memory-exposing entity, such as a memory-exposing CXL device, may be accessed by hosts through the computer's translations without requiring a CXL switch. The computer may implement memory virtualization to present each host with its own view of the device's memory, memory partitioning to allocate specific regions to each host, or memory pooling to dynamically assign memory resources based on demand. The translation may ensure that each host's memory operations target the appropriate memory regions while maintaining isolation and coherency as required.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, a system comprising: first and second entities; a computer configured to: receive a first CXL.mem Master-to-Subordinate (M2S) request from the first entity, wherein CXL denotes Compute Express Link; translate the first CXL.mem M2S request to a second CXL.mem M2S request, wherein value of at least one field, selected from MemOpcode, Tag, or Address, is different between the first and second CXL.mem M2S requests; and send the second CXL.mem M2S request to the second entity. The translation enables communication between components that may utilize different addressing schemes, Tag management conventions, and/or memory operation types, which enables flexible system topologies where entities need not share compatible protocol parameters.

In some implementations of the system, the second entity comprises a second CXL device of a second type, the computer exposes resources associated with the second entity to the first entity via a first CXL device of a first type, and the first type and the second type are different. The translation may further enable abstraction of component identities, such as exposing resources associated with a CXL Type-3 device as a CXL Type-2 device, or exposing resources associated with a CXL Type-2 device as a CXL Type-1 device.

In some implementations of the system, the second entity comprises a CXL Type-3 device, and wherein the computer exposes resources associated with the second entity to the first entity via a CXL Type-2 device. Exposing resources associated with a CXL Type-3 device as a CXL Type-2 device may enable different caching behaviors or coherency models than those natively supported by the Type-3 device.

In some implementations of the system, the second entity comprises a CXL Type-2 device, and wherein the computer exposes memory resources associated with the second entity to the first entity via a CXL Type-3 device. Exposing memory resources associated with a CXL Type-2 device as a CXL Type-3 device may enable simplified memory access semantics for hosts that do not require the full capabilities of Type-2 devices, potentially reducing complexity in system configurations.

In some implementations, the system further comprises a third entity, wherein the computer is further configured to: receive a third CXL.mem M2S request from the third entity; translate the third CXL.mem M2S request to a fourth CXL.mem M2S request, wherein value of at least one field, selected from MemOpcode, Tag, or Address, is different between the third and fourth CXL.mem M2S requests; and send the fourth CXL.mem M2S request to the second entity. The ability of the computer to aggregate and translate requests from multiple sources to a common destination entity enables the multi-host or multi-initiator configuration with the third entity. The computer may perform independent translations for each source entity, enabling per-entity address mapping, Tag namespace management, and/or opcode policies. This enables the second entity, such as a CXL memory device, to serve multiple initiators through the same physical interface while maintaining logical separation of their respective transactions.

In some implementations of the system, the first entity comprises a first host, the third entity comprises a second host, the second entity comprises a CXL device, and there is no CXL switch positioned between the CXL device and the first and second hosts. The CXL specification requires SLDs, MLDs, and GFDs to connect to multiple hosts through a VCS within a CXL switch. This implementation eliminates the requirement for a CXL switch by using the computer to perform the applicable translations, routing decisions, and multi-host coordination functions. The computer may implement the logical equivalent of VCS functionality while operating as a translation unit rather than a switch component, enabling new deployment models and system architectures not contemplated by the standard CXL topology requirements.

In some implementations of the system, the computer is further configured to maintain separate address translation tables for the first and third entities, mapping first and third addresses from first and third address spaces utilized by the first and third entities, respectively, to second addresses within a second address space utilized by the second entity. The separate address translation tables may enable memory isolation between the entities, such as between hosts, preventing unauthorized cross-host memory access. Each translation table may map a host's virtual view of a CXL device to distinct physical regions, implementing hardware-enforced memory protection without requiring CXL switch-based isolation mechanisms. Mapping to non-overlapping regions may enable memory pooling and ensure that memory operations from one host cannot inadvertently or maliciously access another host's allocated memory space, whereas mapping to overlapping regions may enable memory sharing between hosts.

In some implementations of the system, the second entity comprises a second CXL device, and wherein the computer exposes resources associated with the second entity to the first entity via a first CXL device and to the third entity via a third CXL device. The virtualization of the single physical CXL device, such as a memory expander, into multiple virtual devices enables each host to operate as if it has exclusive access to a dedicated memory expander. The computer may present different capacity values, latency characteristics, bandwidth allocations, or feature sets to each host through the virtual device abstraction. This virtualization may include managing separate configuration spaces, capability registers, and control interfaces for each virtual device instance.

In various implementations, a method for enabling multi-host access to a Compute Express Link (CXL) device, comprising: receiving, from a first entity, a first CXL.mem Master-to-Subordinate (M2S) request carrying a first physical address; receiving, from a second entity, a second CXL.mem M2S request carrying a second physical address; translating the first and second physical addresses to third and fourth physical addresses within an address space utilized by a CXL device; generating third and fourth CXL.mem M2S requests comprising the third and fourth physical addresses, respectively; and sending the third and fourth CXL.mem M2S requests to the CXL device. A standard CXL switch typically uses HDM decoders for routing purposes in order to determine which downstream port (DPID/Port ID) should receive the request, and then forwards the original request containing the HPA. Additionally, the standard CXL switch does not perform the HPA-to-DPA translation itself when acting as a router to an endpoint device like an MLD/MHD. This implementation overcomes these limitations by interposing address translation and request routing logic between the CXL hosts and the CXL device. The translation of physical addresses may enable each host to maintain its own memory view while the CXL device may utilize a separate address space, with the translation logic managing the mapping between addresses from the host address spaces and the address space utilized by the CXL device.

In some implementations of the method, the first and second entities comprise first and second CXL hosts, respectively, the CXL device comprises a CXL memory expander, the first and second physical addresses from the first and second CXL hosts target overlapping memory regions, and further comprising implementing coherency control between the first and second CXL hosts for the overlapping memory regions. When hosts access overlapping memory regions, the computer may implement coherency mechanisms including snoop filtering to track which host has cached copies of specific memory lines, invalidation broadcasting to notify hosts when shared data is modified, and/or lock management to serialize concurrent access to the same memory locations. These coherency controls operate independently of CXL switch-based coherency mechanisms, implementing coherency protocols within the translation logic.

In some implementations of the method, the CXL device comprises a CXL memory expander, and further comprising implementing quality-of-service (QoS) policies associated with the first and second entities, wherein the QoS policies comprise bandwidth allocation or latency prioritization for memory accesses to the CXL memory expander. The QoS implementation may prevent an entity (such as a CXL host) from monopolizing the memory expander's resources while guaranteeing minimum performance levels for predetermined workloads. Bandwidth allocation may utilize token bucket algorithms, rate limiting mechanisms, or credit-based flow control to regulate the rate of requests forwarded from each entity. Latency prioritization may involve request reordering based on configured priority levels, deadline scheduling for time-sensitive operations, and/or preferential queue management for high-priority entities.

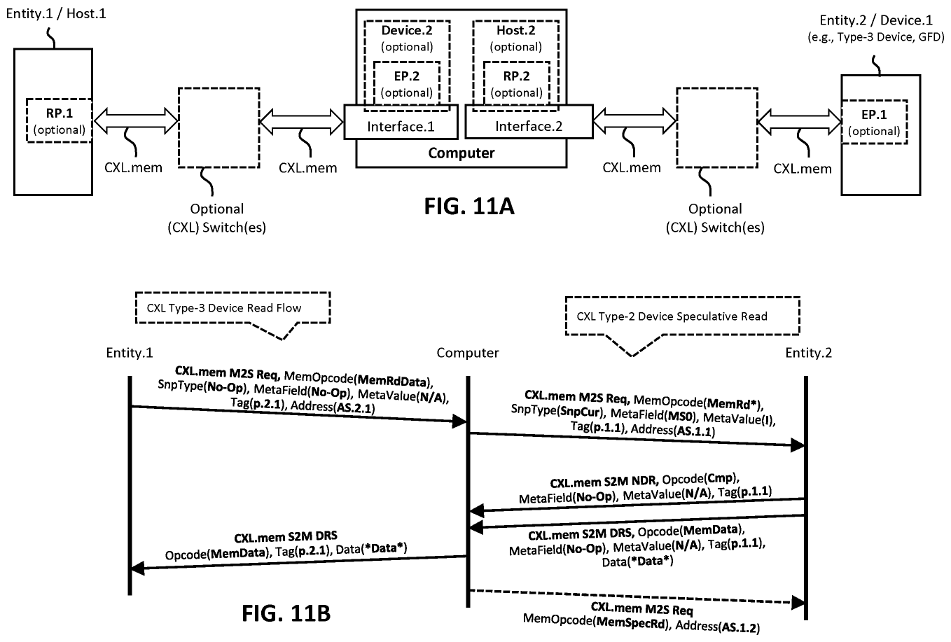

FIG. 11A illustrates an example of a system comprising a computer coupled between a first interface (Interface.1) and a second interface (Interface.2), wherein both the first and second interfaces may communicate according to CXL.mem. The first interface may expose resources associated with a second device (Device.2), such as a CXL type-2 device or a CXL type-3 device, optionally comprising a second endpoint (EP.2), and may communicate according to CXL.mem with a first entity (Entity.1), such as a first host (Host.1), possibly via a first root port (RP.1) of the first host. The second interface may expose a root port (RP.2), via which the computer may communicate as a second host (Host.2) according to CXL.mem with a second entity (Entity.2), such as a first CXL device (Device.1), which may include a first endpoint (EP.1). Additionally or alternatively, the first CXL device may include a Global Fabric-Attached Memory (G-FAM) Device (GFD). The computer may extract physical addresses from messages received via the first interface, wherein these addresses may be from a first HPA space utilized by the first host; translate these addresses; and generate messages carrying the translated physical addresses for transmission via the second interface; wherein these translated addresses may correspond to a physical address space exposed by the computer over the second interface. Optional CXL switch(es) may be positioned between the first interface and the first entity, and/or between the second interface and the second entity. In some examples, the computer and at least one of the first entity and the second entity may be included within the same IC package, optionally coupled via one or more UCIe links.

FIG. 11B illustrates an example of a transaction flow diagram (TFD) demonstrating translations, optionally performed by a computer, between first CXL.mem messages received from a first entity (Entity.1), such as a first host (Host.1), that may utilize a first CXL.mem, and second CXL.mem messages, sent to a second entity (Entity.2), such as a first CXL device (Device.1), that may utilize a second CXL.mem, possibly enabling the computer to abstract resources of the second entity, and possibly enabling the first entity to access resources of the second entity utilizing different memory flow types, such as utilizing optimized type-3 memory flows, instead of type-2 memory flows that may be utilized by the second entity. Additionally or alternatively, the computer may further initiate speculative memory reads targeting the second entity, and may handle memory prefetching on behalf of the first entity, possibly acting as a proxy of the first entity when communicating with the second entity. The first entity may initiate a first CXL.mem transaction that may include a first CXL.mem M2S Req comprising MemOpcode(MemRdData), SnpType(No-Op), MetaField(No-Op), MetaValue(N/A), Tag(p.2.1), and Address(AS.2.1). The computer may translate the first CXL.mem transaction to a second CXL.mem transaction that may include a second CXL.mem M2S Req comprising MemOpcode(MemRd*), SnpType(SnpCur), MetaField(MS0), MetaValue(I), Tag(p.1.1), and Address(AS.1.1), and may send the second CXL.mem M2S Req to the second entity. Upon receiving one or more responses from the second entity, that may include a CXL.mem S2M NDR comprising Opcode(Cmp), MetaField(No-Op), MetaValue(NA), and Tag(p.1.1), and may further include a first CXL.mem S2M DRS comprising Opcode(MemData), MetaField(No-Op), MetaValue(NA), Tag(p.1.1), and Data(*Data*), the computer may translate the one or more responses from the second entity to a second CXL.mem S2M DRS comprising Opcode(MemData), Tag(p.2.1), and Data(*Data*), and may send the second CXL.mem S2M DRS to the first entity.

One example of a speculative memory read targeting the second entity includes a CXL.mem M2S Req comprising MemOpcode(MemSpecRd) and Address(AS.1.2), which may utilize the speculative memory reads, optionally on behalf of the first entity, to facilitate data prefetches and potentially reduce read latency from the second entity. When utilizing MemSpecRd, some of the CXL.mem M2S Req fields, such as Tag, MetaField, MetaValue, and SnpType, may be reserved. The computer may perform further translations, such as opcode translations, e.g., translating between a first CXL.mem M2S Req opcode, such as MemRdData, and a second CXL.mem M2S Req opcode, such as MemRd. The computer may further perform other translations, such as field translations between messages conforming to the first CXL.mem and messages conforming to the second CXL.mem, such as translations between CXL.mem Tags of the two protocols, translations between values of reserved fields of the two protocols, and translations between values of reserved and non-reserved fields of the two protocols. In some examples, the computer may translate between protocols conforming to different CXL revisions, such as translating between transactions of the first CXL.mem conforming to CXL 1.1, which may be utilized by the first entity, and transactions of the second CXL.mem conforming to CXL 2.0, which may be utilized by the second entity.

In some examples, the computer may act as a second device (Device.2), such as a CXL type-3 device or CXL type-2 device optionally comprising a protocol endpoint, and terminate the first CXL.mem transaction. The computer may then issue the second CXL.mem transaction, optionally acting as an independent protocol initiator, such as a second host (Host.2), and may utilize translated fields from the first CXL.mem transaction for constructing the second CXL.mem transaction. In other examples, the computer may maintain, at least partly, an end-to-end transaction context along the path between the first entity and the second entity, optionally without terminating CXL.mem transactions received from the first entity, such as by preserving, at least partly, transaction-related identification fields. In one example, the computer may reuse CXL.mem Tags received from the first entity for constructing CXL.mem Tags sent to the second entity, hence optionally preserving, at least partly, a transaction identifier over the path between the first entity and the second entity, for maintaining, at least partly, an end-to-end transaction context along that path.

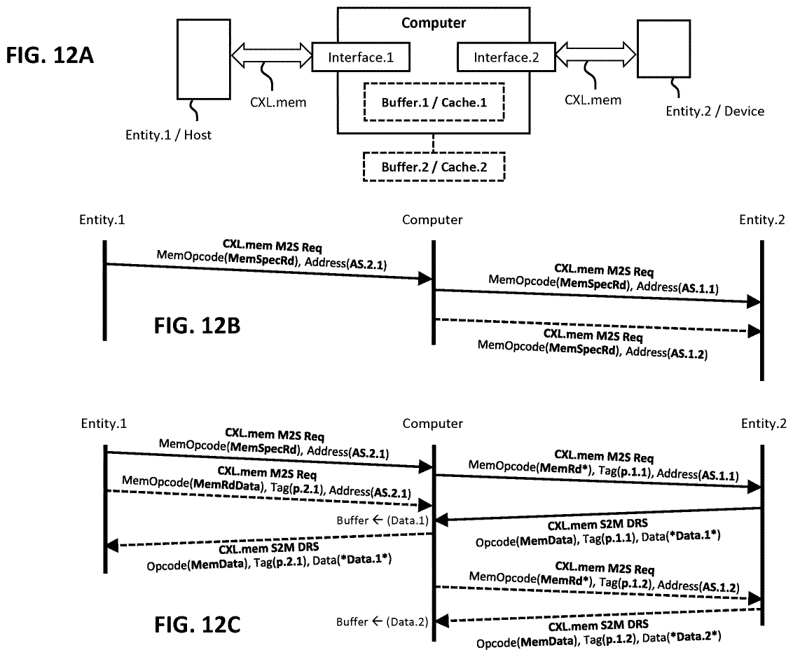

FIG. 12A illustrates an example of a system comprising a computer coupled between a first interface (Interface.1) and a second interface (Interface.2), wherein both the first and second interfaces may communicate according to CXL.mem. The first interface may communicate according to first CXL.mem with a first entity (Entity.1), such as a host. The second interface may communicate according to second CXL.mem with a second entity (Entity.2), such as a device, such as a CXL type-3 device or a Global Fabric-Attached Memory (G-FAM) Device (GFD). The computer may extract field values, such as addresses, opcodes, or Tags, from messages received via the first interface; translate one or more of these field values; and generate messages carrying the translated field values for transmission via the second interface. The computer may include a first buffer (Buffer.1) or a first cache (Cache.1), and may be coupled to a second buffer (Buffer.2) or a second cache (Cache.2). The computer may utilize the buffers or caches for storing data, such as data read from the second entity, data written to the second entity, or data prefetched by the computer from the second entity. Optional CXL switch(es) may be positioned between the first interface and the first entity, and/or between the second interface and the second entity. In some examples, the computer and at least one of the first entity and the second entity may be included within the same IC package, optionally coupled via one or more UCIe links.

FIG. 12B illustrates an example of a TFD demonstrating translations, optionally performed by a computer, between CXL.mem M2S MemSpecRd requests received from a first entity (Entity.1), such as a host, that may utilize a first CXL.mem, and CXL.mem M2S MemSpecRd requests sent to a second entity (Entity.2), such as a CXL device, that may utilize a second CXL.mem, possibly enabling the computer to facilitate data readiness and reduce read latency from the second entity. Additionally or alternatively, the computer may initiate further speculative memory reads targeting the second entity, and may handle memory prefetching on behalf of the first entity, possibly acting as a proxy of the first entity when communicating with the second entity. The first entity may initiate a first CXL.mem transaction that may include a first CXL.mem M2S Req comprising MemOpcode(MemSpecRd) and Address(AS.2.1). When utilizing MemSpecRd, some of the CXL.mem M2S Req fields, such as Tag, MetaField, MetaValue, and SnpType, may be reserved. The computer may translate the first CXL.mem transaction to a second CXL.mem transaction that may include a second CXL.mem M2S Req comprising MemOpcode(MemSpecRd) and Address(AS.1.1), and may send the second CXL.mem M2S Req to the second entity. In some examples, the computer may further translate the first CXL.mem transaction to a third CXL.mem transaction that may include a third CXL.mem M2S Req comprising MemOpcode(MemSpecRd) and Address(AS.1.2), and may send the third CXL.mem M2S Req to the second entity, possibly facilitating the readiness of further data reads that may be expected from the first entity. The computer may further perform other translations, such as translations between messages conforming to the first CXL.mem and messages conforming to the second CXL.mem, translations between reserved fields, and/or translations between reserved and non-reserved fields. In some examples, the computer may translate between protocols conforming to different CXL revisions, such as translating between transactions of the first CXL.mem conforming to CXL 1.1, which may be utilized by the first entity, and transactions of the second CXL.mem conforming to CXL 2.0, which may be utilized by the second entity.

FIG. 12C illustrates an example of a TFD demonstrating translations between CXL.mem messages received from a first entity (Entity.1), such as a host, that may utilize a first CXL.mem, and CXL.mem messages sent to a second entity (Entity.2), such as a CXL device, that may utilize a second CXL.mem, possibly enabling the computer to abstract resources of the second entity and to facilitate data readiness and reduce read latency by prefetching data from the second entity. The first entity may initiate a speculative memory read by initiating a first CXL.mem transaction that may include a first CXL.mem M2S Req comprising MemOpcode(MemSpecRd) and Address(AS.2.1), wherein the first entity may send the first CXL.mem M2S Req to the computer. When utilizing MemSpecRd, some of the CXL.mem M2S Req fields, such as Tag, MetaField, MetaValue, and SnpType, may be reserved. The computer may translate the speculative memory read to a demand read, such as by translating the first CXL.mem transaction to a second CXL.mem transaction that may include a second CXL.mem M2S Req comprising MemOpcode(MemRd*), Tag(p.1.1), and Address(AS.1.1), wherein the computer may send the second CXL.mem M2S Req to the second entity.

Upon receiving one or more responses from the second entity, that may include a first CXL.mem S2M DRS comprising Opcode(MemData), Tag(p.1.1), and Data(*Data.1*), the computer may store *Data.1* in a buffer or a cache, and may further respond to an outstanding read request, if exists, from the first entity, such as a third CXL.mem transaction that may include a third CXL.mem M2S Req comprising MemOpcode(MemRdData), Tag(p.2.1), and Address(AS.2.1), wherein the computer may respond to this request with a second CXL.mem S2M DRS comprising Opcode(MemData), Tag(p.2.1), and Data(*Data.1*), and may send the second CXL.mem S2M DRS to the first entity. Optionally, such as in order to prefetch the next data from the second entity, the computer may further translate the first CXL.mem transaction to a fourth CXL.mem transaction that may include a fourth CXL.mem M2S Req comprising MemOpcode(MemRd*), Tag(p.1.2), and Address(AS.1.2), and may send the fourth CXL.mem M2S Req to the second entity. Upon receiving one or more responses from the second entity, that may include a third CXL.mem S2M DRS comprising Opcode(MemData), Tag(p.1.2), and Data(*Data.2*), the computer may store *Data.2* in the buffer or the cache, wherein the prefetched *Data.2* may be ready for consumption by the first entity, potentially reducing read latency from the second entity as perceived from the first entity. The computer may perform further translations, such as opcode translations, e.g., translating between a first CXL.mem M2S Req opcode, such as MemSpecRd, and a second CXL.mem M2S Req opcode, such as MemRd*.

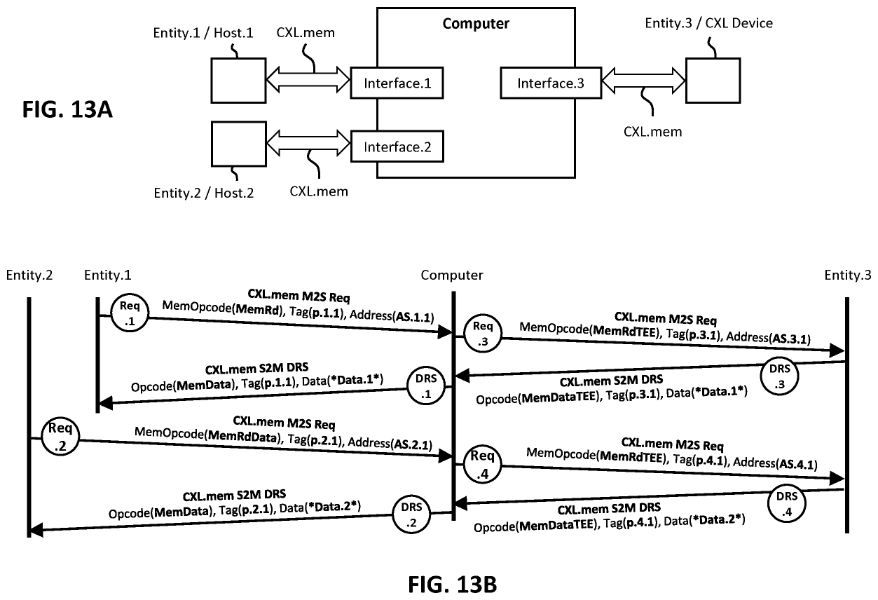

FIG. 13A illustrates an example of a system comprising a computer coupled to a first interface (Interface.1), a second interface (Interface.2), and a third interface (Interface.3). The computer may: (i) receive, via the first interface, a first CXL.mem Master-to-Subordinate request (M2S request) from a first entity (Entity.1), such as a first host (Host.1); (ii) receive, via the second interface, a second CXL.mem M2S request from a second entity (Entity.2), such as a second host (Host.2); (iii) translate the first and second CXL.mem M2S requests to third and fourth CXL.mem M2S requests, respectively; and (iv) send, via the third interface, the third and fourth CXL.mem M2S requests to a third entity (Entity.3), such as a CXL device, that may include an endpoint (EP). Additionally or alternatively, the CXL device may include a Global Fabric-Attached Memory (G-FAM) Device (GFD). In some examples, the computer may further: (i) extract first values of fields, such as first addresses, first opcodes, or first Tags, from messages received via the first interface, translate these first values, and generate messages carrying the translated first values for transmission via the third interface; and/or (ii) extract second values of fields, such as second addresses, second opcodes, or second Tags, from messages received via the second interface, translate these second values, and generate messages carrying the translated second values for transmission via the third interface. In some examples, the computer and at least one of the first entity, the second entity, and the third entity, may be included within the same IC package, optionally coupled via one or more UCIe links.

FIG. 13B illustrates an example of a TFD demonstrating translations, such as translations, optionally performed by a computer, between CXL.mem M2S requests received from a first entity (Entity.1) and a second entity (Entity.2), and CXL.mem M2S requests sent to a third entity (Entity.3), such as a CXL device, possibly enabling the computer to abstract resources of the third entity, such as memory resources, and to expose these resources to the first entity, which may be a first host (Host.1), and to the second entity, which may be a second host (Host.2). In some examples, the translations may enable two hosts to access memory resources of a CXL device. The first entity may initiate a first CXL.mem M2S request (marked as Req.1) comprising MemOpcode(MemRd), Tag(p.1.1), and Address(AS.1.1). The computer may translate the first CXL.mem M2S request to a third CXL.mem M2S request (marked as Req.3) comprising MemOpcode(MemRdTEE), Tag(p.3.1), and Address(AS.3.1), and may send the third CXL.mem M2S request to the third entity. Upon receiving one or more responses from the third entity, which may include a third CXL.mem S2M DRS (marked as DRS.3) comprising Opcode(MemDataTEE), Tag(p.3.1), and Data(*Data.1*), the computer may translate the third CXL.mem S2M DRS to a first CXL.mem S2M DRS (marked as DRS.1) comprising Opcode(MemData), Tag(p.1.1), and Data(*Data.1*), and may send the first CXL.mem DRS to the first entity.

Similarly, the second entity may initiate a second CXL.mem M2S request (marked as Req.2) comprising MemOpcode(MemRdData), Tag(p.2.1), and Address(AS.2.1). The computer may translate the second CXL.mem M2S request to a fourth CXL.mem M2S request (marked as Req.4) comprising MemOpcode(MemRdTEE), Tag(p.4.1), and Address(AS.4.1), and may send the fourth CXL.mem M2S request to the third entity. Upon receiving one or more responses from the third entity, which may include a fourth CXL.mem S2M DRS (marked as DRS.4) comprising Opcode(MemDataTEE), Tag(p.4.1), and Data(*Data.2*), the computer may translate the fourth CXL.mem S2M DRS to a second CXL.mem S2M DRS (marked as DRS.2) comprising Opcode(MemData), Tag(p.2.1), and Data(*Data.2*), and may send the second CXL.mem DRS to the second entity. The computer may perform further translations, such as opcode translations, e.g., translating between CXL.mem M2S request comprising MemRdData, and CXL.mem M2S request comprising MemRdTEE, possibly enabling confidential computing and Trusted Execution Environment (TEE), such as by protecting data-at-rest via encryption. The computer may further perform other translations, such as Tag translations between CXL.mem messages, translations between reserved fields, and/or translations between reserved and non-reserved fields. In some examples, the computer may translate between CXL.mem conforming to different CXL revisions, such as translating between transactions of CXL.mem conforming to CXL 1.1, which may be utilized by the first entity, and transactions of CXL.mem conforming to CXL 4.0, which may be utilized by the third entity.

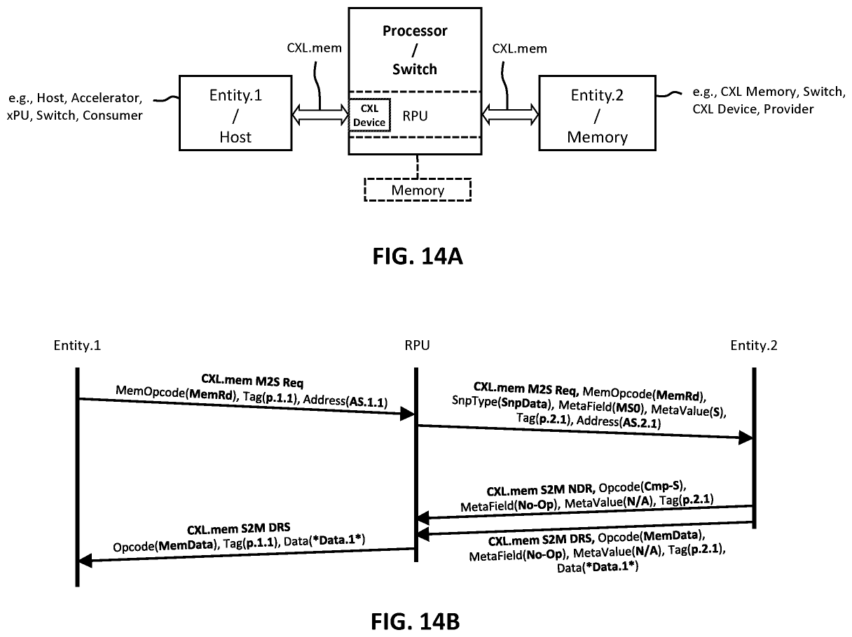

FIG. 14A illustrates an example of a system comprising a processor or a switch, which may include or may be coupled to memory, and may further include an RPU with a CXL device, such as a Global Fabric-Attached Memory (G-FAM) Device (GFD), or a Type-3/2/1 CXL device, enabling external entities to access resources coupled to the processor via the CXL device. The processor is coupled to a first entity (Entity.1), which may be a host, an accelerator, an xPU, or a second switch, wherein the processor may communicate with the first entity according to a first CXL.mem. The processor is further coupled to a second entity (Entity.2), which may be a CXL memory, a CXL device, or a third switch, wherein the processor may communicate with the second entity according to a second CXL.mem. In some examples, the first and second CXL.mem may be associated with first and second physical address spaces, respectively, wherein the RPU may perform address translations between addresses within the first and second physical address spaces, respectively. In other examples, the first and second CXL.mem may be associated with the same physical address space, wherein the RPU may perform address translations between addresses within the same physical address space.

The RPU may perform further translations, such as opcode translations, e.g., translating between MemRd opcodes in requests conforming to the first CXL.mem, to MemRdTEE opcodes in requests conforming to the second CXL.mem, enabling CXL memory accesses with the Trusted Execution Environment (TEE) attribute. The RPU may further perform other translations, such as translations between messages conforming to the first and second CXL.mem, such as Tag translations and traffic class (TC) translations. In some examples, the RPU may translate between protocols conforming to different CXL protocol revisions, such as translating between CXL.mem transactions conforming to CXL 1.1, which may be utilized by the first entity, and CXL.mem transactions conforming to CXL 2.0, which may be utilized by the second entity. In some examples, the RPU may translate between CXL.mem type-3 memory flows and CXL.mem type-2 memory flows, such as CXL.mem transactions that may include CXL.mem S2M NDR responses.

FIG. 14B illustrates an example of a TFD demonstrating translations performed by a processor, a switch, or by an RPU, between a first CXL.mem utilized for communicating with a first entity (Entity.1), such as a host, and a second CXL.mem utilized for communicating with a second entity (Entity.2), such as a CXL device or CXL memory. The first entity may initiate a first CXL.mem transaction that includes a first CXL.mem M2S request comprising MemOpcode(MemRd*), Tag(p.1.1), and Address(AS.1.1). The RPU may translate the first CXL.mem transaction to a second CXL.mem transaction that includes a second CXL.mem M2S request comprising MemOpcode(MemRd), SnpType(SnpData), MetaField(MS0), MetaValue(S), Tag(p.2.1), and Address(AS.2.1), wherein the RPU may send the second CXL.mem M2S request to the second entity. The second entity may respond to the second CXL.mem M2S request with a CXL.mem S2M NDR comprising Opcode(Cmp-S), MetaField(No-Op), MetaValue(NA), and Tag(p.2.1), and may further respond with a first CXL.mem S2M DRS comprising Opcode(MemData), MetaField(No-Op), MetaValue(NA), Tag(p.2.1), and Data(*Data.1*), wherein the RPU may translate the first CXL.mem S2M DRS to a second CXL.mem S2M DRS comprising Opcode(MemData), Tag(p.1.1), and Data(*Data.1*). Optionally, the RPU may act as a protocol endpoint and terminate the first CXL.mem transaction. The RPU may issue the second CXL.mem transaction, optionally acting as an independent protocol initiator, such as a CXL host, and may utilize translated fields from the first CXL.mem transaction for constructing the second CXL.mem transaction. In other examples, the RPU may maintain end-to-end transaction contexts of CXL.mem between the first entity and the second entity, without terminating the CXL.mem transactions, such as by preserving transaction-related identifications such as Tags, and optionally translating other fields such as address fields.

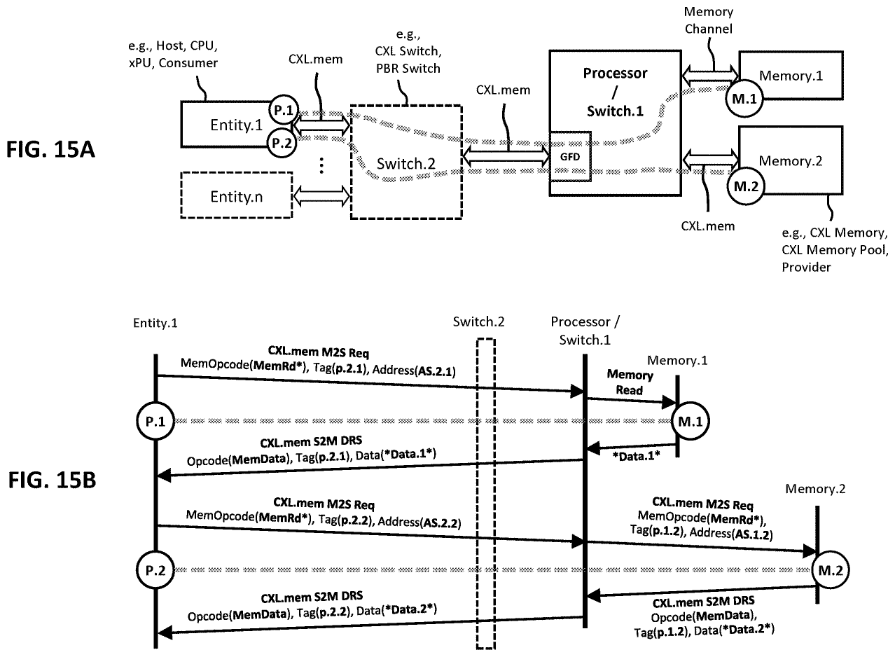

FIG. 15A illustrates an example of a system comprising a processor or a first switch (Switch.1), which may be coupled to a first memory (Memory.1), such as DRAM, via a memory channel, and may be further coupled to a second memory (Memory.2), such as CXL memory, a CXL memory pool, or a CXL-based provider. The processor may include a Global Fabric-Attached Memory (G-FAM) Device (GFD), which may be coupled to one or more entities, such as first entity (Entity.1), optionally via a second switch (Switch.2), such as a CXL switch or a PBR switch, enabling the one or more entities to access, via the GFD, resources coupled to the processor, such as via one or more of the two illustrated paths denoted as (P.1)-(M.1) and (P.2)-(M.2). In some examples, the number of entities, denoted by the parameter n of (Entity. n) may exceed 16. The processor may communicate with the first entity, which may be a host, a CPU, an xPU, or a consumer, according to a first CXL-based protocol, such as a first CXL.mem. The processor may communicate with the second memory, according to a second CXL-based protocol, such as a second CXL.mem.

In some examples, the first and second CXL.mem may be associated with first and second physical address spaces, respectively, such as first and second Host Physical Address (HPA) spaces, wherein the processor may perform address translations between addresses within the first and second physical address spaces, respectively. In other examples, the first and second CXL.mem may be associated with the same physical address space, wherein the processor may perform address translations between addresses within the same physical address space. The processor may perform further translations, such as opcode translations, e.g., translating between MemRd opcodes in requests conforming to the first CXL.mem, to MemRdTEE opcodes in requests conforming to the second CXL.mem, enabling CXL memory accesses with the Trusted Execution Environment (TEE) attribute. The processor may further perform other translations, such as translations between messages conforming to the first and second CXL.mem, traffic class (TC) translations, and/or Tag translations. The processor may maintain tracking between Tags associated with the first CXL.mem and Tags associated with the second CXL.mem, such as in order to associate responses with their corresponding requests. In some examples, the processor may translate between protocols conforming to different CXL protocol revisions, such as translating between CXL.mem transactions conforming to CXL 1.1, which may be utilized by the first entity, and CXL.mem transactions conforming to CXL 2.0, which may be utilized by the second memory.

FIG. 15B illustrates an example of a TFD demonstrating two CXL.mem transactions between a first entity (Entity.1), such as a host, and a processor, or a first switch (Switch.1), corresponding to two distinct memory read paths denoted as (P.1)-(M.1) and (P.2)-(M.2), each associated with a different physical address mapped to different memory resources. The drawing further illustrates translations performed by the processor (or by Switch.1), between a first CXL.mem utilized for communicating with the first entity, and a second CXL.mem utilized for communicating with a second memory (Memory.2), such as a CXL memory, wherein the communication between the processor and the first entity may be performed via a Global Fabric-Attached Memory (G-FAM) Device (GFD) and optionally via a second switch (Switch.2).

The first CXL.mem transaction received by the processor from the first entity includes a first CXL.mem M2S request comprising MemOpcode(MemRd*), Tag(p.2.1), and Address(AS.2.1), which the processor may translate and forward, optionally via an internal interconnect of the processor, via a memory controller, and via a memory channel, to a first memory (Memory.1), resulting in the retrieval of *Data.1*, that the processor sends to the first entity via a first CXL.mem S2M DRS comprising Opcode(MemData), Tag(p.2.1), and Data(*Data.1*).

The second CXL.mem transaction received by the processor from the first entity includes a second CXL.mem M2S request comprising MemOpcode(MemRd*), Tag(p.2.2), and Address(AS.2.2), which the processor may translate to a third CXL.mem transaction that may include a third CXL.mem M2S request comprising MemOpcode(MemRd*), Tag(p.1.2), and Address(AS.1.2), wherein the processor may send the third CXL.mem M2S request to the second memory. Upon receiving a response from the second memory, that may include a second CXL.mem S2M DRS comprising Opcode(MemData), Tag(p.1.2), and Data(*Data.2*), the processor may translate the second CXL.mem S2M DRS to a third CXL.mem S2M DRS comprising Opcode(MemData), Tag(p.2.2), and Data(*Data.2*). The processor may perform further translations, such as opcode translations, e.g., translating between MemRd opcodes in requests conforming to the first CXL.mem, and MemRdTEE opcodes in requests conforming to the second CXL.mem, enabling CXL memory accesses with the Trusted Execution Environment (TEE) attribute.

In some examples, the processor may act as a protocol endpoint and terminate the CXL.mem transactions received from the first entity. The processor may issue CXL.mem transactions to the second memory, optionally acting as an independent protocol initiator, such as a CXL host, and may utilize translated fields from the CXL.mem transactions received from the first entity for constructing the CXL.mem transactions sent to the second memory. In other examples, the processor may maintain end-to-end transaction contexts of the CXL.mem between the first entity and the second memory, without terminating the CXL.mem transactions, such as by preserving transaction-related identification fields such as Tags, and optionally translating other fields such as address.

In environments where entities may utilize different protocols while requiring access to shared memory resources, there may be scenarios where a first entity communicating according to UPLI, such as an accelerator or a UALink switch, needs to access memory resources residing in a CXL domain, such as host memory accessible via a CXL host. An RPU or other suitable device may translate between UPLI and CXL.cache to facilitate memory operations across different protocol domains. The translation may involve converting UPLI requests comprising read or write commands to CXL.cache D2H requests comprising corresponding read or write opcodes, and converting CXL.cache H2D data messages and responses to UPLI read responses, including translations of addresses, Tags, CQIDs, and data formats.

In various implementations, a method comprising: receiving, from a first entity, an Ultra Accelerator Link Protocol Level Interface (UPLI) request comprising a read command; translating, by a Resource Provisioning Unit (RPU), the UPLI request to a CXL.cache Device-to-Host (D2H) request comprising a read opcode, wherein CXL denotes Compute Express Link; sending the CXL.cache D2H request to a second entity; receiving, from the second entity, a CXL.cache Host-to-Device (H2D) data message; translating, by the RPU, the CXL.cache H2D data message to a UPLI read response; and sending the UPLI read response to the first entity. The method translates between UPLI and CXL.cache domains. The RPU receives UPLI requests containing read commands which may include Read commands, AtomicR commands, Vendor Defined Commands with read data returned over the UPLI read response/data (Rd Rsp/Data) Channel, or other read command types supported by UPLI. The RPU translates these read commands into corresponding CXL.cache read opcodes such as RdCurr, RdOwn, RdShared, or RdAny. The translation adapts the operation to the requirements and capabilities of the domain. Upon receiving data responses from the CXL host, the RPU translates the data for the originator, which enables communication between the UPLI and CXL domains while abstracting the protocol differences from both sides.

In some implementations of the method, the UPLI request comprises a source accelerator identifier and a destination accelerator identifier, and the UPLI read response comprises a destination accelerator identifier carrying a value that matches the source accelerator identifier from the UPLI request, and wherein the RPU saves at least the source accelerator identifier from the UPLI request for use in generating the UPLI read response. In some examples, the UPLI request includes identifiers that specify both the source and destination accelerators. The RPU saves at least the source accelerator identifier upon receiving the UPLI request. When generating the UPLI read response, the RPU uses the saved source accelerator identifier from the request as the destination accelerator identifier in the response for proper message routing back to the original requester. In some examples, the RPU may also save the destination accelerator identifier from the UPLI request, and include a source accelerator identifier in the UPLI read response, such as for debugging purposes, however such inclusion is not required for basic functionality.

In some implementations of the method, the UPLI request further comprises a first address and a first Tag, the CXL.cache D2H request comprises a second address translated from the first address and a command queue identifier (CQID) associated with the first Tag, and the UPLI read response comprises the first Tag. In some examples, the RPU performs address translation between physical addresses within UALink address space and physical addresses within CXL.cache address space while maintaining correlations between requests and responses utilizing Tag/CQID mapping. The RPU translates the UALink address to a corresponding CXL.cache address based on configured address mappings. Additionally, the RPU maintains a mapping between UPLI Tags and CXL.cache CQIDs to properly associate responses with their originating requests. This mapping enables the RPU to include the original UPLI Tag in the UPLI read response, allowing the originator to correlate responses with its outstanding requests.

In some implementations of the method, the UPLI request further comprises a length field indicating an amount of data requested; and wherein translating the UPLI request comprises generating multiple CXL.cache D2H requests when the amount of data requested exceeds a maximum CXL.cache transaction size. The RPU may handle UPLI requests that specify data transfers larger than what a CXL.cache transaction can support. The length field in the UPLI request indicates the amount of data requested, which can be up to 256 bytes, while CXL.cache transactions typically handle up to 64 bytes each. When the requested data size exceeds the CXL.cache transaction size limit, the RPU may segment the request into multiple CXL.cache transactions. For example, a 256-byte UPLI request would be translated into four 64-byte CXL.cache transactions, and the RPU manages these multiple transactions while maintaining the appearance of a single operation to the originator.

In some implementations of the method, the UPLI request comprises a Tag, the CXL.cache D2H requests comprise command queue identifiers (CQIDs); and wherein generating the multiple CXL.cache D2H requests comprises associating multiple CQIDs with the Tag. When handling large data transfers that require multiple CXL.cache transactions, the RPU may implement Tag-to-CQID mapping. For a UPLI comprising one Tag, the RPU may generate and track multiple CQIDs, one for each CXL.cache transaction. For example, if a UPLI request comprising Tag#1 requires four CXL.cache transactions, the RPU may generate CQIDs#1 through#4, maintaining mappings between the CQIDs and the original Tag#1. This mapping enables the RPU to associate the relevant CXL.cache responses with the original UPLI request and generate a consolidated response.

In some implementations of the method, translating the CXL.cache H2D data message further comprises: receiving multiple CXL.cache H2D data messages corresponding to the multiple CXL.cache D2H requests, aggregating data from the multiple CXL.cache H2D data messages, and including the aggregated data in the UPLI read response. When handling large data transfers that were split into multiple CXL.cache transactions, the RPU may perform data aggregation before generating the UPLI read response. The RPU receives multiple CXL.cache H2D data messages collectively containing the requested data, which are collected and optionally reassembled in a predetermined order to form a complete data payload. The RPU may manage this aggregation process while maintaining data integrity and proper ordering, such that the originator receives a single, coherent response containing the requested data.

In some implementations of the method, the read opcode of the CXL.cache D2H request is RdCurr, and processing the CXL.cache D2H request does not change existing state in a cache accessible to the RPU. In some examples, the RPU translates the UPLI read command into a CXL.cache D2H request comprising RdCurr, thereby indicating that the memory read is performed using a current state read function, which means that the RPU either does not issue cache commands, or processing the CXL.cache RdCurr request does not change existing state in a cache accessible to the RPU.

In some implementations of the method, the read command is selected from at least one of: a Read command, an AtomicR command, or a Vendor Defined Command with read data returned over a UPLI read response/data (Rd Rsp/Data) Channel; and wherein the read opcode is selected from at least one of: RdCurr, RdOwn, RdShared, or RdAny. The RPU may support translation between various types of read commands in the UPLI domain and read opcodes in the CXL domain. The UPLI read commands may include one or more of memory reads, atomic operations that provide atomicity guarantees, and/or Vendor Defined read commands for custom functionality. The UPLI read commands are translated to appropriate CXL.cache read opcodes based on the operation's requirements. For example, RdCurr requests the current value without changing cache states, RdOwn obtains exclusive ownership, RdShared enables shared access, and RdAny allows flexible coherency state transitions.

In some implementations of the method, the CXL.cache H2D data message comprises first data in a first format; and wherein translating the CXL.cache H2D data message comprises transforming the first data to second data in a second format for the UPLI read response. The RPU may need to transform data between different formats as it moves between UPLI and CXL.cache domains, which may involve changes in data organization, alignment, or representation. The RPU can maintain data integrity while performing the applicable format conversions to meet the requirements of the protocol. The first format may be optimized for CXL.cache operations, while the second format adheres to UPLI specifications for data transfer.

In some implementations, the method further comprises receiving, from the first entity, a UPLI request comprising a write command and write data; translating, by the RPU, the UPLI request comprising the write command to a CXL.cache D2H request comprising a write opcode selected from at least one of: DirtyEvict, ItoMWr, WrCur, or WrInv; and sending the CXL.cache D2H request comprising the write opcode and the write data to the second entity; wherein the first entity comprises a UPLI originator, an accelerator, or a UALink switch; and wherein the second entity comprises a CXL host; and wherein the RPU comprises a CXL device exposing a CXL endpoint to the second entity. The RPU may translate UPLI write commands to CXL.cache D2H write opcodes. DirtyEvict may be utilized when evicting a modified cacheline from the RPU, ItoMWr may be utilized for write operations that upgrade the cacheline from Invalid to Modified state, WrCur may write to a cacheline on a cache hit or to memory on a cache miss, and WrInv may write data while invalidating the cacheline. In some examples, the first entity may be a UPLI originator, such as an accelerator or a UALink switch, that initiates the write transaction, and the second entity may be a CXL host that receives the translated CXL.cache D2H write request. The RPU may expose a CXL endpoint, such as a Type-1 or Type-2 CXL device, to the CXL host for CXL.cache communication.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

An apparatus may include a first interface configured to communicate according to UPLI and a second interface configured to communicate according to CXL.cache, with a computer coupled to both interfaces and configured to translate between the two protocol domains. The apparatus may be implemented as a discrete component, an IP block embedded within an accelerator or a processor, a chiplet within an IC package, or may be integrated into an active cable. The computer may maintain mappings between UPLI Tags and CXL.cache CQIDs, perform address translations between UALink and CXL address spaces, and aggregate data from multiple CXL.cache transactions when a UPLI request exceeds a maximum CXL.cache transaction size. The first interface may include a UPLI completer that receives UPLI requests from a UPLI originator.

In various implementations, an apparatus comprising: a first interface configured to communicate according to an Ultra Accelerator Link Protocol Level Interface (UPLI); a second interface configured to communicate according to CXL.cache, wherein CXL denotes Compute Express Link; and a computer coupled to the first interface and the second interface, the computer configured to: translate a UPLI request comprising a read command, received via the first interface, to a CXL.cache Device-to-Host (D2H) request comprising a read opcode, and send the CXL.cache D2H request via the second interface; and translate a CXL.cache Host-to-Device (H2D) data message, received via the second interface, to a UPLI read response, and send the UPLI read response via the first interface.

In some implementations of the apparatus, the UPLI request comprises a source accelerator identifier and a destination accelerator identifier, the UPLI read response comprises a destination accelerator identifier carrying a value that matches the source accelerator identifier from the UPLI request; and wherein the computer is configured to save at least the source accelerator identifier from the UPLI request for use in generating the UPLI read response. In some examples, the computer processes identifier information embedded in UPLI messages by saving at least the source accelerator identifiers from incoming UPLI requests, and generating UPLI read responses by using the saved source accelerator identifier as the destination accelerator identifier in the response for proper message routing back to the original requester. Optionally, the computer may also save the destination accelerator identifier from the UPLI request, and include a source accelerator identifier in the UPLI read response, such as for debugging purposes, however such inclusion is not required for basic functionality.

In some implementations of the apparatus, the UPLI request further comprises a first address and a first Tag, the CXL.cache D2H request comprises a second address translated from the first address and a command queue identifier (CQID) associated with the first Tag, and the UPLI read response comprises the first Tag; and wherein the computer is further configured to receive, via the second interface, a CXL.cache H2D response comprising a Global Observation (GO) opcode and the CQID, the GO opcode indicating a cache coherency state. In some examples, the computer performs address translation between physical addresses within UALink address space and physical addresses within CXL.cache address space, while maintaining correlations between requests and responses utilizing Tag/CQID mapping. The computer translates the UALink address to a corresponding CXL.cache address based on configured address mappings. Additionally, the computer maintains a mapping between UPLI Tags and CXL.cache CQIDs to properly associate responses with their originating requests. This mapping enables the computer to include the original UPLI Tag in the UPLI read response, allowing the originator to correlate responses with its outstanding requests.

In some implementations of the apparatus, the UPLI request further comprises a length field indicating an amount of data requested; and wherein the computer is further configured to generate multiple CXL.cache D2H requests when the amount of data requested exceeds a maximum CXL.cache transaction size. The computer may handle UPLI requests that specify data transfers larger than what a single CXL.cache transaction can support. The length field in the UPLI request indicates the amount of data requested, which can be up to 256 bytes, while CXL.cache transactions typically handle up to 64 bytes each. When the requested data size exceeds the CXL.cache transaction size limit, the computer may segment the request into multiple CXL.cache transactions. For example, a 256-byte UPLI request would be translated into four 64-byte CXL.cache transactions, and the computer manages these multiple transactions while maintaining the appearance of a single operation to the originator.

In some implementations of the apparatus, the UPLI request comprises a Tag, the CXL.cache D2H requests comprise command queue identifiers (CQIDs); and wherein the computer is further configured to associate multiple CQIDs with the Tag when generating the multiple CXL.cache D2H requests. When handling large data transfers that require multiple CXL.cache transactions, the computer may implement Tag-to-CQID mapping. For a UPLI request comprising one Tag, the computer may generate and track multiple CQIDs, one for each CXL.cache transaction. This mapping enables the computer to associate the relevant CXL.cache responses with the original UPLI request and generate a consolidated response.

In some implementations of the apparatus, the computer is further configured to: receive multiple CXL.cache H2D data messages corresponding to the multiple CXL.cache D2H requests, aggregate data from the multiple CXL.cache H2D data messages, and include the aggregated data in the UPLI read response. When handling large data transfers that were split into multiple CXL.cache transactions, the computer may perform data aggregation before generating the UPLI read response. The computer receives multiple CXL.cache H2D data messages collectively containing the requested data, which are collected and optionally reassembled in a predetermined order to form a complete data payload. The computer may manage this aggregation process while maintaining data integrity and proper ordering, such that the originator receives a single, coherent response containing the requested data.

In some implementations of the apparatus, the read opcode of the CXL.cache D2H request is RdCurr, and as a result of processing the CXL.cache D2H request the computer is further configured not to change existing state in a cache accessible to the computer. In some examples, the computer translates the UPLI read command into a CXL.cache D2H request comprising RdCurr, thereby indicating that the memory read is performed using a current state read function. In some examples, the apparatus either does not issue cache commands, or when processing the CXL.cache RdCurr request it retrieves data in a manner that does not alter the existing state in a cache accessible to the apparatus.

In some implementations of the apparatus, the read command is selected from at least one of: a Read command, an AtomicR command, or a Vendor Defined Command with read data returned over a UPLI read response/data (Rd Rsp/Data) Channel; and wherein the read opcode is selected from at least one of: RdCurr, RdOwn, RdShared, or RdAny. The computer may support translation between various types of read commands in the UPLI domain and read opcodes in the CXL domain. The UPLI read commands may include one or more of memory reads, atomic operations that provide atomicity guarantees, and/or Vendor Defined read commands for custom functionality. The UPLI read commands are translated to appropriate CXL.cache read opcodes based on the operation's requirements. For example, RdCurr requests the current value without changing cache states, RdOwn obtains exclusive ownership, RdShared enables shared access, and RdAny allows flexible coherency state transitions.

In some implementations of the apparatus, the CXL.cache H2D data message comprises first data in a first format; and wherein the computer is further configured to transform the first data to second data in a second format for the UPLI read response. The computer may need to transform data between different formats as it moves between UPLI and CXL.cache domains, which may involve changes in data organization, alignment, or representation. The computer can maintain data integrity while performing the applicable format conversions to meet the protocol requirements. The first format may be optimized for CXL.cache operations, while the second format adheres to UPLI specifications for data transfer.

In some implementations of the apparatus, the computer is further configured to: translate a UPLI request comprising a write command and write data, received via the first interface, to a CXL.cache D2H request comprising a write opcode selected from at least one of: DirtyEvict, ItoMWr, WrCur, or WrInv; and send the CXL.cache D2H request comprising the write opcode and the write data via the second interface; wherein the first interface comprises a UPLI completer. The computer may translate UPLI write commands to CXL.cache D2H write opcodes. The first interface may include a UPLI completer, which may receive UPLI requests from a UPLI originator, such as an accelerator or a UALink switch.

In some implementations of the apparatus, the apparatus comprises a chiplet within an integrated circuit (IC) package of a processor, the processor comprising a coherent interconnect coupling processing cores to a memory controller; and wherein the second interface is coupled to the coherent interconnect via a CXL root port; whereby the computer translates UPLI requests to CXL.cache D2H requests that traverse the coherent interconnect to access memory coupled to the memory controller. The apparatus may be implemented as a chiplet within an IC package of a processor, such as an MxPU. The coherent interconnect, such as a ring or mesh interconnect, may couple processing cores, an LLC, a CXL RP, and a memory controller. The computer may utilize CXL.cache as an intermediate protocol for translating between UPLI and a protocol utilized by the coherent interconnect. The CXL root port may be included in the chiplet or may be part of the processor, and may communicate with the coherent interconnect via a Ring-to-CXL (R2CXL) interconnect interface.

In some implementations of the apparatus, an active cable comprising: a first pluggable module coupled to a first physical medium, a second pluggable module coupled to a second physical medium, and an apparatus according to claim 13 coupling the first and second physical media.

In AI inference environments, accelerators may execute neural network models whose aggregate data requirements exceed the capacity of the accelerator's local memory. Model data such as expert weights, KV cache entries, and attention parameters may be stored in host memory and fetched on demand during inference. An RPU may translate between UPLI utilized by the accelerator and CXL.cache utilized by the host, enabling the accelerator to read model data from the host memory and write inference context data back to the host memory across the protocol domain boundary.

In various implementations, a method comprising: executing, by an accelerator comprising local memory, an inference workload on a neural network model; sending, by the accelerator, an Ultra Accelerator Link Protocol Level Interface (UPLI) request comprising a read command for model data stored in a host memory of a host; translating, by a Resource Provisioning Unit (RPU), the UPLI request to a CXL.cache Device-to-Host (D2H) request comprising a read opcode, wherein CXL denotes Compute Express Link; sending the CXL.cache D2H request to the host; receiving, from the host, a CXL.cache Host-to-Device (H2D) data message comprising the model data; translating, by the RPU, the CXL.cache H2D data message to a UPLI read response comprising the model data; and sending the UPLI read response to the accelerator. The method enables an accelerator executing an inference workload to access model data stored in a host memory via the RPU. The RPU translates between the UPLI domain utilized by the accelerator and the CXL.cache domain utilized by the host, enabling the accelerator to extend its accessible memory capacity beyond the local memory. The model data may include neural network weights, activation data, intermediate computation results, or other data associated with inference processing. The host memory may provide larger capacity than the accelerator's local memory, and the RPU may bridge the two protocol domains to enable memory capacity expansion for inference workloads.

In some implementations of the method, the model data comprises at least one of: expert weights associated with a Mixture-of-Experts (MoE) model, the expert weights fetched from the host memory when a gating network of the MoE model routes one or more tokens to an expert; key-value (KV) cache entries previously offloaded from the local memory to the host memory during inference of a sequence; or attention parameters associated with a transformer-based model. In MoE models, only a subset of expert sub-networks may be active for any given input token. Inactive expert weights may be offloaded to the host memory to free accelerator local memory capacity, and activated expert weights may be fetched from the host memory when the gating network routes tokens to those experts. KV cache entries may be offloaded to host memory during inference of long sequences to free local memory for active computation, and may be fetched back when needed for attention computation. This dynamic staging may enable inference of models that exceed the available local memory capacity.

In some implementations, the method further comprises sending, by the accelerator, a UPLI request comprising a write command and inference context data; translating, by the RPU, the UPLI request comprising the write command to a CXL.cache D2H request comprising a write opcode; and sending the CXL.cache D2H request and the inference context data to the host for storage in the host memory. The write direction may enable the accelerator to offload inference context data to the host memory, such as KV cache entries that are not actively needed, intermediate computation results, or checkpoint data. The RPU may translate the UPLI write command to a CXL.cache D2H write opcode, such as DirtyEvict, ItoMWr, WrCur, or WrInv, and may forward the inference context data to the host for storage in the host memory.

A system may include an accelerator with local memory, a host with host memory, and an RPU coupled between them to bridge the UPLI and CXL.cache protocol domains. The RPU may enable the accelerator to access host memory capacity beyond its local memory, addressing memory capacity limitations for workloads such as AI inference and high-performance computing. The host memory may include removable DDR modules or CXL-attached memory, providing larger but higher-latency capacity compared to the accelerator's local HBM. A UALink switch may couple accelerators to the RPU, enabling accelerators to share access to the host memory via the RPU.

In various implementations, a system comprising: an accelerator comprising local memory and configured to communicate according to an Ultra Accelerator Link Protocol Level Interface (UPLI); a host comprising host memory and configured to communicate according to CXL.cache, wherein CXL denotes Compute Express Link; and a Resource Provisioning Unit (RPU) coupled between the accelerator and the host, the RPU comprising a first interface configured to communicate with the accelerator according to UPLI and a second interface configured to communicate with the host according to CXL.cache; wherein the RPU is configured to: translate a UPLI request comprising a read command, received from the accelerator via the first interface, to a CXL.cache Device-to-Host (D2H) request comprising a read opcode, and send the CXL.cache D2H request to the host via the second interface; and translate a CXL.cache Host-to-Device (H2D) data message, received from the host via the second interface, to a UPLI read response, and send the UPLI read response to the accelerator via the first interface; whereby the accelerator accesses the host memory via the RPU. The system may enable an accelerator to access host memory through protocol translation performed by the RPU. The RPU may bridge the UPLI domain of the accelerator and the CXL.cache domain of the host, translating read commands to CXL.cache D2H read opcodes and translating CXL.cache H2D data messages back to UPLI read responses. The system may address memory capacity limitations of the accelerator by enabling access to the host memory, which may provide larger capacity than the accelerator's local memory. The RPU may be a discrete component, an IP block embedded in a processor, or a chiplet within an IC package.

In some implementations of the system, a capacity of the host memory exceeds a capacity of the local memory; and wherein the local memory comprises high-bandwidth memory (HBM) and the host memory comprises removable DDR modules, or CXL-attached memory; whereby the accelerator accesses a combined memory capacity comprising the local memory and the host memory; and wherein the RPU is further configured to: translate a UPLI request comprising a write command and write data, received from the accelerator, to a CXL.cache D2H request comprising a write opcode; and send the CXL.cache D2H request comprising the write opcode and the write data to the host for storage in the host memory. In one example, the removable DDR modules refer to a standardized hardware assembly comprising one or more memory integrated circuits disposed on a substrate and encompassing various form factors and mounting architectures, including but not limited to: dual in-line memory modules (DIMMs), compression-attached memory modules (CAMM or CAMM2), and any future iterations of modular memory form factors.

In some implementations, the system further comprises a UALink switch coupled between the accelerator and the RPU; wherein the UALink switch routes the UPLI request from the accelerator to the RPU based on a destination accelerator identifier carried in the UPLI request; and wherein accelerators are coupled to the UALink switch, the accelerators sharing access to the host memory via the RPU. The UALink switch may route UPLI traffic based on the destination accelerator identifier, such as the ReqDstPhysAccID field, utilizing a route table to map the destination identifier to an egress port coupled to the RPU. The accelerators may share access to the host memory via the RPU, enabling accelerators to extend their accessible memory capacity. In some examples, the UALink switch may also route UPLI responses from the RPU back to the originating accelerator based on the destination accelerator identifier in the response.

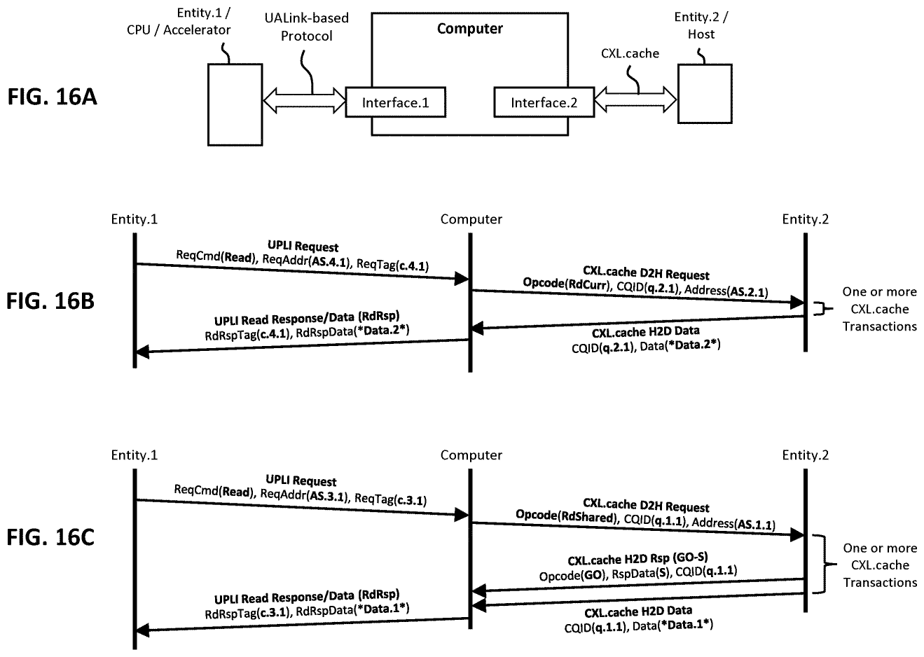

FIG. 16A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.cache, with a second entity (Entity.2), such as a host. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In some examples, the first address space and the second address space may be associated with the same address space, such as a common address space, a global address space, a pod address space, or a fabric address space, wherein the computer may perform address translations between addresses within the same common address space. In other examples, the computer may be implemented in an IC package having high-speed differential I/O balls positioned according to a ball grid array layout defined by a retimer specification.

FIG. 16B illustrates an example of a TFD demonstrating translations, such as protocol translations, between UALink-based requests, such as UPLI requests, received from a first entity (Entity.1), which may be a CPU or an accelerator, and CXL requests, such as CXL.cache D2H requests, sent to a second entity (Entity.2), which may be a host, possibly enabling the first entity to access resources mapped to an address space utilized by the second entity. The first entity may initiate a UPLI transaction that may include a UPLI request comprising ReqCmd(Read), ReqAddr(AS.4.1), and ReqTag(c.4.1). The computer may translate the UPLI transaction to a CXL transaction that may include a CXL.cache D2H request comprising Opcode(RdCurr), CQID(q.2.1), and Address(AS.2.1), and may send the CXL.cache D2H request to the second entity. Upon receiving one or more responses from the second entity, which may include a CXL.cache H2D Data comprising CQID(q.2.1) and Data(*Data.2*), the computer may translate the one or more responses, such as translating the CXL.cache H2D Data to a UPLI read response/data (RdRsp) comprising RdRspTag(c.4.1) and RdRspData(*Data.2*), and send the UPLI RdRsp to the first entity. In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity.

The computer may perform further translations, such as opcode translations, command translations, TLP type translations, and field translations between the UALink-based domain and the CXL domain. In some examples, the computer may issue multiple CXL.cache D2H requests in response to receiving a UPLI request from the first entity, such as when splitting a UPLI request for a large block of data (e.g., 256 B) to smaller CXL.cache D2H requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

FIG. 16C illustrates an example of a TFD demonstrating translations, such as protocol translations, between UALink-based requests, such as UPLI requests, received from a first entity (Entity.1), which may be a CPU or an accelerator, and CXL requests, such as CXL.cache D2H requests, sent to a second entity (Entity.2), which may be a host, possibly enabling the first entity to access resources mapped to an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.cache D2H request comprising Opcode(RdShared), CQID(q.1.1), and Address(AS.1.1), and send the CXL.cache D2H request to the second entity. Upon receiving one or more responses from the second entity, which may include a CXL.cache H2D Rsp comprising Opcode(GO), RspData(S), and CQID(q.1.1), and may further include a CXL.cache H2D Data comprising CQID(q.1.1) and Data(*Data.1*), the computer may translate the one or more responses, such as translating the CXL.cache H2D Data to a UPLI read response/data (RdRsp) comprising RdRspTag(c.3.1) and RdRspData(*Data.1*), and may send the UPLI RdRsp to the first entity. In some examples, the computer may include a cache or may control a cache that is external to the computer, wherein the computer may be configured to select the CXL.cache D2H request opcode according to a cacheline state intent that may be identified based on the UPLI request, or according to a caching policy, such as selecting RdShared for storing a shared copy of the cacheline in the cache, or selecting RdOwn for storing an exclusive copy of the cacheline in the cache.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache D2H requests in response to receiving a UPLI request from the first entity, such as when splitting a UPLI request for a large block of data (e.g., 256 B) to smaller CXL.cache D2H requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

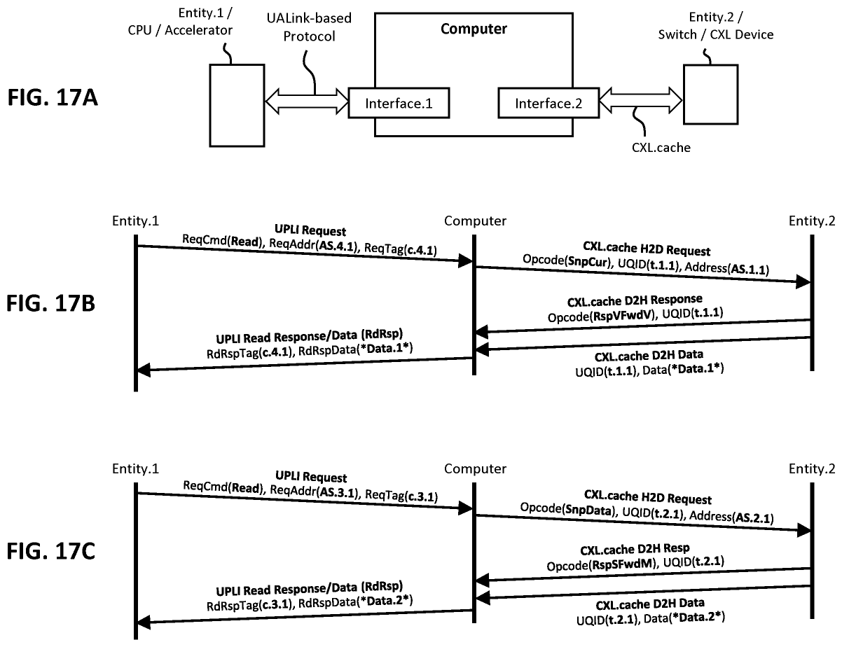

FIG. 17A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.cache, with a second entity (Entity.2), such as a switch, or a CXL device, which may be a CXL memory expander, a CXL memory pool, a GFD, or a CXL accelerator. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In some examples, the first address space and the second address space may be associated with the same address space, such as a common address space, a global address space, a pod address space, or a fabric address space, wherein the computer may perform address translations between addresses within the same common address space. In some examples, the computer may be implemented in an IC package having high-speed differential I/O balls positioned according to a ball grid array layout defined by a retimer specification.

FIG. 17B illustrates an example of a TFD demonstrating translations, such as protocol translations, between UALink-based requests, such as UPLI requests, received from a first entity (Entity.1), which may be a CPU or an accelerator, and CXL requests, such as CXL.cache H2D requests, sent to a second entity (Entity.2), which may be a switch or a CXL device, possibly enabling the first entity to access resources associated with an address space utilized by the second entity. The first entity may initiate a UPLI transaction that may include a UPLI request comprising ReqCmd(Read), ReqAddr(AS.4.1), and ReqTag(c.4.1). The computer may translate the UPLI transaction to a CXL transaction that may include a CXL.cache H2D request comprising Opcode(SnpCur), UQID(t.1.1), and Address(AS.1.1), and may send the CXL.cache H2D request to the second entity. Upon receiving one or more responses from the second entity, which may include a CXL.cache D2H response comprising Opcode(RspVFwdV) and UQID(t.1.1), and may further include a CXL.cache D2H Data comprising UQID(t.1.1) and Data(*Data.1*), the computer may translate the one or more responses, such as translating the CXL.cache D2H Data to a UPLI read response/data (RdRsp) comprising RdRspTag(c.4.1) and RdRspData(*Data.1*), and may send the UPLI RdRsp to the first entity. In some examples, the computer may include a cache or may control a cache that is external to the computer, wherein the computer may be configured to select the CXL.cache H2D request opcode according to a cacheline state intent that may be identified based on the UPLI request, or according to a caching policy, such as selecting SnpData for a cacheline that is intended to be cached in either Shared or Exclusive state, or selecting SnpCur to get the current version of a cacheline without requiring change of any cache state in the hierarchy.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache H2D requests in response to receiving a UPLI request from the first entity, such as when splitting a UPLI request for a large block of data (e.g., 256 B) to smaller CXL.cache H2D requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

FIG. 17C illustrates an example of a TFD demonstrating translations, such as protocol translations, between UALink-based requests, such as UPLI requests, received from a first entity (Entity.1), which may be a CPU or an accelerator, and CXL requests, such as CXL.cache H2D requests, sent to a second entity (Entity.2), which may be a switch or a CXL device, possibly enabling the first entity to access resources associated with an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.cache H2D request comprising Opcode(SnpData), UQID(t.2.1), and Address(AS.2.1), and may send the CXL.cache H2D request to the second entity. Upon receiving one or more responses from the second entity, which may include a CXL.cache D2H response comprising Opcode(RspSFwdM) and UQID(t.2.1), and may further include a CXL.cache D2H Data comprising UQID(t.2.1) and Data(*Data.2*), the computer may translate the one or more responses, such as translating the CXL.cache D2H Data to a UPLI read response/data (RdRsp) comprising RdRspTag(c.3.1) and RdRspData(*Data.2*), and may send the UPLI RdRsp to the first entity. In some examples, the computer may include a cache or may control a cache that is external to the computer, wherein the computer may be configured to select the CXL.cache H2D request opcode according to a cacheline state intent that may be identified based on the UPLI request, or according to a caching policy, such as selecting SnpData for a cacheline that is intended to be cached in either Shared or Exclusive state, or selecting SnpCur to get the current version of a cacheline without requiring change of any cache state in the hierarchy.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache H2D requests in response to receiving a UPLI request from the first entity, such as when splitting a UPLI request for a large block of data (e.g., 256 B) to smaller CXL.cache H2D requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

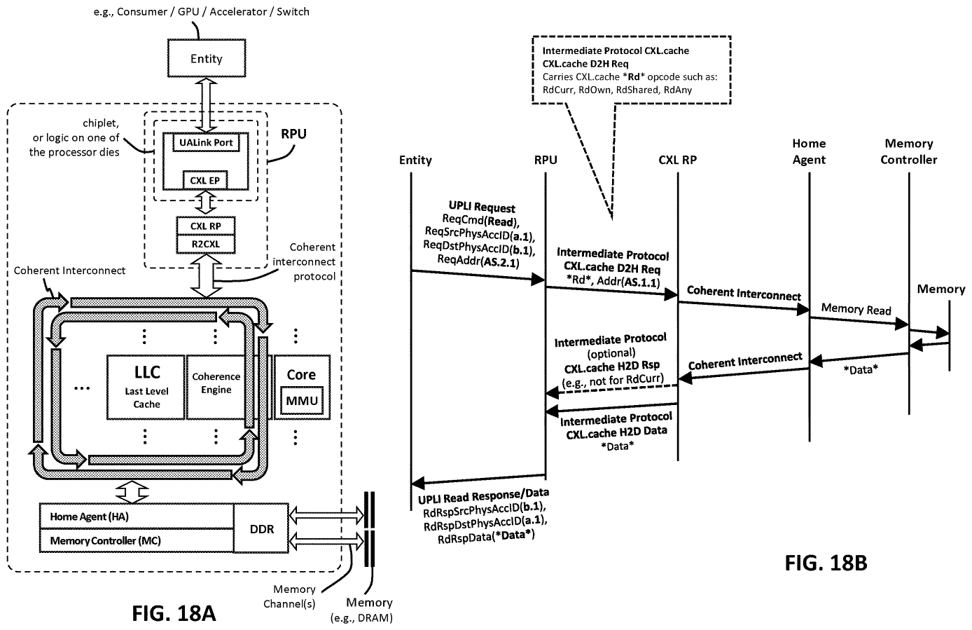

FIG. 18A illustrates an example of a system comprising a processor (such as an MxPU) comprising processing cores, LLC, a CXL RP, and a memory controller optionally coupled via memory channels to memory, such as DRAM. The CXL RP may be coupled to an on-chip coherent interconnect, such as a CHI ring or mesh interconnect, via a Ring-to-CXL (R2CXL) interconnect interface that may communicate with the coherent interconnect according to a protocol utilized by the coherent interconnect, such as ARM CHI, Intel UPI, or AMD Infinity Fabric. An RPU, which may be included in the MxPU, performs physical address translations that may enable an entity such as a GPU to access the memory. The MxPU may expose to the entity, optionally via the RPU, a UALink port that may communicate with the entity according to UPLI. The RPU may further perform translations, such as from UPLI to a protocol utilized by the coherent interconnect, wherein the RPU may utilize an intermediate protocol, such as CXL (e.g., CXL.cache), to provide the translations. The RPU may expose to the processor, via a CXL RP that may be included in the RPU, a CXL device utilizing a CXL endpoint (CXL EP), such as a Type-1 CXL device or a Type-2 CXL device, where an R2CXL, that may reside in the RPU, may communicate with the coherent interconnect and complete the translation path from UPLI to a protocol utilized by the coherent interconnect. In some examples, the RPU, the UALink port and the CXL device may be implemented in a chiplet inside an IC package of an MxPU, whereas in other examples they may be implemented as functional blocks on the same die with the CXL RP of the processor, or split between processor dies or chiplets.

FIG. 18B illustrates an example of a TFD demonstrating a UPLI request (Req) received from an entity, such as a GPU or an accelerator, wherein the RPU may translate a physical address (AS.2.1) carried in the UPLI request, to a physical address (AS.1.1) utilized for accessing the memory. The RPU may perform further translations, such as protocol translations from UPLI to a protocol utilized by the processor's coherent interconnect, possibly utilizing an intermediate protocol such as CXL.cache. The RPU may perform further translations, such as opcode translations and Tag translations, e.g., of transaction Tags, such as translating from UPLI Tags to CQIDs. The CXL.cache request, carrying the translated address (AS.1.1), is sent to the CXL RP for further processing and fetching of the requested data, such as from an LLC over the on-chip ring interconnect, or from memory, such as DRAM via the memory channels. The data may then return over the on-chip ring interconnect to the RPU, wherein the RPU provides UPLI read response/data (RdRsp) to the requesting entity.

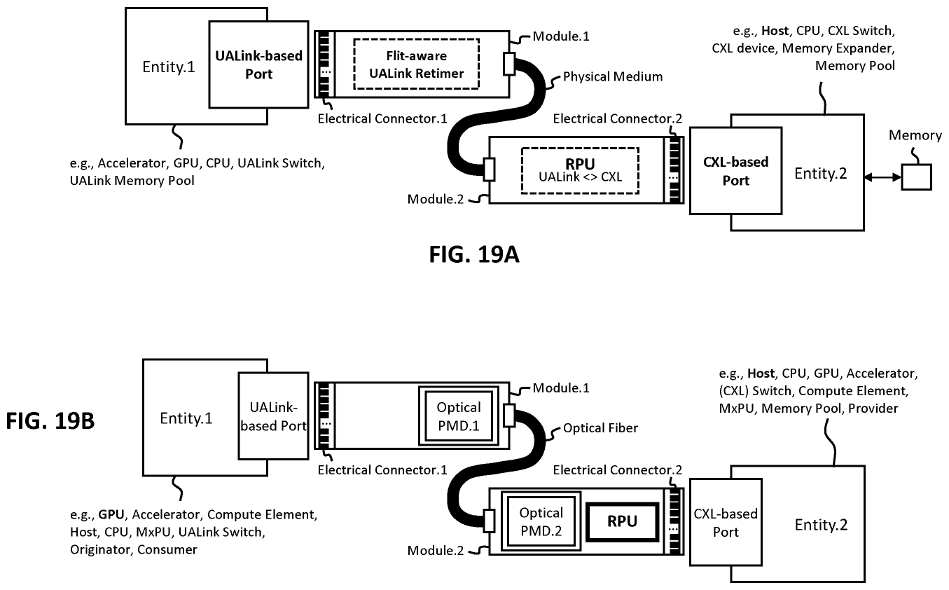

FIG. 19A illustrates an example of a system comprising a cable, such as an active cable, referred to as Cable/RPU, which may translate between UALink-based traffic and CXL-based traffic, such as at least one of CXL.io, CXL.mem, or CXL.cache traffic. The Cable/RPU enables a first entity (Entity.1), which may be an accelerator, a GPU, a CPU, a UALink switch, a UPLI originator, or a resource consumer, to access, via a UALink-based port, via the Cable/RPU, and via a CXL-based port, resources, such as memory, coupled to a second entity (Entity.2), which may be a host, a CPU, a CXL switch, a CXL device, a memory expander, a memory pool, or a resource provider. The Cable/RPU, which may include an RPU, may communicate with the first entity according to a UALink-based protocol, such as a UPLI, and may communicate with the second entity according to a CXL-based protocol, such as at least one of CXL.io, CXL.mem, or CXL.cache. In some examples, the UALink-based protocol, such as UPLI, may be associated with a first address space, such as an NPA space, and the CXL-based protocol, such as CXL.mem, may be associated with a second address space, such as a System Physical Address (SPA) space or a Host Physical Address (HPA) space; wherein the Cable/RPU may perform address translations between addresses within the first and second address spaces, respectively, such as between addresses within the NPA space and addresses within the SPA space or the HPA space.

In other examples, the UALink-based protocol, such as UPLI, and the CXL-based protocol, such as CXL.mem, may be associated with the same physical address space, such as a global address space, a pod address space, or a fabric address space; wherein the Cable/RPU may perform address translations between addresses within the same address spaces. The Cable/RPU may perform further translations, such as opcode, command, or TLP translations, e.g., translating between Read commands in UPLI requests and read opcodes in CXL.cache D2H requests. The Cable/RPU may further translate between messages conforming to the UALink-based protocol and messages conforming to the CXL-based protocol, translate Tags, and/or translate error indications, such as data corruption indications or poison.

In some examples, the Cable/RPU, such as an OSFP copper cable, an OSFP-XD copper cable, an OSFP Active Optical Cable (AOC), or an OSFP-XD AOC cable, may further include a first module (Module.1), which may include a flit-aware UALink retimer, a PAM4 retimer, or a retimer PHY, and may further include a second module (Module.2), which may include the RPU, optionally included in a discrete component compatible with a retimer form-factor. The Cable/RPU may conform to a standard specification, an industry standard, an implementation agreement (IA), or a multi-source agreement (MSA), such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard (such as SFF-8665), an Optical Internetworking Forum (OIF) implementation agreement, or an Institute of Electrical and Electronics Engineers (IEEE) standard. The Cable/RPU may further include a physical medium that may include a copper wire or an optical fiber. In some examples, the Cable/RPU may be coupled to the UALink-based port via a first electrical connector (Electrical Connector.1) and may be further coupled to the CXL-based port via a second electrical connector (Electrical Connector.2), whereas in other examples the Cable/RPU may be coupled to the UALink-based port and/or the CXL-based port via optical connectors.

FIG. 19B illustrates an example of a system comprising an active optical cable. The active optical cable may couple a first entity (Entity.1), such as a GPU, an accelerator, a compute element, a host, a CPU, an MxPU, a UALink switch, a UPLI originator, or a consumer, to a second entity (Entity.2), such as a host, a CPU, a GPU, an accelerator, a CXL switch, a compute element, an MxPU, a memory pool, or a provider. In some examples, the first entity may be coupled to a first port (Port.1), such as a UALink port, via a first electrical connector (Electrical Connector.1). The active optical cable may include a first module (Module.1) comprising a first optical physical media dependent (Optical PMD.1) device, and a second module (Module.2) comprising a second optical physical media dependent (Optical PMD.2) device and an RPU. The first module may be coupled to the first electrical connector and may convert electrical signals from the first entity to optical signals for transmission over an optical fiber. The second module may convert the optical signals back to electrical signals and may further comprise the RPU, which may translate between a UALink-based protocol, such as UPLI, and a CXL-based protocol, such as at least one of CXL.io, CXL.mem, or CXL.cache. The second module may be coupled to the second entity via a second electrical connector (Electrical Connector.2), wherein the second entity may be coupled to a second port (Port.2), such as a CXL port.

In some examples, the RPU within the active optical cable may perform address translations between addresses within a first address space associated with the UALink-based protocol, such as a NPA space, and addresses within a second address space associated with the CXL-based protocol, such as HPA space. The RPU may further perform opcode translations, command translations, Tag translations, and translations of error indications such as data corruption indications or poison. In some examples, the active optical cable may conform to a standard specification, an industry standard, an implementation agreement, or a multi-source agreement, such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard, an Optical Internetworking Forum (OIF) implementation agreement, or an IEEE standard. In other examples the active optical cable may utilize other form factors or standards as they become available.

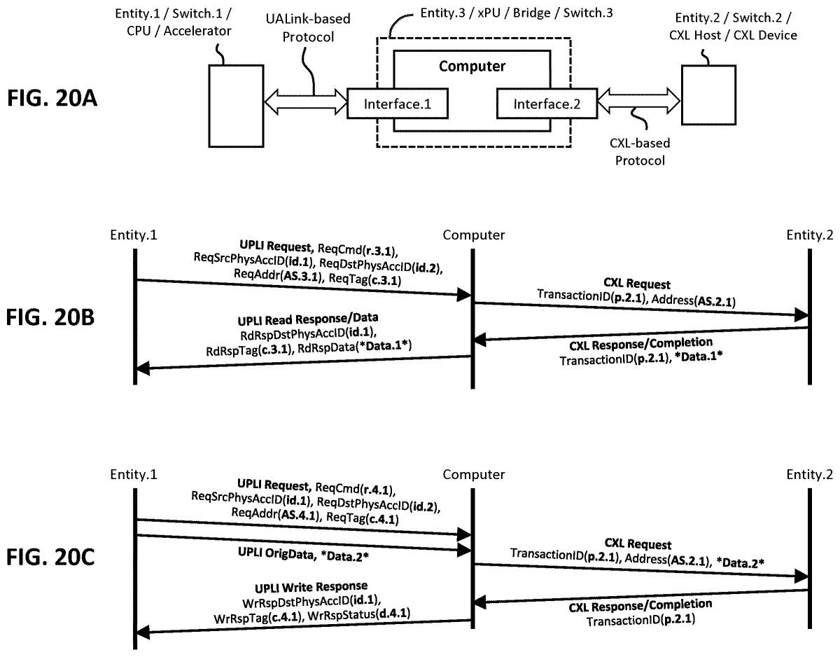

FIG. 20A illustrates an example of a system comprising a third entity (Entity.3), such as an xPU, a bridge, or a third switch (Switch.3). The third entity includes a computer comprising a first interface (Interface.1) and a second interface (Interface.2). The first interface may communicate according to a UALink-based protocol, such as UPLI, with a first entity (Entity.1), such as a first switch (Switch.1), a CPU, or an accelerator. The second interface may communicate according to a CXL-based protocol, such as CXL.io, CXL.mem, or CXL.cache, with a second entity (Entity.2), such as a second switch (Switch.2), a CXL host, or a CXL device which may be a CXL memory expander, a CXL-based memory pool, a GFD, or a CXL accelerator. The computer may perform translations, such as protocol translations between the UALink-based protocol and the CXL-based protocol, transaction translations, protocol data unit (PDU) translations, message translations, and/or address translations between the UALink-based protocol domain and the CXL-based protocol domain. In some examples, the computer may extract addresses from requests received via the first interface, wherein these addresses may refer to a first address space, such as a Network Physical Address (NPA) space utilized by the first entity. The computer may translate these addresses, and generate requests carrying the translated addresses for transmission via the second interface; wherein these translated addresses may refer to a second address space, such as a Host Physical Address (HPA) space utilized by the second entity. In other examples the first address space and the second address space may be associated with the same address space, such as a common address space, a global address space, a pod address space, or a fabric address space, wherein the computer may perform address translations between addresses within the same common address space. In some examples, the computer may be implemented in a chiplet, may utilize UCIe for chip-to-chip or die-to-die connectivity, or may be implemented in an IC package having high-speed differential I/O balls positioned according to a ball grid array layout defined by a retimer specification.

FIG. 20B illustrates an example of a TFD demonstrating translations, such as protocol translations, transaction translations, protocol data unit (PDU) translations, message translations, and/or address translations, which may be performed by a computer, between a UALink-based protocol, such as UPLI, utilized by a first entity (Entity.1), such as a first switch (Switch.1), a CPU, or an Accelerator, and a CXL-based protocol, such as CXL.io, CXL.mem, or CXL.cache, utilized by a second entity (Entity.2), such as a second switch (Switch.2), a CXL host, or a CXL device. The first entity may initiate a UPLI transaction that may include a UPLI request comprising ReqCmd(r.3.1), such as Read or Read class Vendor Defined Command, ReqSrcPhysAccID(id.1), ReqDstPhysAccID(id.2), ReqAddr(AS.3.1), and ReqTag(c.3.1). The computer may translate the UPLI transaction to a CXL transaction that may include a CXL request comprising TransactionID(p.2.1) and Address(AS.2.1), and may send the CXL request to the second entity. In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. Upon receiving from the second entity a CXL response or completion (CXL Response/Completion) comprising TransactionID(p.2.1) and *Data.1*, the computer may translate the CXL Response/Completion to a UPLI read response/data comprising RdRspDstPhysAccID(id.1), RdRspTag(c.3.1), and RdRspData(*Data.1*), and may send the UPLI read response/data to the first entity.

The computer may perform further translations, such as opcode translations, command translations, TLP type translations, or other translations between the UALink-based protocol domain and the CXL-based protocol domain. In some examples, the computer may issue multiple CXL requests in response to receiving a UPLI request from the first entity. For example, the computer may issue CXL.mem M2S requests comprising MemRd or MemRdData, such as when splitting a UPLI request for a large block of data (e.g., 256 B) to smaller CXL.mem reads (e.g., 64 B each), or when prefetching data from the second entity utilizing CXL.mem reads. The computer may translate requests or transactions initiated from the UALink-based protocol domain to the CXL-based protocol domain, may translate requests or transactions initiated from the CXL-based protocol domain to the UALink-based protocol domain, or may translate requests or transactions initiated from the protocol domains.

FIG. 20C illustrates an example of a TFD demonstrating translations, such as protocol translations, transaction translations, protocol data unit (PDU) translations, message translations, and/or address translations, which may be performed by a computer, between a UALink-based protocol, such as UPLI, utilized by a first entity (Entity.1), such as a first switch (Switch.1), a CPU, or an Accelerator, and a CXL-based protocol, such as CXL.io, CXL.mem, or CXL.cache, utilized by a second entity (Entity.2), such as a second switch (Switch.2), a CXL host, or a CXL device. The first entity may initiate a UPLI transaction that may include a UPLI request comprising ReqCmd(r.4.1), such as Write or Write class Vendor Defined Command, ReqSrcPhysAccID(id.1), ReqDstPhysAccID(id.2), ReqAddr(AS.4.1), and ReqTag(c.4.1). The UPLI transaction may further include a UPLI OrigData comprising *Data.2*. The computer may translate the UPLI transaction to a CXL transaction that may include a CXL request comprising TransactionID(p.2.1), Address(AS.2.1), and *Data.2*, and may send the CXL request to the second entity. In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. Upon receiving from the second entity a CXL response or completion (CXL Response/Completion) comprising TransactionID(p.2.1), the computer may translate the CXL Response/Completion to a UPLI write response comprising WrRspDstPhysAccID(id.1), WrRspTag(c.4.1), and WrRspStatus(d.4.1), and may send the UPLI write response to the first entity.

The computer may perform further translations, such as opcode translations, command translations, TLP type translations, or other translations between the UALink-based protocol domain and the CXL-based protocol domain. In some examples, the computer may issue CXL requests in response to receiving a UPLI request from the first entity. For example, the computer may issue multiple CXL.mem M2S RwD comprising MemWr or MemWrTEE, such as when splitting a UPLI request writing a large block of data (e.g., 256 B) to smaller CXL.mem writes (e.g., 64 B each). The computer may translate requests or transactions initiated from the UALink-based protocol domain to the CXL-based protocol domain, may translate requests or transactions initiated from the CXL-based protocol domain to the UALink-based protocol domain, or may translate requests or transactions initiated from the protocol domains.

In some implementations, a computer, such as an RPU, may be coupled between an NVLink interface and a CXL interface, and may translate between NVLink-based traffic and CXL.mem traffic. The computer may receive NVLink-based requests from a first entity, such as a GPU or an accelerator, and may translate the NVLink-based requests to CXL.mem M2S requests for transmission to a second entity, such as a CXL device, a CXL memory expander, or a CXL memory pool. The translation may include address translation between physical address spaces, opcode translation between NVLink commands and CXL.mem memory opcodes, and Tag translation between NVLink transaction identifiers and CXL.mem Tags. The computer may be implemented as a discrete component, as a chiplet within an IC package, as an IP block within a processor, or may be integrated into an active cable or an NVLink switch. The translation may enable NVLink-coupled accelerators to access CXL memory resources for GPU memory disaggregation, capacity expansion, AI model parameter storage, key-value (KV) cache offloading, and other memory-intensive AI workloads.

In various implementations, a method comprising: receiving, by a computer from a first entity via a first interface that communicates according to an NVLink-based protocol, an NVLink-based request comprising a first physical address associated with a first address space; translating, by the computer, the first physical address to a second physical address associated with a second address space; generating, by the computer, a CXL.mem Master-to-Subordinate (M2S) request comprising a read-class memory opcode and the second physical address, wherein CXL denotes Compute Express Link; sending, by the computer via a second interface, the CXL.mem M2S request to a second entity; receiving, by the computer from the second entity, a CXL.mem Subordinate-to-Master Data Response with Status (S2M DRS) comprising data; and sending, by the computer to the first entity, an NVLink-based response comprising the data. The computer may translate the NVLink-based request by terminating the NVLink transaction and initiating a corresponding CXL.mem transaction. For example, the read-class memory opcode may include MemRd, MemRdData, or other read-class opcodes defined by CXL.mem. The address translation may be implemented utilizing lookup tables, page tables, base-and-offset calculations, or programmable translation functions. The computer may translate requests initiated from the NVLink-based domain to the CXL domain, may translate requests initiated from the CXL domain to the NVLink-based domain, or may translate requests initiated from both domains.

In some implementations of the method, the NVLink-based request is associated with a data payload size exceeding a maximum CXL.mem data payload size, and wherein generating the CXL.mem M2S request comprises generating CXL.mem M2S requests corresponding to the NVLink-based request. For example, an NVLink-based read request for 256 Bytes of data may be translated to four CXL.mem M2S requests, each targeting a 64-Byte cacheline. The computer may generate the CXL.mem M2S requests with sequential or non-sequential addresses derived from the first physical address.

In some implementations, the method further comprises accumulating data from CXL.mem S2M DRS responses corresponding to the CXL.mem M2S requests before sending the NVLink-based response to the first entity. The computer may buffer partial data from individual S2M DRS responses and assemble the complete data payload before generating the NVLink-based response. The S2M DRS responses may arrive out of order, and the computer may utilize Tag mappings to associate each response with the corresponding CXL.mem M2S request.

In some implementations, the method further comprises maintaining, by the computer, a mapping between a first Tag associated with the NVLink-based request and a second Tag associated with the CXL.mem M2S request, and utilizing the mapping to associate the CXL.mem S2M DRS with the NVLink-based request. The mapping may be stored in a tracker entry, a translation table, or a content-addressable memory. The first Tag may include an NVLink Tag or TransactionID, and the second Tag may be a CXL.mem Tag allocated from a Tag space utilized by the computer toward the second entity.

In some implementations, the method further comprises generating, by the computer, a second CXL.mem M2S request comprising a MemSpecRd opcode and a third physical address; and sending the second CXL.mem M2S request to the second entity. The computer may generate speculative read requests to prefetch data from the second entity before, or without, the first entity explicitly requesting it. The speculative reads may reduce read latency when the second entity exhibits long access times, such as when accessing slow memory media or remote memory resources over a fabric.

In some implementations of the method, the first address space comprises an NVLink-based network address space or a GPU physical address space, and the second address space comprises a Host Physical Address (HPA) space; and wherein the first entity comprises a GPU, an accelerator, or an NVLink switch, and the second entity comprises a CXL device, a CXL memory expander, or a CXL memory pool. The NVLink-based network address space may be utilized for routing NVLink requests across the NVLink fabric. The HPA space may be utilized by a CXL host or CXL device for memory access operations. The address translation may accommodate differences in size, base addresses, or memory layouts between the address spaces.

In some implementations of the method, the CXL.mem S2M DRS further comprises a Poison indication, and the NVLink-based response further comprises an error indication translated from the Poison indication. The Poison indication in CXL.mem S2M DRS may signal that the data contains an error. The computer may translate the Poison indication to an equivalent error indication in the NVLink-based response to propagate the error status to the first entity.

In some implementations, the method further comprises receiving, from the first entity via the first interface, an NVLink-based write request comprising write data; generating, by the computer, a CXL.mem Master-to-Subordinate Request with Data (M2S RwD) comprising MemWr* and the write data; sending the CXL.mem M2S RwD to the second entity via the second interface; receiving, from the second entity, a CXL.mem Subordinate-to-Master No Data Response (S2M NDR); and sending an NVLink-based write response to the first entity. For example, MemWr* may include MemWr, MemWrPtl, or other memory write opcode variants defined by CXL.mem. The write data may be transferred from the NVLink domain to the CXL.mem domain with optional byte enable manipulation when the write is partial. The S2M NDR may include a Cmp opcode indicating completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to an NVLink-based protocol and a second interface configured to communicate according to CXL, with a computer coupled between the interfaces. The computer may be implemented in various form factors, such as an IC package conforming to a retimer BGA specification, an NVLink Fusion chiplet within a processor IC package, a discrete bridge device, or a component integrated into an active cable or an NVLink switch. The system may include optional NVLink switches and CXL switches to support multi-entity topologies. The computer may translate between physical address spaces and between NVLink-based requests and CXL.mem M2S requests, enabling NVLink-coupled entities to access CXL memory resources.

In various implementations, a system comprising: a first interface configured to communicate according to an NVLink-based protocol with a first entity; a second interface configured to communicate according to Compute Express Link (CXL) with a second entity; and a computer coupled between the first and second interfaces, configured to: translate physical addresses associated with the NVLink-based protocol to physical addresses associated with CXL; and translate between NVLink-based requests received via the first interface and CXL.mem Master-to-Subordinate (M2S) requests transmitted via the second interface. The computer may further translate CXL.mem S2M responses received via the second interface to NVLink-based responses transmitted via the first interface. The computer may include logic for address translation, Tag management, protocol conversion, and transaction tracking. The system may be deployed in datacenters, HPC environments, or AI training and inference clusters to enable NVLink-coupled accelerators to access CXL-attached memory resources such as CXL memory expanders or CXL memory pools.

In some implementations of the system, the computer is packaged in an integrated circuit (IC) package comprising input/output (I/O) connection points arranged according to a retimer ball grid array (BGA) specification. The retimer BGA form factor may enable the computer to be deployed in existing retimer sockets within server platforms, optionally facilitating adoption without requiring board-level redesign.

In some implementations, the system further comprises at least one of: an NVLink switch coupled between the first interface and the first entity, the NVLink switch configured to route NVLink-based requests from NVLink entities to the first interface; or a CXL switch coupled between the second interface and the second entity, the CXL switch configured to route CXL.mem M2S requests to CXL devices or CXL memory pools. The NVLink switch may be an NVSwitch that aggregates traffic from accelerators/GPUs toward the computer. The CXL switch may enable the computer to access multiple CXL memory devices or memory pools via a CXL interface, expanding the addressable memory capacity.

In some implementations of the system, the computer comprises an NVLink Fusion chiplet within an integrated circuit (IC) package of a processor, the NVLink Fusion chiplet comprising the first interface and coupled to the processor via a die-to-die (D2D) interface, the D2D interface utilizing a Universal Chiplet Interconnect Express (UCIe) PHY or a proprietary chip-to-chip PHY. The NVLink Fusion chiplet may enable integration of NVLink connectivity into processors that may not have native NVLink support. The D2D interface may couple the chiplet to a coherent interconnect within the processor, such as an on-chip ring or mesh interconnect.

In some implementations of the system, the NVLink-based protocol and CXL are associated with a same physical address space, the same physical address space comprising a global address space, a pod address space, or a fabric address space. When both protocols are associated with the same physical address space, the computer may perform address translations between addresses within the same space, such as range adjustments or offset calculations, rather than translations between fundamentally different address spaces.

In some implementations, a computer may translate CXL.mem requests to NVLink-based requests, enabling CXL hosts or CPUs to access memory residing on an NVLink fabric via NVLink-coupled entities such as accelerators/GPUs. NVLink provides a distributed memory model where GPUs may access memory via other GPUs. This translation may provide a CXL.mem bridge or gateway for non-NVLink compute elements, such as CPUs, to access memory on the NVLink fabric. The computer may be implemented as a discrete component, integrated into an active cable, or included in an NVLink switch.

In various implementations, a method comprising: receiving, by a computer from a first entity via a first interface that communicates according to Compute Express Link (CXL), a CXL.mem Master-to-Subordinate (M2S) request comprising a read-class memory opcode and a first physical address associated with a first address space; translating, by the computer, the first physical address to a second physical address associated with a second address space; generating, by the computer, an NVLink-based request comprising the second physical address; sending, by the computer via a second interface that communicates according to an NVLink-based protocol, the NVLink-based request to a second entity; receiving, by the computer from the second entity, an NVLink-based response comprising data; and generating, by the computer, a CXL.mem Subordinate-to-Master Data Response with Status (S2M DRS) comprising the data, and sending the CXL.mem S2M DRS to the first entity. The computer may translate the CXL.mem M2S request by terminating the CXL.mem transaction and initiating a corresponding NVLink transaction. The read-class memory opcode in the CXL.mem M2S request may include opcodes such as MemRd, MemRdData, or MemSpecRd. The computer may translate the HPA from the CXL.mem M2S request to an NVLink network address utilized for routing the NVLink request to its destination on the NVLink fabric. The CXL.mem S2M DRS may carry a MemData opcode and the data retrieved from the second entity.

In some implementations, the method further comprises maintaining, by the computer, a mapping between a first Tag associated with the CXL.mem M2S request and a second Tag associated with the NVLink-based request, and utilizing the mapping to associate the NVLink-based response with the CXL.mem M2S request. Upon receiving the NVLink-based response, the computer may utilize the second Tag to retrieve the first Tag from the mapping and include the first Tag in the CXL.mem S2M DRS for transaction completion at the first entity.

In some implementations of the method, the first address space comprises a Host Physical Address (HPA) space, and the second address space comprises an NVLink-based network address space; and wherein the NVLink-based request further comprises a DestinationID derived from the first physical address, the DestinationID identifying a target entity on an NVLink fabric coupled to the second interface. The computer may derive the DestinationID from the translated address, from a routing table, or from address-range-to-destination mappings. The DestinationID may be utilized for routing the NVLink request through NVLink switches to the target entity on the NVLink fabric.

In some implementations of the method, the first entity comprises a CXL host or a CPU, and the second entity comprises a GPU, an NVLink switch, or an accelerator; and wherein the NVLink-based response comprises data retrieved from a memory accessible via the second entity on an NVLink fabric. The translation may enable CPUs to access GPU-attached memory, such as HBM and/or High-Bandwidth Flash (HBF), via the CXL.mem-to-NVLink bridge, facilitating scenarios where CPUs participate alongside NVLink GPUs in AI inference or training workloads.

In some implementations, the method further comprises receiving, from the second entity, a second NVLink-based response that does not carry data; and generating a CXL.mem Subordinate-to-Master No Data Response (S2M NDR) based on the second NVLink-based response, and sending the CXL.mem S2M NDR to the first entity. The S2M NDR may carry a Cmp opcode to indicate completion of a write or invalidation operation. The computer may translate NVLink completion indications to the corresponding CXL.mem S2M NDR opcode.

In some implementations, the method further comprises receiving, from the first entity via the first interface, a CXL.mem Master-to-Subordinate Request with Data (M2S RwD) comprising MemWr* and write data; generating, by the computer, an NVLink-based write request comprising the write data; sending the NVLink-based write request to the second entity via the second interface; receiving, from the second entity, an NVLink-based write response; and generating a CXL.mem Subordinate-to-Master No Data Response (S2M NDR), and sending the CXL.mem S2M NDR to the first entity. MemWr* may include MemWr, MemWrPtl, or other memory write opcode variants. The computer may translate the CXL.mem write data and byte enables to corresponding NVLink write request formats. The S2M NDR may be sent after the NVLink-based write response is received, or may be sent before the NVLink write completes as an early completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to CXL and a second interface configured to communicate according to an NVLink-based protocol, with a computer coupled between the interfaces to translate CXL.mem M2S requests to NVLink-based requests. The computer may be integrated into an active cable, included in an NVLink switch, or implemented as a discrete bridge device. The system may position the computer closer to the CXL interface for signal integrity, since CXL runs over PCIe electricals designed for shorter-reach connectivity, while NVLink may incorporate signaling compatible with longer-reach deployments.

In various implementations, a system comprising: a first interface configured to communicate according to Compute Express Link (CXL) with a first entity; a second interface configured to communicate according to an NVLink-based protocol with a second entity; and a computer coupled between the first and second interfaces, configured to: translate physical addresses associated with CXL to physical addresses associated with the NVLink-based protocol; and translate between CXL.mem Master-to-Subordinate (M2S) requests received via the first interface and NVLink-based requests transmitted via the second interface. The computer may further translate NVLink-based responses received via the second interface to CXL.mem S2M responses transmitted via the first interface. The system may enable CXL hosts or CPUs to access memory on an NVLink fabric, such as GPU-attached HBM and/or HBF, via the NVLink-based protocol. The computer may maintain transaction tracking structures for matching NVLink responses to pending CXL.mem requests.

In some implementations, the system further comprises an active cable comprising a first pluggable module coupled to the first interface, a second pluggable module coupled to the second interface, and a physical medium coupling the first and second pluggable modules; wherein the computer is integrated into the active cable and converts between CXL signaling conforming to PCIe electrical specifications at the first interface and NVLink signaling at the second interface. The physical medium may include twinaxial cable, multimode fiber, or single-mode fiber. The active cable may be implemented as an Active Optical Cable (AOC) or an Active Copper Cable (ACC). The signaling conversion within the cable may simplify system integration by presenting standard CXL and NVLink interfaces at each end.

In some implementations of the system, the second interface utilizes fewer lanes than the first interface, and wherein the NVLink-based protocol operates at a higher per-lane signaling rate than CXL, such that the second interface achieves a bandwidth comparable to the first interface utilizing the fewer lanes. The lane reduction may simplify cable design by reducing the number of copper wires or optical fibers, which may reduce cost and complexity of the interconnect while maintaining bandwidth parity between the two interfaces.

In some implementations of the system, the computer is positioned closer to the first interface than to the second interface; and wherein the first interface communicates via electrical signaling conforming to PCIe physical layer specifications designed for shorter-reach connectivity, and the second interface communicates via electrical signaling compatible with longer-reach interconnect deployments. Positioning the computer closer to the CXL interface may improve signal integrity for the shorter-reach CXL signaling, while the longer-reach NVLink signaling may tolerate the additional distance to the second entity.

In some implementations of the system, the computer is included in an NVLink switch, the NVLink switch coupled to NVLink entities via the second interface; and wherein the computer translates CXL.mem M2S requests from the first entity to NVLink-based requests directed to at least one of the NVLink entities. The NVLink switch may route the translated NVLink-based requests to the appropriate NVLink entity based on destination identifiers or address-based routing. Integrating the computer into the NVLink switch may enable a CXL host to access memory across multiple NVLink-coupled accelerators/GPUs.

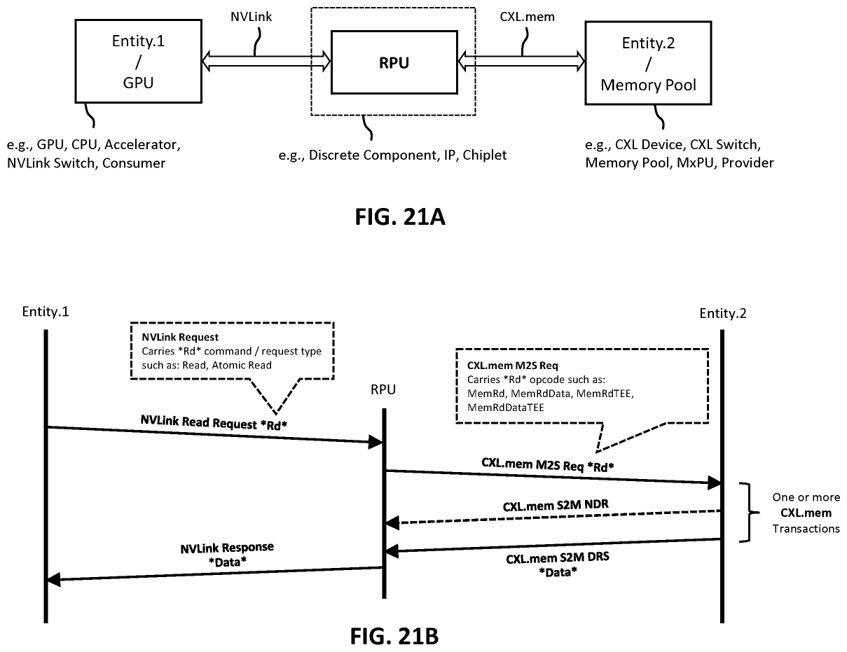

FIG. 21A illustrates an example of a system comprising an apparatus, such as an RPU, coupled between a first entity (Entity.1) and a second entity (Entity.2). The RPU may translate between NVLink-based traffic and CXL-based traffic, such as CXL.mem traffic. Entity.1, shown as a GPU, may communicate with the RPU according to an NVLink-based protocol, and may include a GPU, CPU, Accelerator, NVLink Switch (NVSwitch), or other resource consumer. Entity.2, shown as a Memory Pool, may communicate with the RPU according to CXL.mem, and may include a CXL Device, CXL Switch, Memory Pool, MxPU, or other resource provider. The RPU may be implemented as a discrete component, an IP block within a processor, or a chiplet within an IC package. Additionally or alternatively, the RPU may translate between the NVLink-based traffic and CXL.io traffic, and/or between the NVLink-based traffic and CXL.cache traffic.

FIG. 21B illustrates an example of a Transaction Flow Diagram (TFD) demonstrating an apparatus, such as an RPU, that may translate between NVLink-based traffic and CXL-based traffic, such as CXL.mem traffic. The TFD shows three entities: Entity.1 (a GPU or Consumer) on the left, the RPU in the center, and Entity.2 (a CXL Device or Provider) on the right. The first entity may send an NVLink Read Request carrying a *Rd* command or request type, such as Read or Atomic Read, to the RPU. The RPU may translate the NVLink Read Request to a CXL.mem M2S Req carrying a *Rd* opcode, such as MemRd, MemRdData, MemRdTEE, or MemRdDataTEE, and may send the CXL.mem M2S Req to the second entity. The second entity may respond with one or more CXL.mem transactions, including a CXL.mem S2M NDR and/or a CXL.mem S2M DRS carrying *Data*. The RPU may translate the CXL.mem S2M DRS to an NVLink Response carrying *Data* and send the NVLink Response to the first entity. In some examples, the RPU may translate an NVLink-based request to multiple CXL.mem request, such as when splitting an NVLink request for a data payload of 256 Bytes to CXL.mem M2S requests each carrying 64 Bytes. The RPU may accumulate data from one or more CXL.mem S2M DRS messages before sending the data via an NVLink-based response.

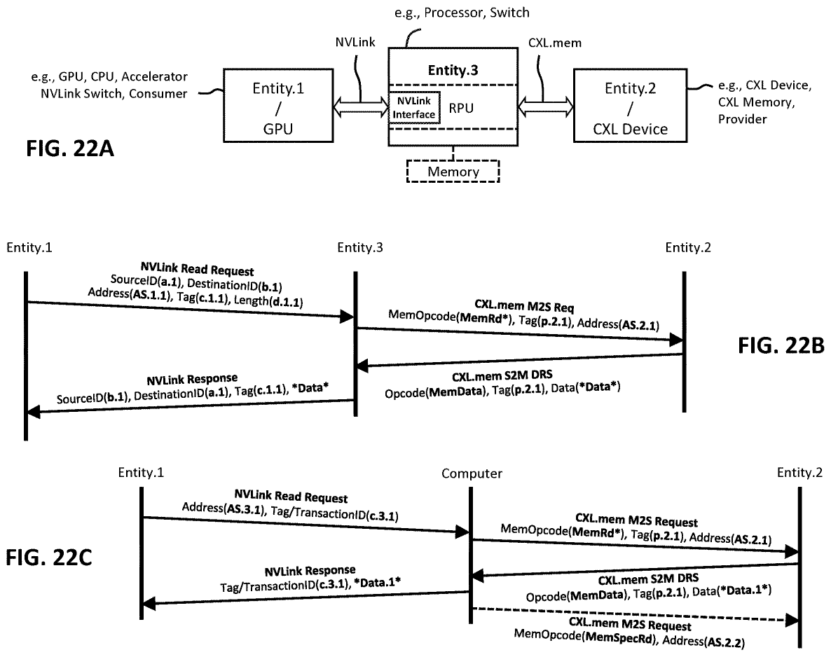

FIG. 22A illustrates an example of a system comprising a third entity (Entity.3), such as a processor or a switch. Entity.3 includes an NVLink Interface and an RPU, and includes or is coupled to an optional Memory. Entity.3 is coupled to a first entity (Entity.1), which may be a GPU, CPU, Accelerator, NVLink Switch (NVSwitch), or resource consumer, via an NVLink-based protocol. Entity.3 is further coupled to a second entity (Entity.2), which may be a CXL Device, CXL Memory, or resource provider, via CXL.mem. In some examples, messages conforming to the NVLink-based protocol may be associated with a first physical address (PA) space, such as a GPU physical address space or an NVLink-based network address space, and messages conforming to CXL.mem may be associated with a second PA space, such as HPA space. The RPU may perform address translations between addresses within the first PA space and addresses within the second PA space. In other examples, messages conforming to the NVLink-based protocol and messages conforming to CXL.mem may be associated with the same PA space, such as a global address space. Optionally, the RPU may perform further translations between the NVLink-based domain and CXL.mem domain, such as protocol translations, opcode translations, command translations, and field translations.

FIG. 22B illustrates an example of a TFD demonstrating translations performed by a third entity (Entity.3), such as a processor, a switch, or an RPU, between messages conforming to an NVLink-based protocol utilized for communicating with a first entity (Entity.1), such as a GPU, a CPU, or an accelerator, and messages conforming to CXL.mem utilized for communicating with a second entity (Entity.2), such as a CXL device or CXL memory. The first entity may initiate an NVLink Read Request comprising SourceID(a.1), DestinationID(b.1), Address(AS.1.1), Tag(c.1.1), and Length(d.1.1), wherein SourceID(a.1) may denote the NVLink interconnect address utilized by the requesting entity, and DestinationID(b.1) may denote the NVLink interconnect address utilized by the target of the NVLink request. The third entity may translate the NVLink request to a CXL.mem M2S Req comprising MemOpcode(MemRd*), Tag(p.2.1), and Address(AS.2.1), and may send the CXL.mem M2S Req to the second entity. Upon receiving a response from the second entity, which may include a CXL.mem S2M DRS comprising Opcode(MemData), Tag(p.2.1), and Data(*Data*), the third entity may translate the CXL.mem S2M DRS to an NVLink Response comprising SourceID(b.1), DestinationID(a.1), Tag(c.1.1), and *Data*. The third entity may perform further translations, such as protocol translations, opcode translations, command translations, or translations between PDUs conforming to the NVLink-based protocol and messages conforming to CXL.mem, such as translations of Tags and translations of error indications, such as poison.

FIG. 22C illustrates an example of a TFD demonstrating translations, such as address translations, optionally performed by a computer, between NVLink-based requests received from a first entity (Entity.1), which may be a CPU or a GPU, and CXL.mem requests sent to a second entity (Entity.2), which may be a CXL device. The first entity may initiate an NVLink Read Request comprising Address(AS.3.1) and Tag/TransactionID(c.3.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.mem M2S Request comprising MemOpcode(MemRd*), Tag(p.2.1), and Address(AS.2.1), and may send the CXL.mem M2S Request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to an NVLink response comprising Tag/TransactionID(c.3.1) and *Data.1*, and send the NVLink response to the first entity. The computer may further initiate speculative memory reads targeting the second entity, such as a CXL.mem M2S request comprising MemOpcode(MemSpecRd) and Address(AS.2.2), to facilitate data prefetches and potentially reduce read latency from the second entity. Optionally, the computer may utilize the speculative memory reads on behalf of the first entity. When utilizing MemSpecRd, some of the CXL.mem M2S Req fields, such as Tag, MetaField, MetaValue, and SnpType, may be reserved. In some examples, the computer may issue multiple CXL.mem reads in response to receiving an NVLink request from the first entity, such as when splitting an NVLink request for a large block of data (e.g., 256 B) to smaller CXL.mem reads (e.g., 64 B each), or when prefetching data from the second entity utilizing CXL.mem reads. The computer may translate requests or transactions initiated from the NVLink-based domain to the CXL domain, and/or may translate requests or transactions initiated from the CXL domain to the NVLink-based domain.

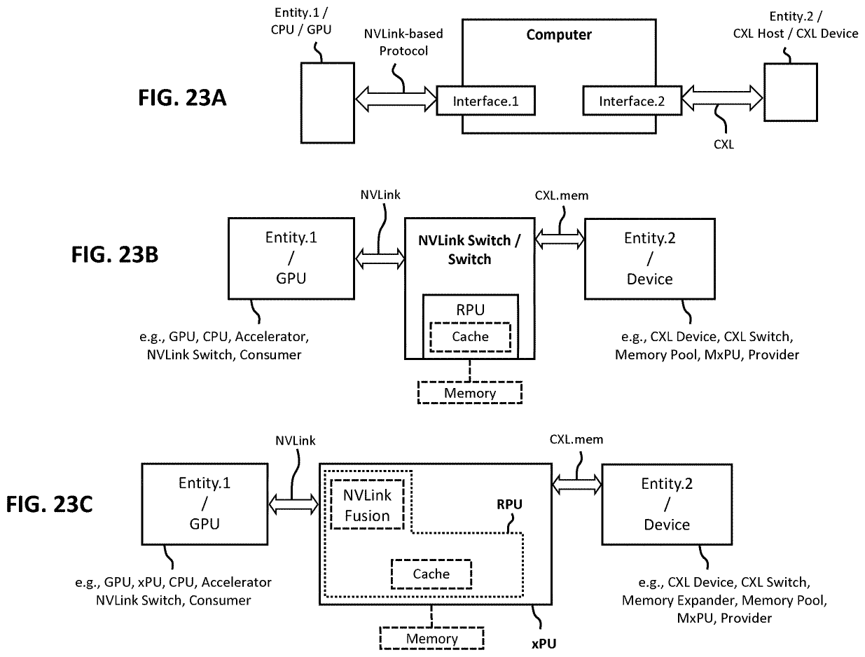

FIG. 23A illustrates an example of a system comprising a computer coupled between a first interface (Interface.1) and a second interface (Interface.2). Interface.1 may communicate according to an NVLink-based Protocol with a first entity (Entity.1), which may be a CPU or a GPU. Interface.2 may communicate according to CXL with a second entity (Entity.2), which may be a CXL host or a CXL device. The computer may extract addresses from requests received via the first interface, wherein these addresses may refer to a first address space, such as an NVLink-based address space, an NVLink-based network address space, or a GPU address space utilized by the first entity. The computer may further translate these addresses and generate requests carrying the translated addresses for transmission via the second interface, wherein the translated addresses may refer to a second address space utilized by the second entity. In other examples, the first address space and the second address space may be associated with the same address space, such as a common address space, a global address space, a pod address space, or a fabric address space. The computer may be implemented in an IC package having high-speed differential I/O balls positioned according to a ball grid array layout defined by a retimer specification. Optional switch(es), such as NVLink switches, may be positioned between the first interface and the first entity. Similarly, optional switch(es), such as CXL switches, may be positioned between the second interface and the second entity.

FIG. 23B illustrates an example of a system comprising an NVLink Switch, or Switch that includes an RPU and a Cache. The switch is coupled to a first entity (Entity.1), shown as a GPU, via an NVLink-based protocol, and to a second entity (Entity.2), shown as a Device, via CXL.mem. Entity.1 may be a GPU, CPU, Accelerator, NVLink Switch, or Consumer. Entity.2 may be a CXL Device, CXL Switch, Memory Pool, MxPU, or Provider. The switch may further be coupled to a Memory. The RPU within the switch may translate between NVLink-based requests received from the first entity and CXL.mem M2S requests transmitted to the second entity. The Cache within the switch may store data for reducing latency or accumulating data from multiple CXL.mem responses.

FIG. 23C illustrates an example of a system comprising a processor, such as an xPU, that includes an RPU that may include an NVLink Fusion chiplet or IP block. The RPU may further include a Cache, and may be coupled to a Memory. The RPU may be coupled, via the NVLink Fusion component, to a first entity (Entity.1) that may be a GPU, xPU, CPU, Accelerator, NVLink Switch, or Consumer. The RPU is coupled via CXL.mem to a second entity (Entity.2), shown as a Device. Entity.2 may be a CXL Device, CXL Switch, Memory Expander, Memory Pool, MxPU, or Provider. The NVLink Fusion chiplet may include the NVLink interface and may be part of the RPU, such that protocol translation between NVLink-based traffic and CXL.mem traffic may be performed within the NVLink Fusion chiplet. The NVLink Fusion chiplet may also include an NVLink PHY. In other examples, the NVLink interface and the RPU may be implemented as functional blocks on the same die with the xPU, or split between silicon dies or chiplets inside the IC package of the xPU.

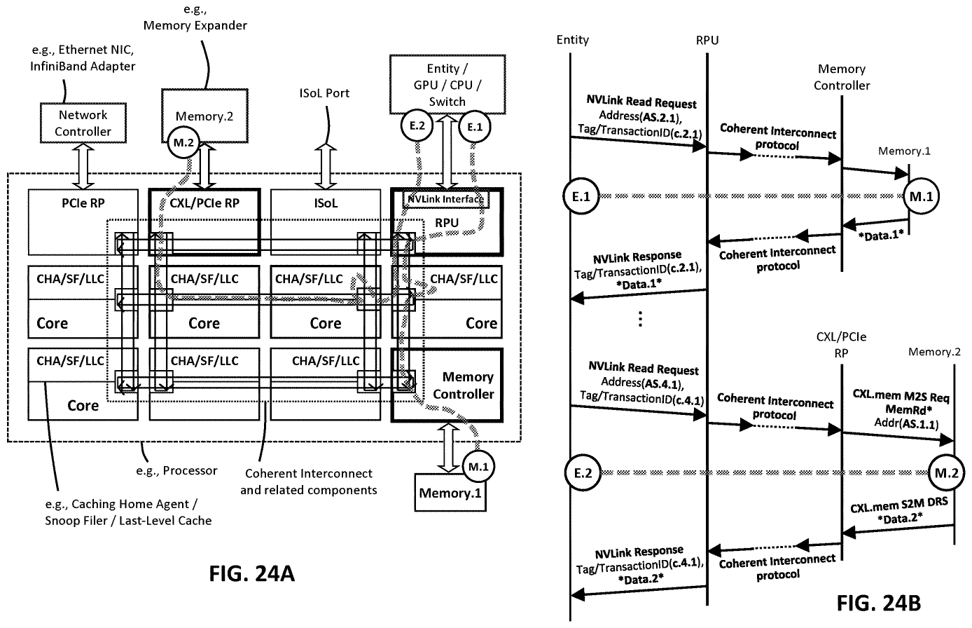

FIG. 24A illustrates an example of a system comprising a processor including a coherent interconnect, which may enable an external entity, such as a GPU, CPU, or Switch, to access memory resources mapped to an address space utilized by the coherent interconnect, such as via one or more of the two illustrated paths denoted as (E.1)-(M.1) and (E.2)-(M.2). The processor may include processing cores, and coherent interconnect, and related components, such as Caching Home Agent/Snoop Filter/Last-Level Cache (CHA/SF/LLC) slices. The processor may further include a PCIe RP coupled to a Network Controller (e.g., Ethernet NIC, InfiniBand Adapter), a CXL/PCIe RP coupled to a second memory (Memory.2, such as a Memory Expander), a memory controller coupled to a first memory (Memory.1), such as DRAM, and an ISoL port (e.g., utilizing NVIDIA NVLink-C2C, ARM CHI C2C, or Intel Coherent Processor Interconnect Protocol (ICPIP)). The processor includes an RPU coupled to an NVLink interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL/PCIe RP, such as over path (E.2)-(M.2). The illustrated RPU may be coupled to the coherent interconnect, and may translate between the NVLink-based protocol and a protocol utilized by the coherent interconnect. The processor may be implemented as a monolithic die, as chiplets within an IC package, or as components on a board, and may utilize a mesh-based coherent interconnect, or other types of coherent interconnects such as a ring, a crossbar, or a Network on Chip (NoC).

FIG. 24B illustrates an example of a TFD demonstrating two NVLink requests, such as NVLink read requests, received from an entity, such as a GPU or a CPU, processed by an RPU and forwarded, possibly using a protocol utilized by a coherent interconnect of a processor, to different memories that may be mapped to an address space utilized by the coherent interconnect. The paths from the RPU to the different memories may traverse other components, such as CHA/SF/LLC slices, memory controllers, or in other examples a home agent or a home node, optionally for resolving coherency. The RPU may perform physical address translations between first physical addresses, such as from GPU physical addresses or NVLink-based network addresses that may be carried in the NVLink requests, and second physical addresses, such as Host Physical Addresses (HPAs), which may refer to an address space utilized by the coherent interconnect, wherein the physical address translations may enable the entity to access the processor's memories. The processor may have multiple memory resources, such as first memory (Memory.1), which may be DRAM coupled to a memory controller of the processor, and/or second memory (Memory.2), which may be a CXL memory expander coupled to a CXL/PCIe RP of the processor. The RPU may further translate between NVLink-based requests and requests based on a protocol utilized by the coherent interconnect, and send the translated requests to the coherent interconnect, requesting read from memory. In some examples, the requested data may be provided by a processor cache, such as by an LLC, instead of by the memory. The data may then return over the coherent interconnect to the RPU, wherein the RPU may provide the data to the requesting entity via an NVLink response.

The TFD illustrates two exemplary transactions between the entity and the RPU, (Entity/GPU/CPU/Switch), processed by an RPU and forwarded via the coherent interconnect protocol to different memories. The TFD illustrates two exemplary transactions corresponding to two distinct memory read paths denoted as (E.1)-(M.1) and (E.2)-(M.2), each associated with a different physical address mapped to different memory resources. The first exemplary transaction (E.1) includes a first NVLink Read Request comprising Address(AS.2.1) and Tag/TransactionID(c.2.1). The RPU may translate the first NVLink request and forward the translated request via the Coherent Interconnect protocol, resulting in the retrieval of *Data.1* from the first memory (Memory.1) via the Memory Controller, wherein *Data.1* may be sent to the entity via the Coherent Interconnect protocol and via the RPU with the first NVLink Response comprising Tag/TransactionID(c.2.1) and *Data.1*.

The second exemplary transaction (E.2) includes a second NVLink Read Request comprising Address(AS.4.1) and Tag/TransactionID(c.4.1). The RPU may translate the second NVLink read request and may further translate the physical address (AS.4.1) carried in the second NVLink read request to a translated physical address (AS.1.1) which may refer to an address space utilized by the coherent interconnect. The RPU may forward the translated request, that may include the translated physical address (AS.1.1), via the coherent interconnect protocol, resulting in the retrieval of *Data.2* from the second memory (Memory.2) via the CXL/PCIe RP, utilizing a CXL.mem M2S request comprising MemRd* and Address(AS.1.1). The second memory (Memory.2) may respond with a CXL.mem S2M DRS comprising *Data.2*, which may be sent to the RPU via the coherent interconnect protocol. The RPU may then send *Data.2* to the entity via the second NVLink response. It is noted that the physical addresses (AS.2.1) and (AS.4.1) may refer to different memory regions within an address space, such as a GPU physical address space or an NVLink-based network address space, which may be exposed via an NVLink interface, enabling the entity to access memory resources based on the translation capabilities of the RPU.

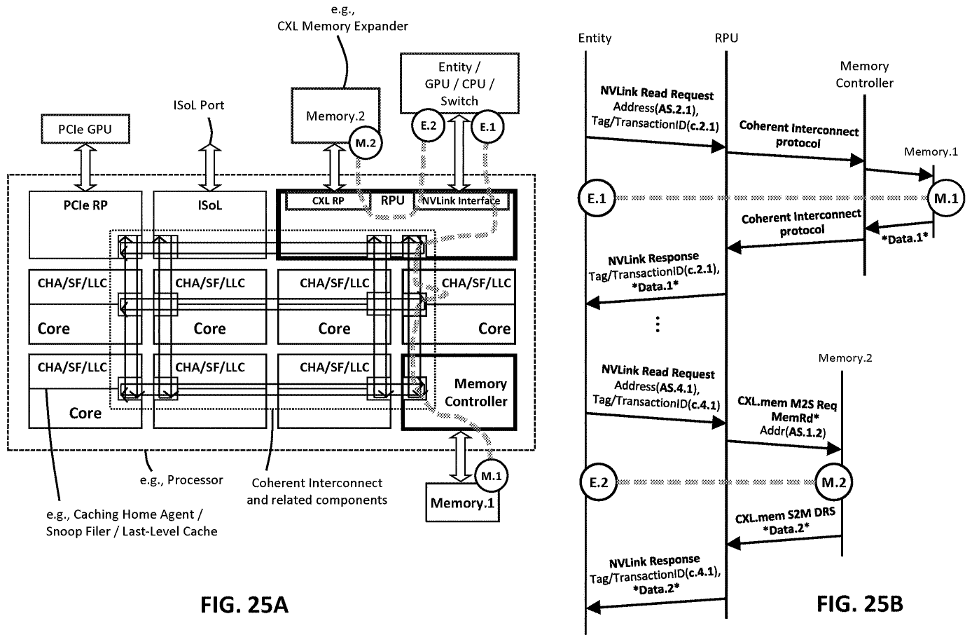

FIG. 25A illustrates an example of a system comprising a processor, including a coherent interconnect, capable of enabling an external entity, such as a GPU, CPU, or accelerator, to access memory resources mapped to an address space utilized by the coherent interconnect, such as via one or more of the two illustrated paths denoted as (E.1)-(M.1) and (E.2)-(M.2). The processor may include processing cores and CHA/SF/LLC, optionally implemented as distributed slices coupled to the coherent interconnect. The processor may further include a PCIe RP that may be coupled to a PCIe GPU, an ISoL port (e.g., utilizing NVLink-C2C, CHI C2C, or Intel Coherent Processor Interconnect Protocol (ICPIP), e.g., Intel UPI), and a Memory Controller coupled to a first memory (Memory.1). The processor includes an RPU that comprises a CXL RP, wherein the CXL RP is coupled to a second memory (Memory.2), such as a CXL Memory Expander. The RPU further includes an NVLink Interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL RP within the RPU, such as over path (E.2)-(M.2). The illustrated RPU and NVLink Interface are coupled to the coherent interconnect, and may translate between the NVLink-based protocol and a protocol utilized by the coherent interconnect. The processor may utilize a mesh-based coherent interconnect, or other types of coherent interconnects such as a ring, a crossbar, or a Network on Chip (NoC).

FIG. 25B illustrates an example of a TFD demonstrating two NVLink requests, such as NVLink read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations between first physical addresses, such as NVLink-based physical addresses, NVLink-based network addresses, or GPU physical addresses, and second physical addresses, such as Host Physical Addresses (HPAs) or System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between an NVLink-based protocol, such as a protocol utilizing an NVLink interconnect, and a protocol utilized by the coherent interconnect, wherein the RPU may send the optionally translated NVLink requests to the coherent interconnect, requesting reads from memory, such as from the first memory or from the second memory. Additionally or alternatively, the RPU may translate NVLink-based traffic to CXL-based traffic (e.g., CXL.mem), and send the translated NVLink traffic to the second memory via the CXL RP. In some examples, the requested data may be provided by a cache of the processor, such as by an LLC, instead of by the memory. The data may then return over the coherent interconnect to the RPU, wherein the RPU may provide an NVLink response to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first NVLink request comprising Address(AS.2.1) and Tag/TransactionID(c.2.1). The Tag/TransactionID may denote a Tag, a transaction Tag, a transaction identifier, or another field or set of fields carried in NVLink requests and/or NVLink responses, which may serve to associate the NVLink responses with the NVLink requests. The RPU may translate the first NVLink request and forward the translated request via the coherent interconnect protocol, resulting in the retrieval of *Data.1* from the first memory (Memory.1) via the memory controller, wherein *Data.1* may be sent to the entity via the coherent interconnect protocol and via the RPU with the first NVLink response. The second exemplary transaction corresponds to the memory read path denoted as (E.2)-(M.2), and may include a second NVLink request comprising Address(AS.4.1) and Tag/TransactionID(c.4.1). The RPU may translate the second NVLink request to a CXL.mem M2S request comprising MemRd* and translated Address(AS.1.2), wherein the RPU may send the translated request to the second memory (Memory.2) via the CXL RP. *Data.2* is retrieved from the second memory utilizing a CXL.mem S2M DRS, and sent to the RPU via the CXL RP, wherein the RPU may send *Data.2* to the entity via the second NVLink response.

In various implementations, a method for translating between Compute Express Link (CXL) messages, comprising: receiving a first CXL message from a first entity; identifying a cacheline state intent based on at least one of a first opcode, a Snoop Type (SnpType), a Metadata Field (MetaField), or a Metadata Value (MetaValue) of the first CXL message, wherein the cacheline state intent pertains to a cacheline address specified in the first CXL message; translating the first CXL message to a second CXL message comprising a second opcode selected based at least in part on the identified cacheline state intent, wherein the second opcode differs from the first opcode; and sending the second CXL message to a second entity. The first entity may include a first host, the second entity may include a second host, and the entities may communicate using CXL. The cacheline state intent may indicate a desired cache state, such as Modified, Exclusive, Shared, or Invalid (MESI) that an entity seeks to acquire or affect for the cacheline address. For CXL.cache messages, the intent may be derived from the opcode, such as SnpData, SnpInv, or SnpCur for H2D requests, or RdOwn, RdShared, or CLFlush for D2H requests. For CXL.mem messages, the intent may be derived from the opcode, the SnpType, or a combination thereof, wherein the SnpType may indicate No-Op, SnpInv, or SnpData snoop requirements. By identifying the intent from the incoming message, the translation logic may select an appropriate opcode for the outgoing message that achieves the desired cache state transition, wherein the selected opcode differs from the incoming opcode due to differences in protocol direction or protocol type. The method may be performed by an RPU, a semiconductor device, or other computing apparatus positioned between the first entity and the second entity.

In some implementations of the method, the first CXL message comprises a CXL.cache Host-to-Device (H2D) request, and the first opcode is selected from SnpData, SnpInv, or SnpCur; and wherein the second CXL message comprises a CXL.cache Device-to-Host (D2H) request, and the second opcode is selected from RdOwn, RdShared, RdOwnNoData, RdCurr, RdAny, or CLFlush. The translation from CXL.cache H2D request to CXL.cache D2H request may enable inter-host communication via a device positioned between the hosts, wherein the device may expose CXL.cache interfaces to each host. H2D requests comprise snoops, such as SnpData, SnpInv, or SnpCur that indicate different cacheline state intents, while D2H requests comprise read or cache operation opcodes such as RdOwn, RdShared, RdOwnNoData, RdCurr, or CLFlush that achieve the corresponding cache state transitions.

In some implementations of the method, the first opcode comprises SnpData, the second opcode is selected from RdShared or RdOwn, whereby RdShared is selected to enable both the first entity and the second entity to retain cached copies of the cacheline in shared state, and whereby RdOwn is selected to cause the second entity to relinquish ownership and provide cacheline data for exclusive state acquisition by the first entity. SnpData indicates a snoop request for a cacheline that is intended to be cached in either shared or exclusive state at the first entity. The translation logic may determine whether shared or exclusive state is desired based on additional context, system configuration, or bias state information. RdShared requests a cacheline to be cached in shared state, enabling concurrent caching by multiple entities. RdOwn requests a cacheline to be cached in exclusive or modified state, causing the second entity to relinquish ownership and provide cacheline data to the translation logic for forwarding to the first entity.

In some implementations of the method, the first opcode comprises SnpInv, the second opcode is selected from CLFlush, RdOwnNoData, or RdOwn, whereby CLFlush is selected to invalidate the cacheline at the second entity without data return, whereby RdOwnNoData is selected to acquire exclusive ownership of the cacheline without data return, and whereby RdOwn is selected to acquire exclusive ownership of the cacheline with cacheline data return from the second entity. SnpInv indicates a snoop request that invalidates the cacheline at the receiving device and signals intent to acquire exclusive state at the first entity. The translation logic may determine whether data transfer is required based on data caching policies associated with the translation logic, the first entity's cache state, pending write operations, or other context. CLFlush requests flushing of the cacheline at the second entity, which may include data return if the cacheline is in Modified state, and may be selected when invalidation of the second entity's cached copy is the primary intent. RdOwnNoData requests exclusive ownership without data return and may be selected when the first entity will overwrite the entire cacheline. RdOwn requests exclusive ownership with data return and may be selected when the first entity requires current cacheline contents before modification.

In some implementations of the method, the first opcode comprises SnpCur, the second opcode comprises RdCurr, and whereby the translation enables the first entity to obtain current cacheline data from the second entity without modifying cache states at either the first entity or the second entity. SnpCur indicates a snoop request to obtain the current version of the cacheline without requiring change of cache states in the hierarchy. RdCurr indicates a read request to get the most current data without changing the existing state in any cache. The translation from SnpCur to RdCurr may enable the first entity to read current data from the second entity without affecting cache coherency states, which may be useful for I/O data operations, such as I/O-coherent reads (e.g., I/O-coherency mode), monitoring, debugging, or speculative operations.

In some implementations of the method, the first CXL message comprises a CXL.cache Device-to-Host (D2H) request, and the first opcode is selected from RdOwn, RdOwnNoData, RdShared, RdCurr, or CLFlush; and wherein the second CXL message comprises a CXL.cache Host-to-Device (H2D) request, and the second opcode is selected from SnpData, SnpInv, or SnpCur based on the cacheline state intent indicated by the first opcode. The translation from CXL.cache D2H request to CXL.cache H2D request may enable inter-device communication, wherein a read request or cache operation from one device is translated to a snoop request targeting another device. The translation logic may map RdShared to SnpData when the intent is to acquire shared state with possible data return, may map RdOwn, CLFlush, or RdOwnNoData to SnpInv when the intent is exclusive ownership acquisition or invalidation, and may map RdCurr to SnpCur when the intent is non-state-changing data access.

In some implementations of the method, the first CXL message comprises a CXL.mem Master-to-Subordinate (M2S) request; and wherein the second CXL message comprises a CXL.cache Device-to-Host (D2H) request, and the second opcode is selected from RdOwn, RdOwnNoData, RdShared, RdCurr, RdAny, or CLFlush. The translation from CXL.mem M2S request to CXL.cache D2H request may enable memory access operations from a first entity utilizing CXL.mem to be translated into cache coherency operations targeting a second entity utilizing CXL.cache. A set of fields in the M2S request, which may include SnpType, MetaField, or MetaValue, may indicate the cacheline state intent, which may be utilized to select an appropriate D2H request opcode. The translation logic may bridge between the CXL.mem and CXL.cache domains while preserving the intent of the memory operation.

In some implementations of the method, the CXL.mem M2S request comprises the SnpType and the MetaValue, the CXL.cache D2H request comprises the second opcode, and the second opcode is selected based on the SnpType and the MetaValue. The combination of SnpType and MetaValue in the M2S request may provide finer-grained indication of the cacheline state intent than SnpType alone. For example, an M2S request with SnpType indicating SnpData and MetaValue indicating Shared(S) may result in selection of RdShared. The translation logic may utilize both fields to determine the appropriate D2H request opcode.

In some implementations of the method, the CXL.mem M2S request comprises the SnpType that comprises SnpCur, and the CXL.cache D2H request comprises the second opcode that comprises RdCurr. The SnpCur to RdCurr translation may enable requests for a non-cacheable but current value of a cacheline, such as for I/O-coherent reads. The M2S request may further include MetaValue indicating Invalid (I) to indicate that the requester will not cache the line. RdCurr may retrieve the most current data from the second entity without causing state transitions in any cache. Upon receiving a response, such as a CXL.cache H2D Data, the computer may translate the response to a CXL.mem S2M DRS comprising MemData and a CXL.mem S2M NDR comprising Cmp.

In some implementations of the method, the CXL.mem M2S request comprises the SnpType that comprises SnpData, and the CXL.cache D2H request comprises the second opcode that comprises RdShared. The SnpData to RdShared translation may enable the requester to acquire a cacheline in shared state, permitting concurrent caching by multiple entities. The M2S request may further include MetaValue indicating Shared(S) to indicate the host may have at most a shared copy of the line. Upon receiving a response from the second entity, which may include a CXL.cache H2D response comprising GO-S, the computer may translate the response to a CXL.mem S2M NDR comprising Cmp-S, providing an indication for Shared state.

In some implementations of the method, the CXL.mem M2S request comprises the SnpType that comprises SnpInv, and the CXL.cache D2H request comprises the second opcode that comprises RdOwn. The SnpInv to RdOwn translation may enable the requester to acquire exclusive ownership of a cacheline, causing the second entity to relinquish any cached copies. The M2S request may further include MetaValue indicating Any (A) to indicate the host may have a shared, exclusive, or modified copy of the line. Upon receiving a response from the second entity, which may include a CXL.cache H2D response comprising GO-E or GO-M, the computer may translate the response to a CXL.mem S2M NDR comprising Cmp-E, providing an indication for Exclusive ownership.

In some implementations of the method, the second opcode is selected based on the SnpType as follows: RdOwn or RdOwnNoData is selected when the SnpType indicates SnpInv for exclusive ownership acquisition with or without data return respectively, CLFlush is selected when the SnpType indicates SnpInv for cacheline invalidation without ownership acquisition, and RdShared is selected when the SnpType indicates SnpData for shared state acquisition. The SnpType in the M2S request may indicate SnpInv for invalidation snoops or SnpData for data snoops. When SnpType indicates SnpInv, the translation logic may select RdOwn if data return is required, RdOwnNoData if exclusive ownership without data is sufficient, or CLFlush if invalidation is needed. When SnpType indicates SnpData, the translation logic may select RdShared to acquire the cacheline in shared state. This mapping enables CXL.mem operations to be properly coordinated with CXL.cache coherency.

In some implementations of the method, the first CXL message comprises a CXL.cache Device-to-Host (D2H) request, and the first opcode is selected from RdOwn, RdShared, RdCurr, RdAny, or CLFlush; and wherein the second CXL message comprises a CXL.mem Master-to-Subordinate (M2S) request comprising MemRd* and a second SnpType. The translation from CXL.cache D2H request to CXL.mem M2S request may enable cache coherency operations from a first entity utilizing CXL.cache to be translated into memory access operations targeting a second entity utilizing CXL.mem. The D2H request opcode may indicate the cacheline state intent, which may be utilized to select an appropriate SnpType value for the M2S request. For example, a D2H request comprising RdOwn may be translated to an M2S request comprising MemRd with SnpType set to SnpInv, while a D2H request comprising RdShared may be translated to an M2S request comprising SnpType set to SnpData.

In some implementations of the method, the CXL.cache D2H request comprises the first opcode, and the second SnpType is set based on the cacheline state intent indicated by the first opcode. The translation logic may analyze the first opcode to determine the cacheline state intent and set the second SnpType accordingly. For example, RdOwn may indicate intent to acquire exclusive state, resulting in SnpType being set to SnpInv, while RdShared may indicate intent to acquire shared state, resulting in SnpType being set to SnpData. This intent-based translation may enable CXL.cache operations to be properly coordinated with CXL.mem coherency semantics.

In some implementations of the method, the CXL.cache D2H request comprises the first opcode that comprises RdCurr, and the CXL.mem M2S request comprises the second SnpType that comprises SnpCur. The RdCurr to SnpCur translation may enable requests for a non-cacheable but current value of a cacheline via the CXL.mem interface. The M2S request may further include MetaField indicating MS0 and MetaValue indicating Invalid (I) to indicate that the requester may not cache the line. Upon receiving a response from the second entity, which may include a CXL.mem S2M DRS comprising MemData and a CXL.mem S2M NDR comprising Cmp, the computer may translate the response to a CXL.cache H2D Data for delivery to the first entity.

In some implementations of the method, the CXL.cache D2H request comprises the first opcode comprising RdShared, and the CXL.mem M2S request comprises the second SnpType comprising SnpData. The RdShared to SnpData translation may enable the CXL.cache requester to acquire a cacheline in shared state via the CXL.mem interface. The M2S request may further include MetaField indicating MS0 and MetaValue indicating Shared(S). Upon receiving a response from the second entity, which may include a CXL.mem S2M NDR comprising Cmp-S providing an indication for Shared state, the computer may translate the response to a CXL.cache H2D response comprising GO-S and a CXL.cache H2D Data comprising the cacheline data.

In some implementations of the method, the CXL.cache D2H request comprises the first opcode comprising RdOwn, and the CXL.mem M2S request comprises the second SnpType comprising SnpInv. The RdOwn to SnpInv translation may enable the CXL.cache requester to acquire exclusive ownership of a cacheline via the CXL.mem interface, typically receiving the cacheline in Exclusive or Modified state. The M2S request may further include MetaField indicating MS0 and MetaValue indicating Any (A). Upon receiving a response from the second entity, which may include a CXL.mem S2M NDR comprising Cmp-E providing an indication for Exclusive ownership, the computer may translate the response to a CXL.cache H2D response comprising GO-E and a CXL.cache H2D Data comprising the cacheline data.

In some implementations, the method further comprises maintaining a mapping between cacheline state intents and corresponding opcodes for the second CXL message, wherein the cacheline state intent indicates whether the first entity seeks to acquire a cache state that permits concurrent caching by other entities, a cache state that requires exclusive ownership, or invalidation of the cacheline at the second entity; and wherein the translating comprises utilizing the mapping to select the second opcode to achieve the indicated cache state transition at the second entity. The mapping may be implemented as a lookup table, combinational logic, or programmable translation function that associates each cacheline state intent with one or more candidate opcodes for the second CXL message. The cacheline state intent may be categorized as shared state acquisition (permitting concurrent caching), exclusive state acquisition (requiring the second entity to relinquish cached copies), or invalidation (causing the second entity to discard cached copies without ownership transfer). The translation logic may utilize the mapping to select an opcode that achieves the desired cache state transition while considering additional context such as whether data return is required.

In some implementations, the method further comprises receiving, from the second entity, a response message indicating a cache state based on at least one of a third opcode or cacheline data included in the response message; translating the response message to a translated response message comprising a fourth opcode selected based on the cache state indicated by the response message; wherein the fourth opcode differs from the third opcode; and sending the translated response message to the first entity. The response message may include a CXL.cache H2D response such as GO-M, GO-E, GO-S, or GO-I indicating Modified, Exclusive, Shared, or Invalid (MESI) cacheline state, respectively. The translation logic may select an opcode for the translated response message, such as a CXL.cache D2H response comprising RspIHitI, RspSHitSE, RspIFwdM, or similar, which communicates the resulting cacheline state to the first entity. The translation may utilize a previously stored identifier mapping to correctly route the response back to the originating transaction.

In some implementations of the method, the cache state indicated by the response message indicates shared state, exclusive state, or modified state; and wherein the fourth opcode is selected as follows: RspSHitSE is selected when the third opcode indicates GO-S for shared state to communicate that the cacheline is available in shared state, RspIHitI or RspIHitSE is selected when the third opcode indicates GO-E for exclusive state to communicate that the cacheline is no longer present in the cache abstraction, and RspIFwdM is selected when the third opcode indicates GO-M for modified state to communicate that modified data is being forwarded. The GO-S indication signifies that the second entity is providing the cacheline in shared state, permitting concurrent caching by multiple entities, and the translation logic may select RspSHitSE to indicate to the first entity that the cacheline was hit in a clean state and its current state is shared. The GO-E indication signifies that the second entity has granted exclusive ownership, and the translation logic may select RspIHitI or RspIHitSE to indicate that the cacheline is no longer present in the cache abstraction. The GO-M indication signifies that the second entity previously held the cacheline in modified state and is relinquishing ownership along with modified data, and the translation logic may select RspIFwdM to indicate that modified data is being forwarded.

In some implementations, the method further comprises exposing a cache abstraction to the first entity, wherein the cache abstraction appears to the first entity as a device cache accessible via CXL transactions, whereby the cache abstraction acts as a proxy for cache resources maintained by the second entity, and wherein the first entity issues CXL messages targeting the cache abstraction that are translated to outgoing CXL messages affecting actual caches in the second entity based on the identified cacheline state intent. The cache abstraction may be exposed as a CXL Type-1 or CXL Type-2 device interface that the first entity may enumerate and interact with as a local device cache. The first entity may issue CXL messages, such as snoop requests, that target the cache abstraction, wherein the translation logic may identify the cacheline state intent from these messages and translate them to appropriate outgoing CXL messages that affect actual caches in the second entity. This proxy arrangement may enable cache coherency operations between entities that cannot communicate directly due to protocol direction constraints or address space differences.

In some implementations of the method, the translating enables cacheline state orchestration between a first cache maintained by the first entity and a second cache maintained by the second entity; wherein the cacheline state orchestration enables the first entity to affect cache states in the second cache through the translated second CXL message, and indicates transitions between at least two states selected from Modified, Exclusive, Shared, or Invalid (MESI) according to a cache coherency protocol. Cacheline state orchestration may encompass coordinated transitions between various cache states according to MESI or similar cache coherency protocols. The translation logic may enable the first entity to cause invalidation, downgrade, or ownership transfer of cachelines in the second entity's cache hierarchy by translating the first entity's CXL messages into appropriate CXL messages for the second entity.

In some implementations of the method, the cacheline state orchestration further enables cache-coherent memory sharing between the first entity and the second entity by allowing both entities to access shared memory resources while maintaining data consistency. The translation logic may track pending transactions and coordinate state transitions to maintain coherency invariants across both cache hierarchies, enabling cache-coherent memory sharing in disaggregated memory systems, multi-GPU clusters, heterogeneous computing platforms, or other multi-entity architectures.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, a system comprising: a computer configured to: receive, from a first entity, a first Compute Express Link (CXL) message; identify a cacheline state intent based on at least one of a first opcode, a Snoop Type (SnpType), a Metadata Field (MetaField), or a Metadata Value (MetaValue) of the first CXL message, wherein the cacheline state intent pertains to a cacheline address specified in the first CXL message; translate the first CXL message to a second CXL message comprising a second opcode selected based at least in part on the identified cacheline state intent, wherein the second opcode differs from the first opcode; and send the second CXL message to a second entity. The computer may include processing logic, memory for storing translation tables and transaction state, and interface controllers for managing CXL communications with each entity. The system may be implemented as a standalone device, integrated into a larger semiconductor component, or distributed across multiple components within a computing platform. The translation capabilities may enable diverse system architectures such as disaggregated memory systems, multi-host configurations, multi-GPU clusters, or heterogeneous computing platforms.

In some implementations of the system, the computer is included within a semiconductor device comprising a first CXL.cache interface configured to receive CXL.cache Host-to-Device (H2D) requests from the first entity and a second CXL.cache interface configured to send CXL.cache Device-to-Host (D2H) requests to the second entity; wherein the semiconductor device is positioned between the first entity and the second entity to enable inter-entity communication based on translating snoops received from the first entity to read or cache operation opcodes sent to the second entity based on the identified cacheline state intent. The semiconductor device may be implemented as an ASIC, FPGA, SoC, RPU, or other integrated circuit technology. The first CXL.cache interface may receive H2D requests comprising snoops such as SnpData, SnpInv, or SnpCur, and the second CXL.cache interface may send D2H requests comprising opcodes such as RdOwn, RdShared, RdOwnNoData, or CLFlush selected based on the cacheline state intent. Each interface may include physical layer circuits, link layer controllers, and protocol layer engines specifically designed for CXL.cache communication.

In some implementations of the system, the first CXL message comprises a CXL.mem Master-to-Subordinate (M2S) request, the second CXL message comprises a CXL.cache Device-to-Host (D2H) request, and wherein the computer is configured to bridge between CXL.mem and CXL.cache by identifying the cacheline state intent, based on at least one of the SnpType or the first opcode, and selecting an opcode for the D2H request that achieves a corresponding cache state transition at the second entity. The computer may be configured to bridge between CXL.mem and CXL.cache domains, enabling memory access operations from entities utilizing CXL.mem to be coordinated with cache coherency operations targeting entities utilizing CXL.cache. The system may analyze SnpType values to determine whether SnpInv or SnpData is indicated, and may select corresponding D2H request opcodes such as RdOwn, RdOwnNoData, CLFlush, or RdShared to achieve the intended cache state transition. This bridging capability may enable heterogeneous systems where different entities utilize different CXL protocols.

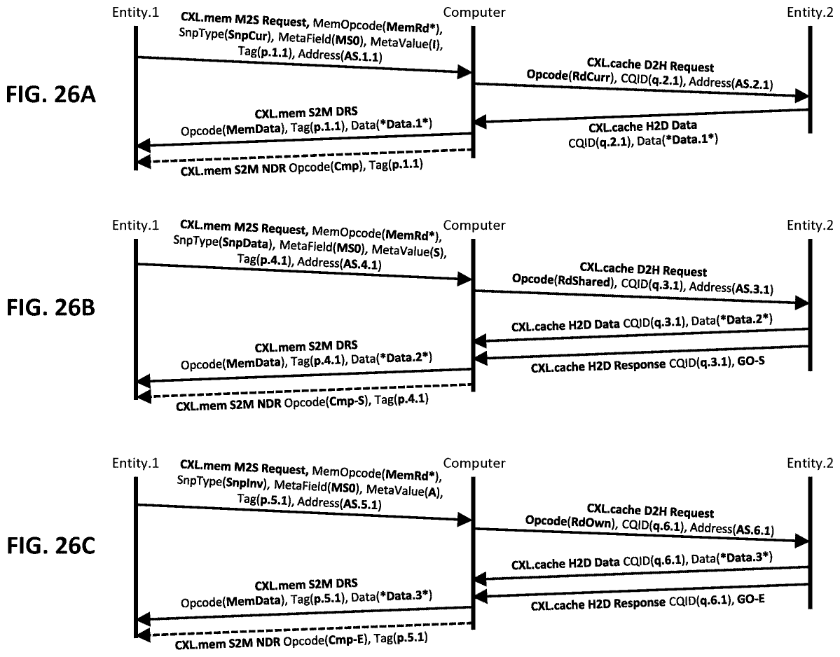

FIG. 26A illustrates an example of a TFD demonstrating intent-based translations between CXL.mem messages received from a first entity (Entity.1), such as a first host (Host.1), and CXL.cache messages sent to a second entity (Entity.2), such as a second host (Host.2), possibly enabling the first entity to access resources mapped to an address space utilized by the second entity. The first entity may initiate a CXL.mem transaction that may include a CXL.mem M2S request comprising MemOpcode(MemRd*), SnpType(SnpCur), MetaField(MS0), MetaValue(I), Tag(p.1.1), and Address(AS.1.1), wherein the CXL.mem M2S request may indicate an intent to request a non-cacheable but current value of a cacheline. The computer may perform intent-based translation between the CXL.mem domain and the CXL.cache domain, by translating the CXL.mem transaction to a CXL.cache transaction that may include a CXL.cache D2H request comprising Opcode(RdCurr), CQID(q.2.1), and Address(AS.2.1), wherein the CXL.cache D2H request may indicate a corresponding intent to request a non-cacheable but current value of a cacheline by utilizing RdCurr. The computer may send the CXL.cache D2H request to the second entity. Upon receiving a response from the second entity, which may include a CXL.cache H2D Data comprising CQID(q.2.1) and Data(*Data.1*), the computer may translate the CXL.cache H2D Data to a CXL.mem S2M DRS comprising Opcode(MemData), Tag(p.1.1), and Data(*Data.1*), and may further translate the CXL.cache H2D Data to a CXL.mem S2M NDR comprising Opcode(Cmp) and Tag(p.1.1). The computer may perform further translations, such as address translations, translations between CXL.mem Tags and CXL.cache CQIDs, translations between reserved fields, and/or opcode translations, e.g., translating between CXL.mem M2S request opcodes, such as MemRd*, and CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed.

FIG. 26B illustrates an example of a TFD demonstrating intent-based translations wherein a first entity may initiate a CXL.mem transaction that may include a CXL.mem M2S request comprising MemOpcode(MemRd*), SnpType(SnpData), MetaField(MS0), MetaValue(S), Tag(p.4.1), and Address(AS.4.1), wherein the CXL.mem M2S request may indicate an intent to request a shared copy of the cacheline. A computer may perform intent-based translation between the CXL.mem domain and the CXL.cache domain, and may translate the CXL.mem transaction to a CXL.cache transaction that may include a CXL.cache D2H request comprising Opcode(RdShared), CQID(q.3.1), and Address(AS.3.1), wherein the CXL.cache D2H request may indicate a corresponding intent to request a cacheline to be cached in shared state by utilizing RdShared. The computer may send the CXL.cache D2H request to a second entity. Upon receiving a response from the second entity, which may include a CXL.cache H2D Data comprising CQID(q.3.1) and Data(*Data.2*), and may further include CXL.cache H2D response comprising CQID(q.3.1) and GO-S, the computer may translate the CXL.cache H2D Data to a CXL.mem S2M DRS comprising Opcode(MemData), Tag(p.4.1), and Data(*Data.2*), and may further translate the CXL.cache H2D response to a CXL.mem S2M NDR comprising Opcode(Cmp-S) and Tag(p.4.1), wherein Cmp-S may provide an indication from the DCOH to the first entity for Shared state.

FIG. 26C illustrates an example of a TFD demonstrating intent-based translations wherein a first entity may initiate a CXL.mem transaction that may include a CXL.mem M2S request comprising MemOpcode(MemRd*), SnpType(SnpInv), MetaField(MS0), MetaValue(A), Tag(p.5.1), and Address(AS.5.1), wherein the CXL.mem M2S request may indicate an intent to request an exclusive copy of the cacheline. A computer may perform intent-based translation between the CXL.mem domain and the CXL.cache domain, and may translate the CXL.mem transaction to a CXL.cache transaction that may include a CXL.cache D2H request comprising Opcode(RdOwn), CQID(q.6.1), and Address(AS.6.1), wherein the CXL.cache D2H request may indicate a corresponding intent to request a cacheline to be cached in any writeable state by utilizing RdOwn, typically receiving the cacheline in Exclusive (GO-E) or Modified (GO-M) state, and wherein the computer may send the CXL.cache D2H request to a second entity. Upon receiving a response from the second entity, which may include a CXL.cache H2D Data comprising CQID(q.6.1) and Data(*Data.3*), and may further include a CXL.cache H2D response comprising CQID(q.6.1) and GO-E, the computer may translate the CXL.cache H2D Data to a CXL.mem S2M DRS comprising Opcode(MemData), Tag(p.5.1), and Data(*Data.3*), and may further translate the CXL.cache H2D response to a CXL.mem S2M NDR comprising Opcode(Cmp-E) and Tag(p.5.1), wherein Cmp-E may provide an indication from the DCOH to the first entity for Exclusive ownership.

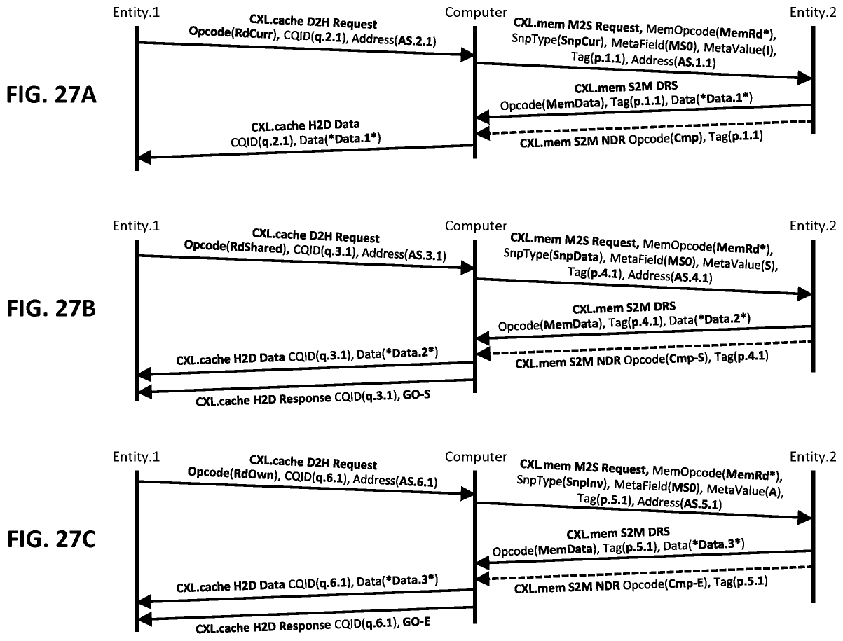

FIG. 27A illustrates an example of a TFD demonstrating intent-based translations between CXL.cache messages received from a first entity (Entity.1), such as a first device (Device.1), and CXL.mem messages sent to a second entity (Entity.2), such as a second device (Device.2), possibly enabling the first entity to access resources mapped to an address space utilized by the second entity. The first entity may initiate a CXL.cache transaction that may include a CXL.cache D2H request comprising Opcode(RdCurr), CQID(q.2.1), and Address(AS.2.1), wherein the CXL.cache D2H request may indicate an intent to request a non-cacheable but current value of a cacheline by utilizing RdCurr.

The computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpCur), MetaField(MS0), MetaValue(I), Tag(p.1.1), and Address(AS.1.1). The CXL.mem M2S request may indicate a corresponding intent to request a non-cacheable but current value of a cacheline. The computer may send the CXL.mem M2S request to the second entity. Upon receiving a response from the second entity, which may include a CXL.mem S2M DRS comprising Opcode(MemData), Tag(p.1.1), and Data(*Data.1*), and may further include a CXL.mem S2M NDR comprising Opcode(Cmp) and Tag(p.1.1), the computer may translate the CXL.mem S2M DRS to a CXL.cache H2D Data comprising CQID(q.2.1) and Data(*Data.1*). The computer may perform further translations, such as address translations, translations between CXL.cache CQIDs and CXL.mem Tags, translations between reserved fields, and/or opcode translations, e.g., translating between CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed, and CXL.mem M2S request opcodes, such as MemRd*.

FIG. 27B illustrates an example of a TFD demonstrating intent-based translations wherein a first entity may initiate a CXL.cache transaction that may include a CXL.cache D2H request comprising Opcode(RdShared), CQID(q.3.1), and Address(AS.3.1), wherein the CXL.cache D2H request may indicate an intent to request a cacheline to be cached in shared state by utilizing RdShared. A computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpData), MetaField(MS0), MetaValue(S), Tag(p.4.1), and Address(AS.4.1), wherein the CXL.mem M2S request may indicate a corresponding intent to request a shared copy of the cacheline, and wherein the computer may send the CXL.mem M2S request to the second entity. Upon receiving a response from the second entity, which may include a CXL.mem S2M DRS comprising Opcode(MemData), Tag(p.4.1), and Data(*Data.2*), and may further include a CXL.mem S2M NDR comprising Opcode(Cmp-S) and Tag(p.4.1), the Cmp-S may provide an indication from the DCOH to the computer for Shared state. The computer may translate the CXL.mem S2M DRS to a CXL.cache H2D Data comprising CQID(q.3.1) and Data(*Data.2*), and may further translate the CXL.mem S2M DRS and/or the CXL.mem S2M NDR to a CXL.cache H2D response comprising CQID(q.3.1) and GO-S.

FIG. 27C illustrates an example of a TFD demonstrating intent-based translations wherein a first entity may initiate a CXL.cache transaction that may include a CXL.cache D2H request comprising Opcode(RdOwn), CQID(q.6.1), and Address(AS.6.1), wherein the CXL.cache D2H request may indicate an intent to request a cacheline to be cached in any writeable state by utilizing RdOwn, typically receiving the cacheline in Exclusive (GO-E) or Modified (GO-M) state. A computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpInv), MetaField(MS0), MetaValue(A), Tag(p.5.1), and Address(AS.5.1), wherein the CXL.mem M2S request may indicate a corresponding intent to request an exclusive copy of the cacheline, and wherein the computer may send the CXL.mem M2S request to a second entity. Upon receiving a response from the second entity, which may include a CXL.mem S2M DRS comprising Opcode(MemData), Tag(p.5.1), and Data(*Data.3*), and may further include a CXL.mem S2M NDR comprising Opcode(Cmp-E) and Tag(p.5.1), the Cmp-E may provide an indication from the DCOH to the computer for Exclusive ownership. The computer may translate the CXL.mem S2M DRS to a CXL.cache H2D Data comprising CQID(q.6.1) and Data(*Data.3*), and may further translate the CXL.mem S2M DRS and/or the CXL.mem S2M NDR to a CXL.cache H2D response comprising CQID(q.6.1) and GO-E.

In various implementations, a system comprising: a processor comprising a coherent interconnect; the processor is coupled to memory having a capacity of at least 64 GB; wherein the processor is configured to utilize physical addresses within a Host Physical Address (HPA) space to access the memory, and to execute an operating system (OS) that utilizes a virtual address space; a memory management unit (MMU) configured to enable access to the memory based on mapping addresses within the virtual address space to physical addresses within the HPA space; a resource provisioning unit (RPU) comprising a Compute Express Link (CXL) device configured to communicate with an entity according to a protocol based on CXL; and wherein the RPU is further coupled to the coherent interconnect and configured to perform host-to-host physical address translations, whereby the host-to-host physical address translations enable the entity to access the memory via the CXL device. The OS may utilize the MMU for virtual to physical address mapping to access the memory, wherein the MMU translates OS-level virtual addresses to physical addresses within the HPA space. Processes, applications and user programs executing under the control of the OS may utilize the MMU to access the memory utilizing virtual addresses while the MMU enforces memory protection and isolation between different processes or applications. Device drivers operating within the OS kernel space may utilize the MMU for accessing memory-mapped device registers and for managing DMA buffers. When the processor supports virtualization, hypervisors may utilize the MMU to manage memory mappings for virtual machines (VMs), wherein hypervisors and/or guest OSs may further utilize the MMU to manage memory mappings for processes within the VMs, optionally supporting nested virtualization that may include multiple levels of address translations. In some examples, an MMU may translate from addresses within a physical address space, such as a Guest Physical Address (GPA) space, to addresses within another physical address space, such as an HPA space. Infrastructure code or firmware running on hidden cores may utilize the MMU for accessing memory regions allocated for infrastructure tasks such as memory telemetry collection or memory pool management operations. And hardware components such as DMA engines within the system may utilize the MMU or IOMMU functionality to perform address translations when moving data between different memory regions.

The processor, MMU, and RPU may be implemented as a semiconductor device that combines processing capabilities with memory pooling functionality. The processor may be a multi-core processor based on x86, ARM, RISC-V, or other instruction set architectures, and may include various levels of cache hierarchy. The HPA space utilized by the processor is the physical address space the processor utilizes to access the memory. The RPU may be implemented as dedicated hardware logic, firmware running on dedicated cores, or a combination thereof, and may maintain translation tables or use programmable mappings to convert between different HPA spaces used by external entities and the local HPA space of the processor.

Optionally, the messages received by the RPU, such as the messages conforming to the CXL protocol, may include additional messages that do not carry HPA, and such messages may be processed by the RPU without performing host-to-host physical address translations. Additionally or alternatively, the RPU may further process additional messages that carry virtual addresses instead of host physical addresses, and the messages carrying host physical addresses may coexist with other types of messages that may be processed differently by the RPU, such that the description of messages carrying host physical addresses does not limit the presence or processing of other types of messages that may be communicated with the entity and through the processor. Furthermore, the RPU may apply different processing methods to different types of messages according to their content and/or requirements, which may include forwarding messages without modification, modifying message contents without performing address translations, or performing other types of translations or modifications that may differ from the above described host-to-host physical address translations.

In some implementations of the system, the entity utilizes a second HPA space, and the host-to-host physical address translations translate physical addresses within the second HPA space to physical addresses within the HPA space. The second HPA space utilized by the entity may have a different size, layout, or addressing scheme compared to the HPA space utilized by the processor. The host-to-host physical address translations may include offset calculations, range remapping, or lookup table operations to convert addresses between the two HPA spaces. The RPU may support configurable translation windows that define which portions of the entity's HPA space are mapped to the processor's HPA space, and may implement protection logic to prevent unauthorized access to memory regions outside the allocated ranges.

In some implementations, the system further comprises a CXL root port configured to communicate with a CXL memory expander that utilizes a Device Physical Address (DPA) space; and wherein at least one of the operating system, system firmware, or the memory expander is configured to map between physical addresses within the HPA space and physical addresses within the DPA space, which enable the entity to utilize the memory and/or the CXL memory expander. The CXL memory expander may be a CXL type-3 device that provides additional memory capacity to the system. The DPA space of the memory expander represents the device-local physical addresses used internally by the expander. The OS or system firmware may maintain mapping tables that associate HPA ranges with DPA ranges of the memory expander, enabling transparent access to the expanded memory. Additionally or alternatively, HPA to DPA mapping may further be maintained by the memory expander, such as via internal firmware, software, or hardware of the expander.

In some implementations of the system, the RPU further comprises a second CXL device configured to communicate with a second entity utilizing a second protocol based on CXL, whereby the second entity utilizes a third HPA space; and wherein the RPU is further configured to translate physical addresses within the third HPA space to physical addresses within the HPA space, which enable the second entity to utilize the CXL memory expander. The system may support multiple entities accessing the CXL memory expander utilizing coordinated address translations. Different entities may have their own portions of the memory expander's capacity utilizing separate HDM regions or virtual CXL devices exposed by the RPU. Additionally or alternatively, the memory expander may expose multiple HDM regions, or may expose multiple logical devices (LDs), which may be mapped via RPU translations to multiple entities. The RPU may maintain separate translation contexts for separate entities, ensuring that memory accesses from different entities are properly isolated while still allowing shared access to designated memory regions when configured for multi-entity sharing. The system may implement Quality-of-Service (QoS) mechanisms to fairly allocate memory expander bandwidth among multiple entities.

In some implementations of the system, the RPU further comprises a second CXL device configured to communicate with a second entity utilizing a second protocol based on CXL, whereby the second entity utilizes a third HPA space, and the RPU is further configured to translate physical addresses within the third HPA space to physical addresses within the HPA space, which enable the second entity to utilize the memory. When supporting multiple entities accessing the memory (e.g., DRAM), the system may implement memory partitioning schemes to allocate specific memory regions to different entities. The RPU may enforce access controls to enable entities to access only their respective allocated memory regions. The system may support dynamic reallocation of memory between entities based on workload demands or administrative policies, and may implement memory tiering and migration capabilities to move data between different entities'allocated regions such as when workload access patterns change or reconfiguration occurs.

In some implementations of the system, the entity comprises a host coupled to the processor via at least one of a CXL root port or a CXL switch, and the second protocol based on CXL is different from the protocol based on CXL. Supporting different CXL protocols for different entities may enable heterogeneous system configurations wherein entities with varying capabilities can utilize or share the memory pool. For example, one entity may use CXL.mem for simple memory expansion while another entity uses CXL.cache for cache-coherent shared memory. The RPU may maintain protocol-specific state machines and translation logic for different supported protocol combinations, enabling interoperability between entities using different CXL protocol subsets.

In some implementations of the system, the processor comprises a modified processing unit (MxPU), the memory comprises dynamic random-access memory (DRAM), and the RPU enables the entity to utilize DRAM having a capacity of at least 256 GB of the DRAM. The MxPU may be derived from an established CPU or GPU design with modifications to support CXL device functionality and host-to-host address translations. The large DRAM capacity (≥256 GB) may be achieved through multiple memory channels supporting high-capacity DRAM modules. The MxPU may implement memory compression, deduplication, or other techniques to effectively increase the usable memory capacity exposed to entities beyond the physical DRAM capacity.

In some implementations of the system, the memory comprises dynamic random-access memory (DRAM) that is coupled via memory channels to the processor, and the CXL device comprises a Global Fabric-Attached Memory (G-FAM) Device (GFD). The memory channels may include channels transmitting in parallel to increase memory bandwidth and reduce latency. The memory channels may support one or more DRAM modules, such as DIMMs or RDIMMs, and may implement various memory technologies including DDR4, DDR5, LPDDR4, LPDDR5, or future memory standards. The memory channels may include memory controllers integrated within the processor or implemented as separate components within the system, and may support features such as ECC, memory interleaving, and channel bonding for improved performance and reliability.

In some implementations of the system, the protocol based on CXL utilizes CXL.mem, and the CXL device exposes at least one Host-managed Device Memory (HDM) address region to the entity. When operating according to CXL.mem, the CXL device (such as CXL EP) may expose one or more HDM regions that appear as memory-mapped regions to the coupled entity. The HDM regions may be configured with specific address ranges, access permissions, and memory attributes through HDM decoders. The entity may access these HDM regions using standard memory load/store operations, which are translated by the entity's CXL root port into CXL.mem transactions. The system may support HDM regions with different characteristics, such as volatile memory regions backed by the memory and persistent memory regions backed by storage-class memory.

In some implementations of the system, the protocol based on CXL utilized CXL.io, and the host-to-host physical address translation translates from physical addresses carried in CXL.io UIOMRd Transaction Layer Packets (TLPs) received from the entity to physical addresses within the HPA space. When operating according to CXL.io, the system may process various types of TLPs including memory read/write TLPs, configuration TLPs, and message TLPs. The UIOMRd TLPs may carry physical addresses within the entity's physical address space that require translation to the local HPA space. The RPU may intercept these TLPs, extract the physical addresses, perform the applicable translations, and generate corresponding transactions in the local HPA space. The system may also support other CXL.io transaction types such as UIOMWr for memory writes and may implement flow control and credit management according to CXL specifications.

In some implementations of the system, the processor comprises cores, from which at least one is a hidden core; and wherein the RPU is further configured to utilize the hidden core for internal tasks, wherein the internal tasks comprise at least one of internal firmware processing, CXL Fabric Manager (FM) API processing, processing in memory (PIM), near-memory processing, or housekeeping tasks. The RPU may utilize at least one hidden core for internal tasks, which may include processing internal firmware, handling CXL Fabric Manager (FM) API processing, processing in memory (PIM), near-memory processing, and/or performing housekeeping tasks. By utilizing hidden cores to these specific functions, the processor may improve its performance and enable efficient operation without overburdening non-hidden cores that may be allocated to running user workloads. Additionally, utilizing the hidden core(s) for the RPU tasks can allow a CPU vendor to differentiate the processor from other CPUs while maintaining compatibility with existing/established designs, applications, and software code base that was developed for established CPUs.

In some implementations of the system, the hidden core is isolated from user access and visibility, providing user-infrastructure isolation. The processor's hidden core(s) may be isolated from user access and visibility, providing user-infrastructure isolation. This isolation ensures that the user cannot affect the execution of code on the hidden cores, enhancing the security and reliability of the system. By separating the visible user-controlled cores from the hidden vendor-controlled cores, the processor can effectively protect critical infrastructure functions from undesired interference or tampering by potentially malicious user code.

In some implementations of the system, the processor comprises cores, from which at least one is hidden and is utilized for collection of memory telemetry. At least one of the processor's hidden core(s) may be utilized to collect memory telemetry. By running memory telemetry on the hidden core(s), the system can effectively monitor and manage memory resources, such as memory resources in a memory pool, without burdening the user-accessible cores, which allows for efficient resource utilization and prevents memory management tasks from interfering with user code execution.

In some implementations of the system, the processor comprises cores, from which at least one is a hidden core utilized for secure key storage and management for encrypting and decrypting data transmitted according to the protocol based on CXL, leveraging user-infrastructure isolation provided by the hidden core. At least one of the processor's hidden core(s) may be utilized to secure key storage and management, specifically for encrypting and decrypting data transmitted according to the protocol based on CXL. By leveraging the user-infrastructure isolation provided by the hidden core(s), the system prevents sensitive cryptographic keys used for securing data transmitted according to the protocol based on CXL from being accessible to user code. This isolation enhances the security of the data transmitted between the processor and the entity, protecting it from potential compromise by malicious user code. The hidden core(s) may perform the cryptographic operations on the data themselves, improving confidentiality, integrity, and/or replay protection. Alternatively, the hidden core(s) may utilize hardware-accelerated cryptographic engine(s) for performing at least part of the cryptographic operations on the data, while the hidden core(s) remain responsible for the management of the secure keys and for controlling the processing flows of the data. In this approach, the cryptographic accelerator may handle the data processing while the hidden core(s) handle the control, following a Control/Data Plane separation. Furthermore, the infrastructure code running on the hidden core(s) may participate in enabling support for confidential computing over memory exposed/provisioned by the RPU via the CXL device of the system.

In some implementations, the system further comprises a hardware-accelerated cryptographic engine, wherein the hidden core is configured to utilize the hardware-accelerated cryptographic engine for performing at least part of the cryptographic operations on the data transmitted according to the protocol based on CXL. The system may include one or more hardware-accelerated cryptographic engines that can be utilized by the hidden core(s) for performing at least part of the cryptographic operations on the data transmitted according to the protocol based on CXL. The hidden core(s) are responsible for managing the secure keys and controlling the processing flows of the data, while the cryptographic engine(s) handle the actual data processing. This approach features control/data plane separation, wherein the hidden core(s) act as the control plane, and the cryptographic engines serve as the data plane. By offloading the computationally intensive cryptographic operations to hardware accelerators, the system may achieve higher performance and efficiency in securing the data transmitted according to the protocol based on CXL.

In some implementations of the system, the hidden core enables support for confidential computing over memory exposed by the RPU via the CXL device; whereby confidential computing performs computation within a secure isolated environment to protect data in use. The hidden core(s) of the processor may support confidential computing over memory exposed/provisioned by the RPU via the CXL device. Confidential computing is a security paradigm that aims to protect data in use by performing computation within a secure, isolated environment, such as a Trusted Execution Environment (TEE). In Confidential computing, data remains encrypted and confidential even during processing, protecting sensitive information from unauthorized access, modification, or disclosure. This may be achieved utilizing a combination of hardware-based security features, such as encrypted memory regions and secure enclaves, and optional software-based logic that enforce access controls and data isolation. By enabling computation on encrypted data without exposing the plaintext contents, confidential computing provides a higher level of security and privacy compared to traditional computing models that only protect data at rest and in transit. The infrastructure code running on the hidden core(s) participates in setting up and managing the secure environment required for confidential computing, including provisioning encrypted memory regions, managing encryption keys, and keeping sensitive data protected from unauthorized access. By leveraging the user-infrastructure isolation provided by the hidden core(s), the system can create a trusted execution environment for confidential computing, enabling secure processing of sensitive data within the memory exposed by the RPU utilizing the protocol based on CXL.

In some implementations of the system, the processor comprises cores, from which at least one core is a hidden core; and wherein the RPU is further configured to utilize the hidden core for error handling and/or correction tasks within a memory pool comprising the memory, enhancing data integrity and reliability. The error handling and correction tasks performed by hidden cores may include detecting and correcting single-bit and multi-bit errors, managing spare memory regions for replacing faulty memory locations, and maintaining error logs for system analysis. The hidden cores may implement scrubbing routines (e.g., patrol scrub) that periodically read and correct memory contents to prevent error accumulation. The system may support various error correction codes and advanced ECC schemes suitable for large-scale memory pools.

In some implementations of the system, the error handling and/or correction tasks further comprise predictive failure analysis (PFA) operations, configured to predict and handle imminent failure of memory components within the memory pool, thereby preempting potential data loss and system downtime. The error handling and correction tasks may include predictive failure analysis operations designed to anticipate and address imminent failures of memory components within the memory pool. By implementing the PFA, the system may proactively identify potential faults before they manifest into actual failures, enabling timely interventions that mitigate the risk of data loss and system downtime. The PFA may not only enhance the reliability and data integrity of the memory system but also improve overall system resilience in high-performance computing architectures.

In some implementations of the system, the memory comprises dynamic random-access memory (DRAM), and the processor comprises cores, from which at least one core is a hidden core; and wherein the RPU is further configured to utilize the hidden core for controlling or managing memory access scheduling within a memory pool comprising the DRAM, to improve memory utilization and throughput. Memory access scheduling controlled or managed by hidden cores, such as via utilizing a hardware-based memory controller or a memory access scheduler managed by hidden cores, may optimize memory bandwidth utilization by reordering memory requests based on factors such as request priority, memory bank availability, and access patterns. The hidden cores may implement and apply scheduling algorithms that consider Quality-of-Service (QoS) requirements, minimize memory access conflicts, and maximize row buffer hit rates. The scheduling may also account for thermal constraints and power management goals while maintaining fair access for the memory pool clients.

In some implementations of the system, the processor comprises cores, from which at least one core is a hidden core; and wherein the RPU is further configured to utilize the hidden core for managing security protocols within a memory pool comprising the memory, including data encryption and/or access controls. Security protocol management by hidden cores may include encryption algorithms for data at rest and in transit, managing security keys and certificates, and enforcing access control policies. The hidden cores may support various security standards such as CXL Integrity and Data Encryption (IDE) for protecting data transmitted over CXL links. The memory pool may include secure enclaves or trusted execution environments to protect sensitive data and cryptographic operations from unauthorized access.

In some implementations of the system, the processor comprises cores, from which at least one core is a hidden core; and wherein the RPU is further configured to utilize the hidden core for configuration management tasks within a memory pool comprising the memory, including dynamic allocation and deallocation of memory resources. In further examples, one or more of the hidden cores of the processor may be utilized for advanced infrastructure management tasks within a memory pool based on the processor and the memory. These tasks may include one or more of: (i) error handling and correction, which enhances data integrity and reliability by promptly addressing memory errors, (ii) memory access scheduling, which improve the allocation and utilization of memory resources based on current demand and operational priorities, (iii) security management, which secures the memory pool by implementing robust encryption and access controls to safeguard data, and/or (iv) configuration management, which dynamically adjusts memory settings to adapt to varying workload requirements. One or more of these tasks may be employed to maintain the overall efficiency, security, and/or performance of the system, such as in environments requiring high-speed, high-integrity memory operations, thereby enhancing the system's capabilities and distinguishing it from architectures based on conventional CPU/GPU (where CPU/GPU refers to CPU and/or GPU).

In some implementations of the system, the processor comprises cores, from which at least one core is a hidden core; and wherein the RPU is further configured to utilize the hidden core for memory tiering tasks. Memory tiering tasks performed by hidden cores may include classifying memory regions into different performance tiers based on their underlying technology characteristics. The hidden cores may monitor access patterns to different memory regions, such as via utilizing hardware-based telemetry collectors and analyzers, and dynamically adjust tier assignments to optimize overall system performance. The system may support various memory technologies and/or speeds in different tiers, such as high-bandwidth DRAM (e.g., MRDIMMs) in tier 1, ordinary DRAM (e.g., RDIMMs) in tier 2, and persistent memory or storage-class memory (SCM) in lower tiers.

In some implementations of the system, the memory tiering tasks further comprise migration of data between memory tiers based on hotness level of the data, thereby increasing performance of memory accesses from the entity to hot data. The hidden core(s) of the processor may enable support for memory tiering, wherein memory regions or subsets of memory regions exposed to entities, may be mapped to memory resources based on parameters such as the hotness of the data in these memory regions, e.g., the frequency at which the data is used. In some implementations, the hidden core(s) may utilize memory telemetry to map hot data to higher-performance memory tiers, whereas colder data may be mapped to slower memory such as Flash memory coupled to the processor. In other implementations, the hidden core(s) may utilize memory mapping based on priority or Service-Level Agreement (SLA) associated with the data, e.g., in cases wherein the system is configured to prioritize particular workloads, virtual machines, users, or tenants, that utilize the data. Yet in other implementations, the hidden core(s) may migrate data between memory tiers, such as migrating hot data from a lower-performance memory tier to a higher-performance memory tier.

In some implementations, the system further comprises a direct Memory Access (DMA) engine, wherein the hidden core is configured to utilize the DMA engine for migrating data between memory tiers. The hidden core(s) of the processor may utilize a DMA engine for data migration between memory tiers, offloading the data movement task from the hidden core(s) to a dedicated engine, thereby providing faster migration of data and freeing the hidden core(s) to perform additional tasks.

In various examples, hidden cores are isolated from the user's access and visibility, while visible cores are available for user utilization. This isolation may be achieved utilizing different techniques, such as utilizing Type 1 hypervisors, Type 2 hypervisors, hardware partitioning, software partitioning, asymmetric multiprocessing (AMP), firmware configuration, CPU microcode updates, custom CPUs, security extensions, and/or a combination thereof.

In a first example, a Type 1 hypervisor may be utilized to create hidden and visible cores. A Type 1 hypervisor, such as VMware ESXi or Microsoft Hyper-V, runs on the hardware and manages virtual machines (VMs). The hypervisor can allocate specific processing cores to VMs using techniques such as CPU affinity or core pinning. For instance, certain cores may be designated as hidden and assigned to a VM that is not accessible or visible to the user. These hidden cores may run system management tasks or specialized applications such as CXL memory management or memory pool operations, while the visible cores are allocated to user-accessible VMs running general-purpose operating systems (GPOS). The hypervisor prevents the user from direct access to the hidden cores, maintaining isolation.

In a second example, a Type 2 hypervisor may be utilized to achieve similar isolation. A Type 2 hypervisor, such as VMware Workstation or Oracle VirtualBox, runs on a host OS and supports guest OSes, wherein the host OS manages the visible cores accessible to the user. The Type 2 hypervisor can then create additional VMs using hidden cores, which run separate OSes or specialized tasks. The overhead of the Type 2 hypervisor is higher compared to a Type 1 hypervisor, but it may provide additional flexibility in managing user-visible and hidden cores.

In a third example, hardware partitioning, also known as hardware-assisted virtualization in some systems, may be utilized to divide processing cores to isolated partitions at the hardware level, wherein the isolated partitions run different operating systems. It may be used in various scenarios wherein isolation between partitions is required, including high-reliability and safety-critical systems. For instance, one partition with hidden cores may run an RTOS or embedded OS for critical system functions, while another partition with visible cores runs a GPOS for user applications. Hardware partitioning enables isolation, as the partitions are managed by the hardware, preventing user access to the hidden cores.

In a fourth example, software partitioning, such as the Jailhouse hypervisor, may be utilized to create isolated partitions while offering lower overhead compared to full virtualization. This approach allocates specific cores to different partitions, wherein hidden cores may run dedicated tasks or specialized applications. For example, Jailhouse can configure certain cores to run an RTOS or bare-metal applications, isolating them from user access; and visible cores can run a GPOS that is available for user applications.

In a fifth example, Asymmetric Multiprocessing (AMP) may be utilized to run different OSes on different cores without a hypervisor. In this configuration, certain cores may run an RTOS or embedded OS, while other cores may run a GPOS. Communication between the operating systems may be achieved utilizing shared memory or inter-process communication logic. For instance, Linux may run on the visible cores for user applications, while an RTOS may run on the hidden cores for real-time tasks. AMP provides a straightforward method to isolate hidden cores from user access while leveraging the specific strengths of different operating systems.

In a sixth example, firmware configuration may be utilized to achieve hidden and visible cores. By accessing the Basic Input/Output System (BIOS) or the Unified Extensible Firmware Interface (UEFI) settings, certain CPU cores can be disabled, making them invisible to the OS. While this method can prevent the OS from utilizing the disabled cores, it is noted that depending on the example, these cores may still be accessible utilizing other means, such as hardware debugging interfaces, and these changes may not be persistent (e.g., rebooting the system could reset the BIOS/UEFI settings, making the hidden cores visible again). Therefore, depending on the specific requirements, additional measures may be necessary to provide complete isolation of the hidden cores.

In a seventh example, CPU microcode updates provided by the hardware vendor may be employed. These updates can include specific instructions to disable or hide cores at the microcode level, preventing their detection or usage by the operating system. This method provides a secure way to manage core visibility, as the updates are controlled by the CPU manufacturer.

In an eighth example, custom CPU designed by hardware vendors can be utilized, which include technologies and mechanisms that enable core partitioning and management of core visibility. For example, Intel's Resource Director Technology (RDT) allows for the partitioning of CPU resources, while ARM's Big. LITTLE architecture enables heterogeneous multi-processing, wherein different types of cores can be used for different purposes. These vendor-specific examples provide control over core allocation and maintain certain cores hidden from the user.

In a ninth example, security extensions such as Intel's Trusted Execution Technology (TXT) or ARM's TrustZone may be used. These technologies create secure execution environments that isolate specific cores for security-sensitive operations. The hidden cores may only be accessible within the secure environment, protecting them from user interference and enabling secure execution of critical tasks.

In various implementations, a method comprising: accessing memory coupled to a processor utilizing physical addresses within a Host Physical Address (HPA) space; wherein the processor comprises a coherent interconnect; mapping addresses within a virtual address space to physical addresses within the HPA space; whereby the addresses within the virtual address space are utilized by an operating system (OS) of an apparatus comprising the processor; communicating, by a Compute Express Link (CXL) device of a resource provisioning unit (RPU), with an entity coupled to the apparatus according to a protocol based on CXL; wherein the RPU is coupled to the coherent interconnect; and performing, by the RPU, host-to-host physical address translations which enable the entity to access the memory via the CXL device.

In some implementations of the method, the entity comprises a second host that utilizes a second HPA space, and the host-to-host physical address translations are translating physical addresses within the second HPA space to physical addresses within the HPA space.

In some implementations, the method further comprises communicating, via a CXL root port, with a CXL memory expander that utilizes a Device Physical Address (DPA) space; and wherein at least one of the operating system or system firmware is mapping between physical addresses within the HPA space and physical addresses within the DPA space, whereby the mapping enables the second host to utilize the memory and/or the CXL memory expander.

In various implementations, an apparatus comprising: a processor comprising a coherent interconnect; the processor is coupled to memory having a capacity of at least 64 GB; wherein the processor is configured to utilize physical addresses within a first Host Physical Address (HPA) space to access the memory, and to execute an operating system (OS) that utilizes a virtual address space; a memory management unit (MMU) configured to enable access to the memory, based on mapping addresses within the virtual address space to physical addresses within the first HPA space; a resource provisioning unit (RPU), coupled to a Compute Express Link (CXL) device configured to exchange messages conforming to a protocol based on CXL which utilizes a second HPA space; and wherein the RPU is further coupled to the coherent interconnect and configured to translate physical addresses within the second HPA space to physical addresses within the first HPA space.

In various implementations, a system designed to function as a Multi-Headed Device (MHD), comprising: a processor comprising a coherent interconnect; the processor is coupled to dynamic random-access memory (DRAM) having a capacity of at least 32 GB; wherein the processor is configured to utilize physical addresses within a Host Physical Address (HPA) space to access the DRAM, and to execute an operating system (OS) that utilizes a virtual address space; a memory management unit (MMU) configured to enable access to the DRAM, based on mapping addresses within the virtual address space to physical addresses within the HPA space; first and second Compute Express Link (CXL) endpoints configured to communicate with hosts coupled to the system according to a protocol based on CXL; and a resource provisioning unit (RPU) configured to perform host-to-host physical address translations which enable the hosts to access the DRAM utilizing messages conforming to the protocol based on CXL.

The CXL Specification revision 3.2 defines a Multi-Headed Device (MHD) in section 2.5 as a CXL type-3 device with CXL ports, referred to as heads. The CXL specification currently defines two types of MHDs that are distinguished by how they present themselves on each head: (i) a MH-SLD, which presents Single Logical Devices (SLDs) on the heads, and has a 1:1 mapping between heads and LDs, and (ii) a MH-MLD, which may present Multi-Logical Devices (MLDs) on any of their heads, wherein a head in a Multi-Headed Device has at least one and no more than 16 Logical Devices mapped.

In some implementations of the system, the DRAM is coupled via at least four memory channels to the processor; wherein the DRAM has a memory capacity exceeding 128 GB, 256 GB, 512 GB, or 1 TB; and wherein the DRAM comprises mainstream DRAM modules exhibiting an average unit price per gigabyte that does not exceed three times an average unit price per gigabyte of a lowest-cost DRAM module technology in volume production for servers in data centers.

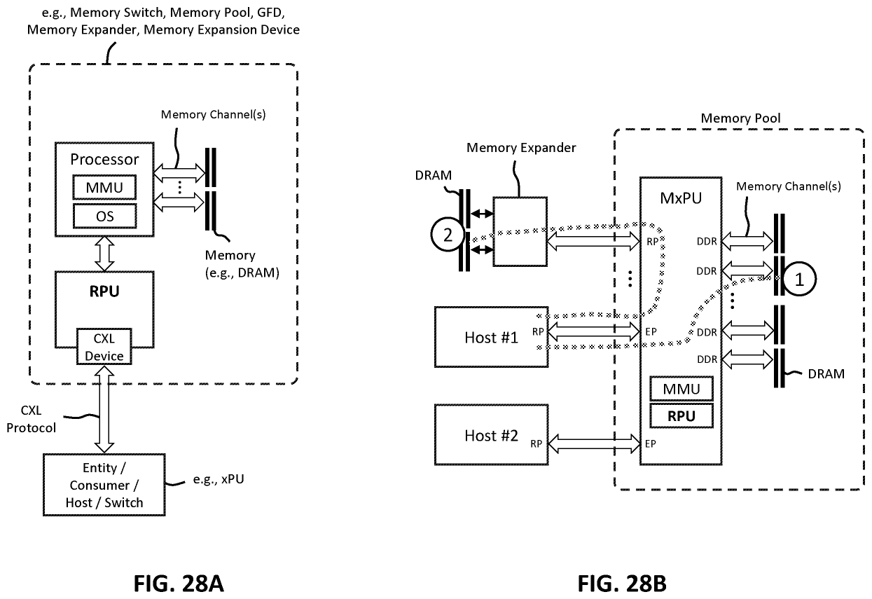

FIG. 28A illustrates an example of a system comprising a memory switch, a memory pool, a Global Fabric-Attached Memory (GFAM) Device (GFD), a memory expander (ME), or a memory expansion device, which comprise a processor, memory (such as DRAM), and an RPU coupled to an entity such as a host. The processor may include processing cores and cache hierarchies that utilize a first HPA space for accessing system resources. The memory may be coupled to the processor via memory channels, such as DDR4 or DDR5 channels, providing high-bandwidth memory access. The RPU may include, or be coupled to, a CXL device (such as a CXL EP), and may be integrated within the same semiconductor device as the processor or implemented as a separate component. The RPU may perform physical address translations between the entity's HPA space and the processor's physical address space. The entity may be coupled to the memory pool via the CXL device that supports one or more CXL protocols, enabling the entity to access the memory based on the address translations performed by the RPU.

FIG. 28B illustrates an example of a system comprising a memory pool coupled to hosts and to a memory expander, wherein the memory pool is based on a processor (such as an MxPU) comprising an RPU and CXL devices. The memory pool may include memory tiers, such as a first memory tier (denoted as “1”) comprising DRAM coupled via memory channels to the MxPU, and a second memory tier (denoted as “2”) comprising DRAM associated with the memory expander. The MxPU may include a CXL RP for coupling to the memory expander, enabling the memory pool to extend its capacity beyond the directly attached DRAM. Multiple hosts may be coupled to the memory pool via separate CXL devices (such as CXL EPs) within the MxPU, wherein the hosts utilize their respective HPA spaces. The RPU within the MxPU may perform different host-to-host physical address translations for the different coupled hosts, enabling concurrent access to both memory tiers while maintaining isolation between different hosts'physical address spaces.

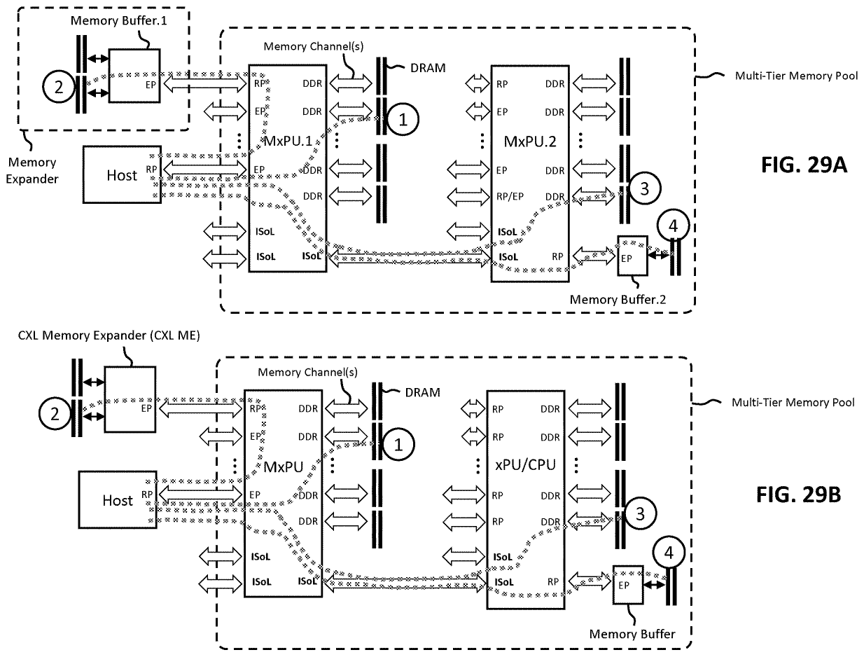

FIG. 29A illustrates an example of a system comprising a memory pool comprising two or more MxPUs. The memory pool may utilize a chipset-based architecture wherein a collection of electronic components such as MxPUs, xPUs, CPUs, and memory buffers, works together on a platform for realizing a memory pool functionality. The memory pool may include memory tiers, such as a first memory tier (denoted as “1”) comprising DRAM coupled via memory channels to the first MxPU, a second memory tier (denoted as “2”) comprising DRAM associated with the memory expander coupled to the first MxPU, a third memory tier (denoted as “3”) comprising DRAM coupled via memory channels to the second MxPU, and a fourth memory tier (denoted as “4”) coupled to the memory buffer that is coupled to the second MxPU. The MxPUs may be interconnected via an ISoL, such as UPI, Infinity Fabric, or CHI C2C, enabling coherent communication between the MxPUs. Each MxPU may include its own RPU for performing host-to-host physical address translations and CXL devices (such as CXL EPs) for coupling to external hosts, allowing at least some of the external hosts to access the distributed memory resources across memory tiers. The memory buffers may provide additional memory capacity and may include buffer control logic for managing data flow between different memory tiers.

FIG. 29B illustrates an example of a system comprising a memory pool comprising at least one MxPU and at least one xPU (that may be a CPU). The memory pool may utilize a chipset-based architecture. The memory pool may include memory tiers, such as a first memory tier (denoted as “1”) comprising DRAM coupled to the MxPU, a second memory tier (denoted as “2”) comprising DRAM associated with the memory expander coupled to the MxPU, a third memory tier (denoted as “3”) comprising DRAM coupled to the xPU/CPU, and a fourth memory tier (denoted as “4”) coupled to the memory buffer. The MxPU may include CXL devices (such as CXL EPs) and serve as the primary interface for external hosts to access the memory pool via protocols based on CXL, while the xPU/CPU may provide additional processing capabilities and memory resources. The RPU within the MxPU may coordinate address translations to enable external hosts to access memory resources across the tiers, including memory attached to the xPU/CPU. This example may optimize cost and performance by combining specialized MxPUs for memory pooling with established xPUs/CPUs for processing tasks and additional memory capacity.

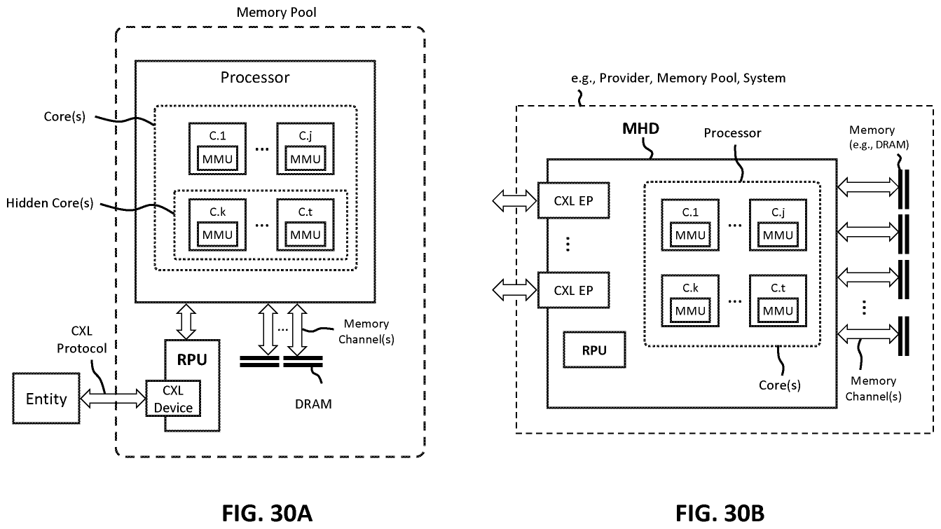

FIG. 30A illustrates an example of a system comprising a memory pool comprising a processor, DRAM, and an RPU. The RPU may include or be coupled to a CXL device. The RPU performs host-to-host physical address translations that enable an entity, external to the memory pool, to access the DRAM coupled to the processor. The processor may include cores, wherein some of the cores may be hidden from the user and may serve for executing infrastructure tasks related to operations, administration and management (OAM) of the memory pool.

FIG. 30B illustrates an example of a system comprising a memory pool comprising a CXL Multi Headed Device (MHD), such as Multi-Headed Single Logical Device (MH-SLD) or Multi-Headed Multi-Logical Device (MH-MLD), comprising a processor coupled to DRAM. The processor includes one or more processing cores wherein each processing core may include an MMU. The MHD further comprises CXL endpoints, wherein at least some of the endpoints may be associated with logical devices such as SLDs or MLDs, and an RPU configured to perform host-to-host physical address translations that enable entities external to the MHD to access the DRAM. Optionally, some of the illustrated blocks may be omitted, combined, or implemented as discrete chiplets, IP blocks, or firmware-assisted logic. The number and type of cores is implementation-dependent and may include general-purpose CPUs, vector engines, AI accelerators, or heterogeneous combinations thereof. In alternative or additional examples, one or more cores execute processing-in-memory (PIM) operations, for example, reductions, searches, or machine-learning kernels, against data resident in the DRAM, thereby reducing link bandwidth consumption. By virtue of the address-translation logic in the RPU, the MHD can expose the DRAM as a shared or partitionable pool that is accessible by entities via the CXL endpoints, which enables memory pooling, memory sharing, multi-tenant isolation, and/or dynamic capacity provisioning within a CXL-based system.

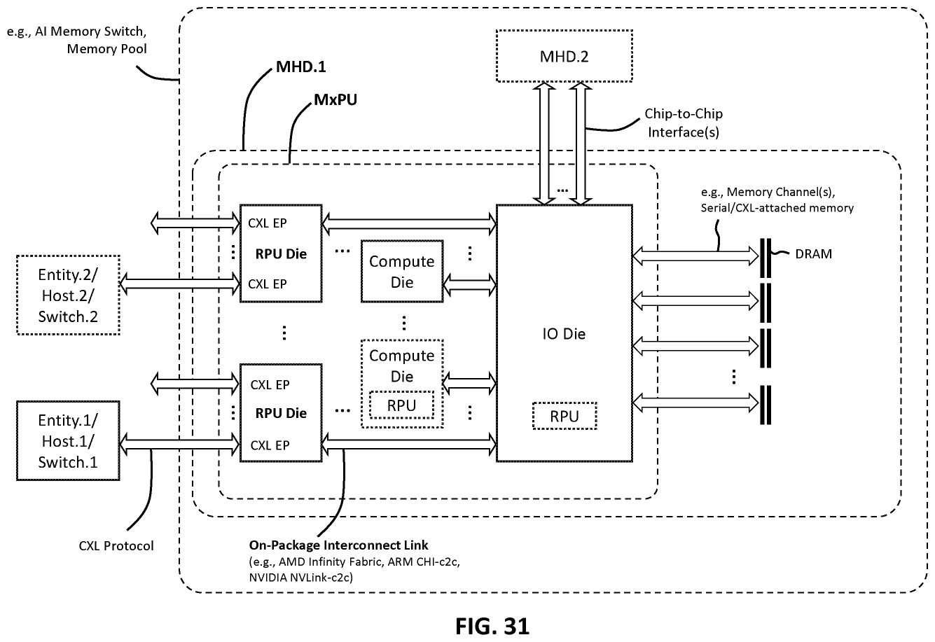

FIG. 31 illustrates an example of a system comprising an AI memory switch or a memory pool, comprising a CXL Multi Headed Device (MHD) coupled to two external entities. The memory pool may include additional MHDs coupled to additional entities. The memory pool may utilize a chipset-based architecture wherein a collection of electronic components such as MxPUs, xPUs, CPUs, and memory buffers, works together on a platform for realizing a memory pool functionality. The MHD comprises an MxPU coupled to DRAM, wherein the DRAM may be internal to the MHD, such as mounted on a PCB alongside the MxPU, possibly within an MHD enclosure, or the DRAM may be external to the MHD, such as in pluggable memory modules (e.g., EDSFF). The MxPU may be derived from an established processor design, such as a CPU design that utilizes a combination of at least one compute die and at least one I/O die that may communicate with each other utilizing an on-package interconnect such as AMD Infinity Fabric, ARM CHI C2C, or NVIDIA NVLink-C2C. An RPU, optionally implemented in a separate die/chiplet, or embedded into an I/O die and/or into a compute die, performs host-to-host physical address translations that enable entities coupled to the memory pool via the CXL endpoints to access the DRAM coupled to the MxPU. The MxPU may include one or multiple chip-to-chip interfaces, such as ISoL, that may provide interconnection of multiple MxPU instances in various topologies to create a larger logical MHD, a distributed MHD, or a memory pool that may serve additional external entities and provide larger memory capacities. The chip-to-chip interface may utilize the same communication protocol utilized by the on-package interconnect links, such as AMD Infinity Fabric, ARM CHI C2C, or NVIDIA NVLink-C2C. Processing cores in the MxPU, optionally hidden cores utilized for infrastructure tasks, may provide Processing In Memory (PIM) services to data residing in the DRAM.

Datacenter workloads in domains such as GenAI inference, LLM training, and distributed analytics may require memory resources that span across racks and pods within a datacenter fabric. Conventional CXL implementations rely on PCIe physical layers, which may constrain deployment distances and limit the ability to leverage existing IEEE 802.3-based datacenter network infrastructure for memory disaggregation. Some implementations provide architectural solutions that enable CXL semantics to traverse physical layers based on IEEE 802.3 PMA, wherein an RPU translates between data received via the physical layer and CXL requests, enabling external entities to access memory resources across different physical address spaces. The RPU may bridge between an external physical address space utilized by the transmissions and a local physical address space utilized by the processing cores and memory controllers, thereby facilitating memory pooling, sharing, and tiering over datacenter network fabric at both intra-rack and inter-pod scales.

In various implementations, an apparatus comprising: an integrated circuit package (IC package) comprising processing cores comprising instruction caches; wherein the processing cores are coupled via a coherent interconnect to a memory controller, and are configured to respond to snoop requests that utilize physical addresses within a first physical address space; a memory management unit (MMU), coupled to the processing cores, configured to translate virtual addresses to physical addresses within the first physical address space; memory channels capable of supporting memory having a capacity of at least 64 GB; a physical layer, based on IEEE 802.3 physical medium attachment (PMA), configured to receive transmissions comprising data indicative of Compute Express Link (CXL) opcodes and physical addresses within a second physical address space; and a resource provisioning unit (RPU) configured to translate the data to CXL requests; whereby the translate of the data enables an entity external to the apparatus to read the memory via the physical layer based on IEEE 802.3 PMA, the memory controller, and the memory channels. The apparatus may represent a processor or system-on-chip (SoC) that combines host processing capabilities with an RPU that exposes local memory resources to external entities over physical layers based on IEEE 802.3 PMA. The coherent interconnect may include mesh networks, ring interconnects, or other on-die fabrics that maintain cache coherency among the processing cores. The RPU may receive transmissions carrying data indicative of CXL opcodes and physical addresses within the second physical address space, translate the data to CXL requests utilizing physical addresses within the first physical address space, and forward the translated CXL requests to the memory controller for servicing via the memory channels. In some examples, the apparatus may further transmit responses back to the entity external to the apparatus via the physical layer based on IEEE 802.3 PMA, completing a read transaction initiated by the external entity.

In some implementations of the apparatus, the translate of the data to CXL requests comprises translate the physical addresses within the second physical address space to the physical addresses within the first physical address space. The address translation may accommodate scenarios where the external entity utilizes a different physical address space than the one utilized by the processing cores and the memory controller. The RPU may implement the address translation utilizing lookup tables, page tables, base-and-offset calculations, hash-based mappings, and/or programmable translation functions. The first and second physical address spaces may have different sizes, different base addresses, or different memory layouts, and the translation may accommodate these differences while maintaining the semantic meaning of the memory operations.

In some implementations of the apparatus, the physical layer based on IEEE 802.3 PMA comprises a UALink physical layer. UALink physical layer may operate at lane rates and link widths defined by the UALink specification while utilizing the electrical and signaling characteristics of IEEE 802.3 PMA.

In some implementations of the apparatus, the physical layer based on IEEE 802.3 PMA comprises an NVLink physical layer. This may enable the apparatus to participate in NVLink-based GPU clusters while exposing its local memory resources to external GPU entities via the RPU.

In some implementations of the apparatus, the physical layer based on IEEE 802.3 PMA is configured to receive and transmit Ethernet frames. The physical layer may transmit and receive standard Ethernet frames, enabling the apparatus to leverage existing Ethernet-based datacenter network infrastructure for CXL memory access operations. The data indicative of CXL opcodes and physical addresses may be carried within Ethernet frame payloads, enabling CXL semantics to traverse Ethernet switches, routers, and other network equipment deployed within the datacenter fabric.

In some implementations of the apparatus, the RPU is included in the IC package or is included in a second IC package coupled to the IC package. Integration of the RPU within the IC package may reduce latency and power consumption by eliminating off-die communication overhead. Alternatively, placement of the RPU in a second IC package, such as a companion chiplet or a discrete bridge device, may enable modular deployment and independent upgradability of the RPU functionality. When the RPU is included in the second IC package, the coupling may be implemented via a die-to-die interconnect, a package substrate, an interposer, or other suitable physical coupling mechanisms.

In some implementations of the apparatus, the memory comprises dynamic random-access memory (DRAM), and the RPU coupled to at least one of a CXL device, a CXL endpoint, or a CXL port. The DRAM may include DDR5, DDR4, HBM, or other DRAM technologies coupled to the memory controller via the memory channels. The RPU may be coupled to a CXL device, a CXL endpoint, or a CXL port to facilitate communication between the external entity and the memory resources. The CXL device, CXL endpoint, or CXL port may expose protocol interfaces that enable the RPU to send translated CXL requests to the CXL domain for processing by the memory controller.

In some implementations of the apparatus, the CXL port comprises a switch port or a root port, and the entity comprises a GPU, a network device, or a storage device. When the CXL port comprises a switch port, the RPU may be coupled to a CXL switch fabric that routes translated requests to the memory controller. When the CXL port comprises a root port, the RPU may interface with the host's root complex, enabling the external entity to access memory as though it were a local CXL device. GPUs may access the memory for compute workloads such as AI/ML training or inference, network devices may access the memory for packet buffer pooling or network function virtualization, and storage devices may access the memory for caching or data staging operations.

In some implementations of the apparatus, the CXL device comprises a Global Fabric-Attached Memory (G-FAM) Device (GFD), and the RPU communicates with the GFD according to at least one of CXL.mem or CXL.io UIO. The GFD may provide a scalable memory resource accessible by multiple requesters within a CXL Fabric, wherein the GFD has a Device Physical Address space common across all requesters. The RPU may communicate with the GFD utilizing CXL.mem for memory load/store operations or utilizing CXL.io for configuration, management, or Unordered I/O (UIO) operations. In some examples, the RPU may translate data received via the physical layer based on IEEE 802.3 PMA into CXL.mem M2S requests targeting the GFD, enabling external entities to access fabric-attached memory across the datacenter.

In some implementations of the apparatus, the second physical address space is identical to the first physical address space, and the RPU is further configured to enable the entity to read memory-mapped I/O (MMIO) registers coupled to the apparatus. When the second physical address space is identical to the first physical address space, the RPU may pass through the physical addresses without translation, enabling the external entity to target addresses within the apparatus's physical address space. The MMIO registers may include registers of peripheral devices coupled to the apparatus, such as Network Interface Cards (NICs), InfiniBand Host Bus Adapters (HBAs), storage controllers, or other I/O devices. This configuration may enable “GPU-direct” or similar methods of operation, wherein an external GPU or accelerator reads MMIO registers of a NIC or HBA coupled to the apparatus.

In some implementations of the apparatus, the CXL opcode comprises a UIOMRd Transaction Layer Packet (TLP) type. By including UIOMRd within the scope of CXL opcodes that the RPU translates, the apparatus may support UIO-based access patterns, enabling external entities to perform unordered memory reads targeting MMIO registers or memory locations coupled to the apparatus, which may be beneficial in multi-path fabric topologies where ordering flexibility improves bandwidth utilization.

In some implementations of the apparatus, the second physical address space is a subset of the first physical address space, and the RPU is further configured to block the entity from reading at least one predetermined address region within the first physical address space. The RPU may enforce access control policies that restrict the external entity from accessing sensitive address regions within the first physical address space, such as MMIO registers of security controllers, firmware storage areas, management engine registers, or other protected resources. The predetermined address regions may be configured by firmware, BIOS, a fabric manager, or system management software during initialization or runtime. The RPU may maintain an access control list, range registers, or bitmask structures that define permitted and restricted address ranges for the external entity.

In some implementations of the apparatus, the data indicative of CXL opcodes and physical addresses is encapsulated within messages conforming to a carrier protocol; and wherein the RPU is further configured to extract the data indicative of CXL opcodes and physical addresses within the messages conforming to the carrier protocol and to translate the extracted data to the CXL requests. The carrier protocol may encapsulate CXL payload data within its own framing, header, and trailer structures, enabling CXL semantics to be transported over network infrastructures that natively support the carrier protocol. The RPU may parse incoming carrier protocol messages, identify and extract the encapsulated CXL opcodes and physical addresses, and translate the extracted data to CXL requests for processing by the memory controller. The encapsulation may enable CXL traffic to traverse standard datacenter networking equipment, such as switches and routers, that operate on the carrier protocol.

In some implementations of the apparatus, the physical layer based on IEEE 802.3 PMA is configured to receive the messages conforming to the carrier protocol; and wherein the RPU is further configured to translate the physical addresses within the second physical address space to physical addresses within the first physical address space when processing the CXL requests. The carrier protocol extraction and address translation may be performed as part of a unified request processing pipeline, wherein both operations are applied sequentially before the translated CXL requests are forwarded to the memory controller. The address translation may be implemented utilizing lookup tables, base-and-offset calculations, or programmable translation functions.

In some implementations of the apparatus, the RPU is further configured to encapsulate data from CXL responses into response messages conforming to the carrier protocol for transmission via the physical layer based on IEEE 802.3 PMA. The RPU may perform reverse address translation when constructing response messages, translating physical addresses from the first physical address space back to the second physical address space so that responses are properly correlated with the original requests at the external entity.

In some implementations of the apparatus, the carrier protocol is based on Ethernet or based on IEEE 802.3; and wherein the data indicative of CXL opcodes and physical addresses is encapsulated within Ethernet frames or IEEE 802.3 frames, respectively. Dedicated EtherType values or protocol identifiers may be utilized to distinguish CXL-encapsulated frames from other Ethernet traffic sharing the same physical infrastructure. This may enable CXL memory access traffic to be routed, switched, and managed by existing datacenter Ethernet infrastructure, including top-of-rack switches, aggregation switches, and spine-leaf fabric elements.

In some implementations of the apparatus, the carrier protocol is based on Ultra Ethernet Transport (UET) protocol; and wherein the data indicative of CXL opcodes and physical addresses is encapsulated within Link Layer Retry eligible frames (LLR-eligible frames). The link layer retry mechanisms of UET may enable retransmission of lost or corrupted frames, which may be beneficial for maintaining data integrity over longer datacenter distances where transient errors may be more prevalent compared to PCIe-based CXL connections.

In some implementations of the apparatus, the carrier protocol is based on Scale Up Ethernet (SUE); and wherein the data indicative of CXL opcodes and physical addresses is encapsulated within an SUE-based Protocol Data Unit (PDU). Examples of SUE-based PDU may include SUE PDU, SUE Lite PDU, or PDUs based on future revisions of SUE. SUE may provide low-latency, high-bandwidth transport optimized for scale-up interconnect topologies within datacenter pods, enabling tightly coupled memory access patterns suitable for distributed AI/ML training and HPC workloads.

In some implementations of the apparatus, the CXL requests comprise CXL.mem Master-to-Subordinate request (M2S Req) messages; and wherein the RPU is further configured to receive CXL responses comprising CXL.mem Subordinate-to-Master Data Response (S2M DRS) messages. The M2S Req messages may carry memory read opcodes such as MemRd* or MemSpecRd. The RPU may correlate S2M DRS messages with corresponding M2S Req messages utilizing Tags or other transaction identifiers, and may encapsulate the response data for transmission back to the external entity via the carrier protocol.

In some implementations of the apparatus, the RPU is further configured to: translate Tags, associated with the data, from a first Tag space to a second Tag space; and wherein the first Tag space is utilized by the entity external to the apparatus and the second Tag space is utilized by a host coupled to the apparatus. The first and second Tag spaces may have different sizes, different allocation policies, or different encoding formats. The RPU may maintain a Tag translation table, a content-addressable memory, or algorithmic mapping logic that associates Tags across the two Tag spaces for each pending transaction. Optionally, the RPU further translates Tags in CXL responses associated with the second Tag space to Tags associated with the first Tag space before encapsulation into the carrier protocol, thereby enabling end-to-end Tag correlation across the carrier protocol boundary.

In various implementations, a method comprising: operating a processor comprising processing cores and instruction caches; and wherein the processing cores communicate via a coherent interconnect with a memory controller, and respond to snoop requests that utilize physical addresses within a first physical address space; translating virtual addresses to physical addresses for the processing cores; communicating, via memory channels, with memory having a capacity of at least 64 GB; receiving, via a physical layer based on IEEE 802.3 physical medium attachment (PMA), transmissions comprising data indicative of Compute Express Link (CXL) opcodes and physical addresses within a second physical address space; and translating, by a resource provisioning unit (RPU), the data to CXL requests; whereby the translating enables an entity external to the processor to read the memory via the physical layer based on IEEE 802.3 PMA, the memory controller, and the memory channels. The method may be performed by a processor, an SoC, or other computing apparatus. The method may further include transmitting CXL response data back to the external entity via the physical layer based on IEEE 802.3 PMA, completing the memory read transaction.

In some implementations of the method, the translating of the data to CXL requests comprises translating the physical addresses within the second physical address space to the physical addresses within the first physical address space. The address translation may be implemented utilizing lookup tables, page tables, base-and-offset calculations, or programmable translation functions maintained by the RPU. The translation may accommodate different address space sizes, base addresses, and memory layouts between the external entity and the local memory subsystem.

In some implementations of the method, the second physical address space is identical to the first physical address space, and further comprising enabling, by the RPU, the entity to read memory-mapped I/O (MMIO) registers coupled to the processor. This configuration may facilitate direct device control scenarios, such as GPU-direct access to NIC registers or accelerator control of peripheral devices coupled to the processor.

In some implementations of the method, the second physical address space is a subset of the first physical address space, and further comprising blocking, by the RPU, the entity from reading at least one predetermined address region within the first physical address space. The blocked address regions may include security-sensitive locations, firmware regions, management interfaces, or other protected resources. The RPU may maintain an access control list, range registers, or bitmask structures that define permitted and restricted address ranges. The access control policies may be configured during system initialization or updated dynamically by system management software or a fabric manager.

In some implementations of the method, the data indicative of CXL opcodes and physical addresses is encapsulated within messages conforming to a carrier protocol, and further comprising extracting, by the RPU, the data indicative of CXL opcodes and physical addresses from the messages conforming to the carrier protocol, and translating the extracted data to the CXL requests. The carrier protocol may include Ethernet, IEEE 802.3, UET, ESUN, SUE, or other transport protocols that provide framing and delivery mechanisms over the physical layer based on IEEE 802.3 PMA. The encapsulation may enable CXL traffic to traverse standard datacenter networking equipment, such as switches and routers, that natively operate on the carrier protocol.

In some implementations, the method further comprises receiving, via the physical layer based on IEEE 802.3 PMA, the messages conforming to the carrier protocol, translating, by the RPU, the physical addresses within the second physical address space to physical addresses within the first physical address space, and encapsulating, by the RPU, data from CXL responses into second messages conforming to the carrier protocol for transmission via the physical layer based on IEEE 802.3 PMA. The bidirectional translation may handle complete request-response cycles across the carrier protocol boundary. The RPU may perform reverse address translation when constructing the second messages.

In some implementations, the method further comprises translating, by the RPU, Tags from a first Tag space to a second Tag space, wherein the first Tag space is utilized by the entity external to the processor, and the second Tag space is utilized by a host coupled to the processor; and further comprising translating, by the RPU, Tags associated with the second Tag space to Tags associated with the first Tag space before encapsulation into the carrier protocol. The RPU may maintain a Tag mapping table or utilize algorithmic mappings to manage concurrent transactions across the two Tag spaces. The Tag mapping may be stored in hardware registers, content-addressable memory, or other suitable storage structures, enabling efficient lookup in both directions for request processing and response correlation.

In various implementations, a system comprising: an integrated circuit package (IC package) comprising processing cores coupled via a coherent interconnect to memory controllers, wherein the processing cores respond to snoop requests utilizing physical addresses within a host physical address space; memory management units (MMUs) configured to translate virtual addresses to physical addresses within the host physical address space; memory channels coupled to memory, having a capacity of at least 64 GB, accessible via the memory controllers; physical layers based on IEEE 802.3 physical medium attachment (PMA), configured to communicate with respective external entities, wherein the physical layers receive transmissions comprising data indicative of memory access requests comprising physical addresses; and at least one resource provisioning unit (RPU) configured to translate between (i) physical addresses associated with the transmissions and (ii) physical addresses within the host physical address space; whereby the translate enables the external entities to access the memory via the physical layers based on IEEE 802.3 PMA, the memory controllers, and the memory channels. The at least one RPU may manage address translations for multiple external entities simultaneously, enabling memory pooling and sharing scenarios where different entities access different or overlapping regions of the memory. The system may be deployed in datacenter environments where GPUs, accelerators, network devices, or other compute elements access shared memory resources for distributed workloads such as AI/ML training, inference serving, or data analytics.

In some implementations “data indicative of memory access requests comprising physical addresses” or “physical addresses associated with the transmissions” may encompass various transmission formats that convey memory access intent. Some formats may include explicit memory access requests comprising complete physical addresses embedded within the protocol messages. Alternatively, certain protocols may employ address caching, shortened address representations, delta encoding, base-and-offset techniques, lookup tables, transaction identifiers that reference previously established address contexts, or implicit addressing schemes wherein addresses are derived from other protocol fields or maintained state information. The RPU or computer may reconstruct or derive the complete physical addresses from these representations to perform the applicable translations.

In some implementations of the system, the memory access requests conform to at least one protocol selected from Ultra Accelerator Link (UALink) requests, UALink Protocol Level Interface (UPLI) requests, or NVLink requests; and wherein at least one of the physical layers based on IEEE 802.3 PMA comprises a UALink physical layer, an NVLink physical layer, or an Ethernet physical layer operating at 100 Gbps or higher. The system may support heterogeneous interconnect environments where different external entities utilize different protocols over physical layers based on IEEE 802.3 PMA. UALink or NVLink may be utilized for accelerator-to-memory communication in AI/ML clusters, while Ethernet physical layers may be utilized for longer-distance inter-pod memory access.

In some implementations of the system, the at least one RPU comprises RPUs distributed across the IC package or across IC packages; and wherein the RPUs are further configured to maintain different address translation tables for different external entities, and to enforce access control policies defining permitted address ranges for corresponding external entities, thereby creating isolated security domains for memory access while sharing the same physical memory resources. Each RPU or RPU instance may maintain a dedicated address translation table and access control policy for its associated external entity. The address translation tables may map different regions of the external entities'address spaces to different or overlapping regions of the host physical address space, enabling flexible memory partitioning and sharing. The access control policies may define permitted address ranges, read/write permissions, and bandwidth allocation for each external entity. This architecture may be beneficial in multi-tenant datacenter environments or in systems where different external entities have different trust levels, enabling scalable memory access with per-entity quality-of-service and isolation guarantees.

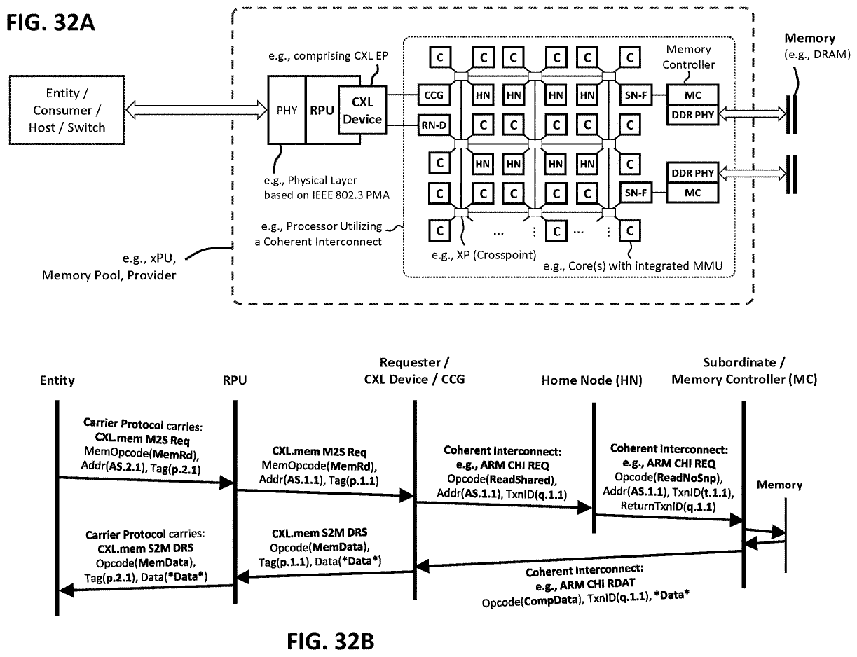

FIG. 32A illustrates an example of a system wherein an entity is coupled via a Physical Layer based on IEEE 802.3 PMA to an RPU that includes or is coupled to a CXL device that is coupled to an ARM architecture processor through one or more CCG nodes and possibly one or more RN-D nodes. The memory controller (MC) within the system is coupled to SN-F nodes and interfaces with DRAM through DDR PHYs and memory channels. The example includes crosspoints (XP) that function as routing elements within the ARM mesh interconnect, examining packet identifiers to determine appropriate routing paths and managing traffic flow between sources and destinations within the mesh structure.

FIG. 32B illustrates an example of a TFD that may be executed on the example described in FIG. 32A, demonstrating a first CXL.mem to a second CXL.mem translation by an RPU, followed by a requester, which may be the CCG or the CXL device from FIG. 32A, initiating a CHI allocating ReadShared request to a Home Node, with the Memory Controller serving as the Subordinate node. The diagram illustrates the optimization technique of combined response from subordinate, wherein the Home Node sends a ReadNoSnp request to the Memory Controller, which then returns data to the requester using a CompData opcode, reducing message count and potentially improving transaction latency by eliminating the need for data to flow back through the Home Node.

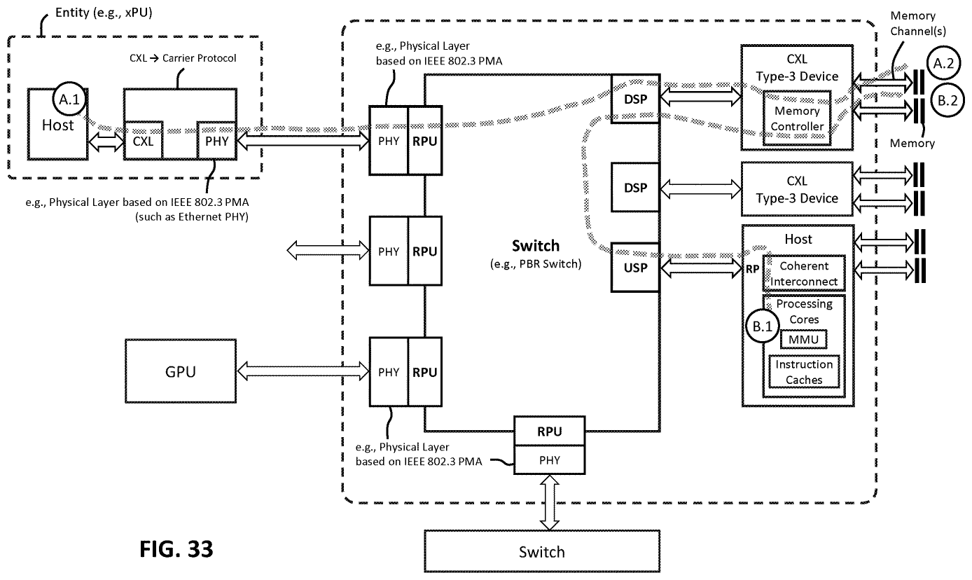

FIG. 33 illustrates an example of a multi-host memory pooling or sharing utilizing a switch-based topology with physical layers based on IEEE 802.3 PMA. The system includes at least two distinct paths for hosts to access memory resources through the same memory channels. The first path shows an entity, such as an xPU, with a host (designated as A.1) that connects via CXL, carried on a carrier protocol interface, which transmits over a physical layer based on IEEE 802.3 PMA (which may utilize Ethernet PHY) to an RPU. RPUs are coupled to or included in a switch, which may be a PBR switch, enabling scalable connectivity. The switch includes downstream ports (DSPs) that are coupled to CXL Type-3 devices containing memory controllers and associated memory channels coupled to memories (denoted as A.2 and B.2), allowing for distributed memory resources. The second path shows the switch's upstream port (USP) coupled via a root port (RP) to a host system (denoted as B.1) that includes a coherent interconnect, processing cores with MMU functionality, and instruction caches. This dual-path coupling enables the host B.1 to access memory through its connection via the switch's USP and RP, while simultaneously allowing external entities like the xPU (host A.1) to access the same memory resources through the RPU and switch infrastructure. A GPU may also connect to the switch through its own RPU and PHY based on IEEE 802.3 PMA, demonstrating the system's capability to integrate heterogeneous computing elements.

In environments where entities may utilize different protocols while requiring coordinated access to shared resources, there may be scenarios where a first entity communicating based on PCIe, such as a GPU, needs to access memory resources coupled to a second entity communicating based on CXL.mem, such as a CXL memory expander or a CXL memory pool. Translations between PCIe TLPs and CXL.mem messages may facilitate memory operations, data transfers, and resource sharing across different domains while maintaining the requirements of each protocol. Such translations may be performed by a computer, an apparatus, a cable, a Fabric Processing Unit (FPU), a Fabric NIC, or other suitable devices positioned between the first entity and the second entity. This translation may enable PCIe devices that do not natively support CXL protocols to access large-capacity CXL-attached memory resources. For example, GPUs designed with PCIe interfaces may access CXL memory pools that provide memory capacity exceeding the HBM integrated within the GPUs, thereby extending the effective memory available for AI/ML workloads, graphics rendering, or general-purpose GPU computing possibly without requiring hardware modifications to existing GPU designs. The computer may perform address translations between different physical address spaces, opcode translations between PCIe and CXL.mem, and Tag translations between PCIe Tag formats and CXL.mem Tag formats.

In various implementations, a method for translating between Peripheral Component Interconnect Express (PCIe) Transaction Layer Packets (TLPs) and Compute Express Link (CXL) messages, comprising: receiving a PCIe memory request by a computer from a first entity; translating, by the computer, the PCIe memory request to a CXL.mem Master-to-Subordinate (M2S) request; sending, by the computer to a second entity, the CXL.mem M2S request; receiving, by the computer from the second entity, a CXL.mem Subordinate-to-Master Data Response (S2M DRS) corresponding to the CXL.mem M2S request; translating, by the computer, the CXL.mem S2M DRS to a PCIe Completion; and sending the PCIe Completion by the computer to the first entity. The translation may encompass various aspects of the protocol messages, including opcodes, addresses, and transaction identifiers, thereby enabling communication between entities that utilize different protocols. The method may be implemented in hardware, firmware, software, or combinations thereof, and may be performed by various types of devices, such as semiconductor devices, switches, bridges, or active cables. The computer may maintain state information, such as pending transaction tables or tracker entries, to correlate CXL.mem S2M DRS responses with previously transmitted CXL.mem M2S requests and with pending PCIe transactions. Additionally, the elements may communicate through one or more intermediary components, such as a switch, a retimer, or other suitable entity that facilitates information transfer. The first entity may include devices such as GPUs, NICs, DMA engines, accelerators, or other PCIe endpoints, while the second entity may include CXL memory expanders, CXL memory pools, GFDs, or other CXL.mem-capable devices.

In some implementations of the method, the PCIe memory request comprises a first physical address belonging to a first physical address space utilized by the first entity, and wherein translating the PCIe memory request to the CXL.mem M2S request comprises generating the CXL.mem M2S request comprising a second physical address belonging to a second physical address space utilized by the second entity. The address translation may be implemented utilizing lookup tables, page tables, hash tables, base-and-offset calculations, and/or programmable translation functions. The first and second physical address spaces may have different sizes, different base addresses, or different memory layouts, and the translation may accommodate these differences while maintaining the meaning of the memory operations. In some examples, the first physical address space may include an address space utilized by the first entity for PCIe memory-mapped I/O (MMIO) operations, and the second physical address space may include a Host Physical Address (HPA) space utilized by a CXL host coupled to a CXL device of the second entity. The computer may maintain translation tables that map regions of the first physical address space to corresponding regions of the second physical address space, enabling the first entity to access CXL-attached memory resources using addresses within its native address space.

In some implementations of the method, the first entity comprises a GPU that does not support CXL.mem, wherein the second entity comprises a CXL memory pool, and wherein the computer exposes memory resources of the CXL memory pool to the GPU via a PCIe memory address space. The computer may expose the CXL memory pool to the GPU by configuring Base Address Registers (BARs) or other PCIe mechanisms to advertise a memory region that the GPU can access using standard PCIe memory read and write operations. The GPU may utilize this exposed memory region for various purposes, such as storing intermediate computation results, model parameters for AI/ML inference, texture data for graphics rendering, or working data sets that exceed the GPU's local HBM capacity. The computer may handle the translation transparently, such that the GPU may operate without awareness that the underlying memory is accessed utilizing CXL.mem rather than standard PCIe memory, which may enable existing GPU designs with PCIe interfaces to benefit from CXL-attached memory resources.

In some implementations of the method, the computer communicates with GPUs via interfaces, and wherein the computer translates PCIe memory requests from the GPUs to CXL.mem M2S requests targeting a shared memory resource of the CXL memory pool. The shared memory region of the CXL memory pool may be accessible by multiple GPUs, enabling data sharing, inter-GPU communication, or load balancing across the GPUs. The computer may implement arbitration logic to manage concurrent memory requests from the GPUs, and may utilize QoS mechanisms to allocate bandwidth or prioritize requests from different GPUs. The shared memory architecture may be beneficial in multi-GPU computing environments, such as AI/ML training clusters, where GPUs may need to access common datasets, model parameters, or intermediate results. The interfaces may include separate PCIe links, lanes within a shared PCIe link, or virtual channels within a PCIe fabric.

In some implementations of the method, the computer maintains memory allocation information associating portions of the CXL memory pool with certain respective GPUs of the GPUs, and wherein translating the PCIe memory request comprises selecting a portion of the CXL memory pool based on an identity of a requesting GPU. The memory allocation information may include address range tables, partition descriptors, or access control lists that define which portions of the CXL memory pool are accessible by each GPU. The computer may identify the requesting GPU based on the Requester ID in the PCIe memory request, a source port identifier, or other identification mechanisms. The partitioning may enable isolation between GPUs for security or fault containment purposes, or may enable dynamic memory allocation wherein portions of the CXL memory pool are assigned to GPUs based on workload requirements. The computer may support exclusive partitions (accessible by a single GPU) and/or shared regions (accessible by multiple GPUs) within the CXL memory pool.

In some implementations of the method, the first entity comprises at least one of a GPU, a Network Interface Card (NIC), or a Direct Memory Access (DMA) engine; wherein the second entity comprises at least one of a CXL memory expander, a CXL memory pool, or a Global Fabric-Attached Memory device (GFD); wherein the PCIe memory request comprises a PCIe Memory Read (MRd) request comprising a first Tag; wherein the CXL.mem M2S request comprises MemRd* and a second Tag; wherein the CXL.mem S2M DRS comprises MemData and data; wherein the PCIe Completion comprises a Completion with Data (CplD) comprising the data and the first Tag; and wherein the computer maintains a mapping between the first Tag and the second Tag. The computer may maintain the mapping between the first Tag and the second Tag in a tracker entry, a translation table, or another relevant data structure. Upon receiving the CXL.mem S2M DRS from the second entity, the computer may utilize the second Tag to identify the corresponding pending transaction and retrieve the first Tag for inclusion in the PCIe CplD. GPUs may utilize PCIe memory reads to access large memory pools for workloads such as graphics rendering, machine learning inference, or general-purpose GPU computing workloads. NICs may utilize PCIe memory reads to access memory buffers for network packet processing, RDMA, or storage traffic handling. DMA engines may utilize PCIe memory reads to transfer data between memory regions on behalf of other system components. The second entity may expose memory resources that are implemented using various memory technologies such as DDR5, DDR4, HBM, persistent memory, or combinations thereof.

In some implementations, the method further comprises receiving, by the computer from the first entity, a PCIe Memory Write request (MWr) comprising write data; translating the PCIe MWr to a CXL.mem M2S request with Data (M2S RwD) comprising a MemWr* and the write data; sending the CXL.mem M2S RwD to the second entity; and receiving, from the second entity, a CXL.mem S2M No Data Response (S2M NDR) comprising Cmp*. The PCIe MWr may be a posted write that does not require a completion to be returned to the first entity. However, CXL.mem may return an S2M NDR with Cmp* to acknowledge receipt of the write data by the second entity. The computer may absorb the S2M NDR without forwarding the acknowledgment to the first entity, or may utilize the S2M NDR to update internal state or flow control mechanisms. The write data may be transferred from the PCIe domain to the CXL.mem domain with optional format conversion, alignment adjustment, or byte enable manipulation as appropriate for the respective protocol specifications. The computer may buffer the write data internally and may implement mechanisms to handle scenarios where the CXL.mem M2S RwD encounters errors or back-pressure from the second entity.

In some implementations of the method, the computer is included in a switch, and wherein the PCIe memory request is selected from: a UIO Memory Read (UIOMRd) request, a UIO Memory Write request (UIOMWr), a Memory Read (MRd) request, or a Memory Write request (MWr). The selection among UIOMRd, UIOMWr, MRd, or MWr may depend on the capabilities of the first entity and the configuration of the path between the first entity and the computer.

In some implementations of the method, the PCIe memory request comprises a PCIe Unordered Input/Output (UIO) Memory Read (UIOMRd) request, and wherein the PCIe Completion comprises a PCIe UIO Read Completion with Data (UIORdCplD). The UIO transaction types may be utilized when the first entity supports UIO capabilities and when the path between the first entity and the computer has UIO enabled. The UIOMRd request type may provide ordering flexibility that enables more efficient utilization of fabric bandwidth in topologies with multiple paths between source and destination. UIO transactions may allow out-of-order completion delivery, which may reduce head-of-line blocking and improve overall system throughput in heavily loaded systems. The UIORdCplD completion may include a CDL that the computer may populate with information collected from the CXL.mem domain, from the computer itself, or from intermediate components.

In some implementations, the method further comprises receiving, by the computer from the first entity, a PCIe UIO Memory Write request (UIOMWr) comprising write data; translating the PCIe UIOMWr to a CXL.mem M2S request with Data (M2S RwD) comprising a MemWr* and the write data; sending the CXL.mem M2S RwD to the second entity; receiving, from the second entity, a CXL.mem S2M No Data Response (S2M NDR); translating the CXL.mem S2M NDR to a PCIe UIO Write Completion (UIOWrCpl); and sending the PCIe UIOWrCpl to the first entity. The UIO Memory Write request may be a non-posted transaction for which the first entity expects a UIOWrCpl, and the computer may translate the CXL.mem S2M NDR to the PCIe UIOWrCpl, thereby providing end-to-end acknowledgment that the write data has been received by the second entity. This non-posted write may be beneficial for maintaining ordering guarantees or for implementing synchronization mechanisms. The UIOWrCpl may include a CDL that the computer may populate based on the DevLoad from the CXL.mem S2M NDR or based on locally generated information.

In some implementations of the method, the CXL.mem S2M DRS comprises a DevLoad, and wherein the PCIe Completion comprises a CXL DevLoad (CDL) populated based on the DevLoad. The DevLoad in the CXL.mem S2M DRS may carry QoS telemetry information indicating the loading or congestion state of the second entity or intermediate components in the CXL.mem path. The computer may translate this telemetry information to the CDL in the PCIe UIORdCplD, thereby propagating QoS information back to the first entity. The first entity may utilize this information to make informed decisions about subsequent memory operations, such as throttling request rates, adjusting request priorities, or selecting alternative memory resources based on observed loading conditions. This end-to-end propagation of telemetry information may enable more efficient resource utilization in heterogeneous computing systems.

In some implementations, the method further comprises sending, by the computer to the second entity, a CXL.mem M2S request comprising MemSpecRd. The speculative memory read may be initiated by the computer to fetch data from the second entity in advance of, or without, the first entity explicitly requesting that data. The CXL.mem MemSpecRd opcode provides a mechanism for speculative memory access that does not have a direct equivalent in PCIe, enabling the computer to leverage CXL.mem-specific capabilities to improve performance for PCIe devices. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. Data returned in response to speculative reads may be buffered by the computer and may be utilized to satisfy subsequent requests from the first entity, potentially reducing observed read latency.

In some implementations, the method further comprises receiving, by the computer from the second entity, a CXL.mem S2M DRS comprising data responsive to the CXL.mem M2S request comprising MemSpecRd; buffering, by the computer, the data; receiving a subsequent PCIe memory request from the first entity targeting an address corresponding to the buffered data; and populating a subsequent PCIe Completion with at least some of the buffered data responsive to the subsequent PCIe memory request. The computer may maintain a prefetch buffer or cache structure to store data received in response to speculative read requests. When a subsequent PCIe memory request from the first entity targets an address for which speculative data has been buffered, the computer may service the request from the buffer without initiating a new CXL.mem transaction, thereby reducing the observed read latency. The buffered data may be invalidated or refreshed based on coherency requirements, timeout policies, or subsequent write operations to the same address. The computer may implement address matching logic to determine whether incoming PCIe memory requests can be satisfied from buffered speculative data.

In some implementations, the method further comprises detecting sequential access patterns in physical addresses of prior PCIe memory requests received from the first entity, and initiating the CXL.mem M2S request comprising MemSpecRd targeting a next sequential physical address. The computer may track physical addresses from consecutive PCIe memory requests received from the first entity to identify sequential access patterns indicative of linear memory traversal. Upon detecting that the first entity has accessed certain addresses in sequence, the computer may speculatively facilitate the readiness of the data from subsequent addresses before the first entity explicitly requests them. The sequential pattern detection may account for cacheline boundaries, page boundaries, or other memory organization units to optimize prefetch granularity.

In some implementations, the method further comprises detecting strided access patterns in physical addresses of prior PCIe memory requests received from the first entity, calculating a stride distance between accessed addresses, and initiating the CXL.mem M2S request comprising MemSpecRd targeting a physical address offset by the stride distance. The computer may identify non-sequential but regular access patterns wherein the first entity accesses memory locations separated by a consistent stride distance, such as when processing array elements or matrix columns. For example, if the computer observes accesses to addresses A, A+S, A+2S, where S represents the stride, it may speculatively prefetch from address A+3S. The stride detection algorithm may maintain a history buffer of recent addresses and compute stride patterns using difference calculations or pattern matching algorithms.

In some implementations of the method, the PCIe memory request comprises a first Tag having a first bit width selected from 5 bits, 8 bits, 10 bits, or 14 bits; wherein the CXL.mem M2S request comprises a second Tag having a 16-bit width; and wherein the computer translates between the first Tag and the second Tag. PCIe supports variable Tag widths depending on device capabilities and negotiated settings, including 5-bit Tags (default), 8-bit extended Tags, 10-bit Tags (for high-speed links), and 14-bit Tags (for flit mode and UIO). CXL.mem utilizes a fixed 16-bit Tag for transaction identification. The computer may translate between these different Tag formats by allocating CXL.mem Tags from a Tag pool, maintaining a mapping table between PCIe Tags and CXL.mem Tags, or implementing algorithmic Tag generation based on the PCIe Tag and additional context. The translation may also accommodate scenarios where the computer needs to maintain more outstanding CXL.mem transactions than the PCIe Tag space allows (for example, when issuing speculative CXL.mem reads independently of PCIe demand requests) by drawing from the larger CXL.mem Tag space for those additional transactions.

In some implementations of the method, the PCIe memory request specifies a requested data length larger than a cacheline size, wherein translating the PCIe memory request comprises generating CXL.mem M2S requests each targeting a cacheline-sized data portion, and wherein the method further comprises: receiving CXL.mem S2M DRS responses from the second entity, and aggregating data from the CXL.mem S2M DRS responses into the PCIe Completion. CXL.mem transactions are typically cacheline-sized (64 bytes), while PCIe memory requests may specify data lengths up to 4 KB using the Length field and byte enables. When a PCIe memory request specifies a data length exceeding the cacheline size, the computer may split the request into CXL.mem M2S requests, each targeting a 64-byte cacheline. The computer may track the outstanding CXL.mem requests and may aggregate the returned data into a single PCIe Completion or into multiple PCIe Completions as permitted by PCIe. The aggregation may involve buffering data from responses, ordering the data according to address sequence, and formatting the aggregated data according to PCIe Completion requirements.

In some implementations of the method, the PCIe memory request specifies a requested data length smaller than a cacheline size, wherein the CXL.mem S2M DRS comprises cacheline-sized data, and wherein the method further comprises trimming the cacheline-sized data to match the requested data length prior to populating the PCIe Completion. PCIe memory requests may specify data lengths smaller than a cacheline using byte enables, requesting as little as a single doubleword (4 bytes) or even individual bytes. CXL.mem responses return cacheline-sized data regardless of the requested length. The computer may trim the returned data to the bytes requested by the first entity, aligning the data to native boundaries such as doubleword boundaries as specified by the PCIe specifications. The trimming operation may reduce the data payload size in the PCIe Completion, potentially improving bandwidth efficiency on the path between the computer and the first entity.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus for translating between Peripheral Component Interconnect Express (PCIe) Transaction Layer Packets (TLPs) and Compute Express Link (CXL) messages, comprising: a first interface configured to communicate with a first entity based on PCIe; a second interface configured to communicate with a second entity based on CXL.mem; and a computer coupled to the first interface and the second interface, wherein the computer is configured to: receive a PCIe memory request from the first entity via the first interface; translate the PCIe memory request to a CXL.mem Master-to-Subordinate (M2S) request; send, to the second entity via the second interface, the CXL.mem M2S request; receive, from the second entity via the second interface, a CXL.mem Subordinate-to-Master Data Response (S2M DRS) corresponding to the CXL.mem M2S request; translate the CXL.mem S2M DRS to a PCIe Completion; and send the PCIe Completion to the first entity via the first interface. The apparatus may be implemented as a switch, a bridge, a semiconductor device, a chiplet within an IC package, or other suitable form factor. The first interface may include PCIe physical layer components, link layer components, and transaction layer logic configured to communicate according to PCIe specifications. The second interface may include CXL physical layer components (which may share physical layer characteristics with PCIe), link layer components, and CXL.mem transaction layer logic. The computer may include translation logic, address translation tables, Tag mapping structures, and pending transaction trackers. In some examples, the apparatus and at least one of the first entity or the second entity may be included within the same IC package, optionally coupled by UCIe links or other die-to-die interconnects.

In some implementations of the apparatus, the PCIe memory request comprises a first physical address belonging to a first physical address space, the CXL.mem M2S request comprises a second physical address belonging to a second physical address space, and wherein the computer is further configured to translate between the first physical address and the second physical address. The apparatus may include address translation logic, which may be implemented using lookup tables, content-addressable memory (CAM), translation lookaside buffers (TLBs), or programmable translation functions. The translation may enable the first entity to access CXL-attached memory using addresses within its native address space while the second entity operates within its own address space. The address translation may be configured by system software, firmware, or hardware during system initialization or dynamically during operation.

In some implementations of the apparatus, the first entity comprises a GPU that does not support CXL.mem, the second entity comprises a CXL memory pool, and wherein the computer is configured to expose memory resources of the CXL memory pool to the GPU as a PCIe memory-mapped region. The apparatus may function as a bridge enabling GPUs designed with PCIe interfaces to access CXL-attached memory resources. The apparatus may expose the CXL memory pool as one or more PCIe BARs that the GPU can access using PCIe memory transactions, which may enable GPU-based AI/ML workloads to utilize memory capacities exceeding the HBM integrated within the GPU.

In some implementations of the apparatus, the computer is further configured to send, to the second entity via the second interface, a CXL.mem M2S request comprising MemSpecRd. The apparatus may include logic configured to initiate speculative memory reads to the second entity based on observed access patterns from the first entity. The speculative reads may utilize the CXL.mem MemSpecRd, which provides speculative access not available in PCIe. Data returned in response to speculative reads may be stored in a buffer within the apparatus for rapid delivery when subsequently requested by the first entity.

In some implementations of the apparatus, the apparatus is located in an active cable. The active cable may include the first interface at one end configured to connect to a PCIe device such as a GPU, and the second interface at the other end configured to connect to a CXL device such as a memory expander or memory pool. The computer may be implemented within the cable housing utilizing embedded logic. The active cable form factor may enable translation to be added to existing systems by replacing passive cables with active translation cables, possibly without requiring modifications to the connected devices.

In various implementations, a system comprising: Graphics Processing Units (GPUs), wherein at least one GPU of the GPUs does not support Compute Express Link (CXL) communications; a CXL device coupled to memory having a capacity greater than a capacity of high-bandwidth memory (HBM) of any one of the GPUs; and a computer coupled between the GPUs and the CXL device, the computer comprising: a first interface configured to communicate with the GPUs based on PCIe; and a second interface configured to communicate with the CXL device based on CXL.mem; wherein the computer is configured to: receive, from a GPU of the GPUs via the first interface, a PCIe memory request; translate the PCIe memory request to a CXL.mem Master-to-Subordinate (M2S) request; send, to the CXL device via the second interface, the CXL.mem M2S request; receive, from the CXL device via the second interface, a CXL.mem Subordinate-to-Master Data Response (S2M DRS); translate the CXL.mem S2M DRS to a PCIe Completion; and send the PCIe Completion to the GPU via the first interface. The system may enable GPUs that do not natively support CXL to access memory resources that exceed their local HBM capacity, such as for storing model parameters, intermediate computation results, KV-cache entries, or working data sets for AI/ML inference and training workloads. The CXL device may include a CXL memory expander, a CXL memory pool, a Global Fabric-Attached Memory device (GFD), or a CXL Type 2 device with device-attached memory. The memory coupled to the CXL device may be implemented using DDR5, DDR4, LPDDR, persistent memory, or combinations thereof, and may provide memory capacity and bandwidth characteristics that complement the high-bandwidth but limited-capacity HBM integrated within the GPUs. The computer may be implemented as a semiconductor device, an ASIC, a chiplet, a switch, an active cable, or other suitable form factor positioned between the PCIe domain of the GPUs and the CXL.mem domain of the CXL device. The computer may maintain per-GPU tracking structures, address translation tables, and Tag mapping resources to support concurrent translations from GPUs. In some examples, the computer and the CXL device may be included within a same IC package, optionally coupled by UCIe links or other die-to-die interconnects.

In some implementations of the system, the memory is accessible by the GPUs as a shared memory region, and wherein the computer is configured to translate PCIe memory requests from the GPUs to CXL.mem M2S requests targeting the shared memory region. The shared memory region may enable GPUs to access common data, such as model parameters, training datasets, or intermediate computation results, without requiring explicit data copying between GPUs. The computer may implement arbitration and flow control mechanisms to manage concurrent access from GPUs. The shared memory architecture may reduce total memory requirements and inter-GPU communication latency in multi-GPU systems.

In some implementations of the system, the computer maintains memory allocation information associating portions of the memory with respective GPUs, and wherein translating the PCIe memory request comprises selecting a target address within the memory based on an identity of a requesting GPU of the GPUs. The memory allocation information may enable partitioned access wherein each GPU is assigned a dedicated portion of the memory for private use. The computer may identify the requesting GPU based on the Requester ID in the PCIe memory request or other identification mechanisms, and may direct the CXL.mem M2S request to the appropriate memory partition. The partitioning may provide isolation between GPU workloads for security, fault containment, or resource management purposes.

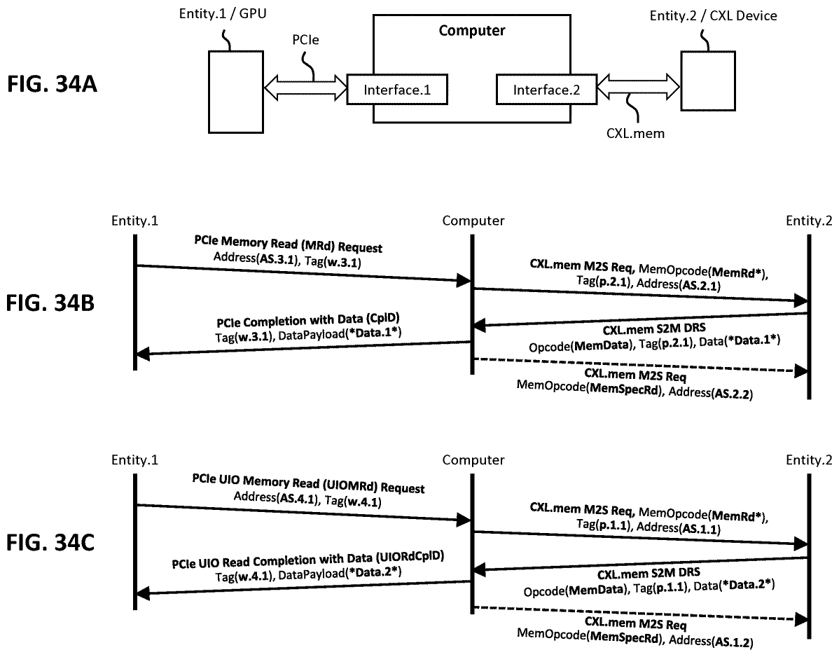

FIG. 34A illustrates an example of a system comprising a switch (e.g., a CXL switch), a processor, or a bridge, which comprises a computer coupled between a first interface (Interface.1) and a second interface (Interface.2). The first interface may communicate according to PCIe with a first entity (Entity.1), such as a GPU. The second interface may communicate according to a CXL protocol, such as CXL.mem, with a second entity (Entity.2), such as a CXL device, which may be a CXL memory expander, a CXL memory pool, or a GFD. The computer may extract physical addresses from messages received via the first interface, wherein these addresses may refer to a first Physical Address (PA) space utilized by the first entity; translate these addresses; and generate messages carrying the translated physical addresses for transmission via the second interface; wherein these translated addresses may refer to a second PA space utilized by the second entity. In some examples, the first PA space and the second PA space may be the same PA space, wherein the computer may perform address translations between addresses within the same PA space. The computer may perform further translations between the PCIe domain and the CXL domain, such as translating between PCIe TLP types (e.g., MRd, UIOMRd) and CXL.mem opcodes (e.g., MemRd, MemRdData, MemRdTEE). The computer may be implemented as a monolithic die, as one or more chiplets within an IC package, or as one or more components on a board. In some examples, the computer and at least one of the first entity or the second entity may be included within the same IC package, optionally coupled by one or more UCIe links.

FIG. 34B illustrates an example of a TFD demonstrating translations, performed by a computer, between PCIe TLPs received from a first entity (Entity.1), which may be a GPU, and CXL.mem messages sent to a second entity (Entity.2), which may be a CXL device, possibly enabling the first entity to access resources mapped to an address space utilized by the second entity. The first entity may initiate a PCIe transaction that includes a PCIe Memory Read (MRd) request comprising Address(AS.3.1) and Tag(w.3.1). The computer may translate the PCIe transaction to a CXL.mem transaction that includes a CXL.mem M2S request comprising MemOpcode(MemRd*), Tag(p.2.1), and Address(AS.2.1), and may send the CXL.mem M2S request to the second entity. Upon receiving one or more responses from the second entity, which may include a CXL.mem S2M DRS comprising Opcode(MemData), Tag(p.2.1), and Data(*Data.1*), the computer may translate the one or more responses such as translating the CXL.mem S2M DRS to a PCIe Completion with Data (CplD) comprising Tag(w.3.1) and DataPayload(*Data.1*), and may send the CplD to the first entity. The computer may perform further translations, such as protocol translations, opcode translations, command translations, or TLP translations, e.g., translating between PCIe TLPs and CXL.mem messages, wherein these translations may include field translations, such as translating between PCIe Tags and CXL.mem Tags, translating between reserved fields, and translating between reserved and non-reserved fields. The computer may further initiate speculative memory reads targeting the second entity, wherein the speculative memory reads may include a CXL.mem M2S Req comprising MemOpcode(MemSpecRd) and Address(AS.2.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved.

FIG. 34C illustrates an example of a TFD demonstrating translations between PCIe UIO TLPs received from a first entity (Entity.1), which may be a GPU, and CXL.mem messages sent to a second entity (Entity.2) which may be a CXL device, possibly enabling the first entity to access resources mapped to an address space utilized by the second entity (Entity.2). The first entity may initiate a PCIe UIO transaction that may include a PCIe UIO Memory Read (UIOMRd) request comprising Address(AS.4.1) and Tag(w.4.1). The computer may translate the PCIe UIO transaction to a CXL.mem transaction that may include a CXL.mem M2S request comprising MemOpcode(MemRd*), Tag(p.1.1), and Address(AS.1.1), and may send the CXL.mem M2S request to the second entity. Upon receiving one or more responses from the second entity, which may include a CXL.mem S2M DRS comprising Opcode(MemData), Tag(p.1.1), and Data(*Data.2*), the computer may translate the one or more responses, such as translating the CXL.mem S2M DRS to a PCIe UIO Read Completion with Data (UIORdCplD) comprising Tag(w.4.1) and DataPayload(*Data.2*); and may send the UIORdCplD to the first entity. The computer may perform further translations, such as protocol translations, opcode translations, command translations, or TLP translations, e.g., translating between PCIe UIO TLPs and CXL.mem messages, wherein these translations may include field translations. The computer may further initiate speculative memory reads targeting the second entity, wherein the speculative memory reads may include a CXL.mem M2S Req comprising MemOpcode(MemSpecRd) and Address(AS.1.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved.

Heterogeneous computing architectures may incorporate hosts within computing systems, wherein these hosts may utilize different address spaces while requiring coordinated access to shared resources. In such multi-host environments, there may be scenarios where a first host operating with a first Host Physical Address (HPA) space needs to maintain cache coherency with a second host operating with a second HPA space, wherein both hosts communicate using CXL.cache. Translations between CXL.cache messages associated with different hosts may facilitate memory coherency operations, cacheline invalidations, and data transfers across different address spaces while maintaining the requirements of CXL.cache.

In various implementations, a method for translating between Compute Express Link (CXL) messages, comprising: receiving, from a first entity, a CXL.cache Host-to-Device (H2D) request; translating the CXL.cache H2D request to a CXL.cache Device-to-Host (D2H) request; and sending the CXL.cache D2H request to a second entity. The translation process may encompass various aspects of the protocol messages, including opcodes, addresses, and transaction identifiers, thereby enabling coherent communication between hosts that cannot communicate directly, such as due to protocol limitations or direction mismatches. The method may be implemented in hardware, firmware, software, or combinations thereof, and may be performed by various types of devices, such as semiconductor devices and/or RPUs.

In some implementations of the method, the first entity comprises a first host, and the CXL.cache H2D request comprises a first address belonging to a first Host Physical Address (HPA) space utilized by the first host; and wherein the second entity comprises a second host, and wherein the CXL.cache D2H request comprises a second address belonging to a second HPA space utilized by the second host. In some examples, the address translation may be implemented utilizing lookup tables, page tables, hash tables, base-and-offset calculations, and/or programmable translation functions. The first and second HPA spaces may have different sizes, different base addresses, or different memory layouts, and the translation may accommodate these differences while maintaining the meaning of the memory operations.

In some implementations of the method, the CXL.cache H2D request comprises snoop invalidate (SnpInv) and Unique Queue ID (UQID), and wherein the CXL.cache D2H request comprises CacheLine Flush (CLFlush) and command queue identifier (CQID). The translation from SnpInv to CLFlush may enable the first host to invalidate cachelines in the second host's cache hierarchy. The UQID from the H2D request may be mapped to the CQID in the D2H request, wherein this mapping may be maintained in a translation table, a tracker entry, or similar data structure.

In some implementations of the method, the CXL.cache H2D request comprises snoop invalidate (SnpInv) and Unique Queue ID (UQID), and the CXL.cache D2H request comprises command queue identifier (CQID) and Read for Ownership No Data (RdOwnNoData) or Read for Ownership (RdOwn). The translation from SnpInv to RdOwnNoData or to RdOwn may enable the first host to perform cross-orchestration of cacheline states between the cache coherency subsystems of the first host and the second host, by optionally invalidating a cacheline address in the cache hierarchy of the second host and marking the cacheline address in exclusive state, possibly preceding a write operation by the first host.

In some implementations, the method further comprises receiving from the second host a CXL.cache H2D Data, translating the CXL.cache H2D Data to a CXL.cache Device-to-Host (D2H) Data, and sending the CXL.cache D2H Data to the first host.

In some implementations of the method, the CXL.cache H2D request comprises SnpData and Unique Queue ID (UQID), and the CXL.cache D2H request comprises RdShared and command queue identifier (CQID). The translation from SnpData to RdShared may enable the first host to acquire a cacheline in shared state from the second host's cache hierarchy. RdShared may request the cacheline to be cached in shared state, which may permit both the first host and the second host to retain cached copies of the cacheline. The UQID from the H2D request may be mapped to the CQID in the D2H request, wherein this mapping may be maintained in a translation table or tracker entry.

In some implementations of the method, the CXL.cache H2D request comprises SnpData and Unique Queue ID (UQID), and the CXL.cache D2H request comprises RdOwn and command queue identifier (CQID). The translation from SnpData to RdOwn may enable the first host to acquire a cacheline in exclusive state, even though SnpData may indicate an intent to acquire shared or exclusive state. The translation logic may select RdOwn based on additional factors such as system configuration, anticipated access patterns, or optimization policies. RdOwn may cause the second host to relinquish ownership of the cacheline and provide cacheline data to the translation logic, which may forward the data to the first host.

In some implementations of the method, the CXL.cache H2D request comprises snoop invalidate (SnpInv) and Unique Queue ID (UQID), the CXL.cache D2H request comprises RdOwn and command queue identifier (CQID), and further comprising receiving from the second host a CXL.cache H2D Data message comprising cacheline data. The translation from SnpInv to RdOwn may enable the first host to acquire exclusive ownership of the cacheline while also receiving cacheline data from the second host. The second host may respond with a GO-M or GO-E indication along with the cacheline data, which may indicate that the second host previously held the cacheline in modified state, or provides the cacheline in exclusive state. The translation logic may translate the received H2D Data message to a D2H Data message for delivery to the first host, thereby completing the data transfer and cache state transition. In one example, the CXL.cache H2D request comprises an opcode selected from SnpData, or SnpCur; and wherein the CXL.cache D2H request comprises an opcode selected from RdCurr, RdOwn, RdShared, RdAny, RdOwnNoData, ItoMWr, WrCur, CleanEvict, DirtyEvict, CleanEvictNoData, WOWrInv, WOWrInvF, WrInv, or CacheFlushed. The translation logic may select appropriate D2H opcodes based on the specific H2D opcode received, preserving the intent of the original operation while adapting to the protocol requirements of the receiving host. For example, in some implementations the translation logic may translate an H2D request comprising SnpCur to a D2H request comprising RdCurr, and may further respond to the H2D request with a D2H response comprising RspSFwdM, RspIFwdM or RspVFwdV and with a D2H Data comprising data retrieved by the RdCurr D2H request. In other implementations, the translation logic may translate an H2D request comprising SnpData to a D2H request comprising RdShared; and may further respond to the H2D request with a D2H response comprising RspSFwdM and with a D2H Data comprising data retrieved by the RdShared D2H request.

In some implementations, the method further comprises receiving, from the second entity, a CXL.cache H2D Data message comprising cacheline data and command queue identifier (CQID); translating the CXL.cache H2D Data message to a CXL.cache D2H Data message comprising the cacheline data and Unique Queue ID (UQID); and sending the CXL.cache D2H Data message to the first entity. The translation of data messages may enable cacheline data to flow from the second host to the first host via the translation logic. The CQID in the H2D Data message may be translated to a corresponding UQID utilizing a previously stored mapping, enabling proper correlation with the originating request. The cacheline data may include 64 bytes or other cacheline sizes supported by CXL.cache, and may be forwarded without modification or may be subjected to additional processing such as address translation or data transformation.

In some implementations, the method further comprises receiving, from the second entity, a CXL.cache H2D response comprising a GO opcode and command queue identifier (CQID); translating the CXL.cache H2D response to a CXL.cache D2H response comprising Rsp* and Unique Queue ID (UQID); and sending the CXL.cache D2H response to the first entity. The GO response from the second host, such as GO-I, may be translated to Rsp*, such as RspIHitI, for the first host, indicating that the cacheline was not found in the device cache (i.e., the cacheline is in Invalid state). The translation may utilize the previously stored UQID-to-CQID mapping to correctly route the response back to the originating transaction.

In some implementations of the method, the CXL.cache H2D response comprises a GO opcode and a field indicating an Invalid state (GO-I), and wherein the CXL.cache D2H response comprises RspIHitI.

In some implementations, the method further comprises receiving, from the second entity, a CXL.cache H2D Data comprising command queue identifier (CQID); translating the CXL.cache H2D Data to a CXL.cache D2H response comprising *Fwd* and Unique Queue ID (UQID); and sending the CXL.cache D2H response to the first entity. The CXL.cache H2D Data from the second host may be translated to a CXL.cache D2H response comprising *Fwd*, such as RspSFwdM, RspIFwdM, or RspVFwdV, sent to the first host, indicating that a CXL.cache D2H response may be followed by a CXL.cache D2H Data, possibly enabling data transfer from the second host to the first host via the RPU.

In some implementations of the method, the CXL.cache D2H request comprises RdCurr and command queue identifier (CQID); and further comprising translating the CXL.cache H2D Data to a CXL.cache D2H response comprising RspVFwdV and Unique Queue ID (UQID).

In some implementations, the method further comprises receiving, from the second entity, a CXL.cache H2D response comprising a GO opcode and command queue identifier (CQID); translating the CXL.cache H2D response to a CXL.cache D2H Data comprising Unique Queue ID (UQID); and sending the CXL.cache D2H Data to the first entity. The CXL.cache H2D response from the second host may be translated to a CXL.cache D2H Data and sent to the first host, such as in error scenarios where synthesized data may be generated based on error responses from the second host.

In some implementations, the method further comprises exposing a CXL Type-1 device or a CXL Type-2device to the first entity via a first interface, and exposing a CXL Type-1 device or a CXL Type-2 device to the second entity via a second interface. The device type exposure may determine the types of CXL.cache transactions that can be initiated and received by each interface. By exposing appropriate device types to each host, the translation may accommodate different system configurations and use cases. Similar or different device types may be exposed to different hosts simultaneously based on system configuration requirements.

In some implementations of the method, the translating comprises performing translations between the CXL.cache H2D request and the CXL.cache D2H request, wherein the translations comprise translations between Unique Queue ID (UQID) and command queue identifier (CQID), translations between reserved fields, and/or translations between reserved and non-reserved fields. UQIDs and CQIDs may serve as transaction identifiers in their respective protocol directions. Reserved fields in one protocol direction may be mapped to active fields in the other direction, potentially carrying additional metadata or control information.

In some implementations, the method further comprises receiving, from the second entity, a CXL.cache H2D response comprising a GO-S indication and command queue identifier (CQID); translating the CXL.cache H2D response to a CXL.cache D2H response comprising RspSHitSE and Unique Queue ID (UQID); and sending the CXL.cache D2H response to the first entity. The GO-S indication may signify that the second host is providing the cacheline in shared state, permitting concurrent caching by multiple entities. RspSHitSE may indicate to the first host that the cacheline was hit in a clean state and its current state is shared, enabling cacheline state orchestration wherein both the first host and the second host may store the cacheline in shared state. The translation may utilize a previously stored UQID-to-CQID mapping to correctly route the response back to the originating transaction.

In some implementations, the method further comprises receiving, from the second entity, a CXL.cache H2D response comprising a GO-E indication and command queue identifier (CQID); translating the CXL.cache H2D response to a CXL.cache D2H response comprising an opcode selected from RspIHitI, RspIHitSE, or RspIFwdM, and comprising Unique Queue ID (UQID); and sending the CXL.cache D2H response to the first entity. The GO-E indication may signify that the second host has granted exclusive ownership of the cacheline address. The translated D2H response opcode may indicate to the first host that the cacheline is no longer present in the cache abstraction exposed by the translation logic, enabling the first host to transition the cacheline state to exclusive. The selection among RspIHitI, RspIHitSE, or RspIFwdM may depend on the prior state of the cacheline and whether data forwarding is involved, and may enable proper cache coherency protocol completion at the first host.

In some implementations, the method further comprises receiving, from the second entity, a CXL.cache H2D response comprising a GO-M indication and command queue identifier (CQID), and a CXL.cache H2D Data message comprising cacheline data; translating the CXL.cache H2D response to a CXL.cache D2H response comprising RspIFwdM and Unique Queue ID (UQID); and sending the CXL.cache D2H response to the first entity. The GO-M indication may signify that the second host previously held the cacheline in modified state and is relinquishing ownership along with the modified data. RspIFwdM may indicate to the first host that the cacheline was found in modified state and is being forwarded, possibly enabling the first host to transition the cacheline state to modified. The modified cacheline data may be translated from the H2D Data message to a D2H Data message and forwarded to the first host, thereby completing the ownership transfer and data delivery.

In some implementations, the method further comprises exposing a cache abstraction to the first entity via a CXL.cache interface, wherein the cache abstraction acts as a proxy for a cache included in the second entity, and the CXL.cache H2D request targets the cache abstraction. The cache abstraction may appear to the first host as a device cache accessible utilizing CXL.cache transactions, while internally representing or proxying cache resources maintained by the second host. The first host may issue CXL.cache H2D requests, such as snoop requests, that target the cache abstraction, wherein the translation logic may translate these requests to CXL.cache D2H requests that affect actual caches in the second host. This proxy arrangement may enable cache coherency operations between hosts that cannot communicate directly, such as due to protocol direction constraints or address space differences.

In some implementations of the method, the translating enables cacheline state orchestration between a first cache maintained by the first entity and a second cache maintained by the second entity. The cacheline state orchestration may coordinate transitions between cache states, such as Modified, Exclusive, Shared, or Invalid (MESI) states, across the first and second caches maintained by the first and second entities, respectively, wherein a transition of the first cache to a first cache state (e.g., Exclusive) may be coordinated with a transition of the second cache to a second cache state (e.g., Invalid). The translation logic may enable the first entity to influence the cacheline state in the second entity's cache hierarchy by translating H2D requests into corresponding D2H requests that trigger appropriate cache state transitions at the second entity.

In some implementations of the method, the cacheline state orchestration comprises cross invalidation of cacheline states; and/or wherein the cacheline state orchestration enables cache-coherent memory sharing between the first entity and the second entity. Cross invalidation may enable the first host to cause invalidation of cacheline entries in the second host's cache hierarchy, or vice versa, thereby maintaining cache coherency across the multi-host system. The cacheline state orchestration may encompass transitions between various cache states such as Modified, Exclusive, Shared, or Invalid (MESI), or similar cache coherency protocols. The translation logic may track pending transactions and coordinate state transitions to maintain coherency invariants across both cache hierarchies. Additionally or alternatively, cache-coherent memory sharing may enable the first host and the second host to access shared memory regions while maintaining data consistency through the cache coherency protocol. The translation logic may facilitate coherent access by translating snoop operations, read requests, and writeback operations between the hosts, such that memory updates by one host are visible to the other host in accordance with the memory consistency model. Such cache-coherent memory sharing may be utilized in disaggregated memory systems, multi-GPU clusters, heterogeneous computing platforms, or other multi-host architectures.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, a system comprising: first and second interfaces based on Compute Express Link (CXL); a computer coupled to the first and second interfaces, wherein the computer is configured to: receive, from a first entity via the first interface, a CXL.cache Host-to-Device (H2D) request comprising a first address belonging to a first Host Physical Address (HPA) space; translate the CXL.cache H2D request to a CXL.cache Device-to-Host (D2H) request comprising a second address belonging to a second HPA space; and send the CXL.cache D2H request to a second entity via the second interface. The computer may include processing logic, memory for storing translation tables and transaction state, and interface controllers for managing CXL.cache communications with each host. The system may be implemented as a standalone device, integrated into a larger semiconductor component, or distributed across components within a computing platform. The translation capabilities may enable diverse system architectures such as disaggregated memory systems, multi-GPU clusters, or heterogeneous computing platforms. Additionally or alternatively, the computer may further expose a cache abstraction to the first entity via the first interface, wherein the cache abstraction acts as a proxy for a cache included in the second entity. The first host may enumerate and interact with the cache abstraction as a local device cache, while the computer internally translates cache operations to CXL.cache D2H requests directed to the second host. It may enable transparent cache coherency operations across hosts without requiring direct host-to-host communication or protocol-level awareness of the multi-host topology.

In some implementations of the system, the first entity comprises a first host utilizing the first HPA space, and the second entity comprises a second host utilizing the second HPA space; and wherein the computer is further configured to identify an intent indicated by the CXL.cache H2D request, wherein the intent comprises a cacheline state intent for a cacheline address, and wherein the translating is based at least in part on the identified intent. The computer may include logic circuits, processing elements, or firmware that analyze incoming CXL.cache H2D requests and determine the cacheline state intent from request attributes such as opcodes and address values. The identified intent may be utilized to select appropriate translation mappings, D2H request opcodes, and/or address translations. The computer may maintain intent-to-opcode mapping tables or may implement intent identification through combinational logic or state machines.

In various implementations, a system comprising: first and second interfaces based on Compute Express Link (CXL); a computer coupled to the first and second interfaces, wherein the computer is configured to: receive, from a first entity via the first interface, a CXL.cache Host-to-Device (H2D) request; translate the CXL.cache H2D request to a CXL.cache Device-to-Host (D2H) request; and send the CXL.cache D2H request to a second entity via the second interface; wherein the translation enables cacheline state orchestration between a first cache maintained by the first entity and a second cache maintained by the second entity. The system may be implemented as a standalone semiconductor device, integrated into a larger component such as an RPU, or distributed across components within a computing platform. The cacheline state orchestration may coordinate transitions between cache states across both entities, such as transition of the first cache to Exclusive state that is coordinated with transition of the second cache to an Invalid state, wherein translating the CXL.cache messages enables coherency operations that would otherwise be prevented by protocol constraints. The first and second interfaces may expose CXL Type-1 or CXL Type-2 device interfaces to the respective entities, enabling the entities to interact with the system utilizing CXL.cache transactions.

In some implementations of the system, the cacheline state orchestration comprises cross invalidation of cacheline states, and wherein the cacheline state orchestration enables cache-coherent memory sharing between the first entity and the second entity. Cross invalidation may enable the first entity to cause invalidation of cacheline entries in the second entity's cache hierarchy, or vice versa, which may enable the first cache to transition to an Exclusive state coordinated with a transition of the second cache to an Invalid state, thereby maintaining cache coherency across a multi-entity system. Cache-coherent memory sharing may enable the first entity and the second entity to access shared memory regions while maintaining data consistency through the cache coherency protocol. The computer may facilitate coherent access by translating snoop operations, read requests, and writeback operations between the entities, and may be utilized in disaggregated memory systems, multi-GPU clusters, heterogeneous computing platforms, or other multi-entity architectures.

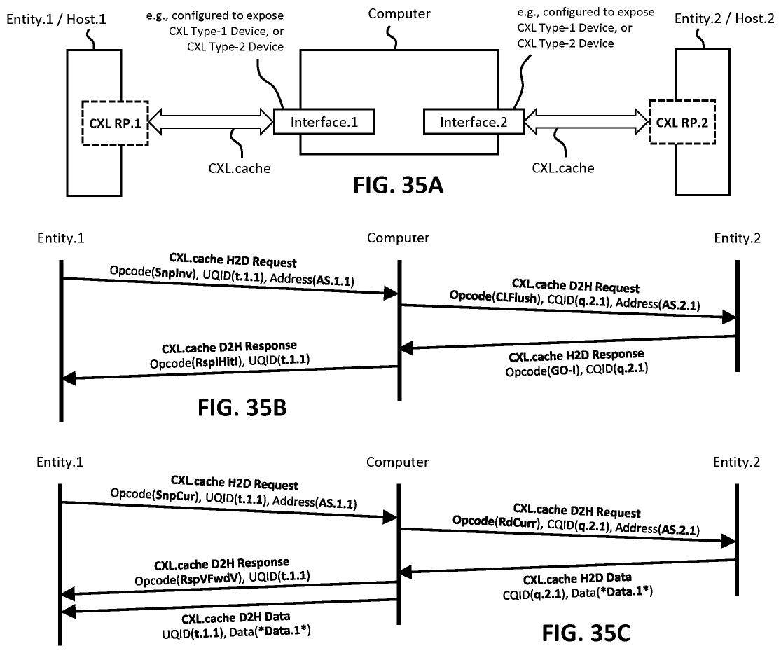

FIG. 35A illustrates an example of a system comprising a computer coupled between a first interface (Interface.1) and a second interface (Interface.2). The first interface may expose a CXL type-1 device or a CXL type-2 device, and may communicate according to a first CXL.cache with a first entity, such as a first host (Host.1), optionally via a first CXL root port (CXL RP.1) of the first entity. Similarly, the second interface may expose a CXL type-1 device or a CXL type-2 device, and may communicate according to a second CXL.cache with a second entity (Entity.2), such as a second host (Host.2), optionally via a second CXL root port (CXL RP.2) of the second entity. The computer may: extract physical addresses within messages received via the first interface, wherein these addresses may be from a first HPA space utilized by the first entity; translate these addresses; and generate messages carrying the translated physical addresses for transmission via the second interface; wherein these translated addresses may correspond to a second HPA space utilized by the second entity. Optionally, the interfaces may be implemented as internal and/or external interfaces of a semiconductor device comprising the computer.

FIG. 35B illustrates an example of a TFD demonstrating translations, performed by a computer, between first CXL.cache messages received from a first entity (Entity.1), such as a first host (Host.1), and second CXL.cache messages sent to a second entity (Entity.2), such as a second host (Host.2), possibly enabling the first entity to maintain, at least partly, memory sharing and/or memory coherency with the second entity, such as by enabling the first entity to invalidate cachelines in the second entity. The first entity may initiate a first CXL.cache transaction that includes a CXL.cache H2D request comprising Opcode(SnpInv), UQID(t.1.1), and Address(AS.1.1). The computer may translate the first CXL.cache transaction to a second CXL.cache transaction that includes a CXL.cache D2H request comprising Opcode(CLFlush), CQID(q.2.1), and Address(AS.2.1), and may send the CXL.cache D2H request to the second entity. Upon receiving a response from the second entity, which may include a CXL.cache H2D response comprising Opcode(GO-I) and CQID(q.2.1), the computer may translate the CXL.cache H2D response to a CXL.cache D2H response comprising Opcode(RspIHitI), and UQID(t.1.1). The computer may perform further translations, such as opcode translations, e.g., translating between CXL.cache H2D request opcodes, such as Snp* (e.g., SnpData, SnpInv, and SnpCur), and CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed. The computer may further perform other translations, such as field translations between messages conforming to the first CXL.cache transaction and messages conforming to the second CXL.cache transaction, such as translations between UQIDs and CQIDs, translations between reserved fields, and/or translations between reserved and non-reserved fields.

FIG. 35C illustrates an example of a TFD demonstrating translations performed by a computer between CXL.cache transactions, wherein the transactions may include messages such as requests, responses, and optionally data messages. A first entity (Entity.1), such as a first host (Host.1), may send to the computer a CXL.cache H2D request comprising Opcode(SnpCur), UQID(t.1.1), and Address(AS.1.1), wherein the CXL.cache H2D request may indicate a snoop request for the current version of a cacheline. The computer may translate the CXL.cache H2D request to a CXL.cache D2H request comprising Opcode(RdCurr), CQID(q.2.1), and Address(AS.2.1), wherein the CXL.cache D2H request may indicate a read request from the computer to the second entity for the current version of the cacheline. The computer may provide intent-based translations, such as by identifying intents in CXL.cache H2D requests received from the first entity, such as intents to get the current version of a cacheline, and utilizing the identified intents for translating between the CXL.cache H2D requests and the CXL.cache D2H requests. The second entity may respond to the CXL.cache D2H request comprising the RdCurr opcode with a CXL.cache H2D Data comprising CQID(q.2.1) and Data(*Data.1*). The computer may translate the CXL.cache H2D Data to a CXL.cache D2H response comprising Opcode(RspVFwdV) and UQID(t.1.1) and may send the CXL.cache D2H response to the first entity. The computer may further translate the CXL.cache H2D Data to a CXL.cache D2H Data comprising UQID(t.1.1) and Data(*Data.1*) and may send the CXL.cache D2H Data to the first entity.

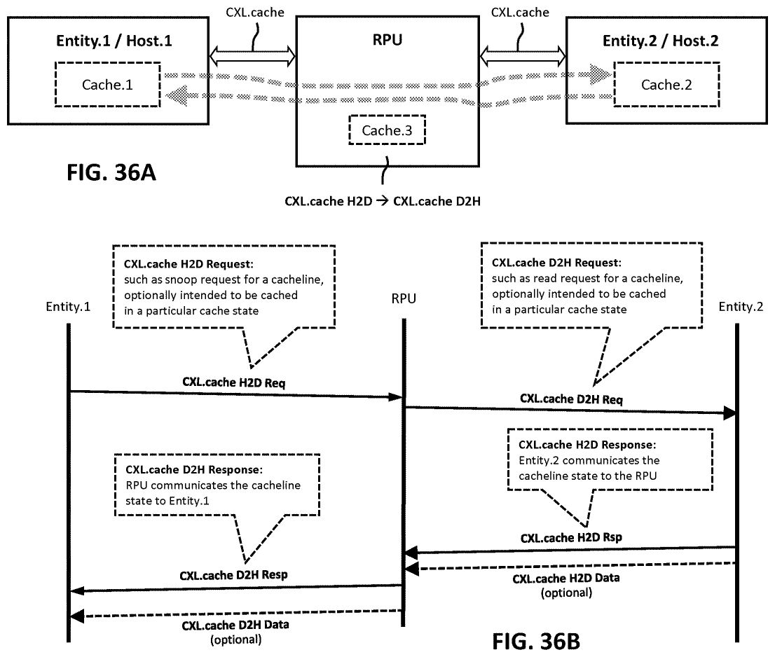

FIG. 36A illustrates an example of a system comprising an RPU and an optional third cache (Cache.3). The RPU may utilize CXL.cache for communicating with a first entity (Entity.1), such as a first host (Host.1), which may include a first cache (Cache.1). The RPU may further utilize CXL.cache for communicating with a second entity (Entity.2), such as a second host (Host.2), which may include a second cache (Cache.2). The RPU may translate between CXL.cache transactions, or between CXL.cache messages, such as between CXL.cache H2D requests and CXL.cache D2H requests, between CXL.cache H2D responses and CXL.cache D2H responses, and optionally between CXL.cache H2D Data messages and CXL.cache D2H Data messages, possibly enabling cacheline state orchestration between the first cache, the second cache, and optionally the third cache, wherein the cacheline state orchestration may be utilized, at least partly, for enabling memory sharing, such as cache-coherent memory sharing, between the first entity and the second entity. In some examples, the first entity may issue CXL.cache H2D requests, such as snoop requests, that may target a cache maintained by the RPU, such as the third cache (Cache.3) that may be included in the RPU. In other examples, the first entity may issue CXL.cache H2D requests, such as snoop requests, that may target a cache abstraction maintained by the RPU, wherein the RPU may act as a proxy for a cache included in the second entity, such as the second cache (Cache.2), and wherein the RPU may affect the second cache utilizing CXL.cache D2H requests that may cause cacheline state transitions in the second cache.

FIG. 36B illustrates an example of a TFD demonstrating translations, performed by an RPU, between CXL.cache transactions, wherein the transactions may include messages such as requests, responses, and optionally data messages. A first entity (Entity.1), such as a first host (Host.1), may send to the RPU a CXL.cache H2D request, such as a snoop request for a cacheline optionally intended to be cached in a particular cache state in the first entity. In a first example, the first entity may send to the RPU a CXL.cache H2D request comprising SnpData, that may indicate a snoop request from the first entity for a cacheline that is intended to be cached in either shared or exclusive state at the first entity. In a second example, the first entity may send to the RPU a CXL.cache H2D request comprising SnpInv, that may indicate a snoop request from the first entity for a cacheline that is intended to be cached in exclusive state at the first entity. The RPU may translate the CXL.cache H2D request to a CXL.cache D2H requests, such as a read request for a cacheline, optionally intended to be cached in particular cache state, and send the CXL.cache D2H requests to the second entity. The RPU may provide intent-based translations, such as by identifying intents in CXL.cache H2D requests received from the first entity and utilizing the identified intents for translating the CXL.cache H2D requests to the CXL.cache D2H requests.

In a first example, the RPU may translate a CXL.cache H2D request comprising SnpData, to a CXL.cache D2H request comprising RdShared, which requests a cacheline read to be cached in shared state, wherein the translation may enable the first entity to transition the cacheline state to shared, resulting in cacheline state orchestration between caches maintained by the first entity and caches maintained by the second entity. In a second example, the RPU may translate a CXL.cache H2D request comprising SnpInv to a CXL.cache D2H request comprising RdOwnNoData, requesting from the second entity to get exclusive ownership of a cacheline address, wherein the translation may invalidate the cacheline maintained by the second entity and may enable the first entity to acquire exclusive ownership and transition the cacheline state to exclusive, resulting in cacheline state orchestration between caches maintained by the first entity and caches maintained by the second entity.

The second entity may respond to the CXL.cache D2H request with a CXL.cache H2D response, which may communicate the cacheline state (e.g., via GO-S, GO-E) from the second entity to the RPU, wherein the RPU may translate the CXL.cache H2D response to a CXL.cache D2H response, which may communicate the cacheline state to the first entity. In some examples, the second entity may also respond to the CXL.cache D2H request with a CXL.cache H2D Data, such as when the second entity forwards modified data or when the CXL.cache D2H request comprises a read opcode, such as RdOwn, that return data. The RPU may translate the CXL.cache H2D Data to a CXL.cache D2H Data, and may send the CXL.cache D2H Data to the first entity. The RPU may perform further translations, such as opcode translations, e.g., translating between CXL.cache H2D request opcodes, such as snoops (e.g., SnpData, SnpInv, or SnpCur), and CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed. The RPU may further perform other translations, such as translations between CXL.cache messages, translations between reserved fields, and/or translations between reserved and non-reserved fields.

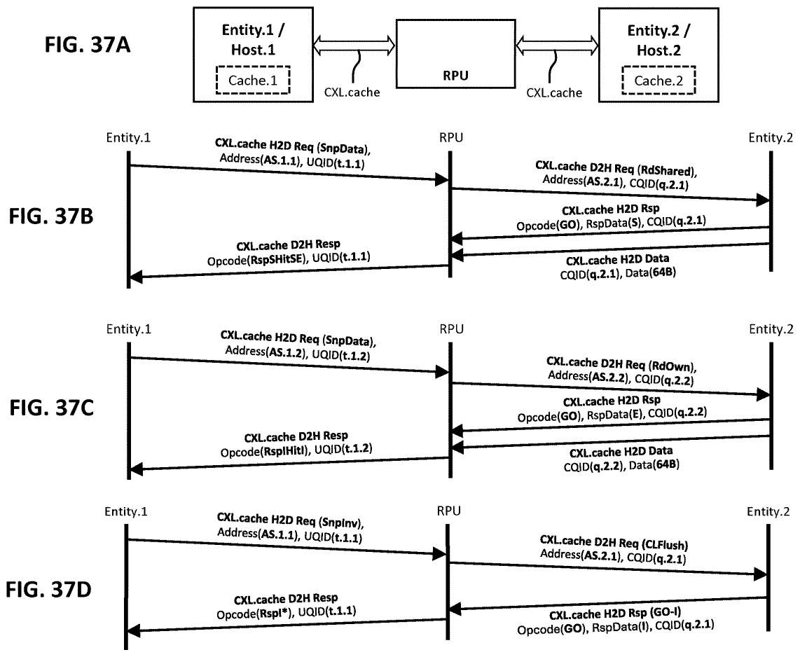

FIG. 37A illustrates an example of a system comprising an RPU that utilizes CXL.cache for communicating with a first entity (Entity.1), such as a first host (Host.1), which may include a first cache (Cache.1). The RPU may further utilize CXL.cache for communicating with a second entity (Entity.2), such as a second host (Host.2), which may include a second cache (Cache.2). The RPU may translate between CXL.cache transactions, or between CXL.cache messages, such as between CXL.cache H2D requests comprising snoops, and CXL.cache D2H requests comprising read opcodes, possibly enabling cacheline state orchestration between the first cache, and the second cache, wherein the cacheline state orchestration may be utilized, at least partly, for enabling memory sharing, such as cache-coherent memory sharing, between the first entity and the second entity.

FIG. 37B illustrates an example of a TFD demonstrating translations, performed by an RPU, between CXL.cache transactions, wherein the transactions may include messages such as requests, responses, and optionally data messages. A first entity (Entity.1), such as a first host (Host.1), may send to the RPU a CXL.cache H2D request comprising SnpData, Address(AS.1.1), and UQID(t.1.1), wherein the CXL.cache H2D request may indicate a snoop request from the first entity to the RPU for a cacheline that is intended to be cached in either shared or exclusive state at the first entity. The RPU may translate the CXL.cache H2D request to a CXL.cache D2H request comprising RdShared, Address(AS.2.1), and CQID(q.2.1), wherein the CXL.cache D2H request may indicate a read request from the RPU to the second entity for a cacheline to be cached in shared state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdShared with a CXL.cache H2D response comprising Opcode(GO), RspData(S), and CQID(q.2.1), and may further respond with a CXL.cache H2D Data comprising CQID(q.2.1) and Data(64 B), wherein the Opcode(GO) and RspData(S) may indicate a GO-S shared state of the cacheline received by the RPU from the second entity. The RPU may translate the CXL.cache H2D response to a CXL.cache D2H response comprising Opcode(RspSHitSE) and UQID(t.1.1), wherein the Opcode(RspSHitSE) may indicate that the line was hit in a clean state and its current state is shared, possibly resulting in cacheline state orchestration between the first cache and the second cache, where both caches may store the cacheline in a shared state. The RPU may further perform other translations, such as translations between CXL.cache messages, translations between reserved fields, and/or translations between reserved and non-reserved fields. In some examples, the first entity may issue CXL.cache H2D requests, such as snoop requests, that may target a cache abstraction maintained by the RPU, wherein the RPU may expose a device cache over CXL.cache that may act as a proxy for caches included in the second entity, and wherein the RPU may affect caches in the second entity utilizing CXL.cache D2H requests that may cause cacheline state transitions in these caches.

FIG. 37C illustrates another example of a TFD demonstrating translations between CXL.cache transactions. A first entity (Entity.1), such as a first host (Host.1), may send to the RPU a CXL.cache H2D request comprising SnpData, Address(AS.1.2), and UQID(t.1.2), wherein the CXL.cache H2D request may indicate a snoop request from the first entity to the RPU for a cacheline that is intended to be cached in either shared or exclusive state at the first entity. The RPU may translate the CXL.cache H2D request to a CXL.cache D2H request comprising RdOwn, Address(AS.2.2), and CQID(q.2.2), wherein the CXL.cache D2H request may indicate a read request to the second entity for a cacheline to be cached in exclusive state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests. The second entity may respond to the CXL.cache D2H request comprising RdOwn with a CXL.cache H2D response comprising Opcode(GO), RspData(E), and CQID(q.2.2), and may further respond with a CXL.cache H2D Data comprising CQID(q.2.2) and Data(64B), wherein the Opcode(GO) and RspData(E) may indicate a GO-E exclusive state of the cacheline received by the RPU from the second entity. The RPU may translate the CXL.cache H2D response to a CXL.cache D2H response comprising Opcode(RspIHitI) and UQID(t.1.2), wherein the Opcode(RspIHitI) may indicate that the cacheline was not found in the caches, possibly resulting in cacheline state orchestration between the first cache and the second cache, wherein the first cache may transition the cacheline state to exclusive given that the second cache does not have that cacheline.

FIG. 37D illustrates an example of a TFD demonstrating translations, performed by an RPU, between CXL.cache transactions, wherein the transactions may include messages such as requests, responses, and optionally data messages. A first entity (Entity.1), such as a first host (Host.1), may send to the RPU a CXL.cache H2D request comprising SnpInv, Address(AS.1.1), and UQID(t.1.1), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising CLFlush, Address(AS.2.1), and CQID(q.2.1), wherein the CXL.cache D2H request may indicate a request from the RPU to the second entity to invalidate (flush) the cacheline. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests. The second entity may respond to the CXL.cache D2H request comprising CLFlush with a CXL.cache H2D response comprising Opcode(GO), RspData(I), and CQID(q.2.1), wherein the Opcode(GO) and RspData(I) may indicate a GO-I and may confirm the invalidation of the cacheline. The RPU may translate the CXL.cache H2D response to a CXL.cache D2H response comprising Opcode(RspI*) and UQID(t.1.1), wherein the Opcode(RspI*), such as RspIHitI, RspIHitSE, or RspIFwdM, may indicate that the line is no longer at the cache, possibly resulting in cacheline state orchestration between the first cache and the second cache, wherein the first cache may transition the cacheline state to exclusive, given that the second cache does not have that cacheline. In some examples, the first entity may issue CXL.cache H2D requests, such as snoop requests, that may target a cache abstraction maintained by the RPU, wherein the RPU may expose a device cache over CXL.cache that may act as a proxy for caches included in the second entity, and wherein the RPU may affect caches in the second entity utilizing CXL.cache D2H requests that may cause cacheline state transitions in these caches.

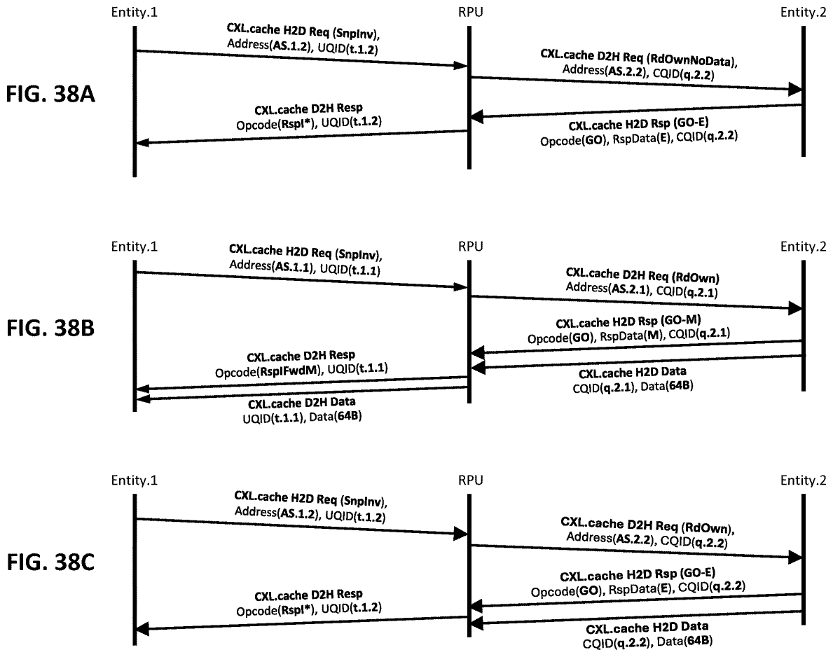

FIG. 38A illustrates an example of a TFD demonstrating translations performed by an RPU between CXL.cache transactions, wherein the transactions may include messages such as requests, responses, and optionally data messages. A first entity (Entity.1), such as a first host (Host.1), may send to the RPU a CXL.cache H2D request comprising SnpInv, Address(AS.1.2), and UQID(t.1.2), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising RdOwnNoData, Address(AS.2.2), and CQID(q.2.2), wherein the CXL.cache D2H request may indicate an intent to get exclusive ownership of the cacheline address indicated in the address field. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests. The second entity may respond to the CXL.cache D2H request comprising RdOwnNoData with a CXL.cache H2D response comprising Opcode(GO), RspData(E), and CQID(q.2.2), wherein the Opcode(GO) and RspData(E) may indicate a GO-E exclusive state of the cacheline received by the RPU from the second entity. The RPU may translate the CXL.cache H2D response to a CXL.cache D2H response comprising Opcode(RspI*) and UQID(t.1.2), wherein the Opcode(RspI*), such as RspIHitI, RspIHitSE, or RspIFwdM, may indicate that the line is no longer at the cache, possibly resulting in cacheline state orchestration between the first cache and the second cache, wherein the first cache may transition the cacheline state to exclusive given that the second cache does not have that cacheline.

FIG. 38B illustrates an example of a TFD demonstrating translations performed by an RPU between CXL.cache transactions, wherein the transactions may include messages such as requests, responses, and optionally data messages. A first entity (Entity.1), such as a first host (Host.1), may send to the RPU a CXL.cache H2D request comprising SnpInv, Address(AS.1.1), and UQID(t.1.1), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising RdOwn, Address(AS.2.1), and CQID(q.2.1), wherein the CXL.cache D2H request may indicate a read request from the RPU to the second entity for a cacheline to be cached in exclusive state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdOwn with a CXL.cache H2D response comprising Opcode(GO), RspData(M), and CQID(q.2.1), and may further respond with a CXL.cache H2D Data comprising CQID(q.2.1) and Data(64B), wherein the Opcode(GO) and RspData(M) may indicate a GO-M, and wherein the RPU may receive the cacheline in Modified state. The RPU may translate the CXL.cache H2D response to a CXL.cache D2H response comprising Opcode(RspIFwdM) and UQID(t.1.1), that may indicate to the first entity that the cacheline being snooped is now in I (Invalid) state after having hit the line in M (Modified) state, possibly resulting in cacheline state orchestration between the first cache and the second cache, wherein the first cache may transition the cacheline state to modified given that the second cache delivered a modified cacheline and was further invalidated.

FIG. 38C illustrates an example of a TFD demonstrating translations performed by an RPU between CXL.cache transactions. A first entity (Entity.1), such as a first host (Host.1), may send to the RPU a CXL.cache H2D request comprising SnpInv, Address(AS.1.2), and UQID(t.1.2), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising RdOwn, Address(AS.2.2), and CQID(q.2.2), wherein the CXL.cache D2H request may indicate a read request from the RPU to the second entity for a cacheline to be cached in exclusive state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdOwn with a CXL.cache H2D response comprising Opcode(GO), RspData(E), and CQID(q.2.2), and may further respond with a CXL.cache H2D Data comprising CQID(q.2.2) and Data(64 B), wherein the Opcode(GO) and RspData(E) may indicate a GO-E exclusive state of the cacheline received by the RPU from the second entity. The RPU may translate the CXL.cache H2D response to a CXL.cache D2H response comprising Opcode(RspI*) and UQID(t.1.2), wherein the Opcode(RspI*), such as RspIHitI, RspIHitSE, or RspIFwdM, may indicate that the line is no longer at the cache, possibly resulting in cacheline state orchestration between the first cache and the second cache, wherein the first cache may transition the cacheline state to exclusive given that the second cache does not have that cacheline.

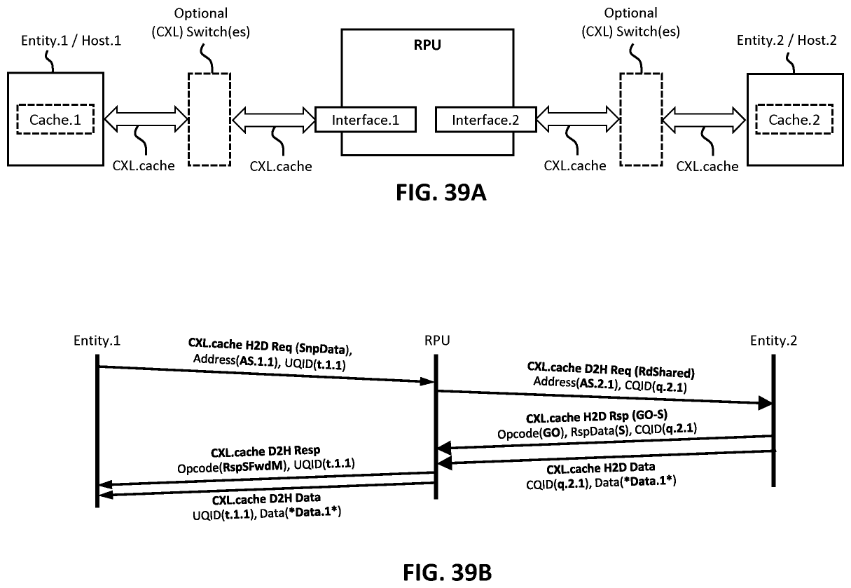

FIG. 39A illustrates an example of a system comprising an RPU that may utilize CXL.cache for communicating with a first entity (Entity.1), such as a first host (Host.1), which may include a first cache (Cache.1). The RPU may further utilize CXL.cache for communicating with a second entity (Entity.2), such as a second host (Host.2), which may include a second cache (Cache.2). The RPU may translate between CXL.cache transactions, and may further translate between CXL.cache messages, such as between CXL.cache H2D requests comprising snoop (e.g., SnpData) opcodes, and CXL.cache D2H requests comprising read opcodes (e.g., RdShared), possibly enabling cacheline state orchestration between the first cache and the second cache, such as cross coordination of cacheline states, wherein the cacheline state orchestration may be utilized, at least partly, for enabling memory sharing, such as cache-coherent memory sharing, between the first entity and the second entity. Optionally, the RPU may be implemented in an IC package having high-speed differential I/O balls positioned according to a ball grid array layout defined by the PCIe 5.0, 6.0, or 7.0 Retimer Supplemental Features and Standard BGA Footprint Specification. The RPU may extract physical addresses within messages received via the first interface, wherein these addresses may correspond to a first HPA space utilized by the first entity; translate these addresses; and generate messages carrying the translated physical addresses for transmission via the second interface; wherein these translated addresses may correspond to a second HPA space utilized by the second entity. Optional CXL switch(es) may be positioned between the first interface and the first entity, and/or between the second interface and the second entity.

FIG. 39B illustrates an example of a TFD demonstrating translations performed by an RPU between CXL.cache transactions, wherein the transactions may include messages such as requests, responses, and optionally data messages. A first entity (Entity.1), such as a first host (Host.1), may send to the RPU a CXL.cache H2D request comprising SnpData, Address(AS.1.1), and UQID(t.1.1), wherein the CXL.cache H2D request may indicate a snoop from the first entity to the RPU for a cacheline that is intended to be cached in either shared or exclusive state at the first entity (the exclusive state may be cached at the first entity only if all devices respond with RspI*). The RPU may translate the CXL.cache H2D request to a CXL.cache D2H request comprising RdShared, Address(AS.2.1), and CQID(q.2.1), wherein the CXL.cache D2H request may indicate a read request from the RPU to the second entity for a cacheline to be cached in shared state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdShared with a CXL.cache H2D response comprising Opcode(GO), RspData(S), and CQID(q.2.1), and may further respond with a CXL.cache H2D Data comprising CQID(q.2.1) and Data(*Data.1*), wherein the Opcode(GO) and RspData(S) may indicate a GO-S, and wherein the RPU may receive the cacheline in Shared state. The RPU may translate the CXL.cache H2D response to a CXL.cache D2H response comprising Opcode(RspSFwdM) and UQID(t.1.1), that may indicate to the first entity that the cacheline being snooped is now in S (Shared) state after having hit the line in M (Modified) state, possibly enabling an explicit delivery of data from the RPU to the first entity. The RPU may further translate the CXL.cache H2D Data to a CXL.cache D2H Data comprising UQID(t.1.1) and Data(*Data.1*). The RPU may utilize *FwdM such as RspSFwdM when translating the CXL.cache H2D response to the CXL.cache D2H response, wherein the *FwdM may enable data transfer from the RPU to the first entity utilizing the CXL.cache D2H Data, irrespective of the actual GO-S response from the second entity. Such translation may enable delivery of a cacheline data in shared state from the second entity to the first entity via the RPU, a path that is not supported by the CXL specification.

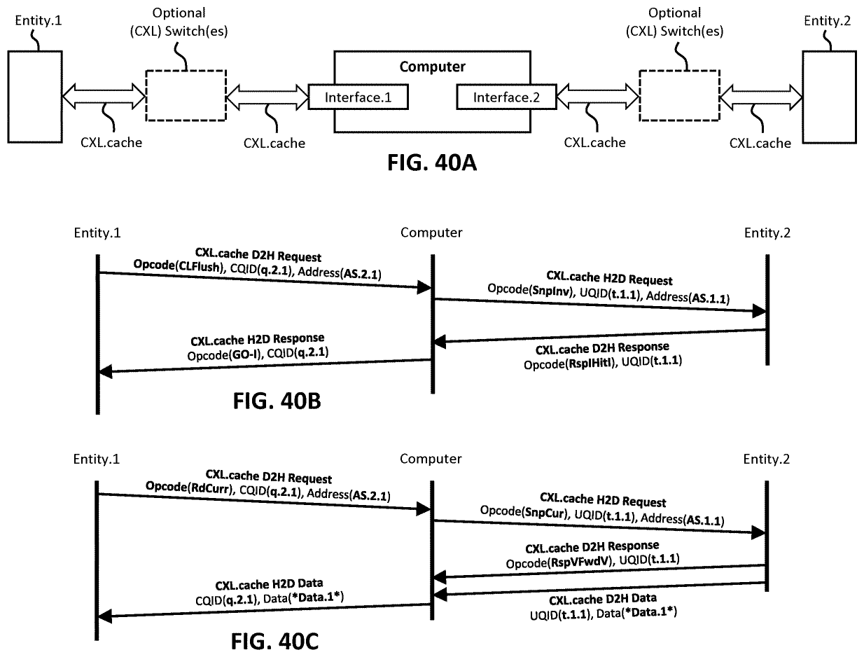

FIG. 40A illustrates an example of a system comprising a computer coupled between a first interface (Interface.1) that may communicate according to CXL.cache with a first entity (Entity.1), and a second interface (Interface.2) that may communicate according to CXL.cache with a second entity (Entity.2), possibly enabling the first entity to communicate with the second entity, such as via affecting cacheline state transitions in the second entity. The computer may extract physical addresses within messages received via the first interface, wherein these addresses may refer to a first physical address space utilized by the first entity; translate these addresses; and generate messages carrying the translated physical addresses for transmission via the second interface; wherein these translated addresses may correspond to a second physical address space utilized by the second entity. In some examples, the first address space and the second address space may be associated with a single HPA space. Optional CXL switch(es) may be positioned between the first interface and the first entity, and/or between the second interface and the second entity. In some examples, the computer may be implemented as a chiplet, or as a functional unit within an IC such as an accelerator, a processor, or a switch. In other examples, the computer may be implemented as a discrete component, such as in an IC package having high-speed differential I/O balls positioned according to a ball grid array layout defined by a PCIe Retimer Supplemental Features and Standard BGA Footprint Specification.

FIG. 40B illustrates an example of a TFD demonstrating translations, such as intent-based translations, performed by a computer, between first CXL.cache messages received from a first entity (Entity.1), such as a first device (Device.1), and second CXL.cache messages sent to a second entity (Entity.2), such as a second device (Device.2), possibly enabling the first entity to maintain, at least partly, cacheline state orchestration, memory coherency, and/or memory sharing with the second entity, such as by enabling the first entity to invalidate cachelines in the second entity. The first entity may initiate a first CXL.cache transaction that may include a CXL.cache D2H request comprising Opcode(CLFlush), CQID(q.2.1), and Address(AS.2.1). The computer may translate the first CXL.cache transaction to a second CXL.cache transaction that may include a CXL.cache H2D request comprising Opcode(SnpInv), UQID(t.1.1), and Address(AS.1.1), and may send the CXL.cache H2D request to the second entity. Upon receiving a response from the second entity, which may include a CXL.cache D2H response comprising Opcode(RspIHitI), and UQID(t.1.1), the computer may translate the CXL.cache D2H response to a CXL.cache H2D response comprising Opcode(GO-I) and CQID(q.2.1).

The computer may perform further translations, such as opcode translations, e.g., translating between CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed, and CXL.cache H2D request opcodes, such as Snp* (e.g., SnpData, SnpInv, and SnpCur). The computer may further perform other translations, such as field translations between messages conforming to the first CXL.cache transaction and messages conforming to the second CXL.cache transaction, such as translations between UQIDs and CQIDs, translations between reserved fields, and/or translations between reserved and non-reserved fields.

FIG. 40C illustrates an example of a TFD demonstrating translations performed by a computer between CXL.cache transactions, wherein the transactions may include messages such as requests, responses, and optionally data messages. A first entity (Entity.1), such as a first device (Device.1), may send to the computer a CXL.cache D2H request comprising Opcode(RdCurr), CQID(q.2.1), and Address(AS.2.1), wherein the CXL.cache D2H request may indicate a read request from the first entity to the computer for the current version of a cacheline. The computer may translate the CXL.cache D2H request to a CXL.cache H2D request comprising Opcode(SnpCur), UQID(t.1.1), and Address(AS.1.1), and may send the CXL.cache H2D request to the second entity, wherein the CXL.cache H2D request may indicate a snoop request from the computer to the second entity for the current version of the cacheline. The computer may provide intent-based translations, such as by identifying intents in CXL.cache D2H requests received from the first entity, such as intents to get the current version of a cacheline, and utilizing the identified intents for translating between the CXL.cache D2H requests and the CXL.cache H2D requests. The second entity may respond to the CXL.cache H2D request comprising the SnpCur with a CXL.cache D2H response comprising Opcode(RspVFwdV) and UQID(t.1.1), and with a CXL.cache D2H Data comprising UQID(t.1.1) and Data(*Data.1*). The computer may translate the CXL.cache D2H Data to a CXL.cache H2D Data comprising CQID(q.2.1) and Data(*Data.1*), and may send the CXL.cache H2D Data to the first entity.

### Terminology

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Resource Provisioning Unit” (RPU) refers to a physical and/or logical processing module comprising or coupled to at least two interfaces and/or ports. The RPU may be implemented in various hardware, firmware, and/or software configurations, such as an ASIC, an FPGA, a logical and/or physical module inside a CPU/GPU/TPU/MxPU, a hardware accelerator, a host, a device, a controller, a switch, a memory pool, and/or a network node. The RPU may be implemented as a single module, a single computer, and/or as a distributed computation entity running on a combination of computing machines, such as ASICs, FPGAs, hosts, servers, network devices, CPUs, GPUs, accelerators, fabric managers, and/or switches. Unless the context indicates otherwise, descriptions of the RPU as comprising its interfaces and/or ports, descriptions of the RPU as being coupled to such elements, and descriptions of such elements as being part of or separate from the RPU, may be used herein interchangeably. Furthermore, references to the RPU performing operations may encompass both direct implementation by the RPU and indirect implementation through components coupled to or associated with the RPU, unless specifically distinguished by the context.

Various implementations described herein involve interconnected computers. The term “computer” refers to a device, an integrated circuit (IC), or a system that includes at least a processor or processing element, memory to store instructions or data, and a communication interface. This definition encompasses a wide range of implementations, including but not limited to: traditional computers, mobile devices, embedded systems, specialized computing elements (such as GPUs, FPGAs, ASICs, and DSPs), System-on-Chip (SoC) designs, network nodes, RPUs, MxPUs, and ICs incorporating processing capabilities, memory, and a communication interface. The processor may be of any type, including single-core or multi-core microprocessors, embedded controllers, accelerators, or any combination thereof. The memory may include volatile or non-volatile storage media. The communication interface allows the processor to send and/or receive data, signals, or instructions, and may include memory interfaces, buses, interconnects, network interfaces, or other arrangements facilitating data exchange. References to a “computer” or a “processor” include any collection of one or more computers and/or processors that individually or jointly execute one or more sets of computer instructions, meaning that the singular term “computer” is intended to imply one or more computers, which jointly perform the functions attributed to “the computer”.

It is noted that in an apparatus comprising interconnect interfaces and/or ports, the computer may be implemented as part of one or more of the interconnect interfaces and/or ports, as a separate component, or as a combination thereof. Unless the context indicates otherwise, operations attributed to the computer may be performed by one or more of the interconnect interfaces and/or ports, and conversely, relevant operations attributed to one or more of the interconnect interfaces and/or ports may be performed by the computer. This interchangeability applies to relevant processing operations described in this specification in relation to elements such as the computer, RPU, MxPU, xPU, switch, or the interconnect interfaces and/or ports.

The term “memory pool” refers to a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, but are not limited to, hosts, servers, processors, accelerators, computing devices, virtual machines, containers, processes, applications, services, operating systems, hypervisors, or other memory pools. Memory pool encompasses relevant implementations that perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. Furthermore, a memory pool may be implemented as a logical entity that borrows, aggregates, or otherwise utilizes memory resources from other entities (such as hosts, devices, or other memory pools), rather than solely relying on dedicated physical memory resources under its direct control.

Depending on the context, the term “inter-socket link” (ISoL) may refer to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as “ISoL ports”, though they may have technology-specific designations. ISoL encompasses direct inter-processor links, switched fabric designs, node controller-based topologies, optical interconnects, and/or heterogeneous computing interconnects linking different processor types. These interconnects support various processor arrangements including those soldered to PCBs, installed in motherboard sockets, or integrated as separate dies within chiplet-based designs.

Non-limiting examples of ISoL technologies include Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); Ethernet for Scale-Up Networking (ESUN), and Scale Up Ethernet (SUE), including SUE-based Protocol Data Units (PDUs) such as SUE PDU, SUE Lite PDU, or PDUs based on future revisions of SUE. Each of these technologies, their successors, and other technologies developed in the future, implements specific port, interface, and protocol designs for inter-processor communication. The interface points for these technologies may have technology-specific designations, such as “UPI port” or “UPI link” for Intel processors, “IF link” or “xGMI link” for AMD processors, “NVLink port”, “NVLink link”, or “NVLink interface” for NVIDIA GPUs, or “UALink port”, “UPLI interface”, or “UPLI interface port” for UALink implementations.

A Cache-Coherent Chip-to-Chip Interconnect (CCCI) refers to a subset of ISoL that enables communication between processors while maintaining cache coherency across chips. CCCI may connect various types of processing units, such as CPUs to CPUs, GPUs to GPUs, CPUs to GPUs, or other combinations of processing units, and may implement cache coherency protocols such as MESI (Modified, Exclusive, Shared, Invalid), MOESI (Modified, Owned, Exclusive, Shared, Invalid), or other coherency schemes. The cache coherency support provided by CCCI may enable the processing units to efficiently share data, maintain memory consistency, and coordinate access to shared resources. Examples of ISoL technologies that function as CCCI include Intel's UPI, AMD's xGMI and Infinity Fabric, ARM's CHI C2C, and NVIDIA's NVLink-C2C.

The term “Physical Layer” or “PHY” refers to hardware and protocol responsible for transmission and reception of signals, typically in the context of data communication wherein raw data bits are converted to physical signal representations, and vice versa, to be sent and received over a target medium such as copper twin-axial (Twinax) cabling, fiber optics, PCB traces for chip-to-chip (C2C) communication, or a silicon interposer for die-to-die (D2D) connectivity. The physical layer (PHY) is typically associated with the lower layer, or layer 1, of the Open System Interconnection (OSI) reference model, and may include, but is not limited to, sub-layers such as a Physical Coding Sublayer (PCS), a Physical Medium Attachment (PMA), and a Physical Medium Dependent (PMD). Examples of physical layers may include the Flex Bus Physical Layer as specified in the various CXL specifications, the collection of physical layers defined by the IEEE 802.3 Working Group, sometimes collectively referred to as “802.3 PHY”, “Ethernet PHY”, or “IEEE 802.3 PMA” when referring to sub-layers of the PHY, such as a PMA. Other PHYs may include UALink physical layers, such as UALink_200 Rev 1.0 that is based on IEEE 802.3dj (D1.4), NVIDIA NVLink physical layers, Ultra Ethernet Transport (UET) physical layers, or other appropriate current or future communication technologies.

When referring to fields, operations, or operation types associated with communication protocols, the terms “opcode”, “command”, “TLP type”, “request”, “request type”, “transaction”, and “transaction type” may be used herein interchangeably as long as they refer to the same operation, and unless a particular context specifies otherwise. This interchangeable usage may apply to data indicative of operation types (such as a field or a set of fields) within messages, packets (such as TLPs), flits, phits, frames, protocol data units (PDUs), or other protocol data structures, as well as descriptions of protocol operations, requests, transactions, or communications across different communication protocols. For example, a “CXL.cache DirtyEvict opcode”, a “CXL.cache DirtyEvict command”, and a “CXL.cache DirtyEvict request” may refer to the same operation where a device communicates with a host, such as via a D2H request message, asking the host to evict a full 64-byte modified cacheline from the device. Likewise, an “ARM CHI ReadOnce opcode”, an “ARM CHI ReadOnce command”, an “ARM CHI ReadOnce request”, and an “ARM CHI ReadOnce transaction” may refer to the same operation that specifies a read within the CHI framework, whether referring to the actual field within a CHI message or to the operation itself. Similarly, a “UPLI read command”, a “UPLI read opcode”, a “UPLI read request”, and a “UPLI read transaction” may refer to the same operation, field, or set of fields within a UPLI message that indicates a read within the UPLI framework.

The CXL Specifications use terms such as message, transaction, command, opcode, request, and response in contexts that sometimes overlap. For example, “MemRd message”, “MemRd command”, and “MemRd opcode” may refer to similar or related concepts. Similarly, “CXL.mem message”, “CXL.mem transaction”, “CXL.mem request”, and “CXL.mem response” may be used in overlapping contexts. Accordingly, depending on the context, this specification may use such terms broadly. Additionally, references to CXL messages may encompass CXL transactions, and vice versa. Moreover, the CXL Specifications occasionally describe CXL.cache and CXL.mem using various terms such as protocols, channels, interfaces, or transactional interfaces, which may be used herein interchangeably depending on the context.

Depending on the context and implementation, the terms “UALink requests”, “UALink UPLI requests”, and “UPLI requests” may be used herein interchangeably. The interchangeable use of these terms reflects that UPLI constitutes the protocol layer of UALink communications, and unless a particular context requires distinction between the physical layer aspects and the protocol layer aspects, these terms may refer to the same underlying communication transactions within the UALink ecosystem.

In the context of ARM CHI implementations, the terms “CHI messages”, “CHI packets”, and “CHI flits” may be used herein interchangeably, unless a particular context specifies otherwise. The ARM AMBA CHI Architecture Specification defines communication granularity at different layers, including transactions at the protocol layer, packets at the network layer, and flow control units (flits) at the link layer. For CHI, packets may include a single flit, which may contribute to the interchangeable use of these terms. When referring to CHI communications herein, any of these terms may be used to describe CHI protocol-level communications without implying limitations to a specific layer or format.

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context. For example, the following pairs may be used herein interchangeably unless a particular context specifies otherwise: CHI interface and CHI port, CXL interface and CXL port, UALink interface and UALink port, and NVLink interface and NVLink port.

The term “Coherent Hub Interface” (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless stated otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term “NVLink” as used herein is intended to encompass previous, current, and future versions, variations, revisions, and equivalent implementations of NVIDIA's NVLink interconnect, including NVLink-C2C, NVLink used with NVSwitch and/or NVLink Switch fabrics, and other NVLink-related implementations that provide a high-bandwidth, low-latency, scalable interconnect between GPUs, between GPUs and CPUs, and/or between other types of processing units. Unless stated otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

### General Considerations

Asterisks (*) may be utilized as wildcard notations within the context of an implementation and/or an example, such as for representing a subset of relevant operations within a broader set of operations that may be indicated by opcodes, TLP types, commands, requests, request types, transactions, or transaction types, collectively referred to in this specific paragraph as “operation types”. The subset of relevant operations may include operation types that are relevant to the revisions or standards being discussed, encompassing both existing operation types and potential future operation types that may be introduced in subsequent versions of the applicable interconnect standards, including CXL, UALink, ESUN, SUE, PCIe, UCIe, ARM CHI, ARM AXI, or protocol implementations based on NVLink technology, provided they are applicable and relevant to the implementation in question. For example, the wildcard operation type ReadOnce* may represent a subset of relevant requests or transactions within the ARM CHI specifications, which may include, but is not limited to: ReadOnce, ReadOnceCleanInvalid, and ReadOnceMakeInvalid. Similarly, the wildcard operation type MemRd* may represent a subset of relevant opcodes within the CXL standard, which may include, but is not limited to: MemRd, MemRdData, MemRdFwd, MemRdTEE, MemRdDataTEE, or other opcodes that may be introduced in future CXL standard revisions, provided they are relevant to the implementation under consideration. Likewise, the wildcard operation type *Rd* may represent a broader subset of relevant operations across different protocols or different standards, which may encompass, but is not limited to: (1) ReadNoSnp, ReadOnce, ReadClean, ReadShared, ReadUnique and MakeReadUnique commands in ARM CHI; (2) UIOMRd and MRd TLP types in CXL.io; (3) RdCurr, RdOwn, RdShared, RdAny, and RdOwnNoData opcodes in CXL.cache; (4) MemRd, MemRdData, MemRdFwd, MemRdTEE, MemRdDataTEE, MemSpecRd, or MemSpecRdTEE opcodes in CXL.mem; (5) read commands in UALink UPLI; (6) memory read TLP types in PCIe; (7) read-class operations in SUE; or (8) read request types in NVLink-based protocol implementations. The examples listed for each protocol are non-limiting and are intended to encompass future operation types that may be introduced in subsequent revisions of the applicable standards, provided they are relevant to the implementations. The wildcard notation does not extend to operation types that are irrelevant to the implementation in question, even if such operation types exist within the broader specifications of the respective standards.

The wildcard form “*Data*” may be utilized for denoting essentially the same underlying information (“the Data”) irrespective of its representation, state, or protocol encoding. *Data* may encompass functionally equivalent forms and transformations of “the Data”, such as encoding, packetization, encapsulation, serialization, scrambling, compression, encryption, segmentation, or splitting, and their respective reverse transformations, represented in a suitable structure, manner, form, or format that may be carried by or interoperate with the applicable interconnect standard specifications, such as CXL, UALink, ESUN, SUE, PCIe, UCIe, ARM CHI, ARM AXI, or NVLink-based protocol implementations. For example, *Data* may refer to the same essential data payload when carried across different hops of a communication path that may each use different encryption, such as when one hop utilizes CXL Integrity and Data Encryption (CXL IDE) and another hop utilizes a different encryption mechanism or no encryption, or when different encryption keys are used on different interconnect links or channels. *Data* may further encompass the same essential data payload when carried in PDUs associated with the same or different protocols, such as: a CXL.mem S2M Data Response (DRS), a CXL.cache H2D Data message, a PCIe Completion with Data (CplD), a PCIe UIO Read Completion with Data (UIORdCplD), a UALink UPLI Data Beat carrying Read Response Data, or an NVLink data transmission. *Data* may also denote PDUs having collectively essentially the same payload, such as when splitting a 128B cacheline into two 64B transfers carried in two separate messages, or when an RPU splits a request for a large data block into smaller requests for translation to another protocol that supports a smaller maximum transfer size per request.

Depending on the context, each line, arrow, label, and/or box illustrated in the figures may represent one or more lines, arrows, labels, and/or boxes. For example, a single arrow representing a *Rd* operation in CXL, UALink UPLI, ESUN, SUE, PCIe, or an NVLink-based protocol may encompass one or more read or data messages relevant to the specific implementation and applicable standard, even though each may be represented by a single arrow. Additionally, optional messages, such as completion, acknowledgment, or response messages in the respective standards, may be explicitly depicted or implicitly included within the mandatory messages or their equivalents.

It is specifically noted that the transaction flow diagrams (TFDs) presented herein are schematic representations, which means that the number, order, timings, dimensions, and other properties of the information illustrated in the TFDs are non-limiting examples. Every modification, variation, or alternative allowed by a current or future Specification mentioned in the TFD (such as CXL, UALink, ESUN, SUE, PCIe, UCIe, CHI, AXI, etc.) that is relevant to a diagram, is also intended to be included within the scope of said diagrams. Furthermore, the scope of these diagrams extends to encompass implementations that may deviate from the strict specifications mentioned in the TFDs due to factors such as hardware bugs, relaxed designs, or implementation-specific optimizations.

Herein, terms such as send/ sending, receive/ receiving, communicate/ communicating, or exchange/ exchanging when used to describe elements (e.g., computer, RPU, MxPU, processor, semiconductor device, switch, port, interface) involved in data, message, packet, or other information exchanges, may refer to direct or indirect operation(s) that facilitate information transfer to/ from/ between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

As used herein, “mounted to” refers to a physical coupling between components, such as cards, boards, or devices, where a first component is mechanically secured or attached to a second component through a suitable mounting mechanism. The physical mounting may be direct or may involve intermediate mounting structures, and encompasses components that are mounted on, mounted in, mounted within, mounted through, mounted under, mounted alongside, or mounted via a mechanical coupling arrangement. The physical mounting connection may include an electrical connection integrated with the mechanical mounting mechanism, such as when a card is inserted into a slot with integrated electrical contacts. Alternatively, the electrical connection between mounted components may be established through a separate element from the mechanical mounting structure. Non-limiting examples of such separate electrical connection elements may include: cables (such as MCIO cables, SlimSAS cables, or power cables), sockets, card edge connectors, PCIe connectors, CXL connectors, backplane connectors, EDSFF connectors, OCP connectors, QSFP-DD connectors, or other electrical interconnects suitable for establishing electrical communication between the mounted components.

References to a protocol “based on” a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the essential accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while maintaining the fundamental interconnect functionality.

References to a protocol-based port (such as CXL-based port, UALink-based port, NVLink-based port, or PCIe-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a CXL-based port may refer to a standard CXL port communicating over PCIe physical layer, a port communicating according to CXL over a physical layer based on IEEE 802.3 PMA, or a port communicating according to CXL over UCIe. A UALink-based port may communicate over its native physical layer, over UCIe, over ESUN, or over SUE. Similarly, an NVLink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

In the context of RPUs and/or translations, references to “first” and “second” protocols may denote either distinct protocol types, which are different protocols with differing opcodes and functionalities (such as CXL.mem vs. CXL.cache, PCIe vs. NVLink, or UALink vs. SUE), or different instantiations of the same protocol type operating in separate domains or with distinct configurations (such as a first CXL.mem utilizing a first physical address space vs. a second CXL.mem utilizing a second physical address space).

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

In implementations where the first domain and the second domain may be associated with the same physical address space, the translator may utilize the address in the transaction associated with the first protocol for generating the address in the transaction associated with the second protocol, possibly copying the address value as is between the messages, or adjusting for address width differences between the messages by zero-extending or truncating unused upper address bits. For example, when translating between CXL-based traffic and ISoL traffic such as UPI, wherein both requests utilize the same physical address space, an address such as (AS.1.1) in a CXL.mem request may be utilized to generate the corresponding address (AS.2.1) in a UPI request. Similarly, when translating between CHI-based traffic and PCIe traffic that share the same physical address space, or between NVLink traffic and CHI traffic in certain configurations, the translator may perform comparable address formatting operations without changing the underlying memory location being referenced. Hence, in relevant contexts, notations in the form of (AS.1.1) and (AS.2.1) used in the drawings may refer to the same address represented in different protocols, such as the address (AS.1.1)=00-00-CA-FE in a protocol that utilizes 32-bit address fields, which corresponds to the address (AS.2.1)=00-00-00-00-00-00-CA-FE in a protocol that utilizes 64-bit address fields.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

We claim:

1. An apparatus comprising:
a processor comprising processing cores coupled via an interconnect;
an interconnect component coupled to the interconnect;
a resource provisioning unit (RPU) coupled to the interconnect component;
a physical layer based on IEEE 802.3 physical medium attachment (PMA), coupled to the RPU, configured to communicate with an external entity;
a Compute Express Link (CXL) device implemented in at least one of the RPU or the interconnect component; and
wherein at least one of the RPU or the interconnect component is configured to translate between CXL transactions and interconnect transactions; wherein the CXL transactions are associated with data communicated with the external entity via the physical layer based on IEEE 802.3 PMA, and the interconnect transactions are communicated via the interconnect.

2. The apparatus of claim 1, wherein the interconnect component comprises an ARM CXL/CCIX Gateway (CCG).

3. The apparatus of claim 1, wherein the interconnect comprises a mesh interconnect, the mesh interconnect comprising crosspoints (XPs) configured to route interconnect transactions between the processing cores, the interconnect component, and memory controllers based on packet identifiers.

4. The apparatus of claim 1, further comprising an I/O-coherent Request Node with Distributed Virtual Memory support (RN-D) coupled to the interconnect, the RN-D configured to handle CXL.io or non-coherent traffic between the CXL device and the processing cores.

5. The apparatus of claim 1, further comprising Subordinate Node (SN-F) nodes coupled to memory controllers, the memory controllers coupled to DRAM via DDR PHY and memory channels.

6. The apparatus of claim 1, wherein the interconnect component comprises a CXL Streaming (CXS) interface and a Coherent Multichip Link (CML) gateway or a Cache Coherent Interconnect for Accelerators (CCIX) Gateway (CXG) that utilizes the CXS interface.

7. The apparatus of claim 1, wherein the interconnect component is configured to initiate a CHI allocating ReadShared request to a Home Node in response to a CXL.mem request, wherein the Home Node is coupled to a memory controller.

8. The apparatus of claim 7, wherein the Home Node is configured to send a ReadNoSnp request to the memory controller, and the memory controller is configured to return data to the interconnect component using a CompData response.

9. The apparatus of claim 1, wherein the CXL device comprises a Global Fabric-Attached Memory Device (GFD) supporting CXL.mem transactions, and the interconnect component is optimized for handling CXL.mem traffic.

10. The apparatus of claim 1, wherein the data communicated with the external entity via the physical layer based on IEEE 802.3 PMA comprises protocol data units (PDUs) of a carrier protocol encapsulating CXL PDUs, and the RPU is configured to extract CXL PDUs from the carrier protocol PDUs.

11. The apparatus of claim 1, wherein the external entity comprises at least one of a GPU, an accelerator, or a switch, and the apparatus is configured to enable the external entity to access memory coupled to memory controllers of the processor via the RPU and the interconnect component.

12. A method comprising:
receiving, via a physical layer based on IEEE 802.3 physical medium attachment (PMA), data from an external entity;
translating, utilizing a Compute Express Link (CXL) device implemented in at least one of a resource provisioning unit (RPU) or an interconnect component coupled to an interconnect of a processor, between CXL transactions and interconnect transactions communicated via the interconnect; and
wherein the processor comprises processing cores coupled via the interconnect, and the CXL transactions are associated with the data received from the external entity via the physical layer based on IEEE 802.3 PMA.

13. The method of claim 12, wherein the data comprises protocol data units (PDUs) of a carrier protocol encapsulating CXL PDUs, and the translating comprises extracting CXL PDUs from the carrier protocol PDUs and reconstructing CXL transactions from the extracted CXL PDUs.

14. An active cable comprising first and second pluggable modules coupled by a physical medium, wherein the active cable further comprises hardware circuitry, integrated into the active cable, configured to perform the method of claim 12.

15. An apparatus configured to operate as a switch, wherein the apparatus comprises switching circuitry and is configured to perform the method of claim 12.

16. An apparatus comprising:
a processor comprising processing cores coupled via an interconnect;
a Compute Express Link (CXL) root port coupled to the interconnect;
a resource provisioning unit (RPU) coupled to the CXL root port;
a physical layer based on IEEE 802.3 physical medium attachment (PMA), coupled to the RPU, configured to communicate with an external entity; and
wherein at least one of the RPU or the CXL root port is configured to translate between CXL transactions and interconnect transactions; wherein the CXL transactions are associated with data communicated with the external entity via the physical layer based on IEEE 802.3 PMA, and the interconnect transactions are communicated via the interconnect.

17. The apparatus of claim 16, wherein the CXL root port is coupled to a fully coherent request node (RN-F) and a fully coherent home node (HN-F) on the interconnect.

18. The apparatus of claim 17, wherein the RN-F enables the external entity to access memory coupled to memory controllers of the processor via the physical layer based on IEEE 802.3 PMA, the RPU, the CXL root port, and the RN-F.

19. The apparatus of claim 17, wherein the HN-F enables the processing cores to access a resource coupled to the external entity via the interconnect, the CXL root port, the RPU, and the physical layer based on IEEE 802.3 PMA.

20. The apparatus of claim 16, wherein the CXL root port is coupled to the interconnect via a CXL/CCIX Gateway (CCG) and an I/O-coherent Request Node with Distributed Virtual Memory support (RN-D).

21. The apparatus of claim 20, wherein the CCG is optimized for handling CXL.mem traffic.

22. The apparatus of claim 20, wherein the RN-D is configured to handle CXL.io or PCIe traffic communicated via the CXL root port.

23. The apparatus of claim 16, further comprising Subordinate Nodes (SN-F) coupled to memory controllers, the memory controllers coupled to DRAM via DDR PHY and memory channels.

24. The apparatus of claim 16, wherein the data communicated with the external entity via the physical layer based on IEEE 802.3 PMA comprises protocol data units (PDUs) of a carrier protocol encapsulating CXL PDUs, and the RPU is configured to extract CXL PDUs from the carrier protocol PDUs.

25. The apparatus of claim 16, wherein the external entity comprises at least one of a GPU, an accelerator, or a switch, and the apparatus is configured to enable the external entity to access memory coupled to memory controllers of the processor via the RPU, the CXL root port, and the interconnect.

26. The apparatus of claim 16, wherein the interconnect comprises a mesh interconnect, the mesh interconnect comprising crosspoints (XPs) configured to route interconnect transactions between the processing cores, the CXL root port, and memory controllers based on packet identifiers.

27. A method comprising:
receiving, via a physical layer based on IEEE 802.3 physical medium attachment (PMA), data from an external entity;
translating, by at least one of a resource provisioning unit (RPU) or a Compute Express Link (CXL) root port coupled to an interconnect of a processor, between CXL transactions and interconnect transactions;
wherein the processor comprises processing cores coupled via the interconnect, the CXL transactions are associated with the data received from the external entity via the physical layer based on IEEE 802.3 PMA, and the interconnect transactions are communicated via the interconnect.

28. The method of claim 27, wherein the CXL root port is coupled to a fully coherent request node (RN-F) and a fully coherent home node (HN-F) on the interconnect, the RN-F enabling the external entity to access memory coupled to memory controllers of the processor, and the HN-F enabling the processing cores to access a resource coupled to the external entity.

29. An active cable comprising first and second pluggable modules coupled by a physical medium, wherein the active cable further comprises hardware circuitry, integrated into the active cable, configured to perform the method of claim 27.

30. An apparatus configured to operate as a switch, wherein the apparatus comprises switching circuitry and is configured to perform the method of claim 27.
